(19) United States
(12) Patent Application Publication
(10) Pub. No.: US 2003/0094354 A1
(43) Pub. Date: May 22, 2003

(54) Operating device

(76) Inventor: Ziad Badarneh, Oslo (NO)

Correspondence Address: Rodman & Rodman, 7 South Broadway, White Plains, NY, 10601, US

(21) Appl. No.: 10/204,332

(22) PCT Filed: Feb. 16, 2001
(86) PCT No.: PCT/NO01/00057

(30) Foreign Application Priority Data
Feb. 18, 2000 (NO) 20000819
Aug. 4, 2000 (NO) 20003974

(51) Int. Cl. H01H 3/00

(52) U.S. Cl. 200/18

(57) ABSTRACT

An operating device having a control button that is tiltable relative to the operating device housing, and where the device has switch elements for actuating on manipulation of the control button, e.g., by tilting, at least one of the switch elements. The control button has a downward projecting, central, spring-supported boss that is rounded at the bottom, is tiltably supported in a tiltable shaft in the housing and, preferably against spring action, is displaceable along a limited portion of the shaft. Projecting from the boss, transverse to the direction of the shaft there is provided a pair of oppositely oriented projections. Located in the housing and spaced from the underside of the control button is a plurality of switch elements that are positioned two-dimensionally. In a first pair of switch elements, each of the elements is designed to be actuated by a respective end area of the shaft on the tilting thereof in one direction or the other. In a second pair of switch elements, each of the elements is designed to be actuated by a respective projection on the tilting of the control button and its boss about the shaft in one direction or the other. In a third pair of switch elements, each of the elements is designed to be actuated by the boss on its sliding movement in a respective direction of the shaft.

The present invention relates to an operating device, e.g., for electronic devices such as telephones, mobile telephones, remote control units, text and character transmitters, calculators, electronic planners, computer equipment, games equipment, alarm equipment, access control equipment or the like, as disclosed in the preamble of attached independent patent claims 1, 13, 22, 23, 24, 34, 35, 39, 40, 45, 50, 51, 52, 56, 59, 63, 68, 69, 87, 94, 100, 102, 104, 106, 108, 110, 111, 112, 113, 114, 117, 118, 124, 138-140, 143, 145, 147, 149, 151, 154, 156-158 and 165.

Moreover, the invention relates to an operating device arrangement as disclosed in claims 134 and 137.

The device is especially designed to be capable of being actuated by the finger of an operator to execute at least two function commands, and preferably where the movement of the control element can be indicated in some way or another, e.g., by sound and/or light and/or display. The use of a plurality of keys or multifunction keys is previously known in connection with devices such as mobile telephones. These keys are operated by the user who presses them. As a general rule, these known function keys are connected to microswitches, and there is therefore only a limited number of functions that are possible through the use of one and the same key without making the functionality complicated and difficult to use. Today's mobile telephones incorporate a great number of functions in addition to the conventional telephone functions, and they are equipped with a memory that at times is similar to that that of a small computer. This means that a user can compile information, e.g., telephone numbers and address lists. Technological advance has had a tendency to move towards mobile telephones that are constructed as complete communication units for text, video and voice by using, for example, the Internet that is normally used on a personal computer (PC). A new format for this application is called WAP and is standard for Internet services for GSM telephones. All these new services and functions require simpler, more logical and more efficient methods for operation and navigation than provided by a conventional keypad. It is clear that a standard push button key pad will require a great number of buttons in order to be capable of providing so many functions and as a result this will render the apparatus difficult or awkward to use, and not least voluminous. With the ever-increasing tendency towards miniaturisation, there are natural limitations, especially in connection with mobile telephones, with respect to how small function keys can be made without creating problems with regard to the operation of the keypad, as the human hand and its fingers set limits for how small the key pad can be.

Thus, the object of the present invention is to provide operating devices where at least two, but preferably a larger number and ranges of functions can be performed by using one and the same control element (optionally divided into two or more parts), where the user can make use of the device for many different apparatuses, preferably mobile telephones, in a simple, logical and reliable manner, to effectively operate through functions and menus, whilst during some operations, such as the use of a mobile telephone (e.g., to dial a number) the user is not dependent upon monitoring the apparatus visually. Accordingly, it is an object of the invention to improve the interface between man and machine.

To illustrate especially well-known and relevant art in this field reference can be made in particular to the Applicant's own International Patent Application PCT/NO99/00373.

The characteristic features of the operating device according to the application will in the main be apparent from independent patent claims 1, 13, 22, 23, 24, 34, 35, 39, 40, 45, 50, 51, 52, 56, 59, 63, 68, 69, 87, 94, 100, 102, 104, 106, 108, 110, 111, 112, 113, 114, 117, 118, 124, 138-140, 143, 145, 147, 149, 151, 154, 156-158 and 165, but also from the subsidiary patent claims related to respective ones of said independent claims.

The characteristic features of the aforementioned arrangement according to the invention will be apparent from claim 134 and associated subsidiary claims, and from claim 137.

The invention will now be described in more detail with reference to the attached drawings.

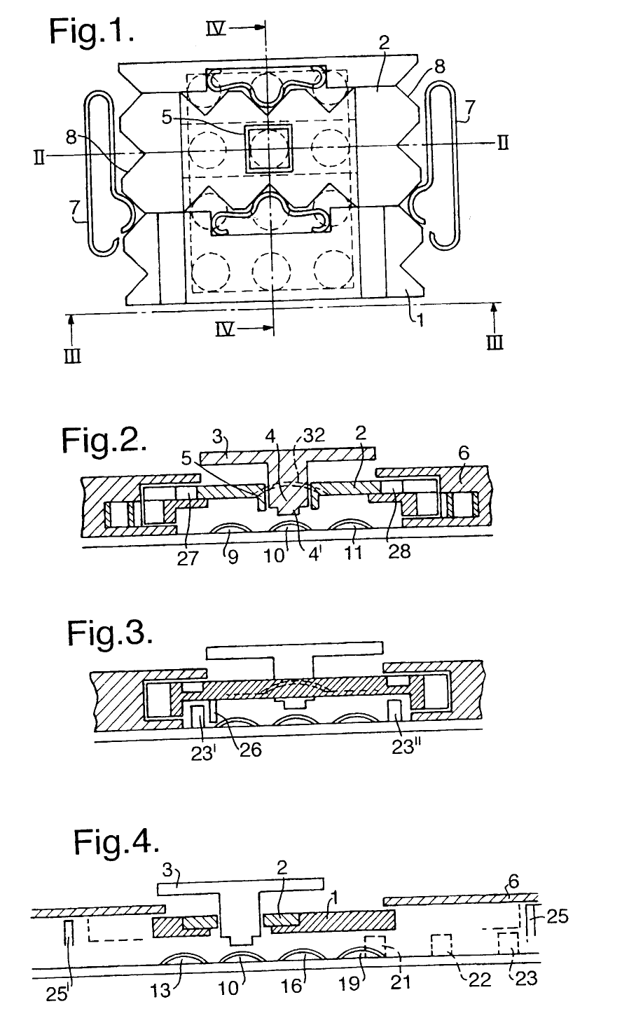

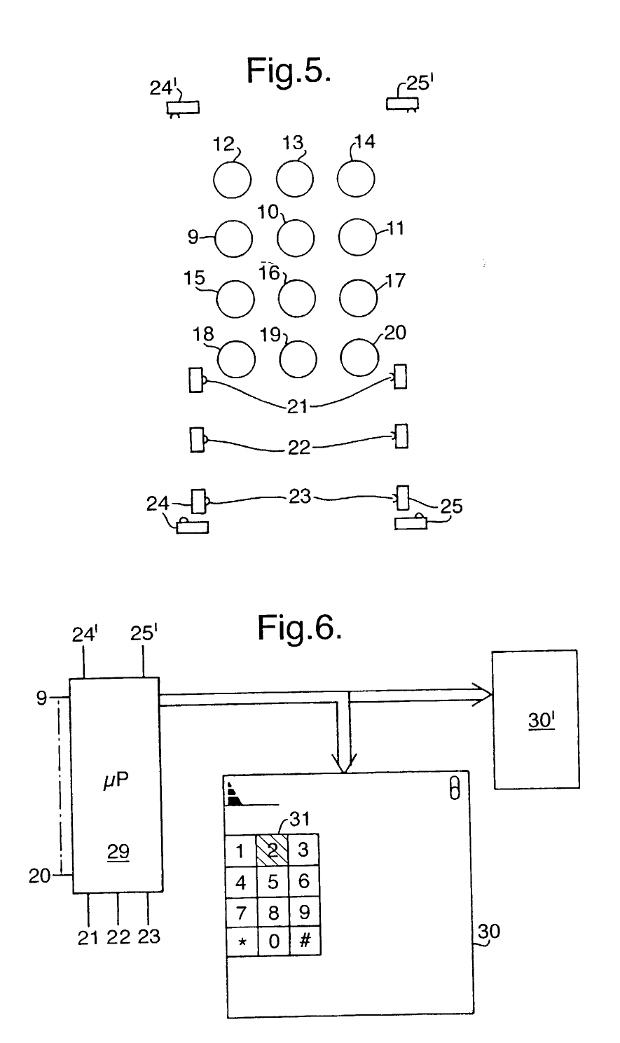

FIGS. 1-6 show a first embodiment of the operating device according to the invention where FIG. 1 shows the device from above; FIG. 2 is a sectional view of the device taken along the line II-II; FIG. 3 is a view taken along the line III-III in FIG. 1; FIG. 4 is in essence a sectional view taken along the line IV-IV is FIG. 1; FIG. 5 shows the location of detectors in the device; and FIG. 6 shows how the location of the detectors can be related to the operation of the operating device.

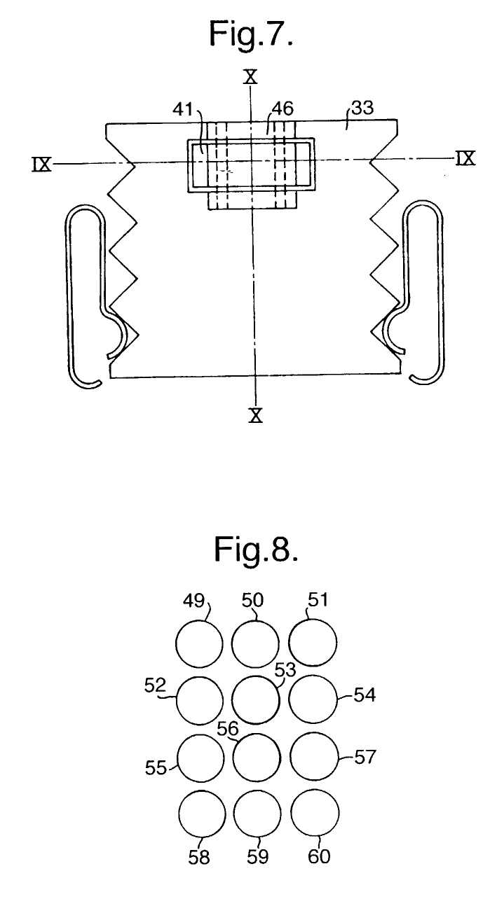

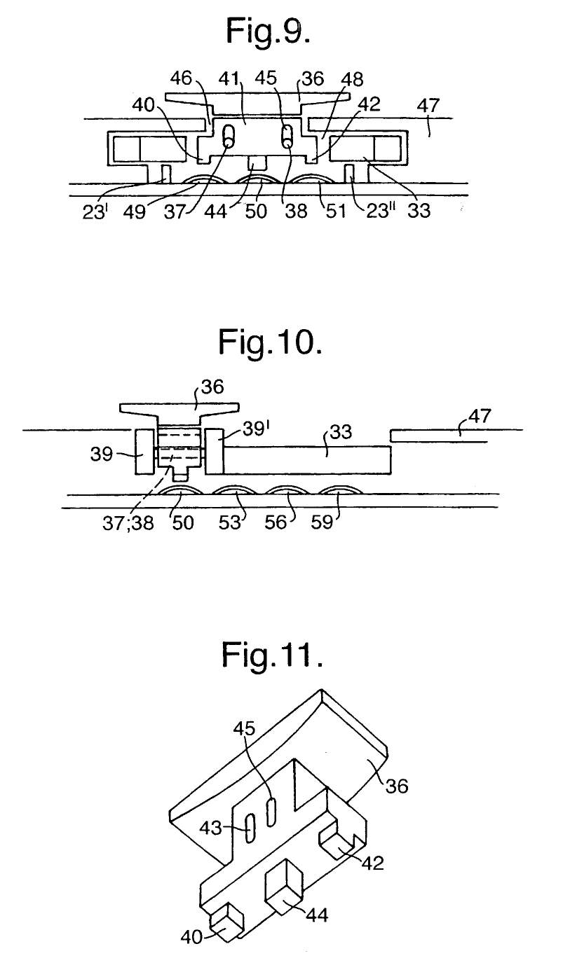

FIGS. 7-11 show a second embodiment of the operating device according to the invention where FIG. 7 shows the device from above, FIG. 8 shows the location of the switches; FIG. 9 is a sectional view taken along the line IX-IX in FIG. 7; FIG. 10 is a sectional view taken along the line X-X in FIG. 7; and FIG. 11 shows in more detail a control button for operating the device.

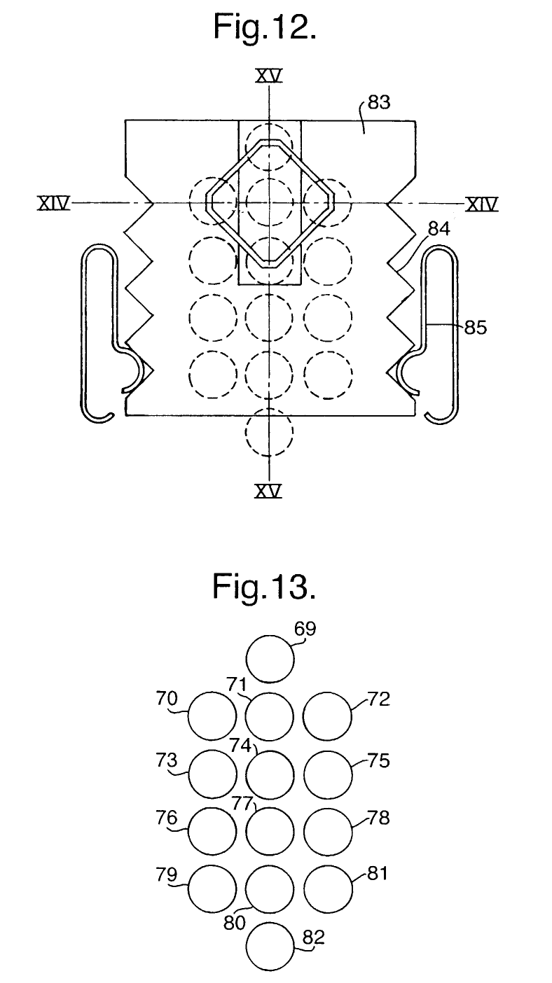

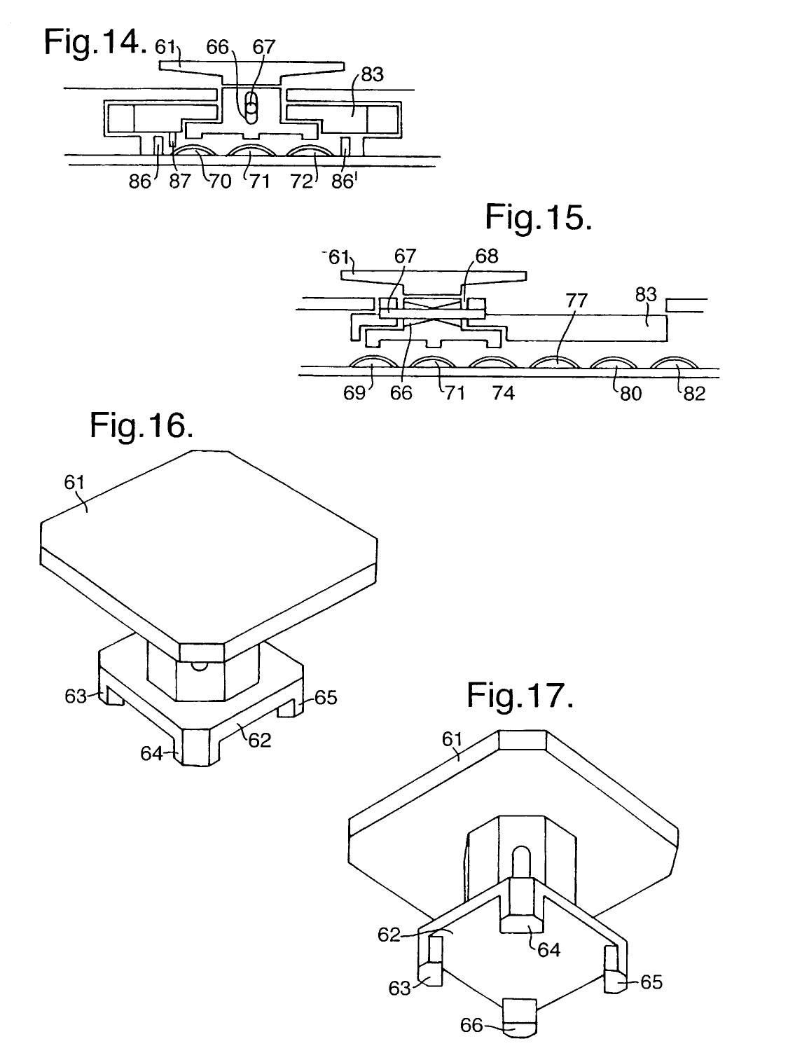

FIGS. 12-17 show a third embodiment of the operating device according to the invention where FIG. 12 shows the device from above; FIG. 13 shows a typical switch array; FIG. 14 is a sectional view taken along the line XIV-XIV in FIG. 12; FIG. 15 is a sectional view taken along the line XV-XV in FIG. 12; and FIGS. 16 and 17 show respectively in perspective from above and in perspective from below a control button for use with the operating device.

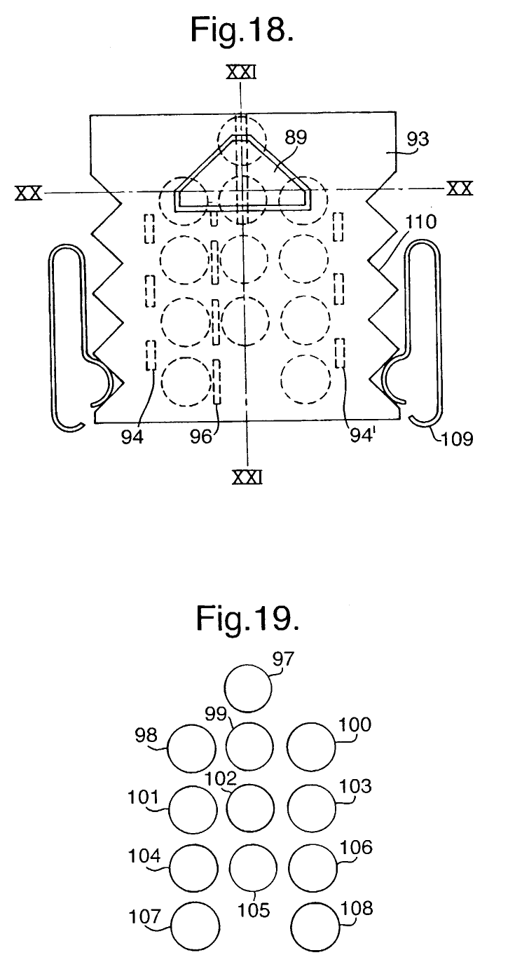

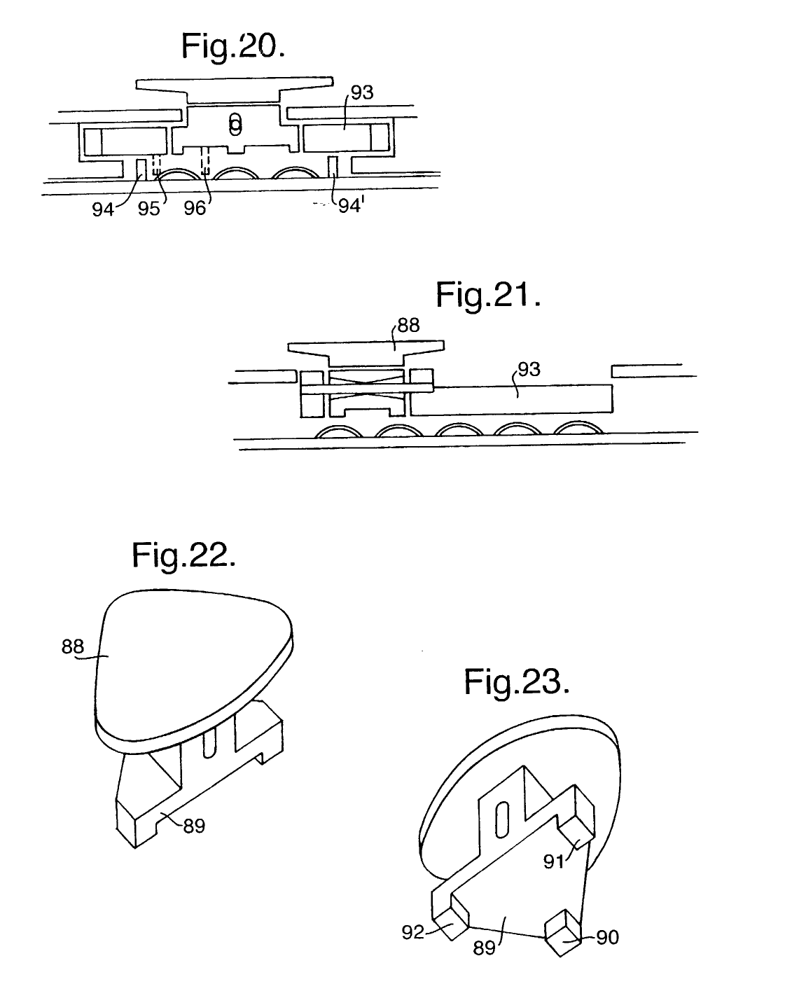

FIGS. 18-23 show a fourth embodiment of the operating device according to the invention where FIG. 18 shows the device seen from above, FIG. 19 shows a typical switch array; FIG. 20 is a sectional view taken along the line XX-XX in FIG. 18; FIG. 21 is a sectional view taken along the line XXI-XXI in FIG. 18; and FIGS. 22 and 23 show respectively in perspective from above and in perspective from below a control button for use with the operating device.

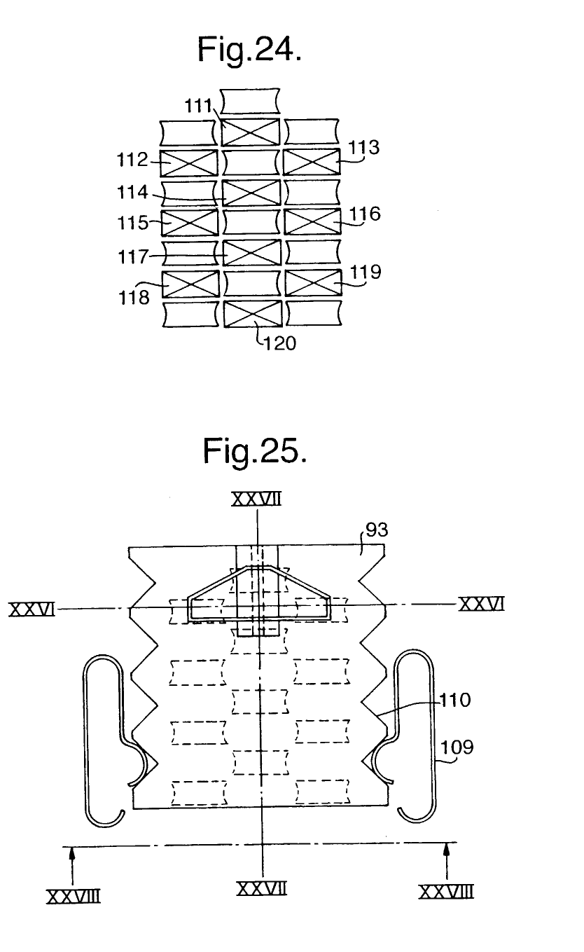

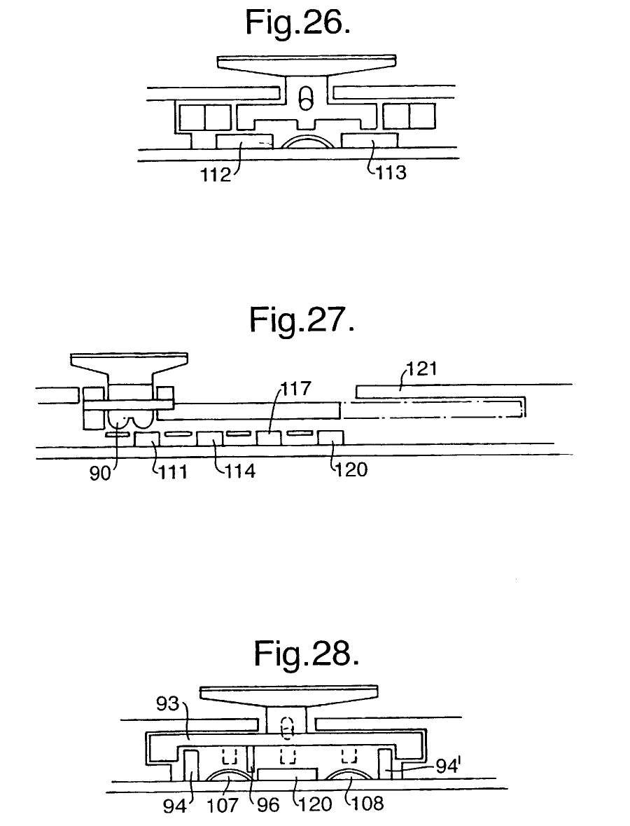

FIGS. 24-28 show a fifth embodiment of the operating device according to the invention, and which must be seen in relation to the embodiment shown in FIGS. 18-23, where FIG. 24 shows a detail of locking means for intermediate positions of the operating device; FIG. 25 is a schematic illustration of the operating device from above; FIG. 26 is a sectional view taken along the line XXVI-XXVI in FIG. 25; FIG. 27 is a sectional view taken along the line XXVII-XXVII in FIG. 25; and FIG. 28 is a sectional view taken along the line XXVIII-XXVIII in FIG. 25.

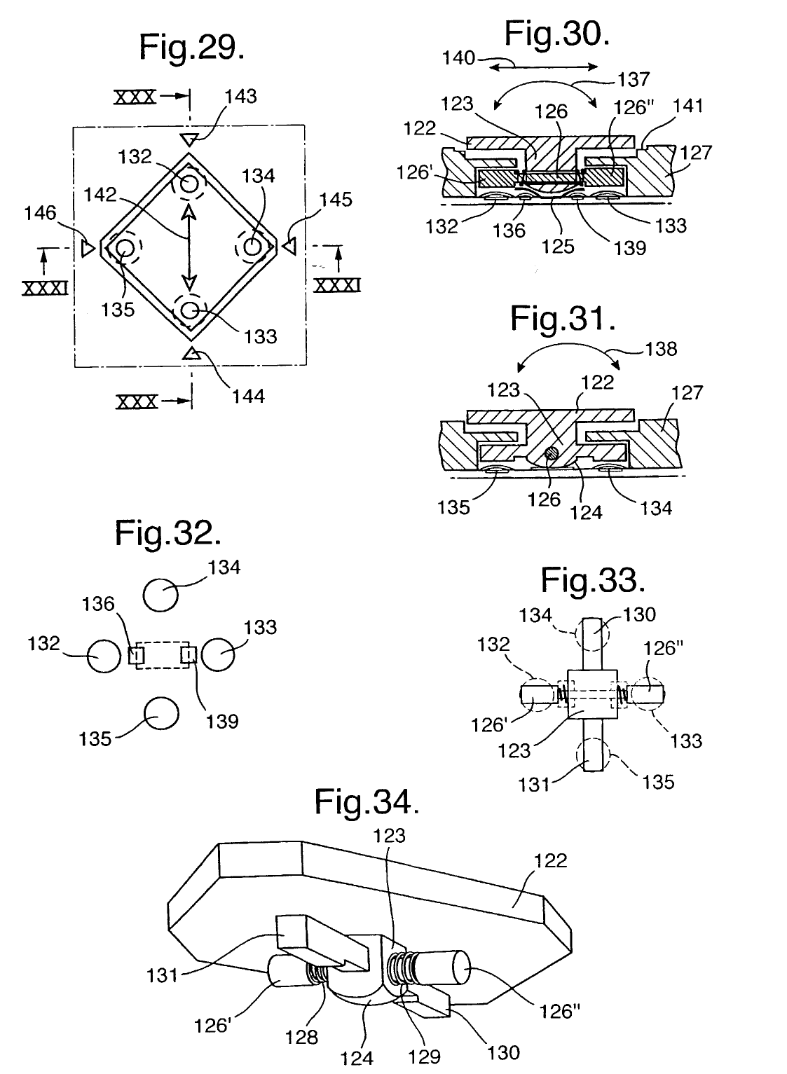

FIGS. 29-34 show the principle of a sixth embodiment of the operating device according to the invention, where FIG. 30 is a sectional view taken along the line XXX-XXX in FIG. 29; FIG. 31 is a sectional view taken along the line XXXI-XXXI in FIG. 29; FIG. 32 shows a detail of the switch array; FIG. 33 shows a detail of the control arms on a control button; and FIG. 34 shows a control button with control arms.

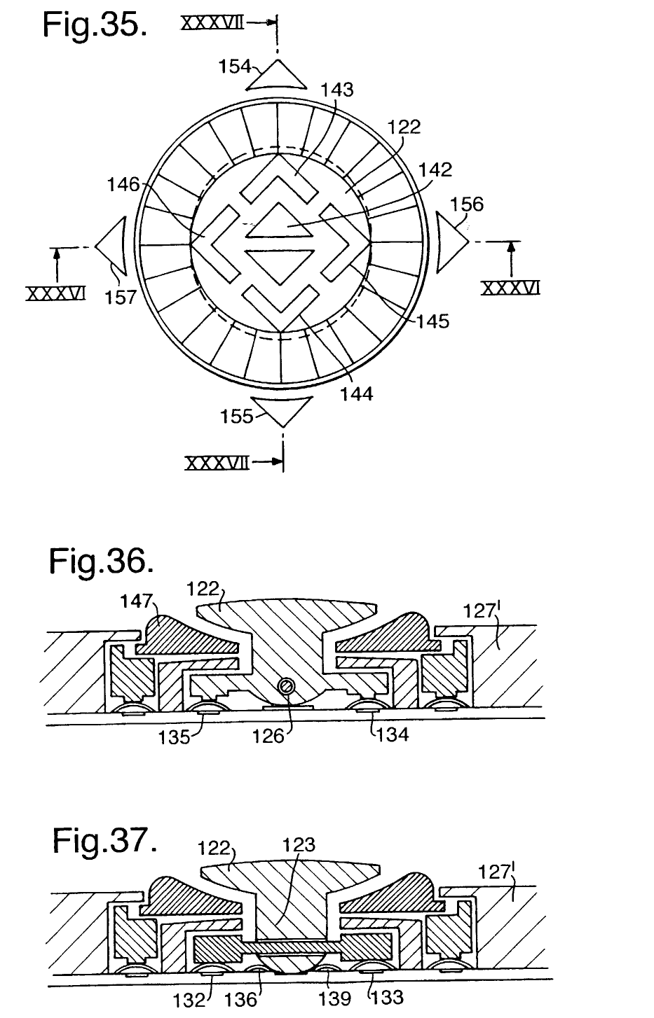

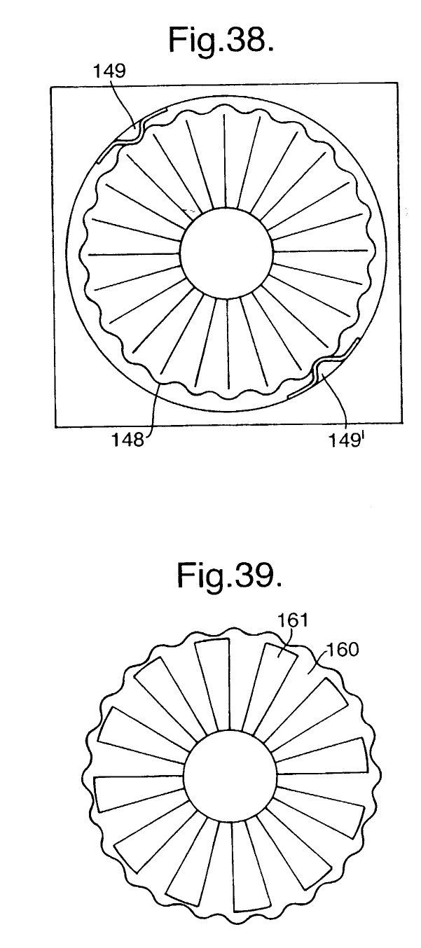

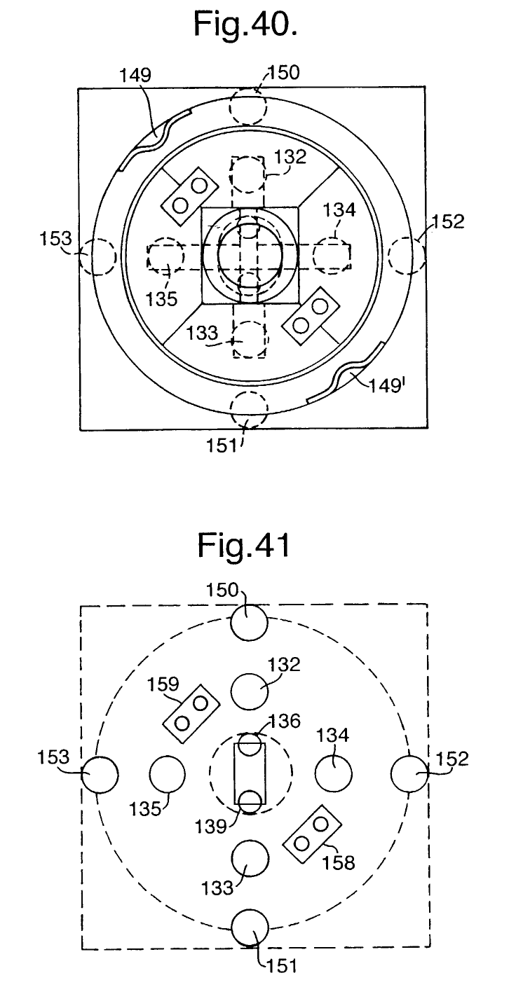

FIGS. 35-41 show a seventh embodiment of the operating device according to the invention as a development of the embodiment according to FIGS. 29-34, where FIG. 35 shows the device from above; FIG. 36 is a sectional view of the device taken along the line XXXVI-XXXVI in FIG. 35; FIG. 37 is a sectional view taken along the line XXXVII-XXXVII in FIG. 35; FIG. 38 shows a control wheel on the device where the control button has been removed; FIG. 39 shows the control wheel seen from below; FIG. 40 shows a part of the operating device through an opening therein, seen from above; and FIG. 41 shows the switches/detectors that are integral parts of the operating device.

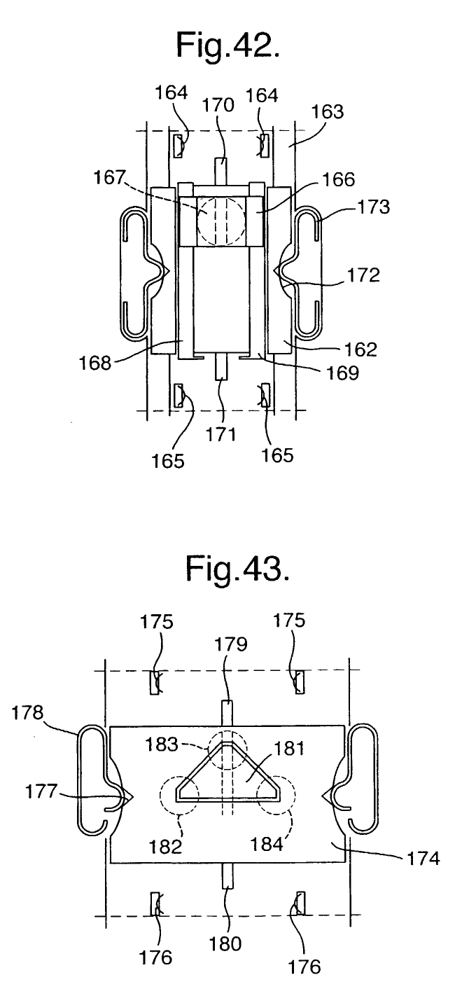

FIGS. 42 and 43 show respectively and eighth and a ninth embodiment of the operating device according to the invention, seen from above.

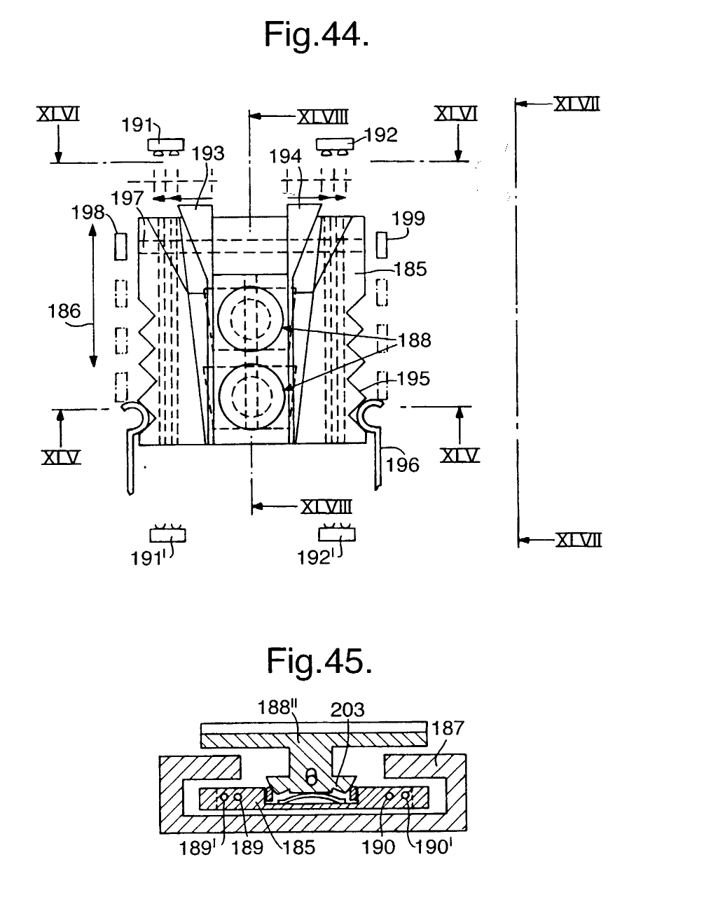

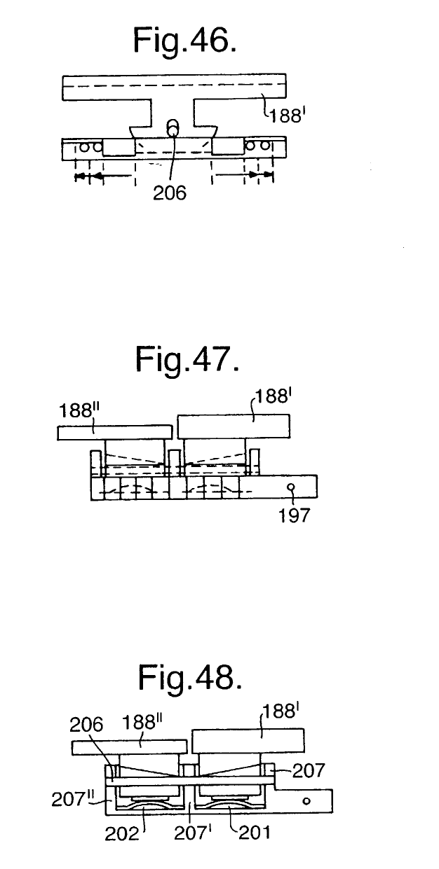

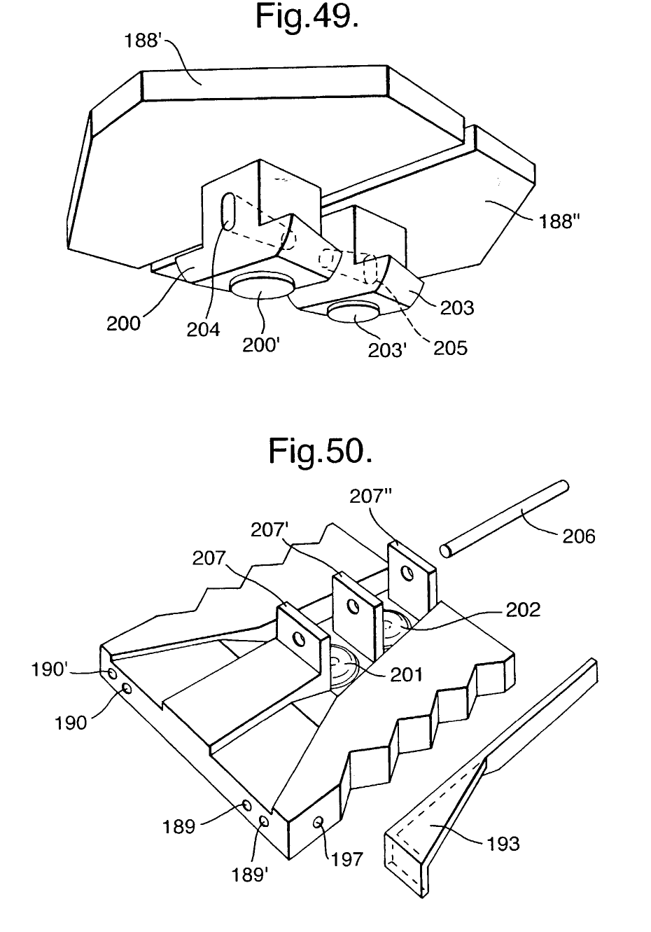

FIGS. 44-50 show a tenth embodiment of the operating device according to the invention, where FIG. 44 shows the operating device from above, FIG. 45 is a view taken along the line XLV-XLV in FIG. 44; FIG. 46 is a view taken along the line XLVI-XLVI in FIG. 44; FIG. 47 is a view taken along the line XLVII-XLVII in FIG. 44; FIG. 48 is a sectional view taken along the line XLVIII-XLVIII in FIG. 44; and FIG. 49 shows the control buttons in FIGS. 47 and 48 seen in perspective from below for interaction with the bottom part of the operating device as shown in perspective from above in FIG. 50.

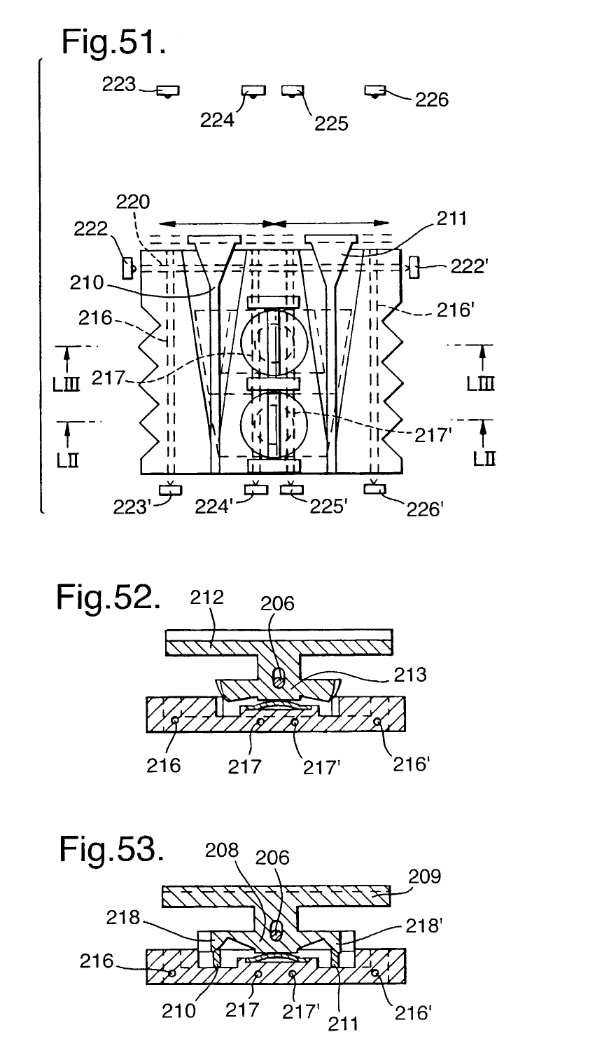

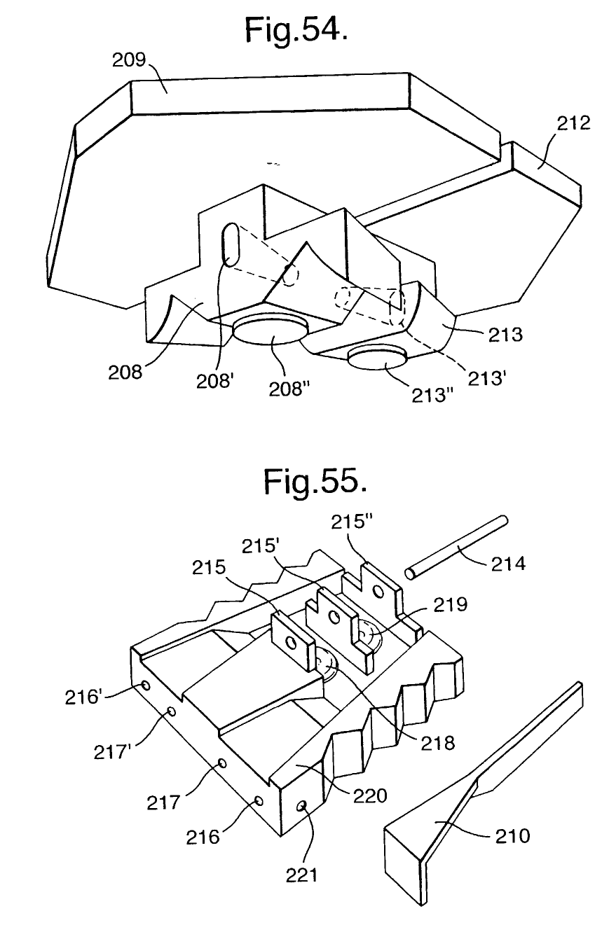

FIGS. 51-53 show an eleventh embodiment of the operating device according to the invention and as a modification of the operating device shown in FIGS. 44-50, where FIG. 51 shows the operating device seen from above, FIG. 52 is a sectional view taken along the line LII-LII in FIG. 51; FIG. 53 is a view taken along the line LIII-LIII in FIG. 51; and where FIG. 54 shows in perspective from below control buttons for use with the operating device and FIG. 55 shows in principle a bottom part of the operating device for use with the control buttons as shown in FIG. 54.

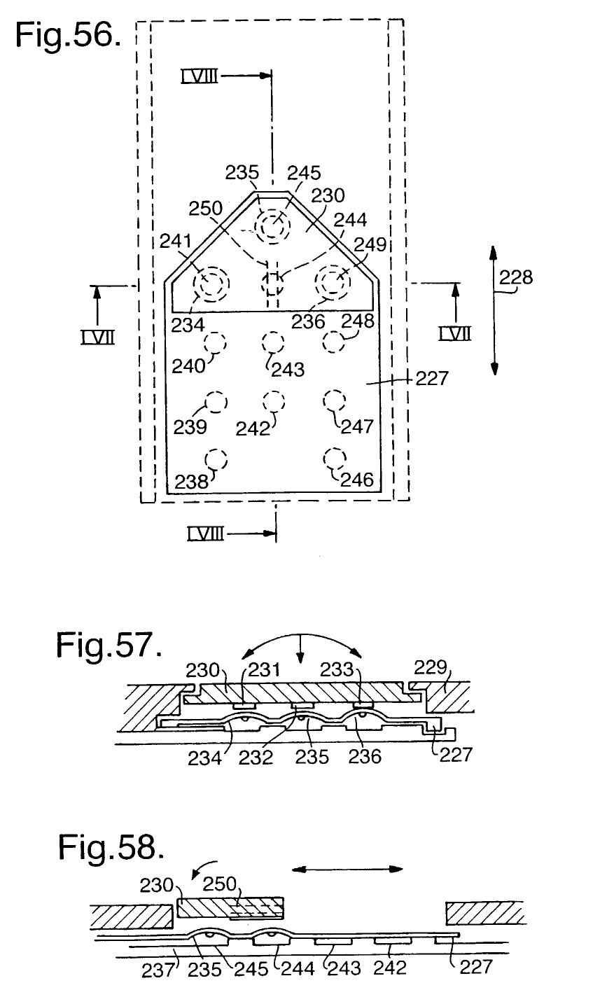

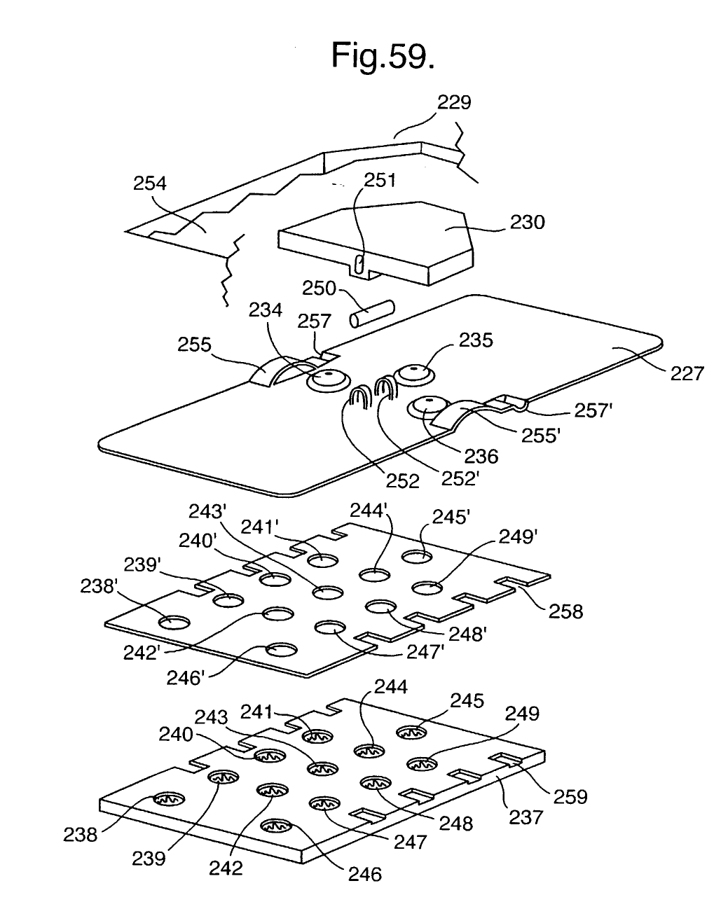

FIGS. 56-59 show a twelfth embodiment of the operating device according to the invention, where FIG. 56 shows the operating device from above, FIG. 57 is a sectional view of the operating device taken along the line LVII-LVII in FIG. 56; FIG. 58 is a sectional view taken along the line LVIII-LVIII in FIG. 56; and FIG. 59 is an exploded view of the operating device.

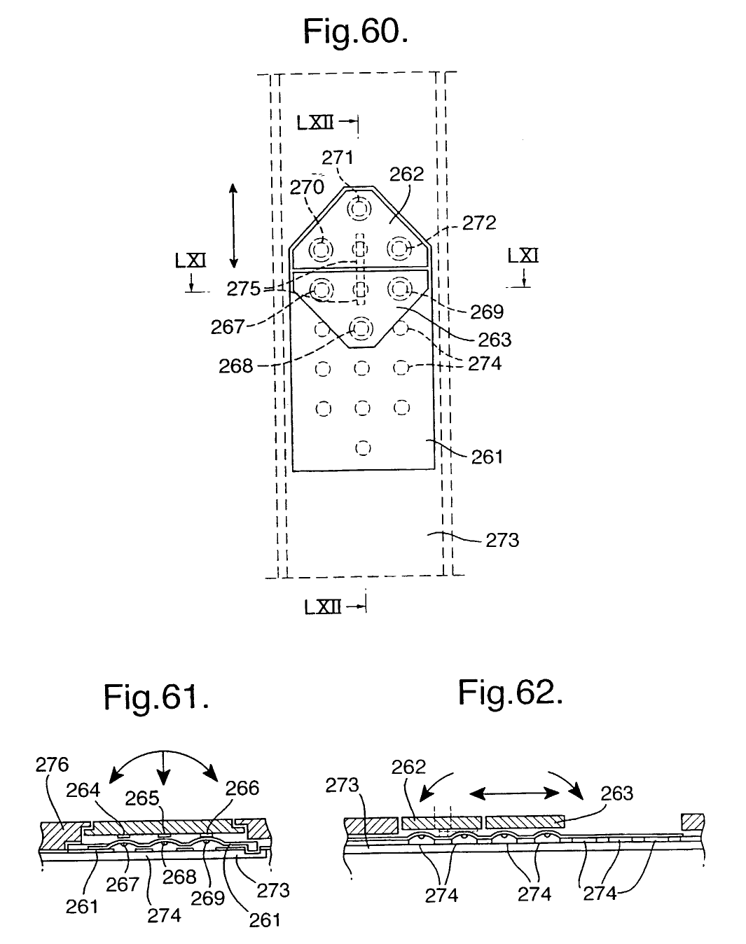

FIGS. 60-62 show a thirteenth embodiment of the operating device according to the invention where FIG. 60 shows the device from above, FIG. 61 is a sectional view taken along the line LXI-LXI in FIG. 60; and FIG. 62 is a sectional view taken along the line LXII-LXII in FIG. 60.

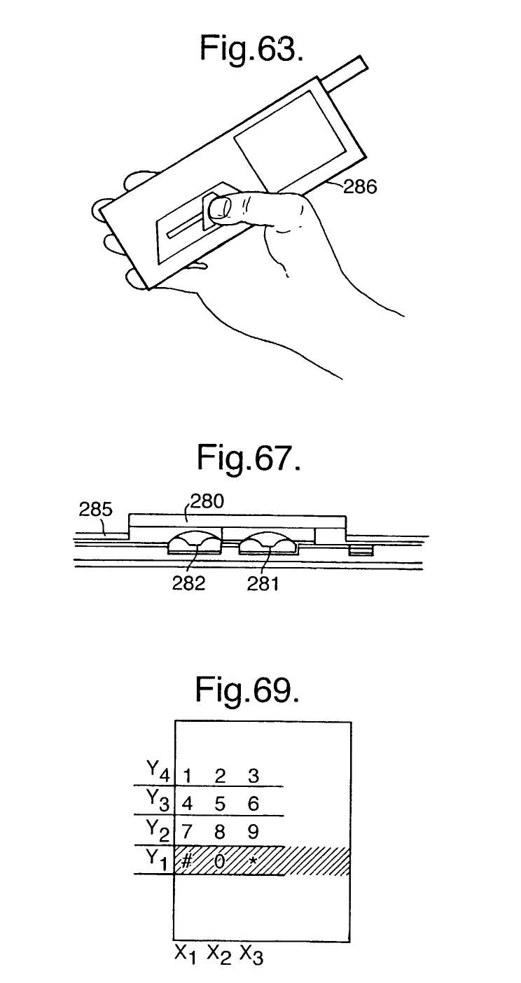

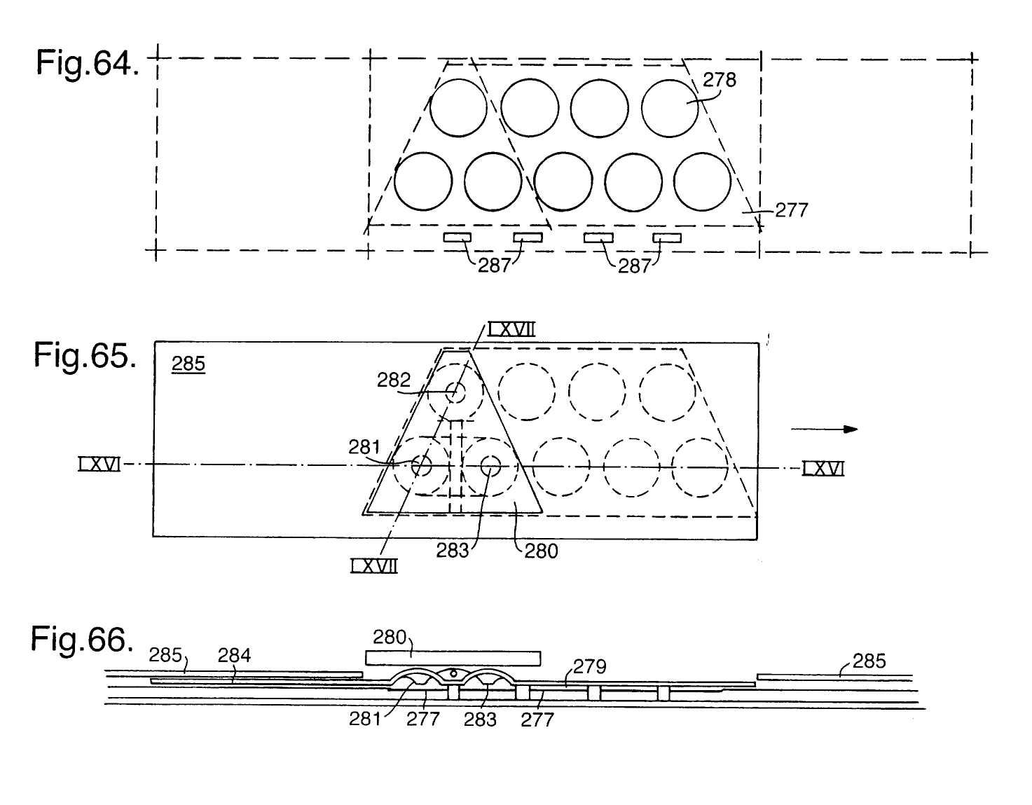

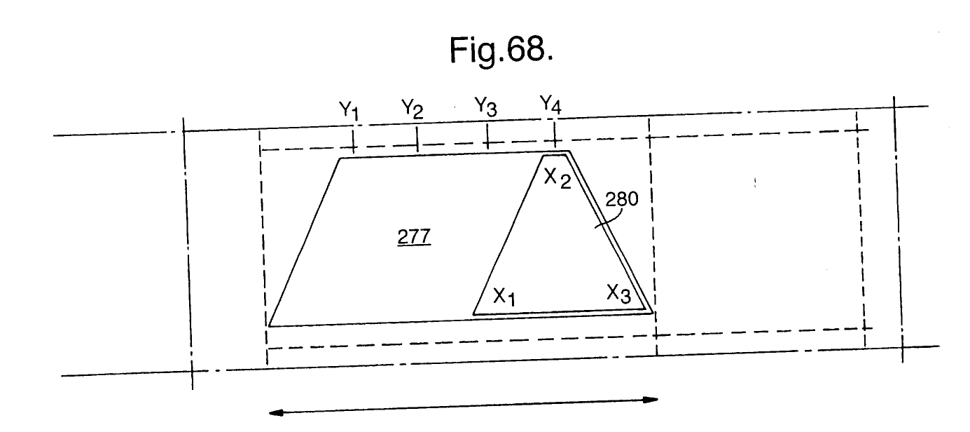

FIGS. 63-69 show a fourteenth embodiment of the operating device according to the invention, as a variant of the device shown in FIGS. 56-59 and 60-62, and where FIG. 63 is a schematic diagram showing the use of the device in connection with a mobile telephone; FIG. 64 shows the structure of the base plate in connection with the device; FIG. 65 shows the arrangement in FIG. 64 with control button and associated coverings; FIG. 66 is a sectional view taken along the line LXVI-LXVI in FIG. 65; FIG. 67 is a sectional view taken along the line LXVII-LXVII in FIG. 65; FIG. 68 shows the device from above for practical use; and FIG. 69 shows the relation to FIG. 68 as regards X and Y coordinates

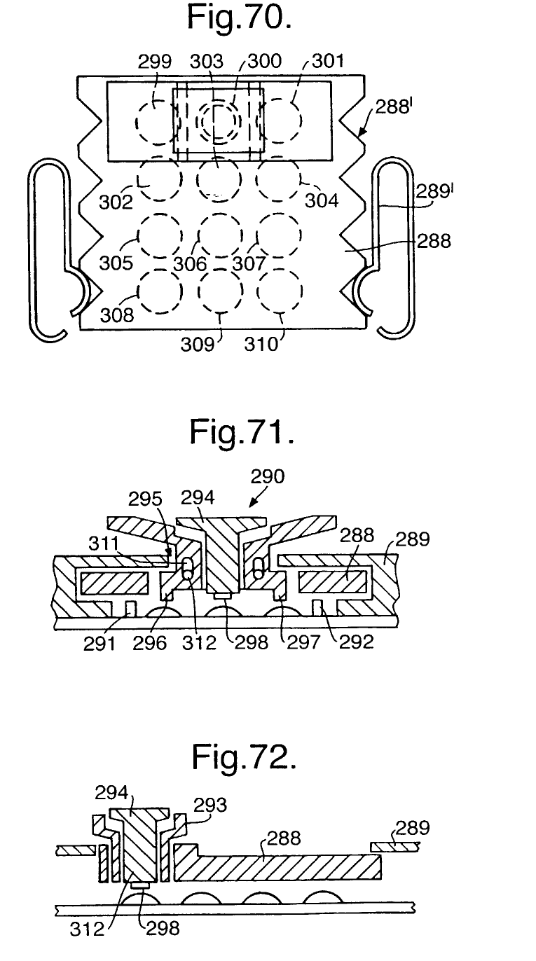

FIGS. 70-72 show a fifteenth embodiment of the operating device according to the invention, where FIG. 70 shows the device from above; FIG. 71 is a sectional view taken along the line LXXI-LXXI in FIG. 70; and FIG. 72 is a sectional view taken along the line LXXII-LXXII in FIG. 70.

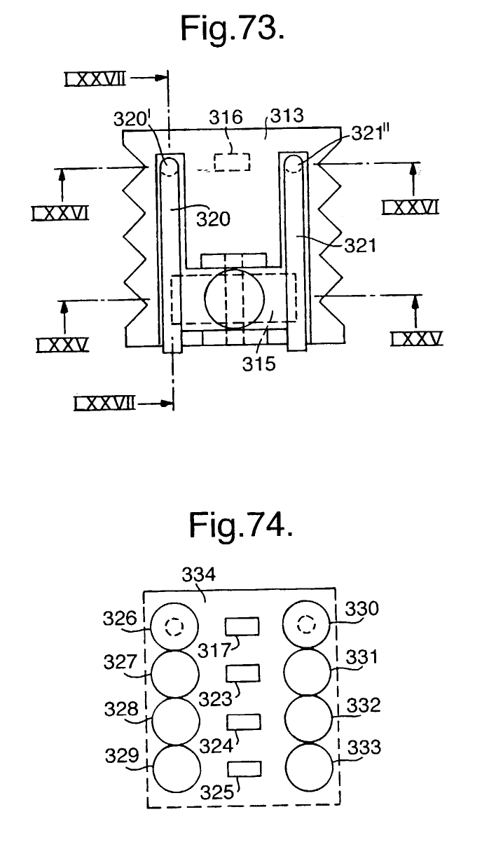

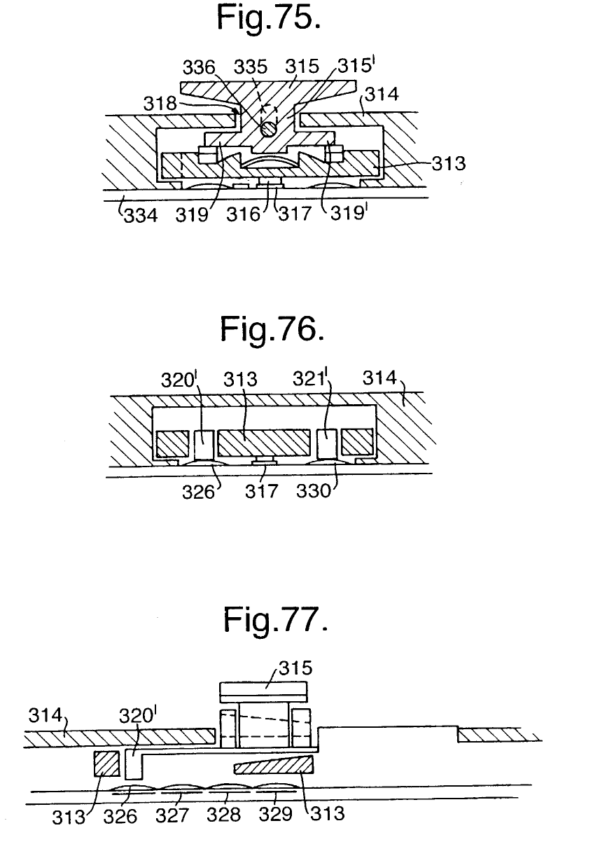

FIGS. 73-77 show a sixteenth embodiment of the operating device according to the invention, where FIG. 73 shows the device from above; FIG. 74 shows a base plate with switches; FIG. 75 is a sectional view taken along the line LXXV-LXVV in FIG. 73; FIG. 76 is a sectional view taken along the line LXXVI-LXXVI in FIG. 73; and FIG. 77 is a sectional view taken along the line LXXVII-LXXVII in FIG. 73.

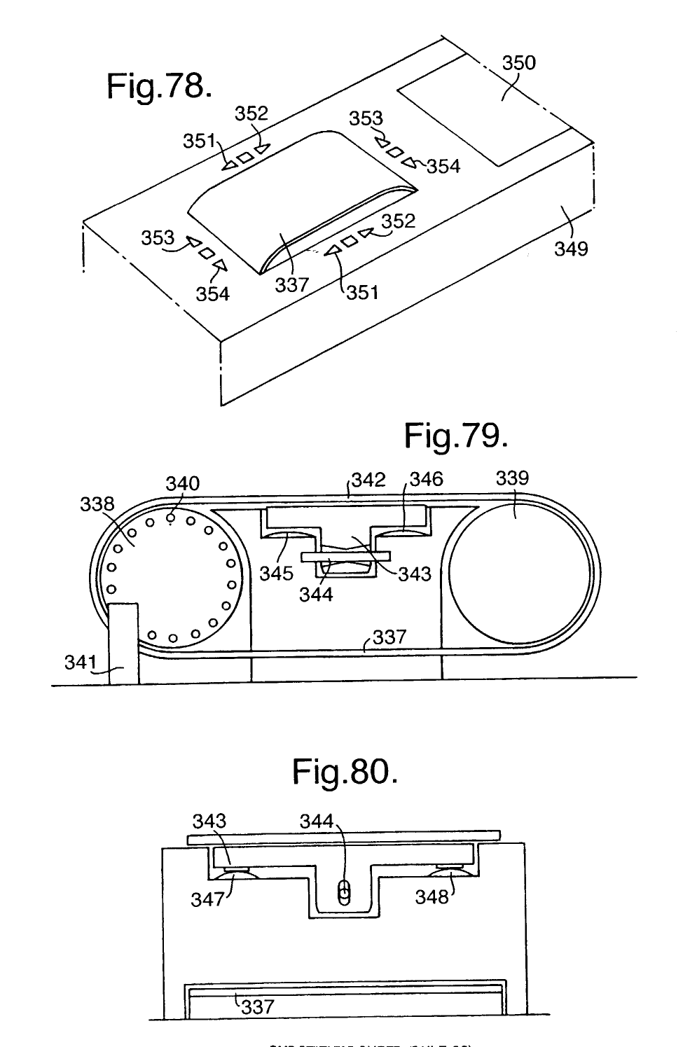

FIGS. 78-80 show as a seventeenth embodiment a simplified embodiment of the device disclosed in International Patent Application PCT/NO99/00373, and where through this reference the section of the description in the PCT application pertaining to FIGS. 80-87 is now incorporated in the present description.

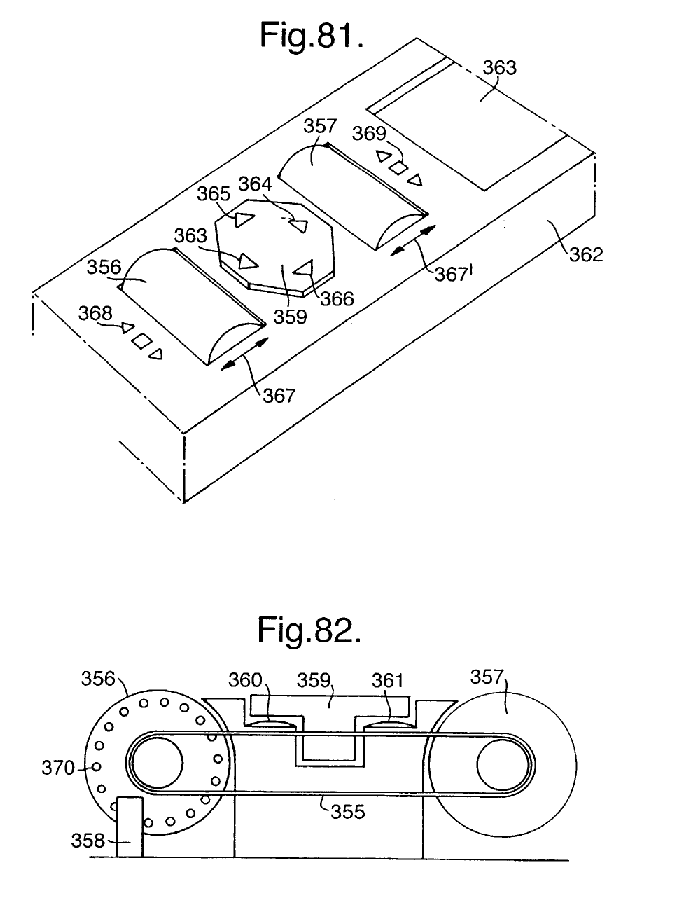

FIGS. 81 and 82 show as an eighteenth embodiment a variant of the embodiment shown in FIGS. 78-80, and with in addition the use of a four-way switch.

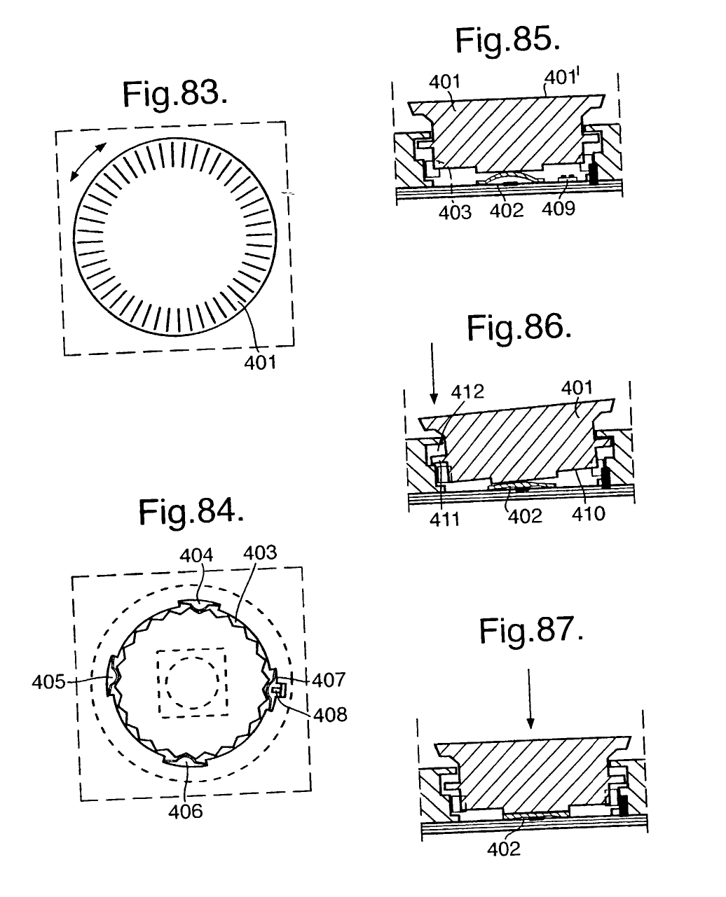

FIGS. 83-87 show a nineteenth embodiment of the device according to the invention where FIG. 83 shows the operating device from above; FIG. 84 shows the operating device with the top rotatable disc removed; FIG. 85 shows a cross-section of the operating device; and FIG. 86 shows the operating device in a tilting position, whilst FIG. 87 shows the operating device in a depressed position.

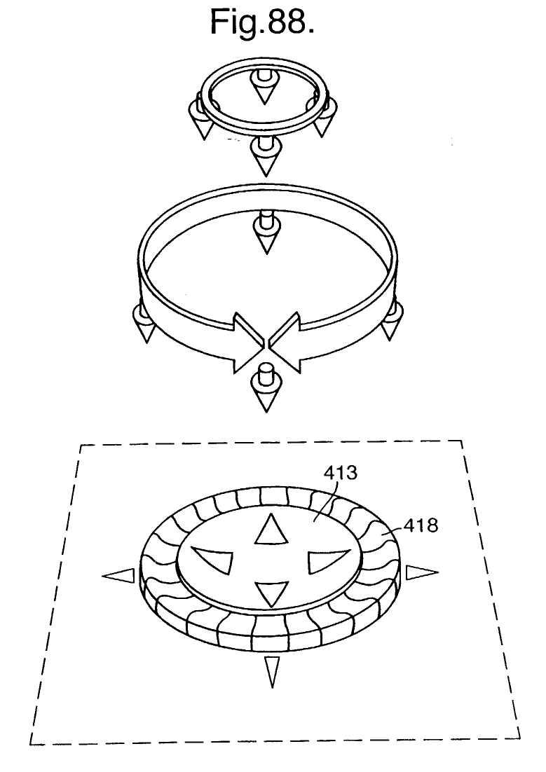

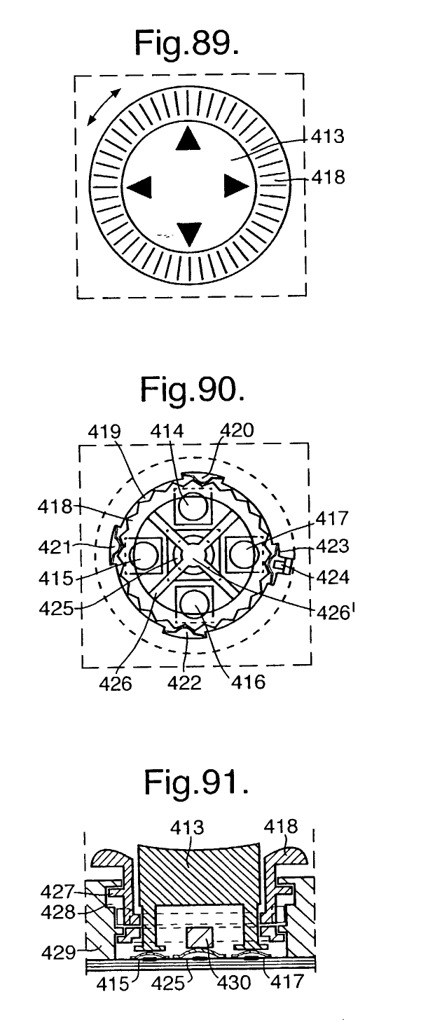

FIGS. 88-91 show a twentieth embodiment of an operating device according to the invention, where FIG. 88 shows the device from above in perspective; FIG. 89 shows the device from above; FIG. 90 shows the device with a part of its top portion removed for clarity; and FIG. 91 shows a cross-section through the device.

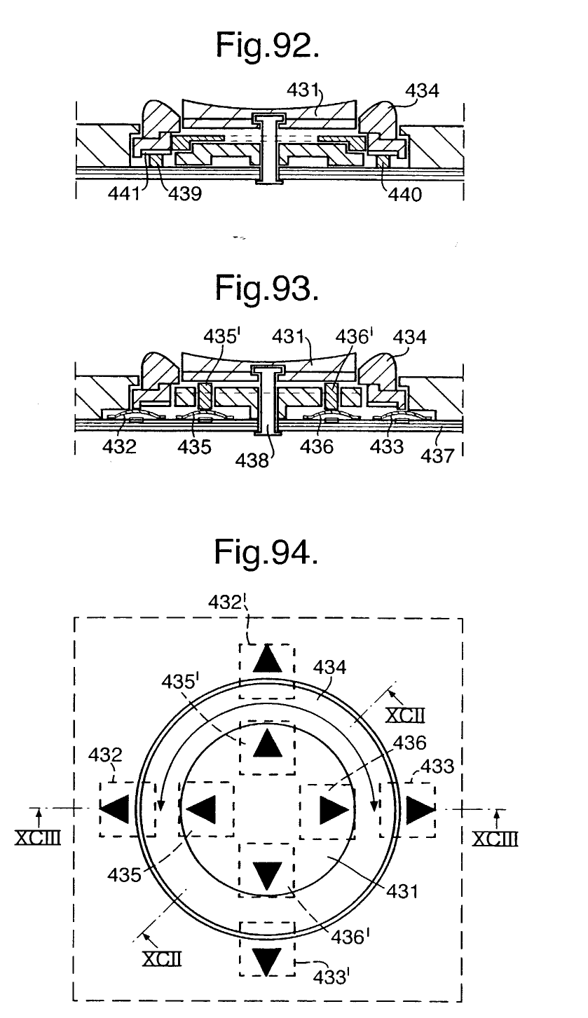

FIGS. 92-94 show a twenty-first embodiment of an operating device according to the invention, where FIG. 92 shows a first cross-section (XCII-XCII in FIG. 94) of the device; FIG. 93 a second cross-section (XCIII-XCIII in FIG. 94) of the device; and FIG. 94 is top view of the device.

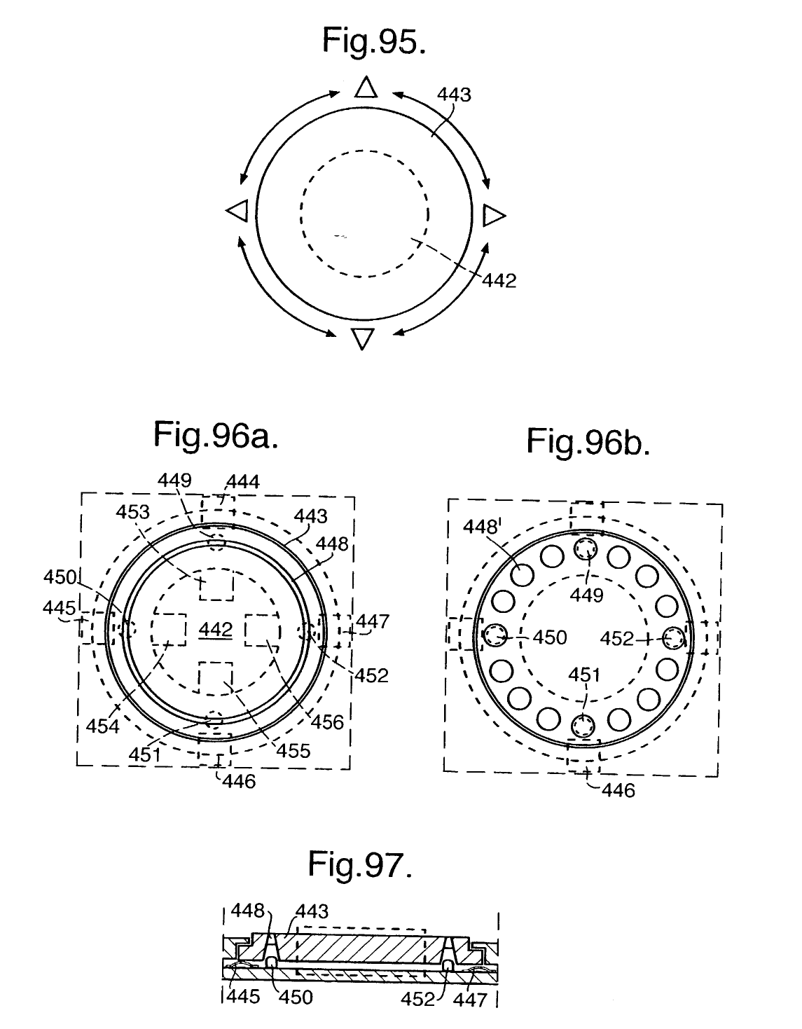

FIGS. 95-97 show a twenty-second embodiment of an operating device according to the invention, where FIG. 95 shows prior art, whilst FIGS. 96a and 97 show the device from above and in section respectively; and FIG. 96b shows a smaller variant of that shown in FIG. 96a.

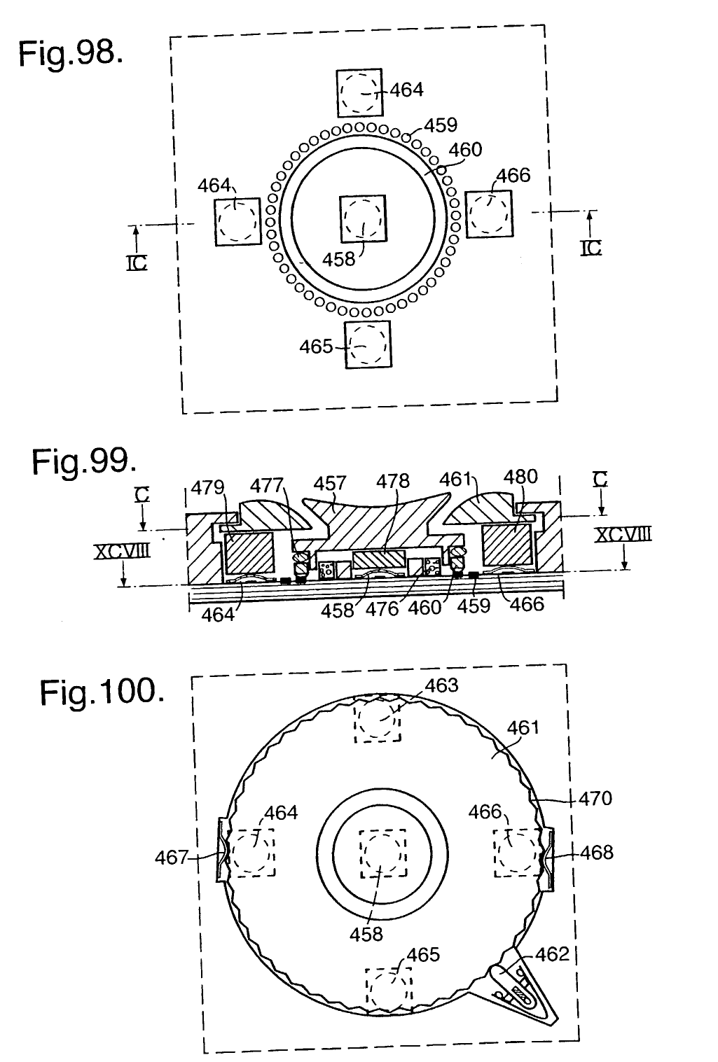

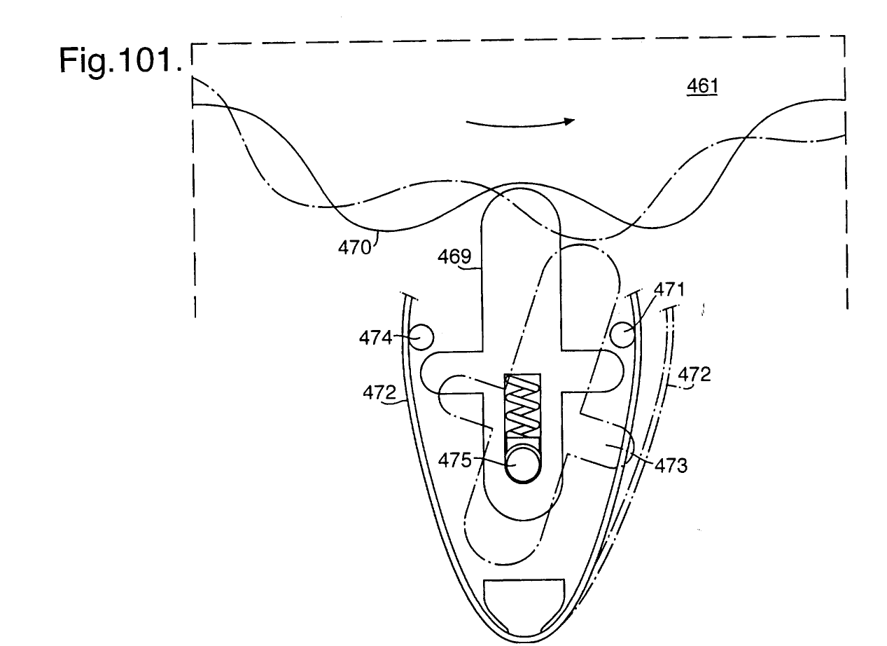

FIGS. 98-101 show a twenty-third embodiment of the operating device according to the present invention, where FIG. 98 is a view taken along the line XCVIII-XCVIII in FIG. 99; FIG. 99 is a view taken along the line IC-IC in FIG. 98; and FIG. 100 is a view taken along the line C-C in FIG. 99, whilst FIG. 101 shows on an enlarged scale a detail of a directional switch shown in FIG. 100, and where the operating device is suitable as a cursor control means.

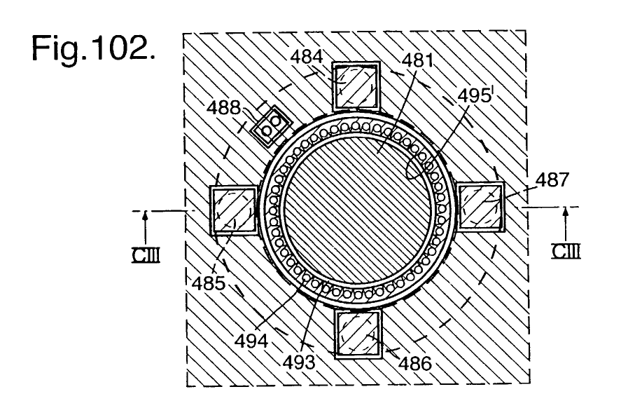

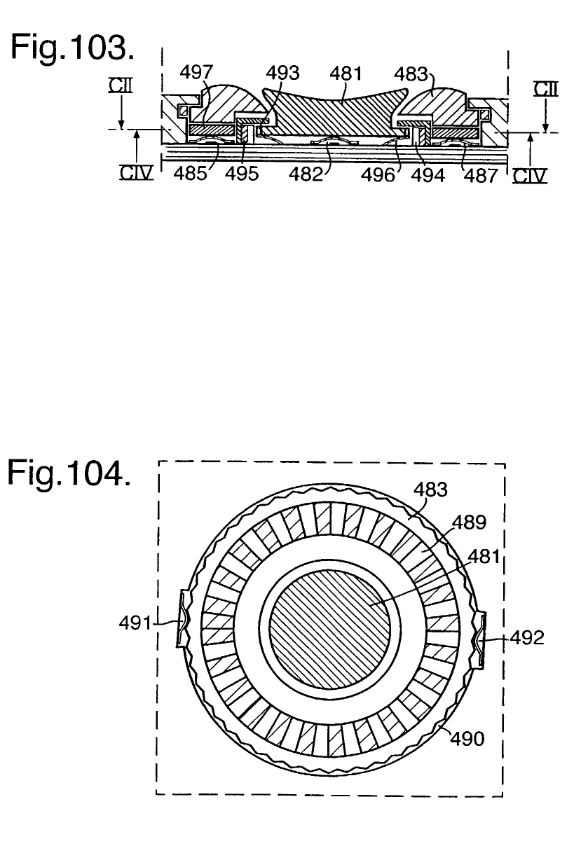

FIGS. 102, 103 and 104 show a twenty-fourth embodiment of the operating device according to the present application, where FIG. 102 is a view taken along the line CII-CII in FIG. 103; FIG. 103 is a view taken along the line CIII-CIII in FIG. 102; and FIG. 104 is a view taken along the line CIV-CIV in FIG. 103, and where the operating device is especially suitable for cursor control, for example, on a computer screen.

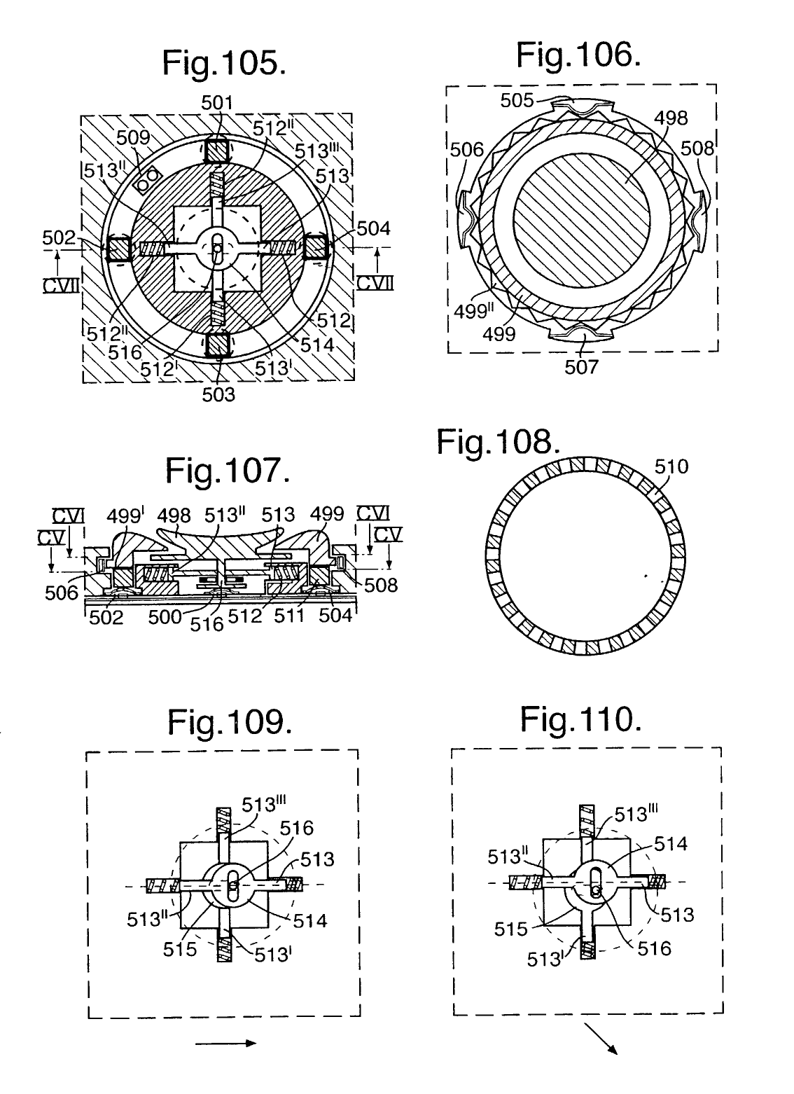

FIGS. 105-110 show a twenty-fifth embodiment of the operating device according to the present invention, where FIG. 105 shows a cross-section or view taken along the line CV-CV in FIG. 107; FIG. 106 is shows a cross-section taken along the line CVI-CVI in FIG. 107; FIG. 107 shows a cross-section taken along the line CVII-CVII in FIG. 105; FIG. 108 shows the underside of a second control element on the operating device; FIG. 109 shows a detail of the operating device shown in FIG. 105 in a sideways displacement; and FIG. 110 illustrates a displacement in the transverse direction relative to that shown in FIG. 109, this operating device also being highly suitable for cursor control.

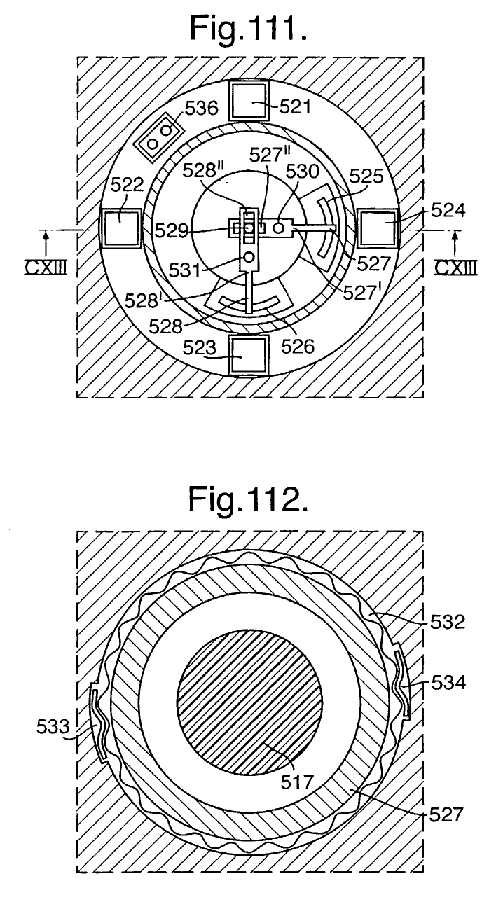

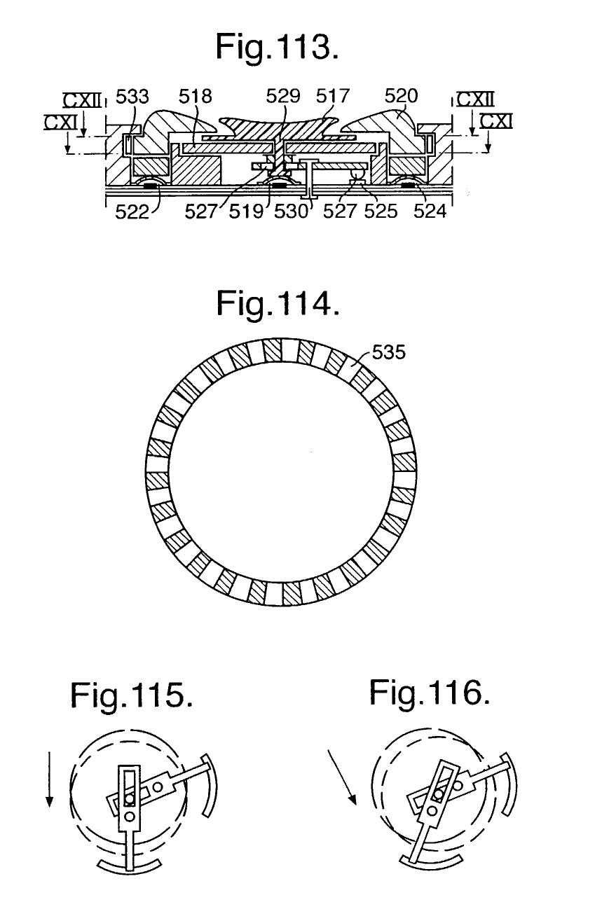

FIGS. 111-116 show a twenty-sixth embodiment of the operating device according to the invention, where FIG. 111 is a sectional view taken along the line CXI-CXI in FIG. 113; FIG. 112 is a sectional view taken along the line CXII-CXII in FIG. 113; FIG. 113 is a sectional view taken along the line CXIII-CXIII in FIG. 111; FIG. 114 shows the underside of a second control element of the operating device, FIGS. 115 and 116 show details of the x-y detector on the operating device as shown in other figures including FIG. 111, the operating device being suitable for control of a cursor on, for example, a computer screen.

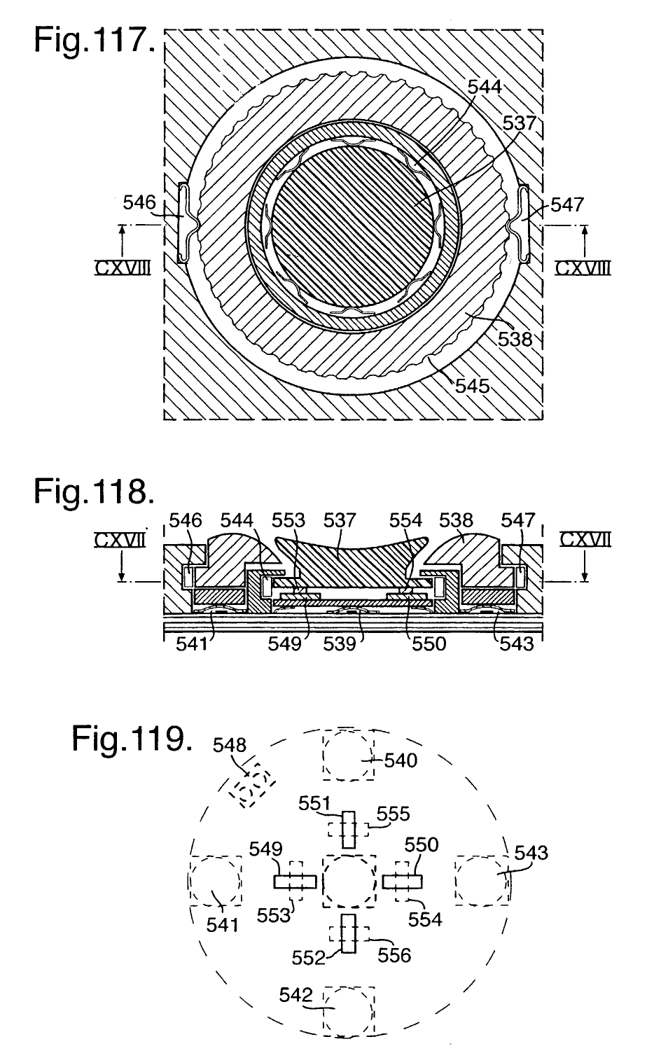

FIGS. 117-119 show a twenty-seventh embodiment of the operating device according to the invention, particularly suitable as a control device for a cursor on a display screen, and where FIG. 117 is a sectional view taken along the line CXVII-CXVII in FIG. 118, whilst FIG. 118 is a sectional view taken along the line CXVIII-CXVIII in FIG. 117.

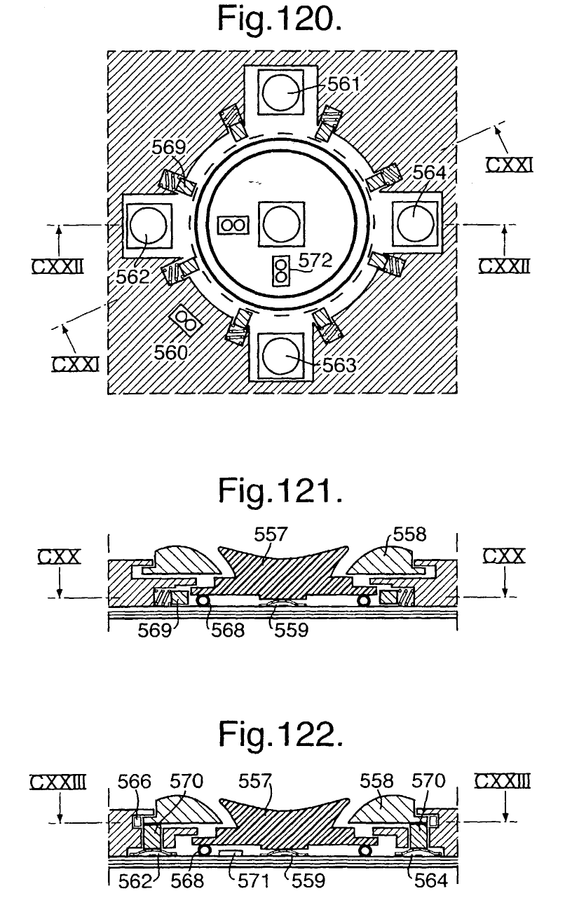

FIGS. 120-124 show a twenty-eighth embodiment of the operating device according to the invention which is also suitable as a control means for cursor control, and where FIG. 120 is a sectional view taken along the line CXX-CXX in FIG. 121; FIG. 121 is a sectional view taken along the line CXXI-CXXI in FIG. 120; FIG. 122 is a sectional view taken along the line CXXII-CXXII in FIG. 120; FIG. 123 is a sectional view taken along the line CXXIII-CXIII in FIG. 122; and FIG. 124 shows a first control element of the device seen from below.

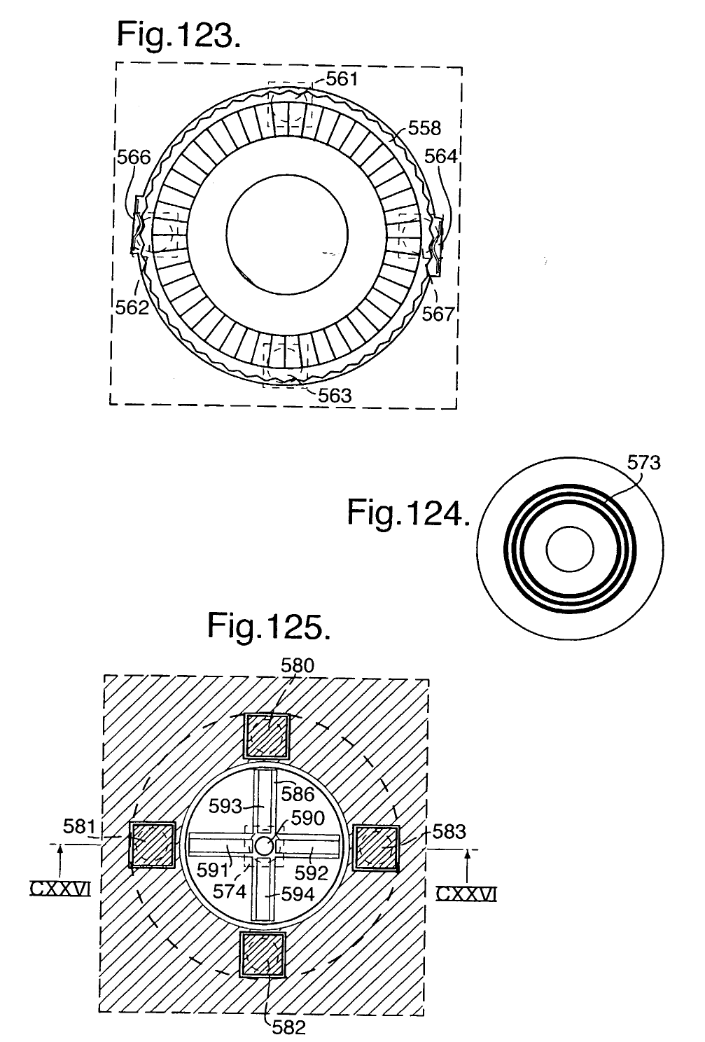

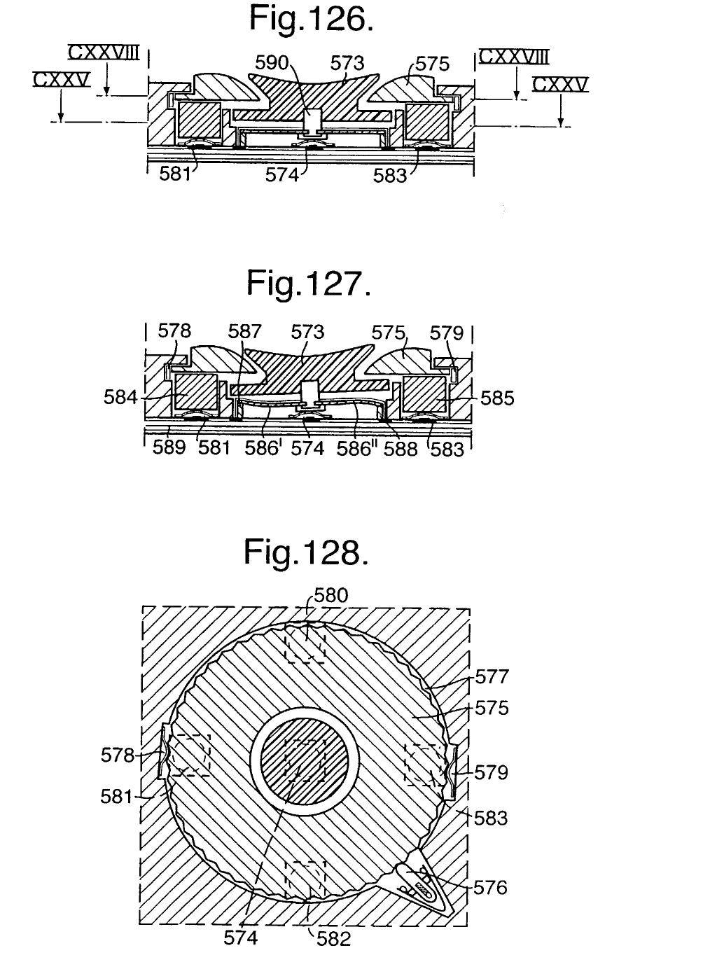

FIGS. 125-128 show a twenty-ninth embodiment of the operating device according to the invention where the device is suitable as a control means for cursor control, and where FIG. 125 is a sectional view taken along the line CXXV-CXXV in FIG. 126; FIG. 126 is a sectional view taken along the line CXXVI-CXXVI in FIG. 125; FIG. 127 shows the section in FIG. 126 with a first of the control elements tilted slightly to one side, and where FIG. 128 is a sectional view taken along the line CXXVIII-CXXVIII in FIG. 126.

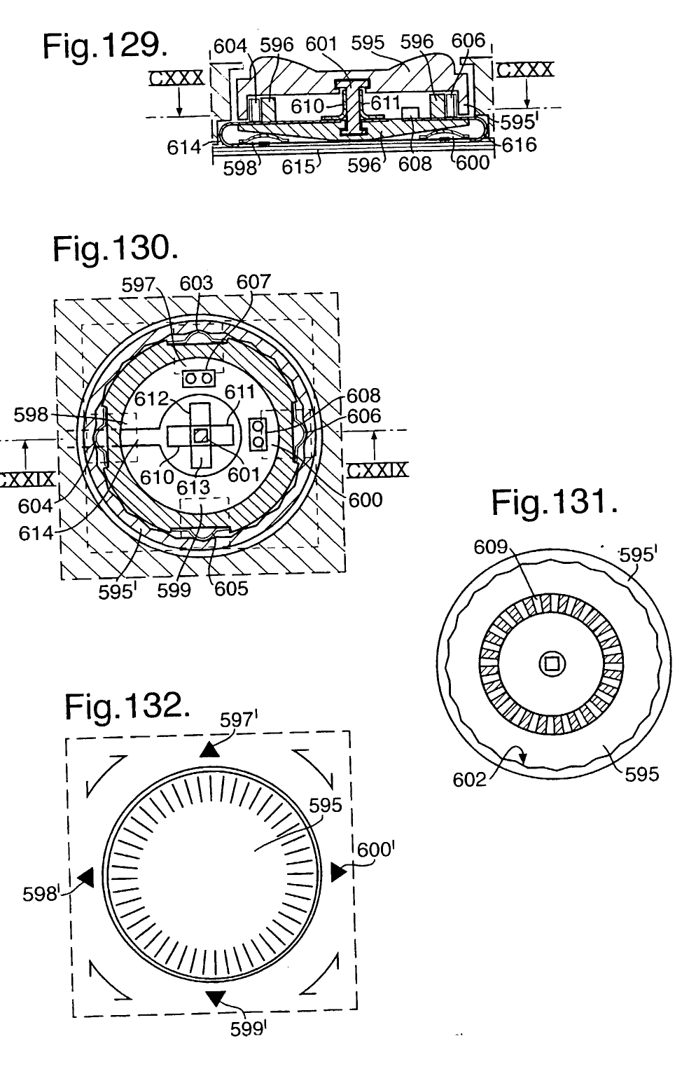

FIGS. 129-132 show a thirtieth embodiment of the operating device according to the invention where the device is highly suitable as a control means for cursor control, and where FIG. 129 is a sectional view taken along the line CXXIX-CXXIX in FIG. 130; FIG. 130 is a sectional view taken along the line CXXX-CXXX in FIG. 129; FIG. 131 shows the device from above; and FIG. 132 shows the control element of the device from below.

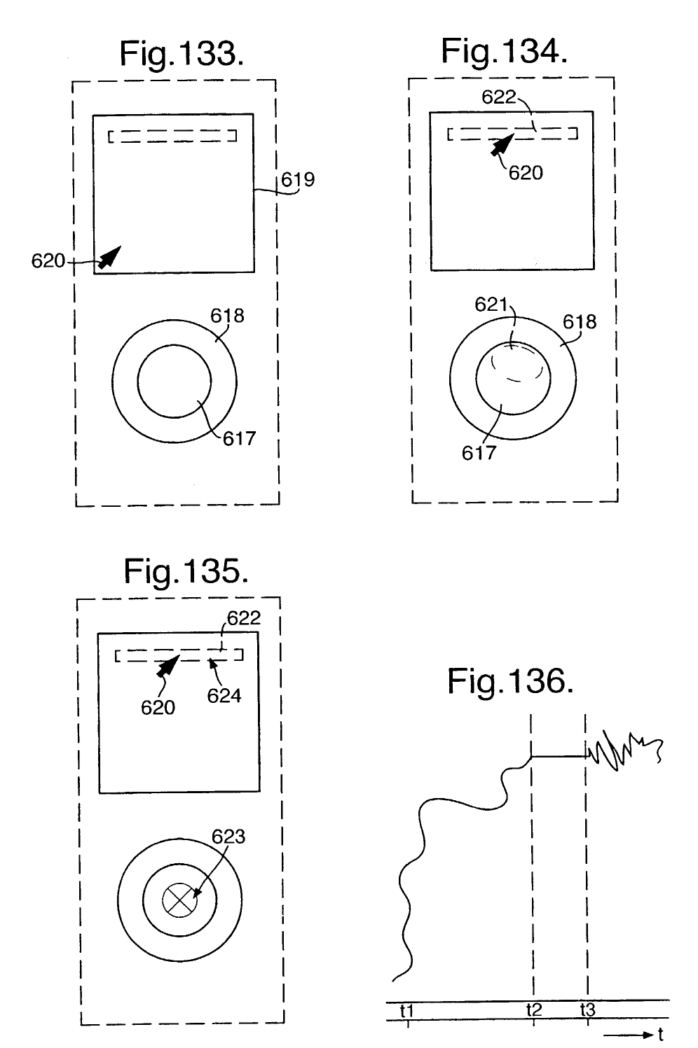

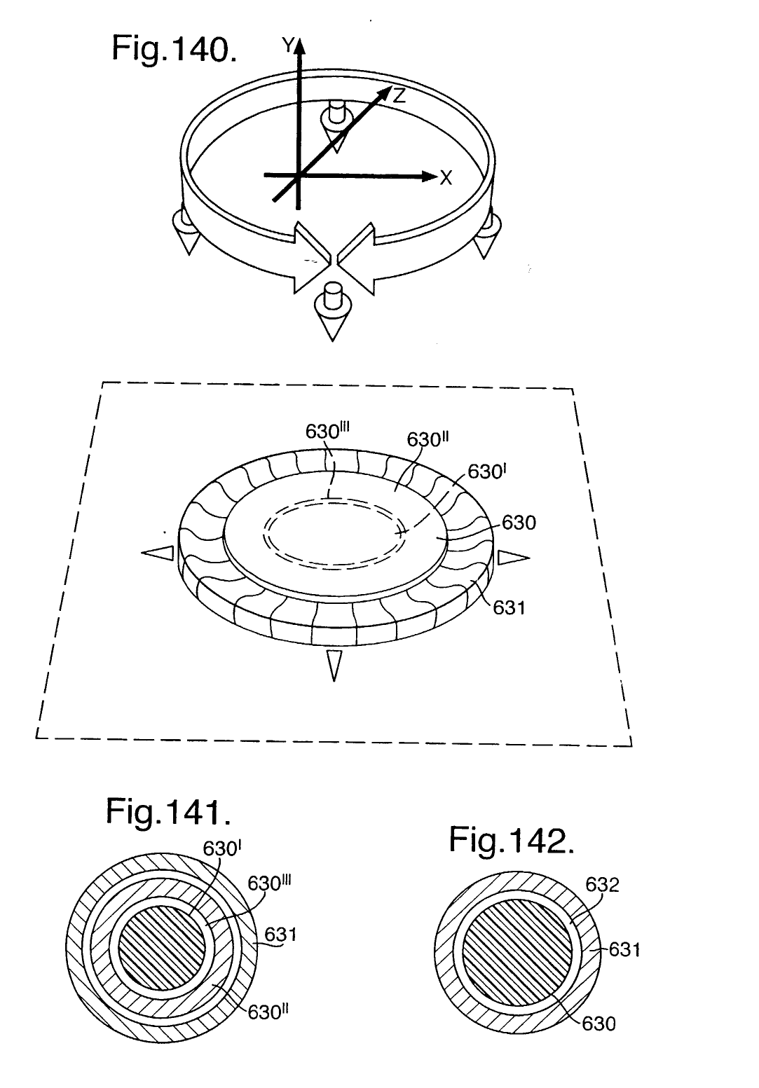

FIGS. 133-136 and 137-139 will serve to provide a more detailed explanation of the use of the operating devices as shown in particular in FIGS. 98-101, FIGS. 102-104, FIGS. 105-110, FIGS. 111-114, FIGS. 117-119, FIGS. 120-124 and FIGS. 125-128, whilst FIG. 140 shows the operating device in connection with these figures in a purely schematic manner.

FIGS. 141 and 142 are schematic illustrations of an operating device and based on the use of a capacitive sensor.

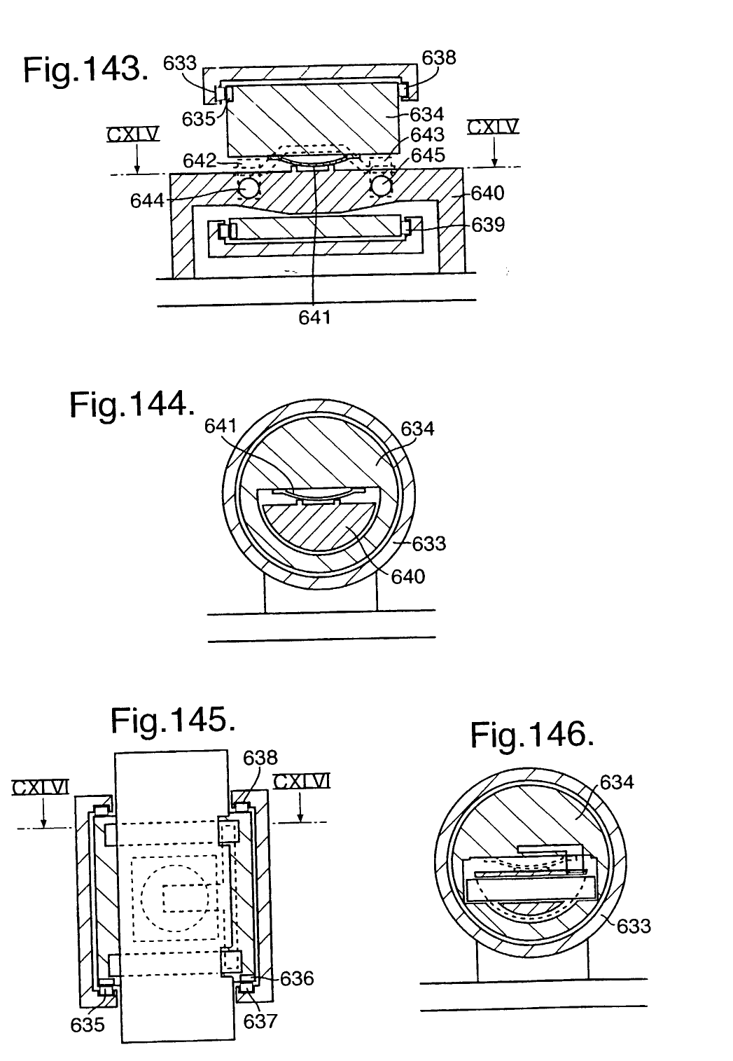

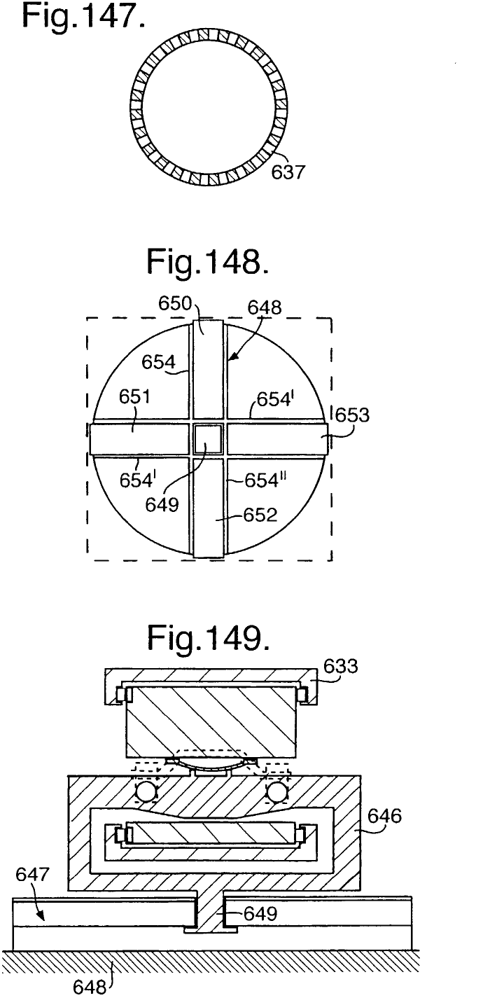

FIGS. 143-147 relate to a thirty-first embodiment of the operating device according to he invention, where FIG. 143 shows a longitudinal cross-section of the device; FIG. 144 shows a cross-section through the device; FIG. 145 shows a view taken along the line CXLV-CXLV in FIG. 143; FIG. 146 shows a second cross-section through the device, as shown by a section taken along the line CXLVI-CXLVI in FIG. 145; FIG. 147 shows a marker ring for placing on a portion of the device for registration of rotation.

FIGS. 148 and 149 show a thirty-second embodiment of the operating device according to the invention and which represents a modification of the device shown in FIGS. 143147, and where FIG. 148 shows a measuring support structure for the device, and FIG. 149 shows the device with the support structure.

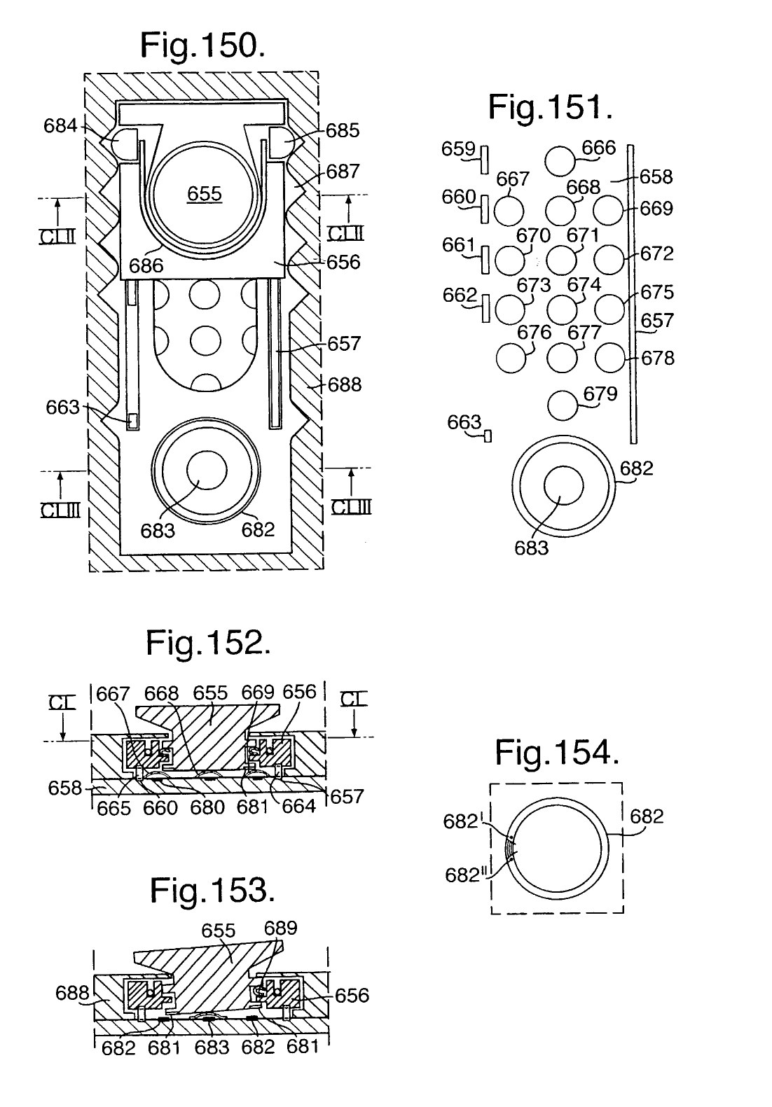

FIGS. 150-154 show a thirty-third embodiment of the operating device according to the present invention, where FIG. 150 shows a view taken along the line CL-CL in FIG. 152; FIG. 151 shows a detail of contacts used with the device shown in FIG. 150; FIG. 152 is a sectional view taken along the line CLII-CLII in FIG. 150; FIG. 153 is a view taken along the line CLIII-CLIII in FIG. 152 with the control element of the device tilted to one side; and FIG. 154 shows a detail of the device.

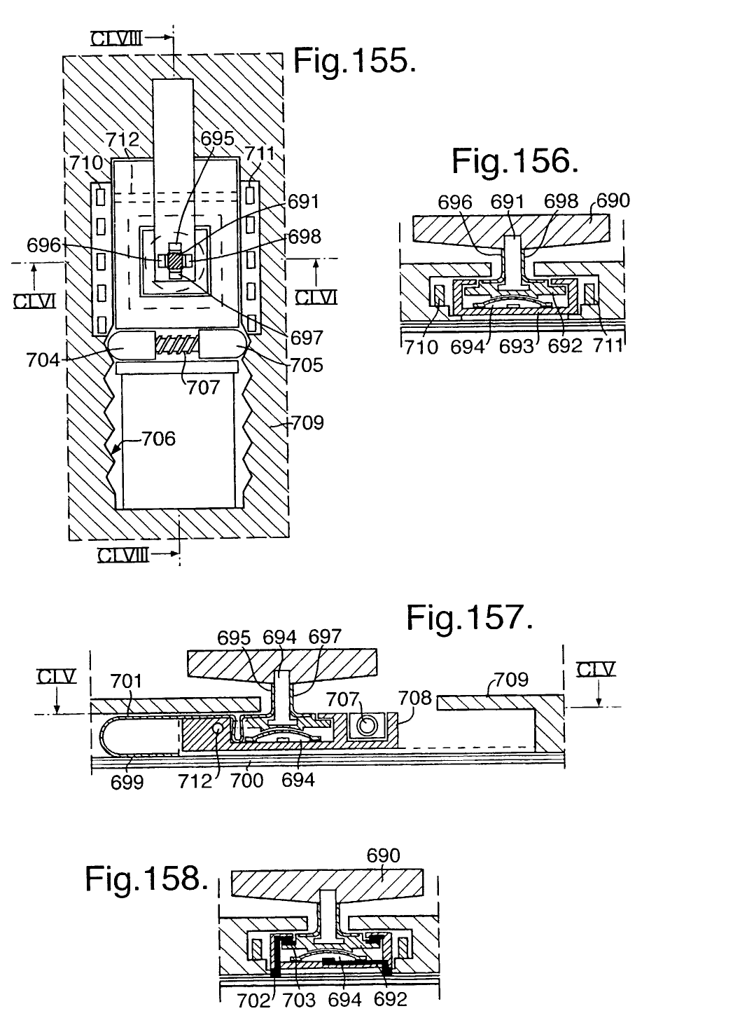

FIGS. 155-158 show a thirty-fourth embodiment of the operating device according to the present invention, where FIG. 155 shows a view taken along the line CLV-CLV in FIG. 157; FIG. 156 is a sectional view taken along the line CLVI-CLVI in FIG. 155; FIG. 157 is a sectional view taken along the line CLVII-CLVII in FIG. 155, and FIG. 158 shows wiring in connection with the section shown in FIG. 157.

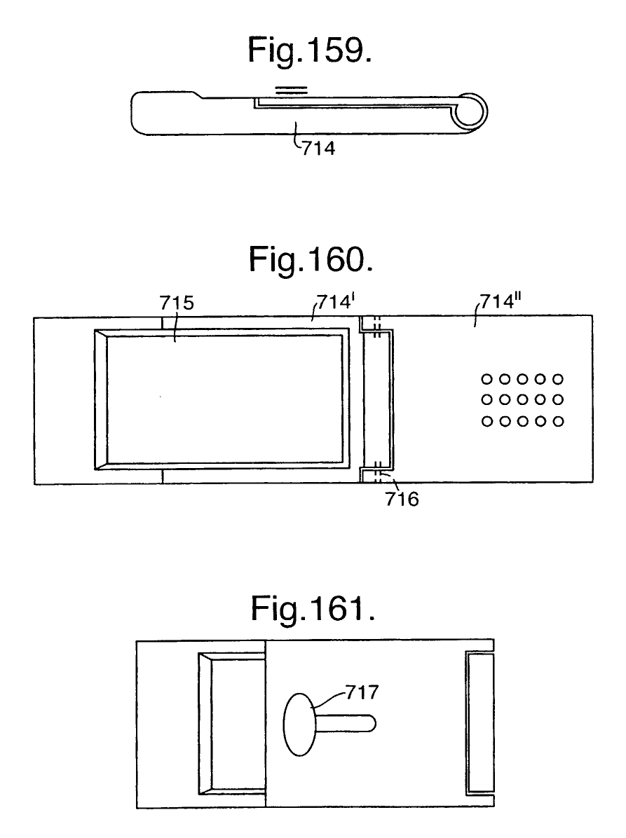

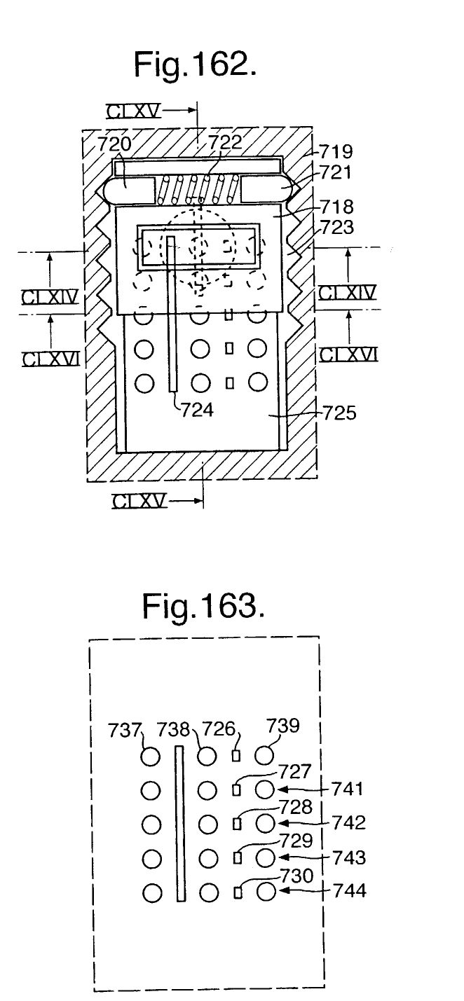

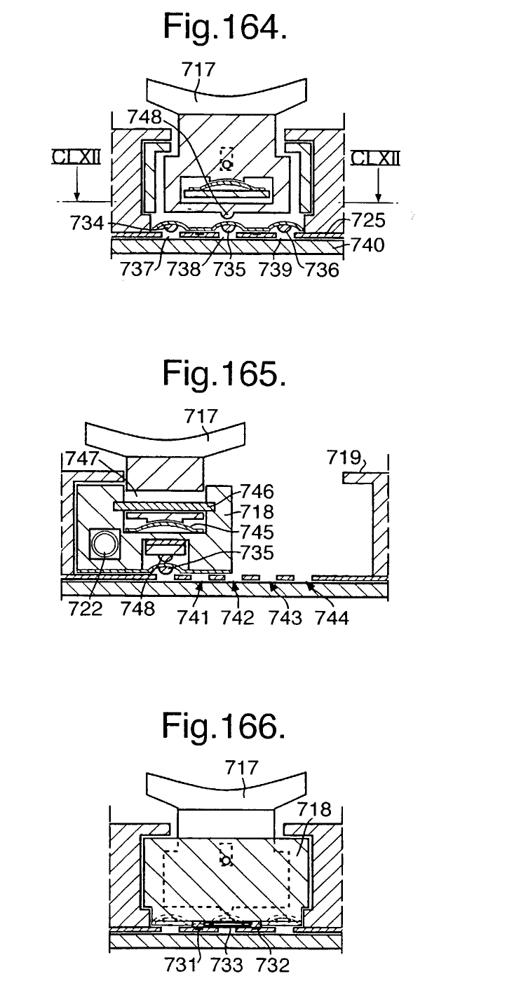

FIGS. 159-166 show a thirty-fifth embodiment of the operating device according to the present invention, where the operating device in FIGS. 159-161 is shown in connection with a functional apparatus, as for instance a mobile telephone, and shown respectively from the side (FIG. 159), from in front with the operating device tilted to the side (FIG. 160), and in FIG. 161 with the operating device tilted in place over the touch screen of the functional apparatus; FIG. 162 is a sectional view taken along the line CLXII-CLXII in FIG. 164; FIG. 163 is a closer detail of the base part of the device shown in FIG. 162; FIG. 164 is a cross-section taken along the line CLXIV-CLXIV in FIG. 162; FIG. 165 shows the cross-section taken along the line CLXV-CLXV in FIG. 162; and FIG. 166 shows a cross-section taken along the line CLXVI-CLXVI in FIG. 162.

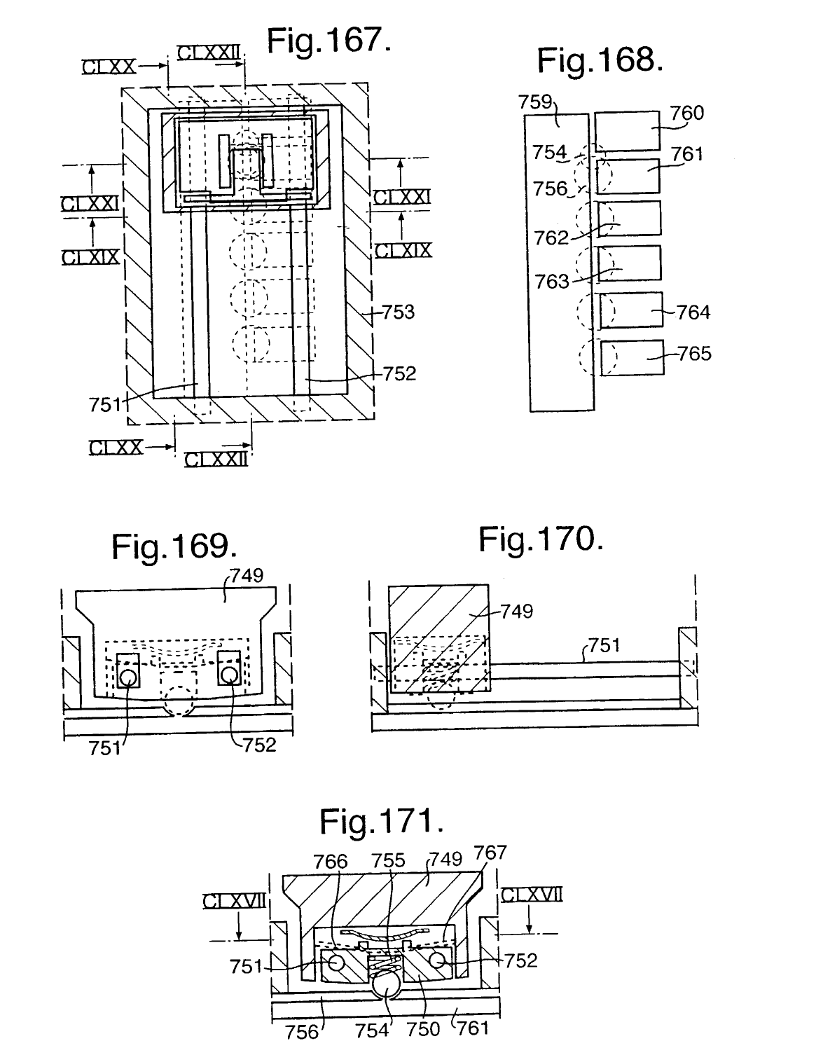

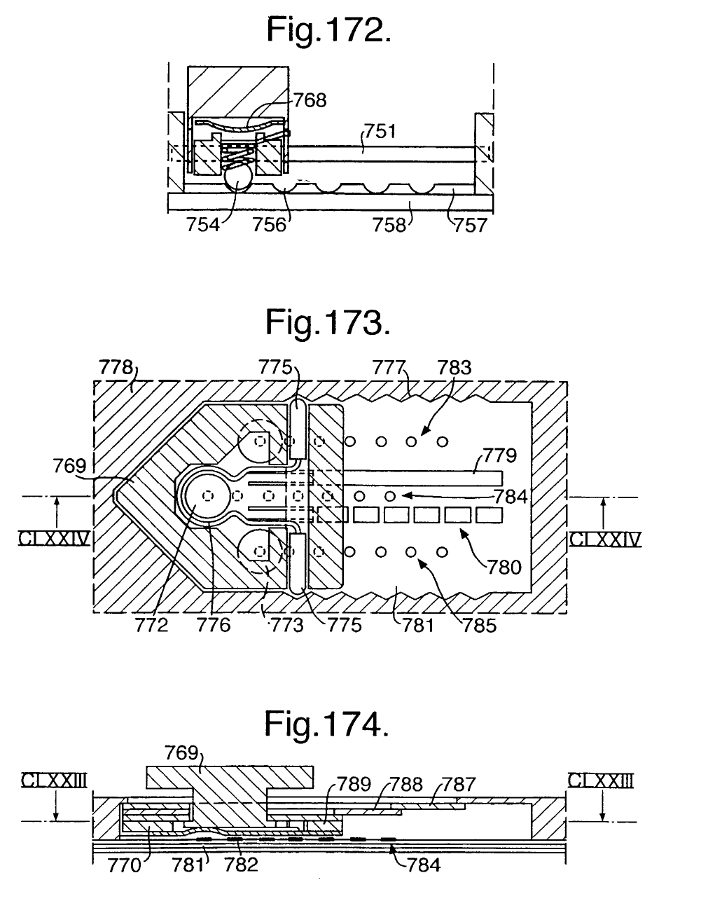

FIGS. 167-172 show a thirty-sixth embodiment of the operating device according to the present invention, where FIG. 167 shows a cross-section taken along the line CLXVII-CLXVII in FIGS. 171 and 172; FIG. 168 shows a closer detail of that shown in FIG. 167; FIG. 169 shows a cross-section taken along the line CLXIX-CLXIX in FIG. 167; FIG. 170 shows a cross-section taken along the line CLXX-CLXX in FIG. 167; FIG. 171 shows a cross-section taken along the line CLXXI-CLXXI in FIG. 167; and FIG. 172 shows a cross-section taken along the line CLXXII-CLXXII in FIG. 167.

FIGS. 173 and 174 show a thirty-seventh embodiment of the operating device according to the invention, seen respectively from above and in a longitudinal cross-section, FIG. 173 showing a cross-section taken along the line CLXXIII-CLXXIII in FIG. 174; and FIG. 174 shows a sectional view taken along the line CLXXIV-CLXXIV in FIG. 173.

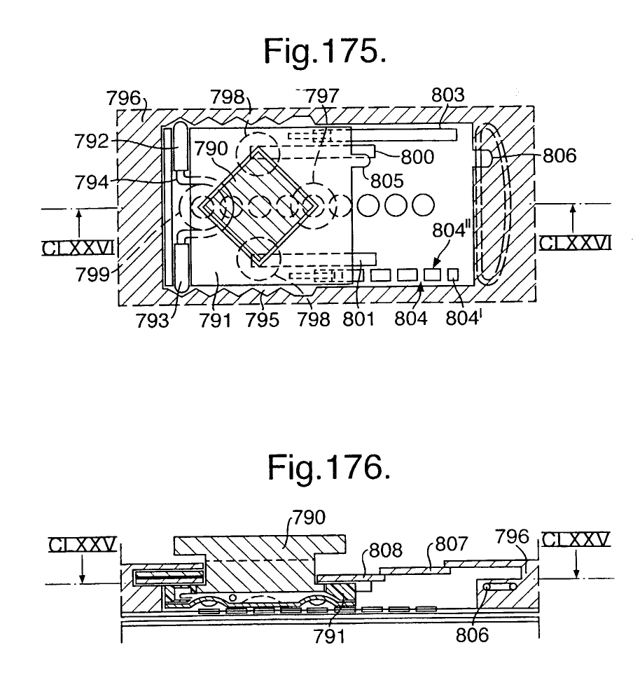

FIGS. 175 and 176 show a thirty-eighth embodiment of the operating device according to the invention, where FIG. 175 shows the device from above and FIG. 176 shows the device in a longitudinal cross-section, i.e., FIG. 175 shows a cross-section taken along the line CLXXV-CLXXV in FIG. 176 and FIG. 176 shows a cross-section taken along the line CLXXVI-CLXXVI in FIG. 175.

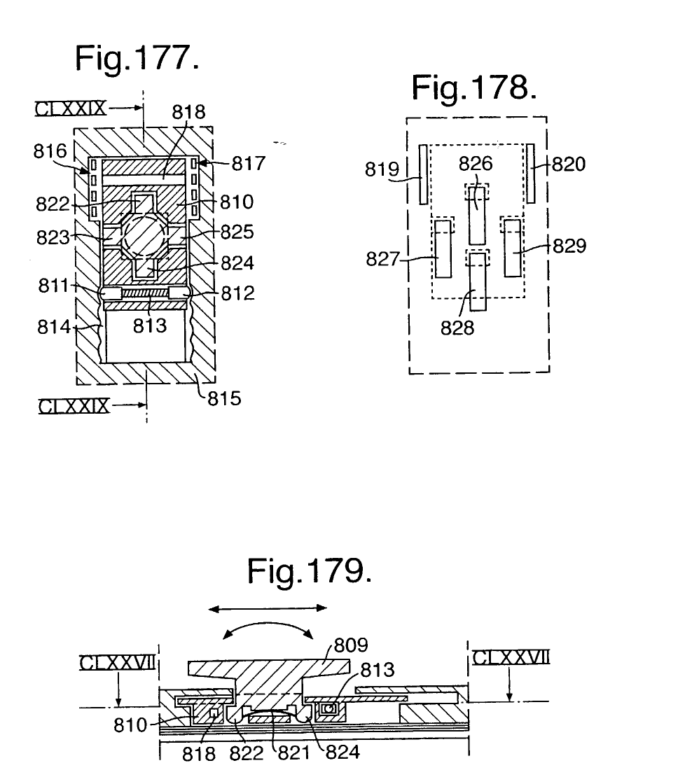

FIGS. 177-179 show a thirty-ninth embodiment of the operating device according to the present invention, where FIG. 177 shows a cross-section taken along the line CLXXVII-CLXXVII in FIG. 179; FIG. 178 shows a detail of a base member of the device; and FIG. 179 shows the cross-section CLXXIX-CLXXIX in FIG. 177.

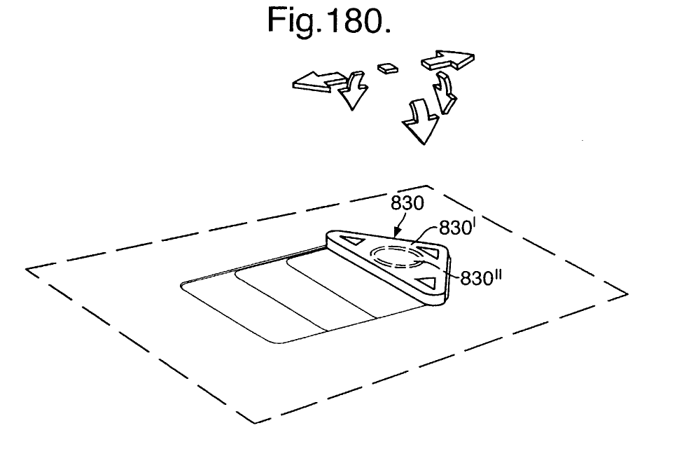

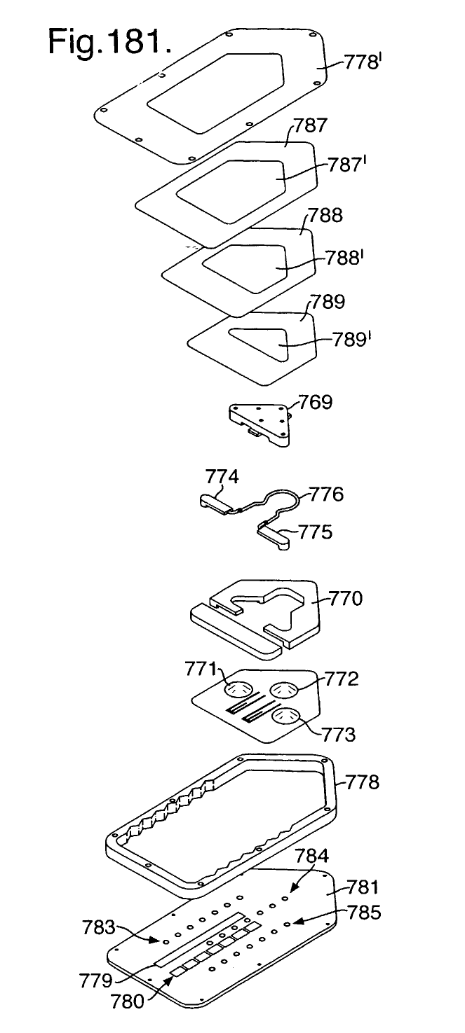

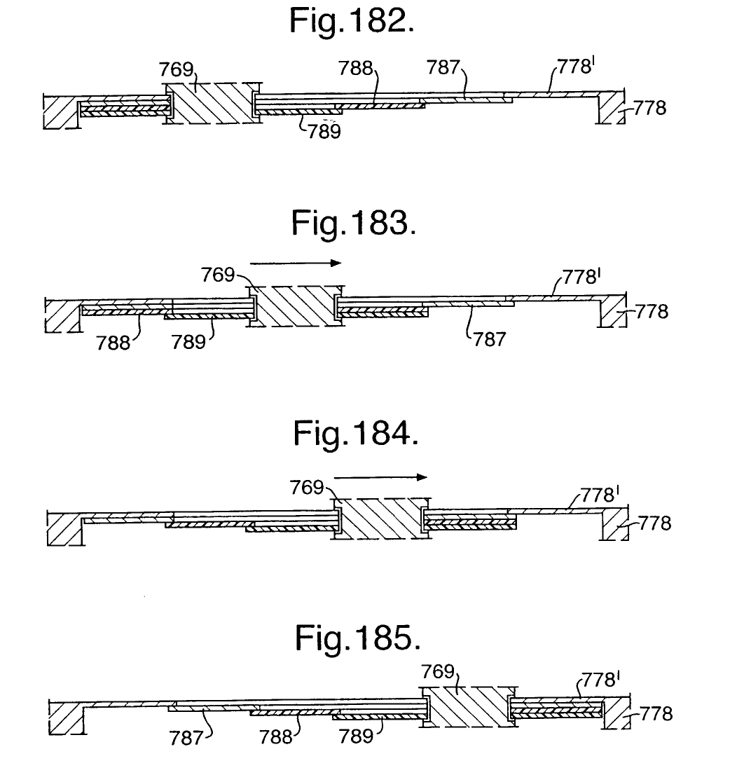

FIGS. 180-185 show the principle of a covering arrangement for the operating device of the slide type, where FIG. 180 shows in perspective a non-limiting schematic top view of an operating device with covering arrangement, FIG. 181 is an exploded view of an operating device having slats as covering arrangement, and FIGS. 182, 183, 184 and 185 show how the slats in the covering arrangement move when the control element of the operating device is moved in the longitudinal direction of the device.

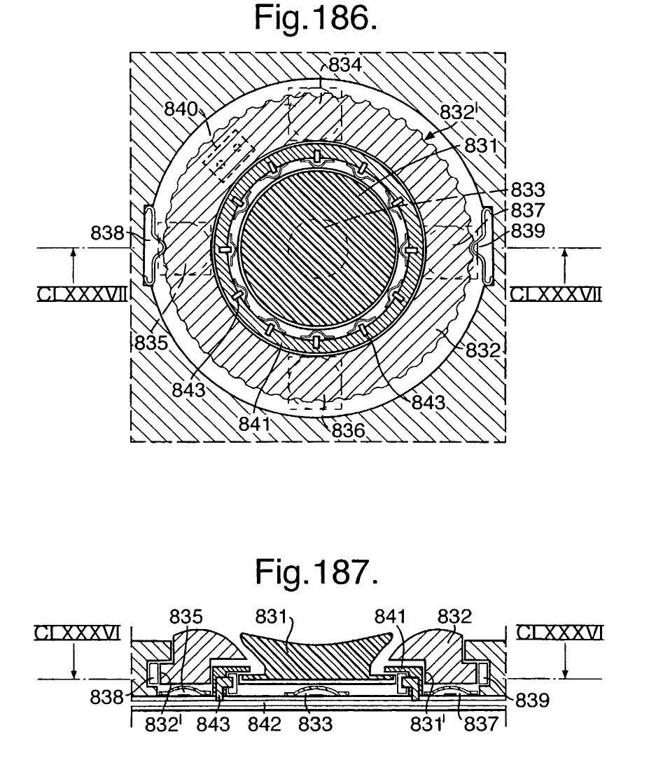

FIGS. 186 and 187 show a fortieth embodiment of the operating device and which is related to that described in general in relation to FIGS. 98-132 and in connection with FIGS. 133-142, and where FIG. 186 is a sectional view taken along the line CLXXXVI-CLXXXVI in FIG. 187; and FIG. 187 shows a sectional view taken along the line CLXXXVII-CLXXXVII in FIG. 186.

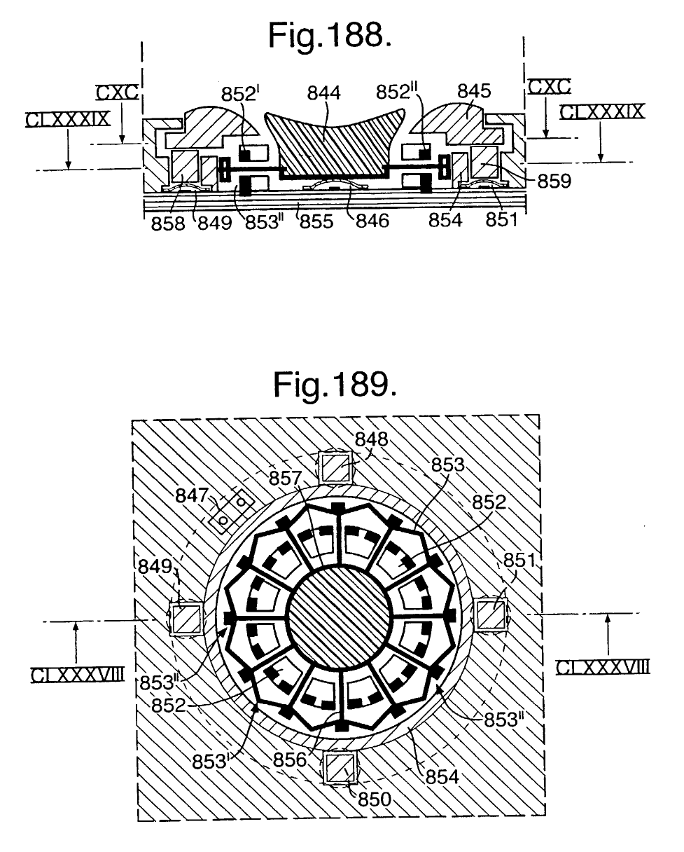

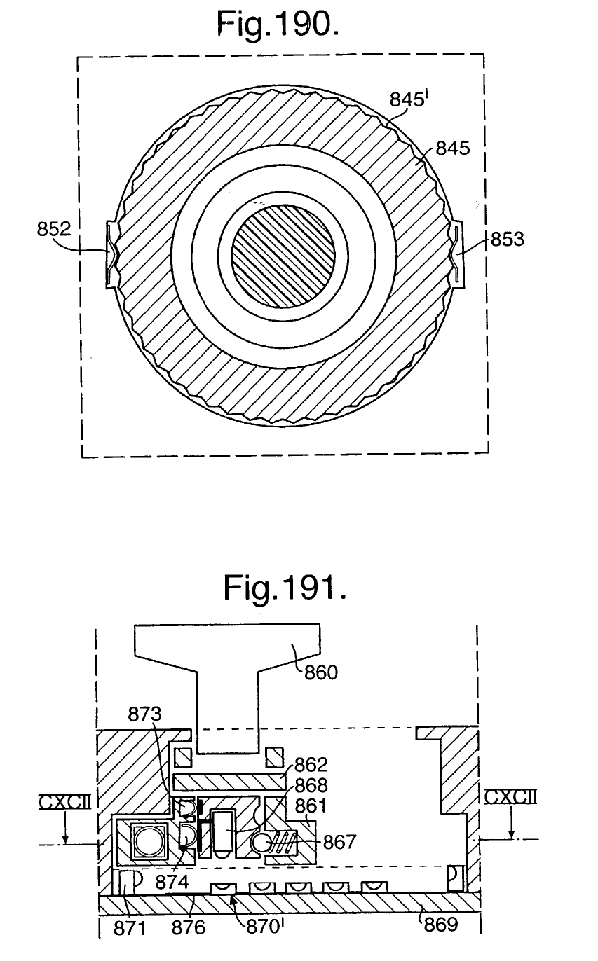

FIGS. 188-190 show a forty-first embodiment of the operating device and which is related to that described in general in relation to FIGS. 98-132 and in connection with 133-142, and also FIGS. 186 and 187, and where FIG. 188 is a sectional view taken along the line CLXXXVIII-CLXXXVIII in FIG. 189; FIG. 189 is a sectional view taken along the line CLXXXIX-CLXXXIX in FIG. 188; and FIG. 190 is a sectional view taken along the line CXC-CXC in FIG. 188.

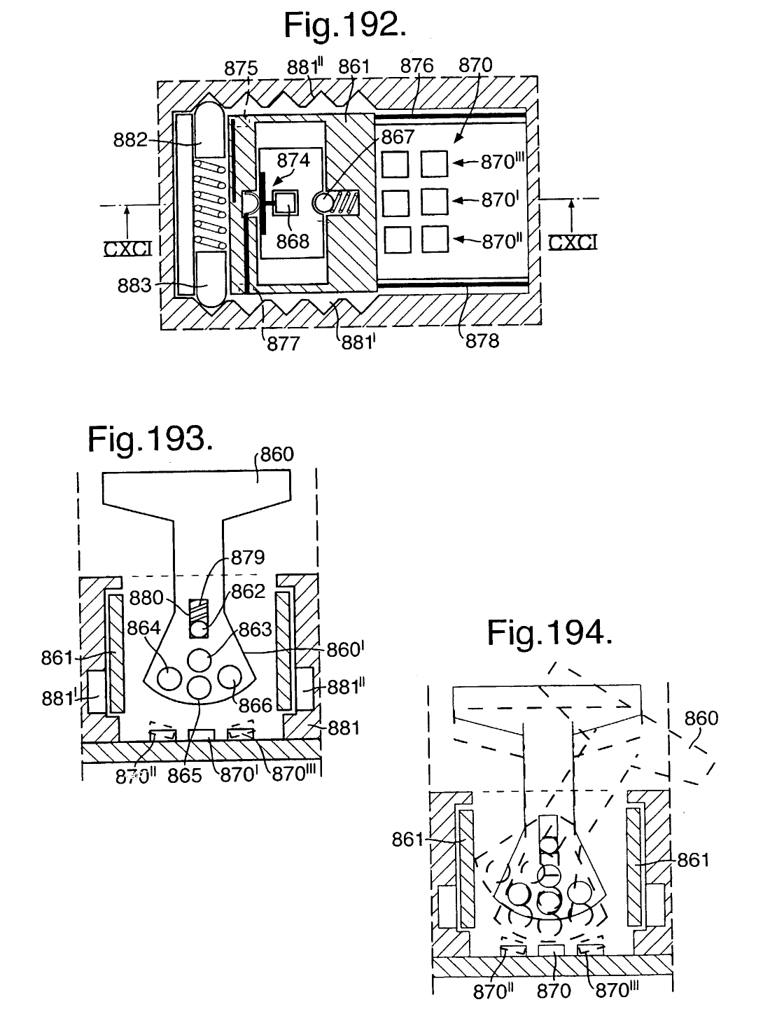

FIGS. 191-194 show a forty-second embodiment of the operating device, where FIG. 191 is a sectional view taken along the line CXCI-CXCI in FIG. 192; FIG. 192 is a sectional view taken along the line CXCII-CXCII in FIG. 191; FIG. 193 is a sectional view taken along the line CXCIII-CXCIII in FIG. 192; and FIG. 194 shows FIG. 193 with the control element in a tilted and depressed position respectively.

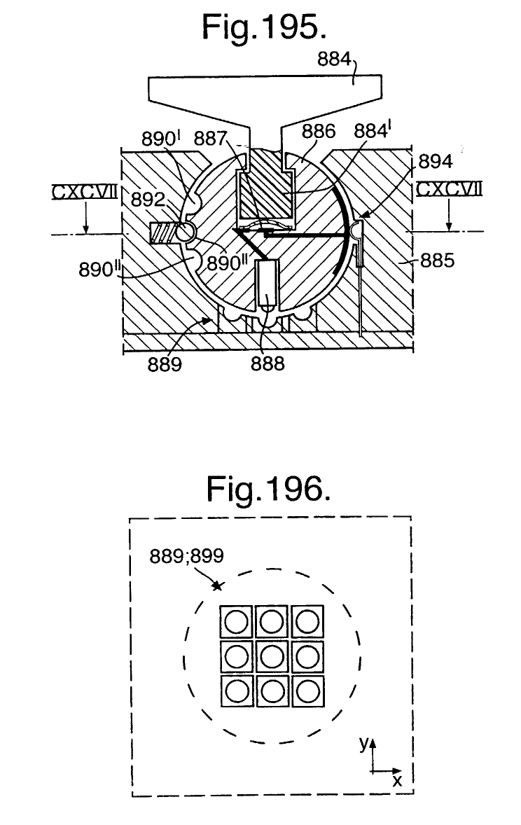

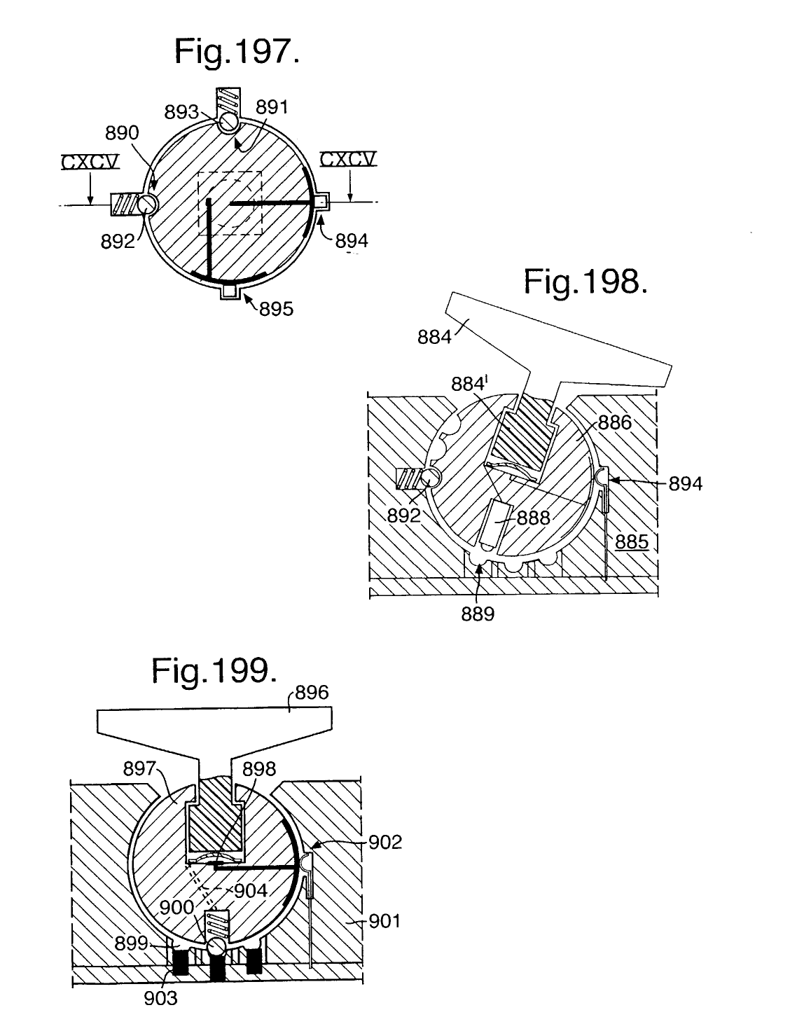

FIGS. 195-198 show a forty-third embodiment of the operating device, where FIG. 195 is a sectional view taken along the line CXCV-CXCV in FIG. 197; FIG. 196 shows a base part of the device; and FIG. 197 is a sectional view along the line CXCVII-CXCVII in FIG. 195.

FIG. 199 shows a forty-fourth embodiment of the operating device and is a variant of the embodiment shown in FIGS. 195-197, and where FIG. 199 also is related to FIG. 196.

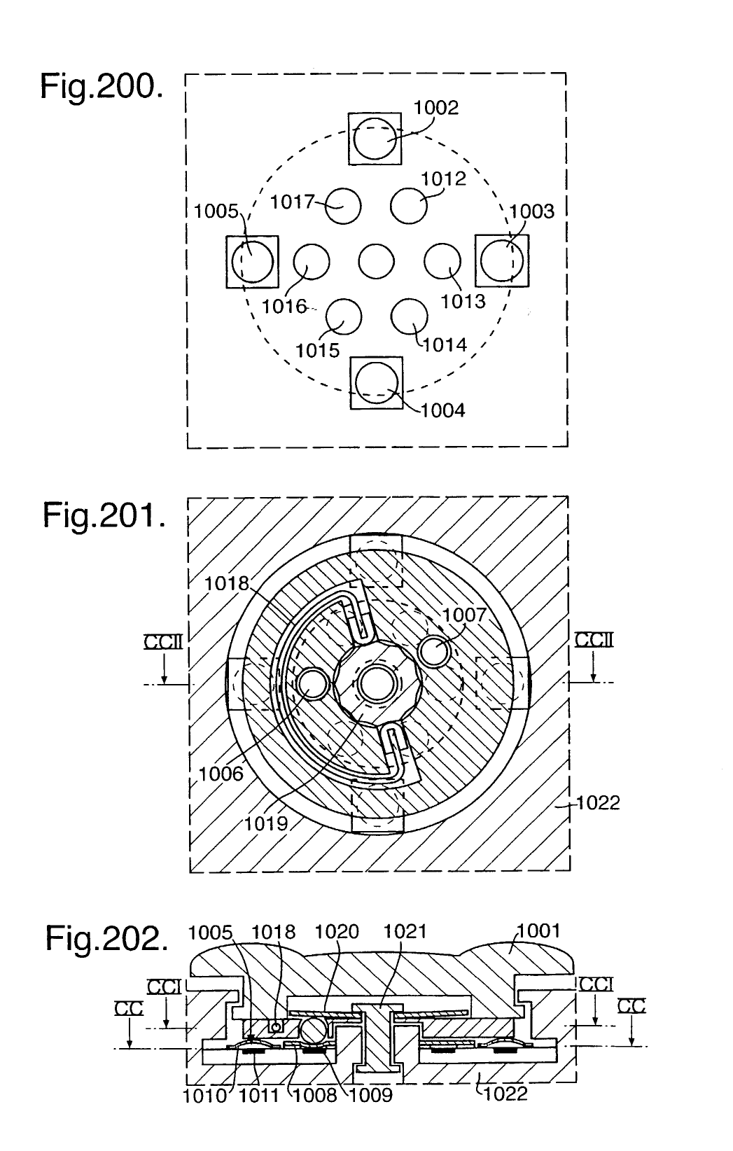

FIGS. 200-202 show a forty-fifth embodiment of the operating device, where FIG. 200 is a sectional view taken along the line CC-CC in FIG. 202; FIG. 201 is a sectional view taken along the line CCI-CCI in FIG. 202; and FIG. 202 is a sectional view taken along the line CCII-CCII in FIG. 201.

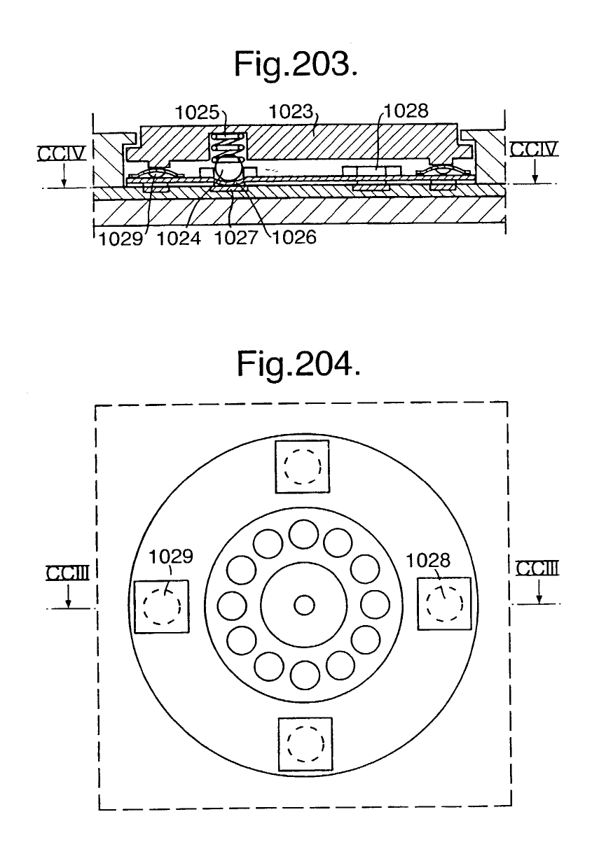

FIGS. 203-204 show a forty-sixth embodiment of the operating device, and is a variant of the embodiment shown in FIGS. 200-202, and where FIG. 203 represents a cross-section taken along the line CCIII-CCIII in FIG. 204; and FIG. 204 represents a section taken along the line CCIV-CCIV in FIG. 203.

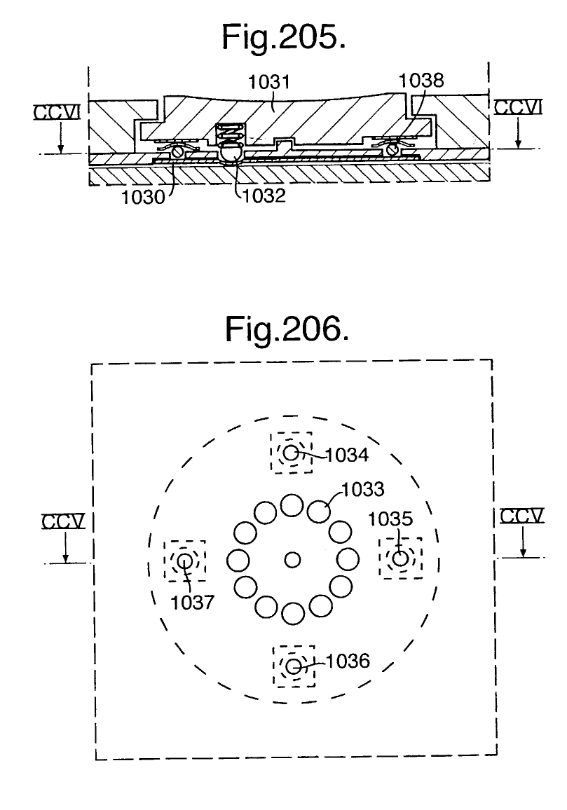

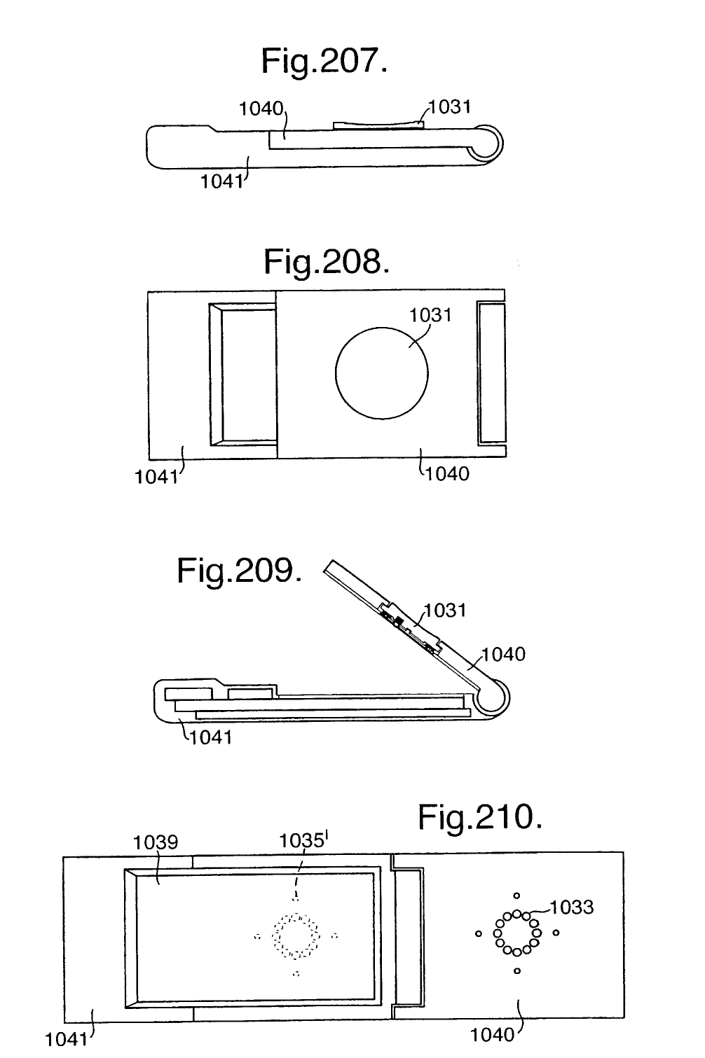

FIGS. 205-210 show a forty-seventh embodiment of the operating device in connection with a touch screen, wherein FIG. 205 shows a sectional view taken along the line CCVCCV in FIG. 206; FIG. 206 is a sectional view taken along the line CCVI-CCVI in FIG. 205, and where FIGS. 207-210 show the operating device used in connection with an apparatus that has a touch screen, for example, a mobile telephone or electronic note pad (PDA), where FIG. 207 shows the apparatus from the side, FIG. 208 shows the apparatus from above; FIG. 209 shows the apparatus in sectional view and FIG. 210 shows the apparatus with the cover fully open.

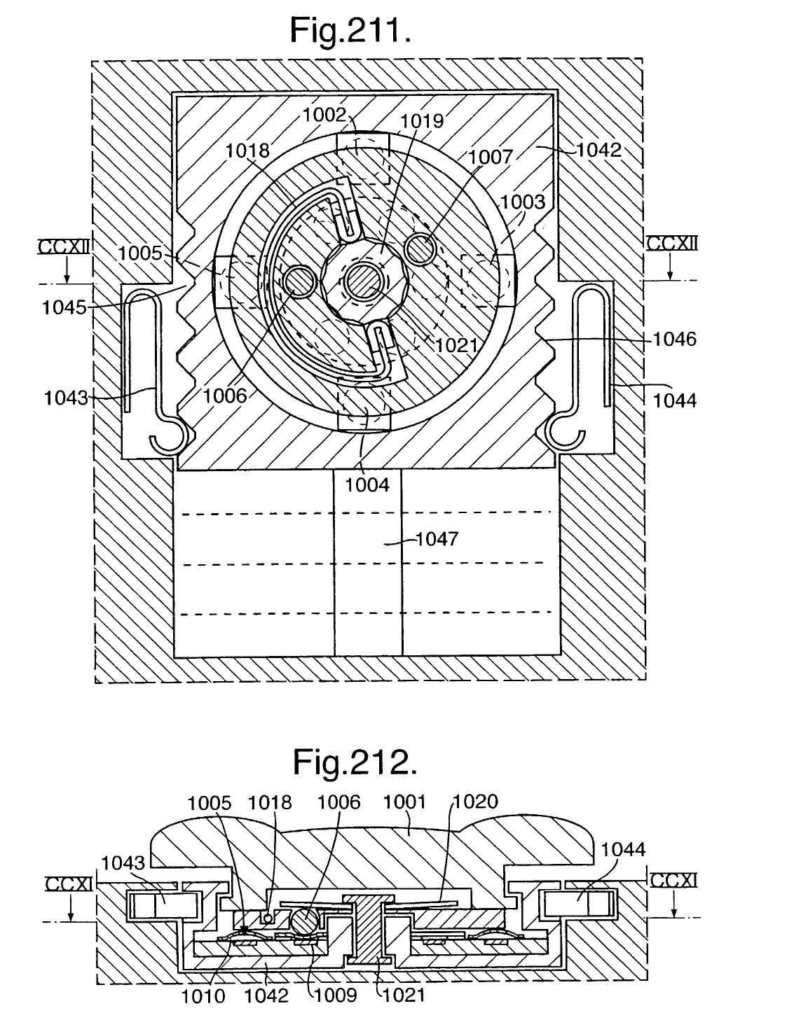

FIGS. 211-212 show a forty-eighth embodiment of the operating device, where FIG. 211 is a sectional view taken along the line CCXI-CCXI in FIG. 212; and FIG. 212 is a sectional view taken along the line CCXII-CCXXII in FIG. 211, the embodiment representing a variant of that shown in FIGS. 200-202.

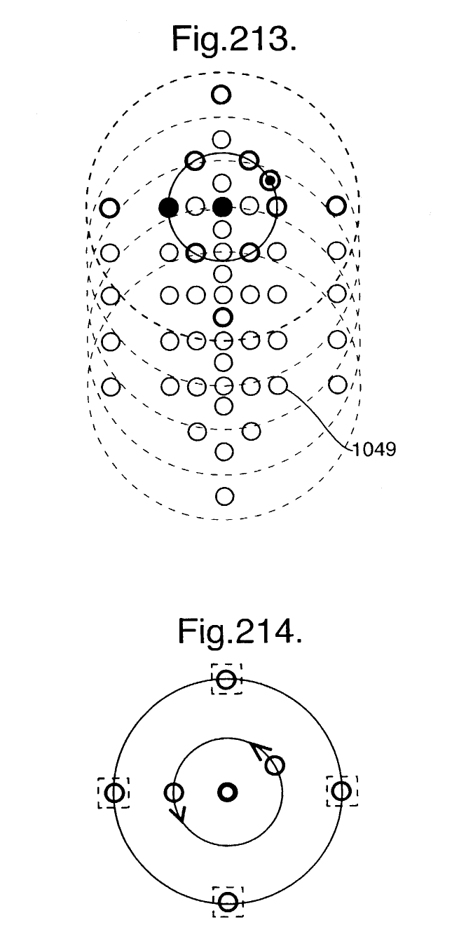

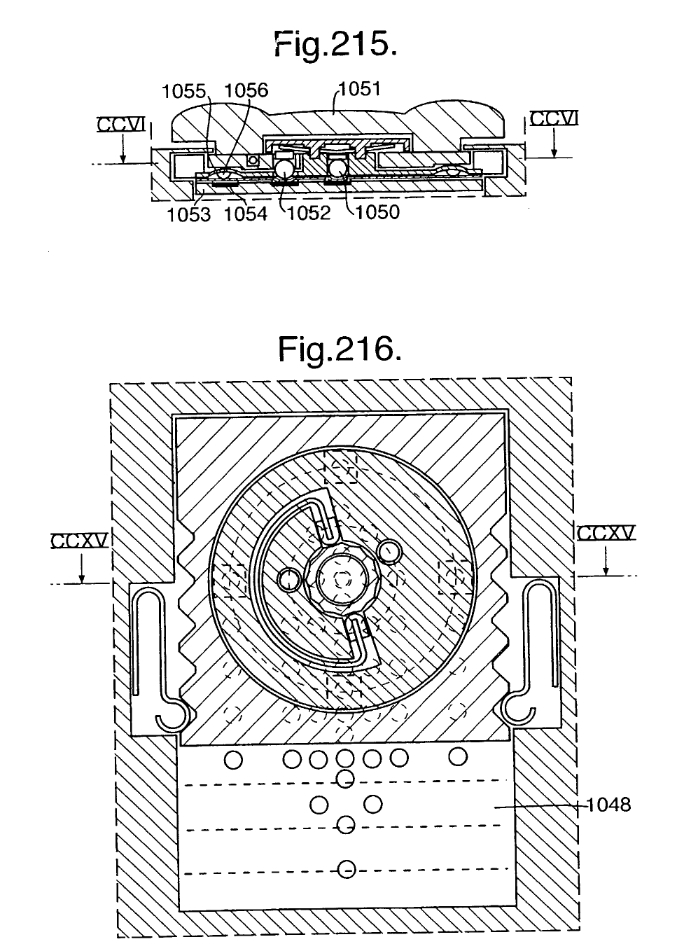

FIGS. 213-216 show a forty-ninth embodiment of the operating device, where FIG. 213 shows a pattern of movement; FIG. 214 shows the possible movements of the control element on rotation; FIG. 215 is a sectional view along the line CCXV-CCXV in FIG. 216; and where FIG. 216 is a sectional view taken along the line CCVI-CCVI in FIG. 215.

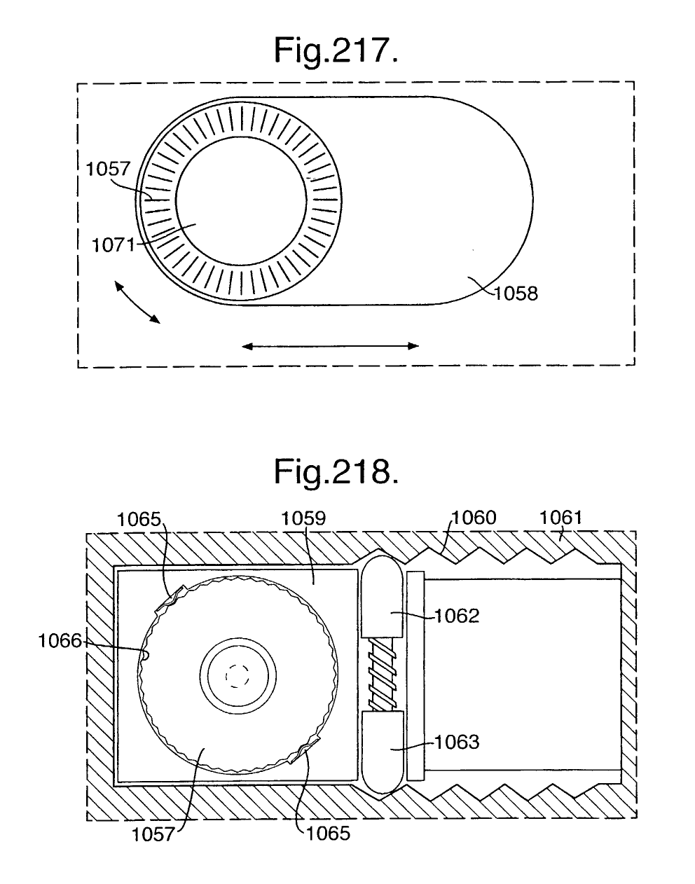

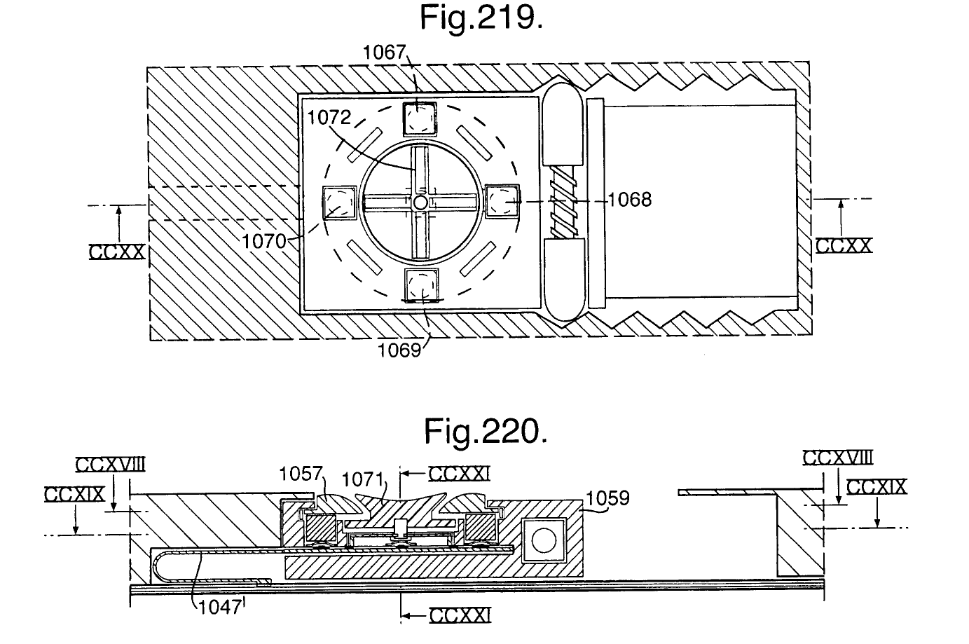

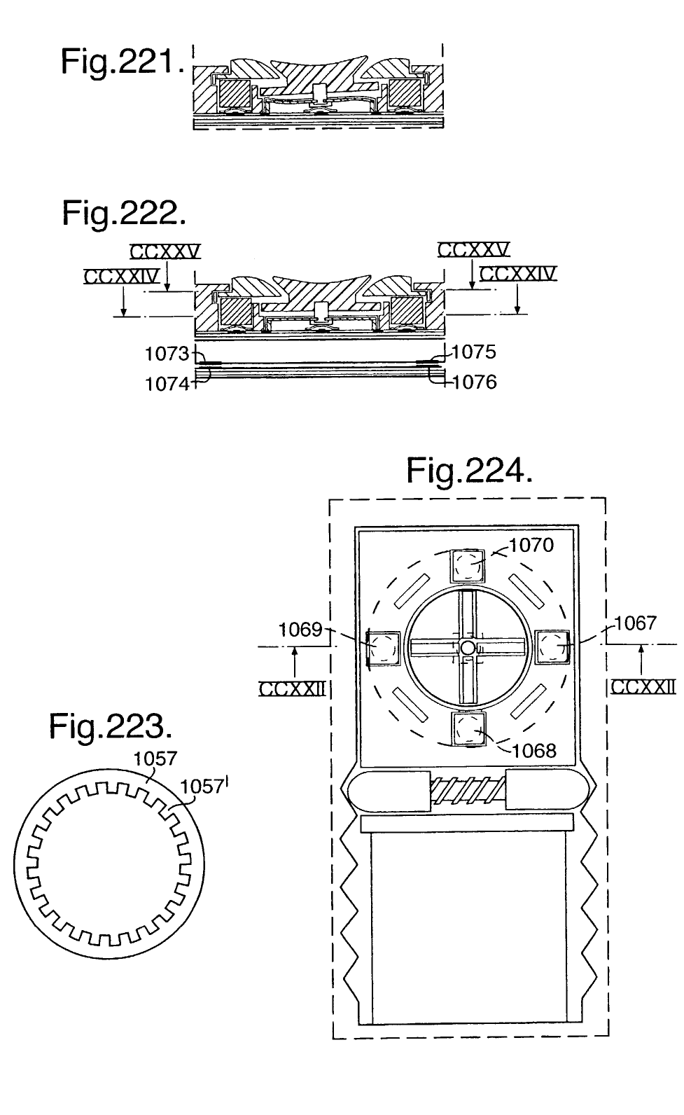

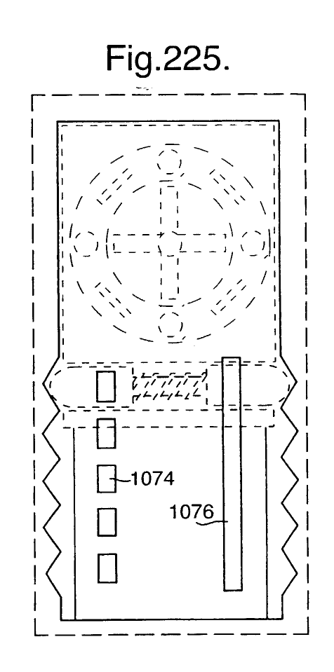

FIGS. 217-225 show a fiftieth embodiment of the operating device, where FIG. 217 is a top view the operating device; FIG. 218 is a sectional view taken along the line CCXVIII-CCXVIII in FIG. 220; FIG. 218 is a sectional view taken along the line CCXIX-CCXIX in FIG. 220; FIG. 220 is a sectional view taken along the line CCXX30 CCXX in FIG. 219; FIG. 221 is a sectional view taken along the line CCXXI-CCXXI in FIG. 220, and where the control element of the operating device is shown tilted slightly; FIG. 222 is a sectional view taken along the line CCXXII-CCXXII in FIG. 224; FIG. 223 shows a toothed code ring for registering stepwise rotational movement of a rotating ring that surrounds the control element; FIG. 224 is a sectional view taken along the line CCXXIV-CCXXIV in FIG. 222; and FIG. 225 is a sectional view taken along the line CCXXV-CCXXV in FIG. 222.

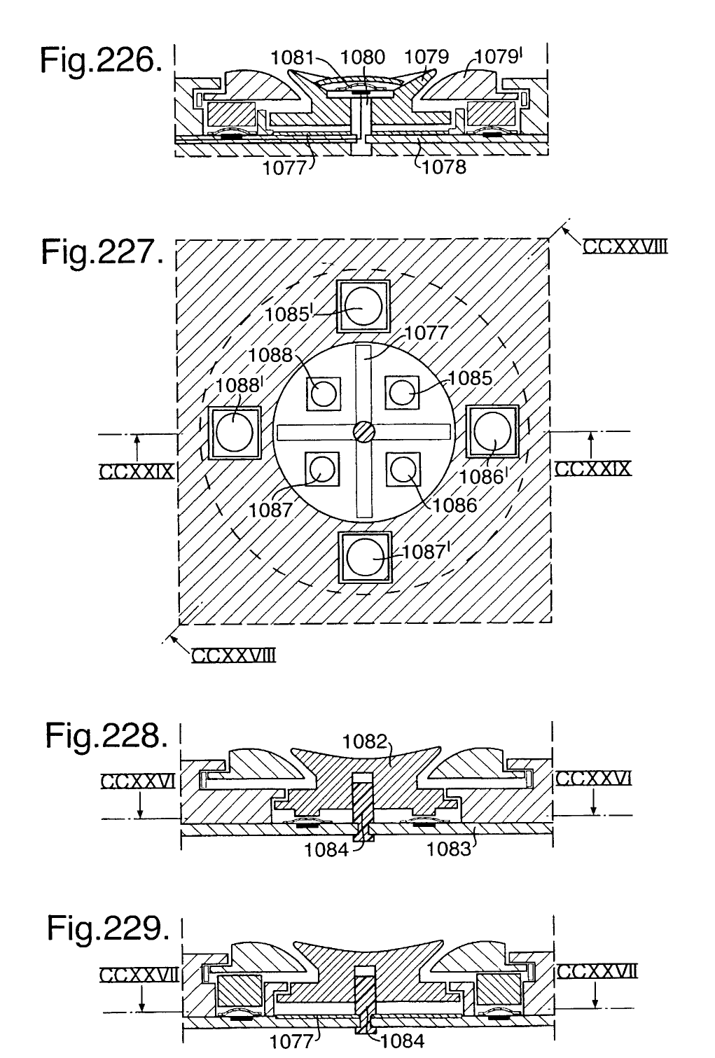

FIG. 226 shows a fifty-first embodiment of the operating device and represents a minor modification of the solution shown in FIGS. 217-225.

FIGS. 227-229 show a fifty-second embodiment of the operating device, which represents a modification of the device shown in FIGS. 217-225, where FIG. 227 is a sectional view taken along the line CCXXVII-CCXXVII in FIG. 228 and FIG. 229; and where FIG. 228 is a sectional view taken along the line CCXXVIII-CCXXVIII in FIG. 227; and FIG. 229 is a sectional view taken along the line CCXXIX-CCXXIX in FIG. 227.

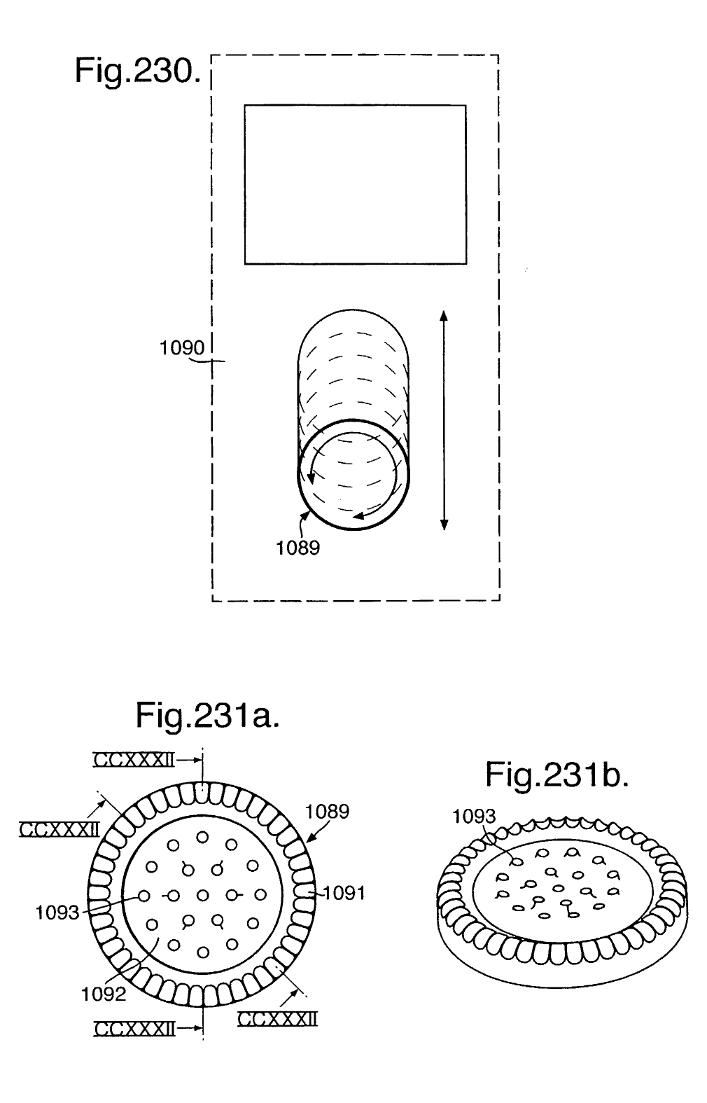

FIG. 230 is a schematic illustration of a functional apparatus equipped with an operating device where the control element consists of one or more rotatable parts.

FIGS. 231a-231b show respectively a plan view and a perspective view of a button arrangement on a control element of this kind.

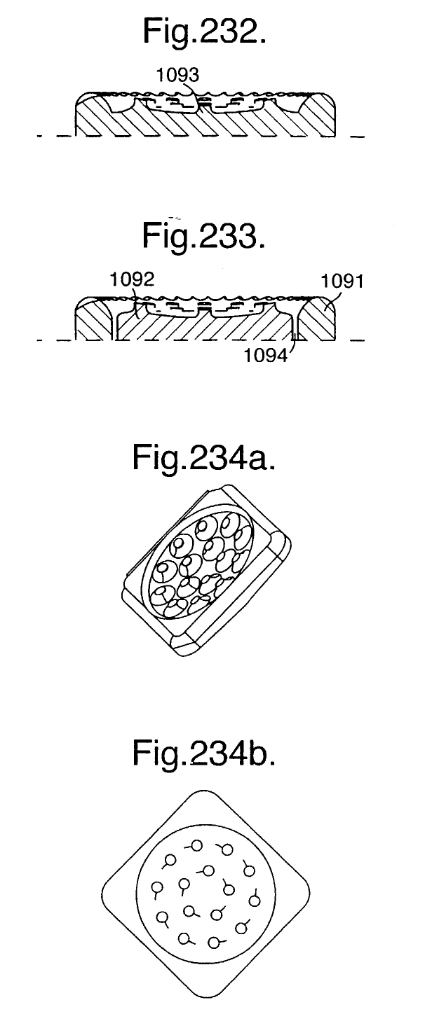

FIG. 232 is a cross-sectional view taken along the line CCXXXII-CCXXXII in FIG. 231a, illustrating an embodiment when the control element button is in one piece; and FIG. 233 is a cross-sectional view taken along the line CCXXXIII-CCXXXIII in FIG. 231a of the control element, illustrating an embodiment when it is two-part.

FIGS. 234a and 234b show a modification of the control element shown in FIG. 221 in connection with a control element which is not rotatable, but tiltable in four directions.

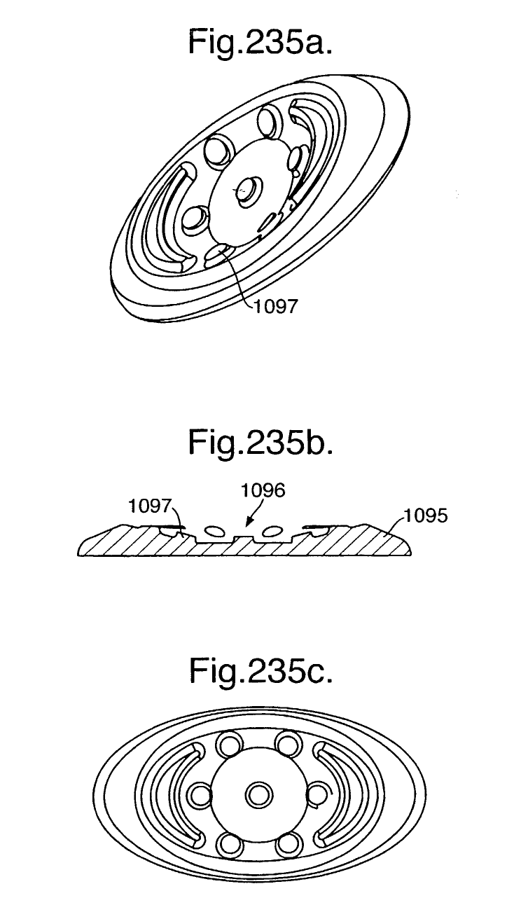

FIGS. 235a, 235b and 235c are related to the surface of a control element for a sliding switch.

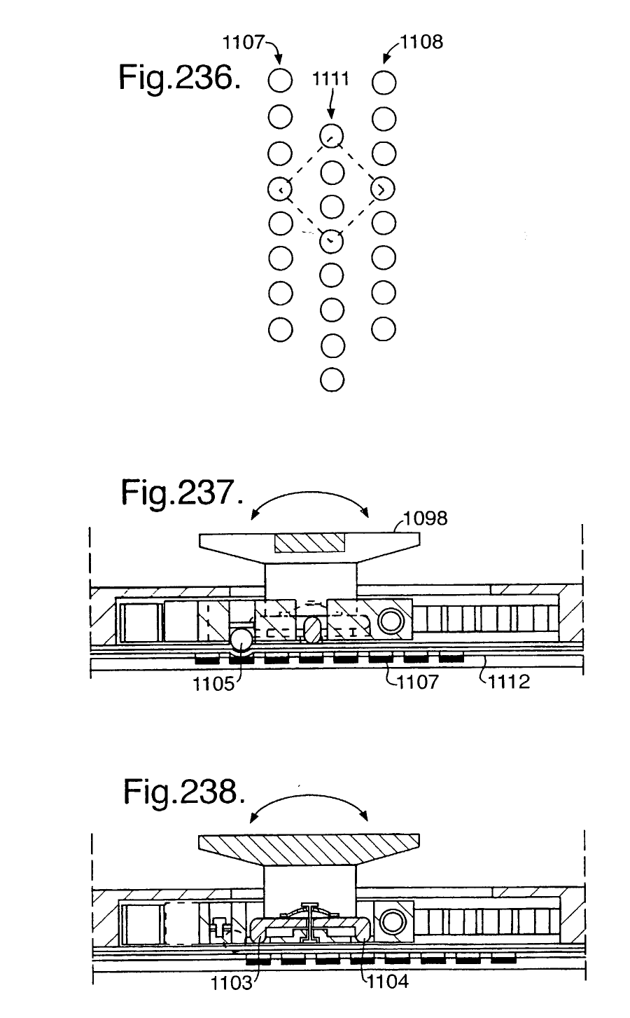

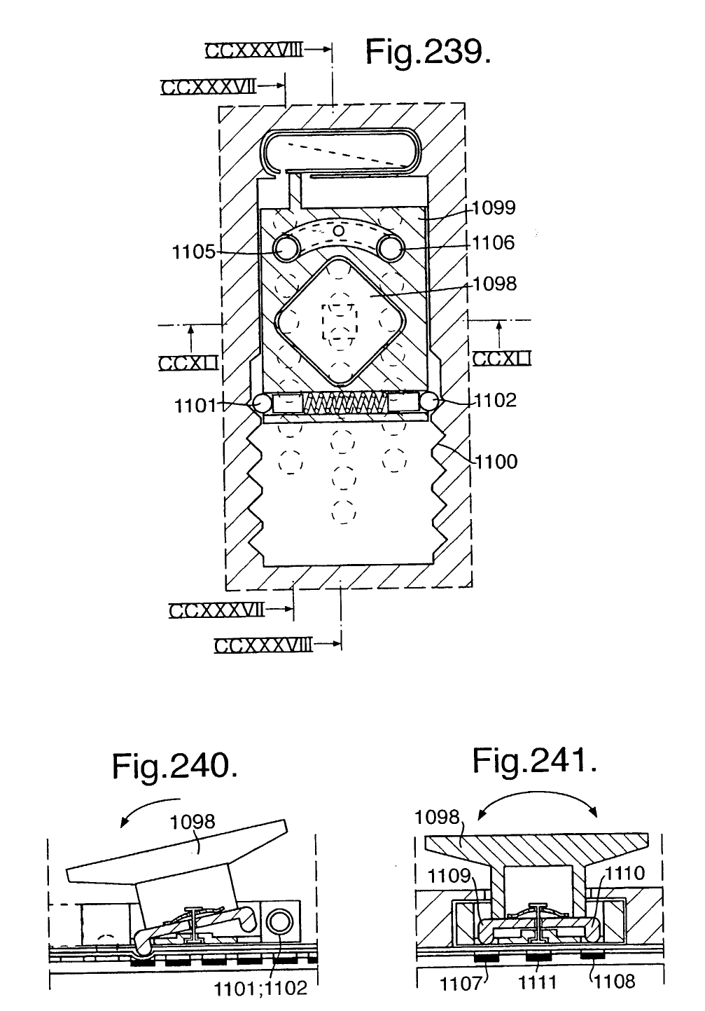

FIGS. 236-241 represent a fifty-third embodiment of the operating device, where FIG. 236 shows an array of foil/membrane switches; FIG. 237 is a sectional view taken along the line CCXXXVII-CCXXXVII in FIG. 239; FIG. 238 is a sectional view taken along the line CCXXVIII-CCXXVIII in FIG. 239; FIG. 240 shows the control element of the operating device in a tilting position; and FIG. 241 is a sectional view taken along the line CCXLI-CCXLI in FIG. 239.

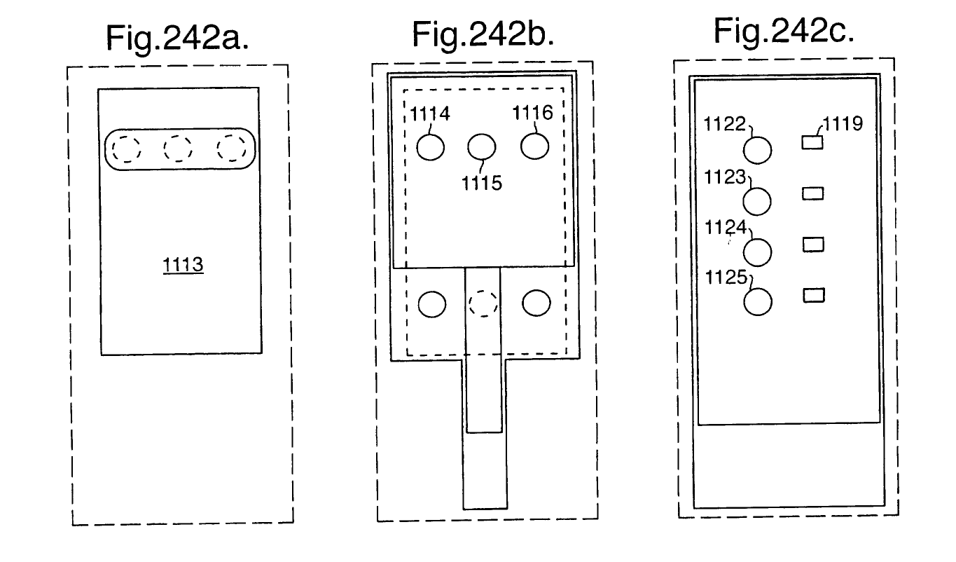

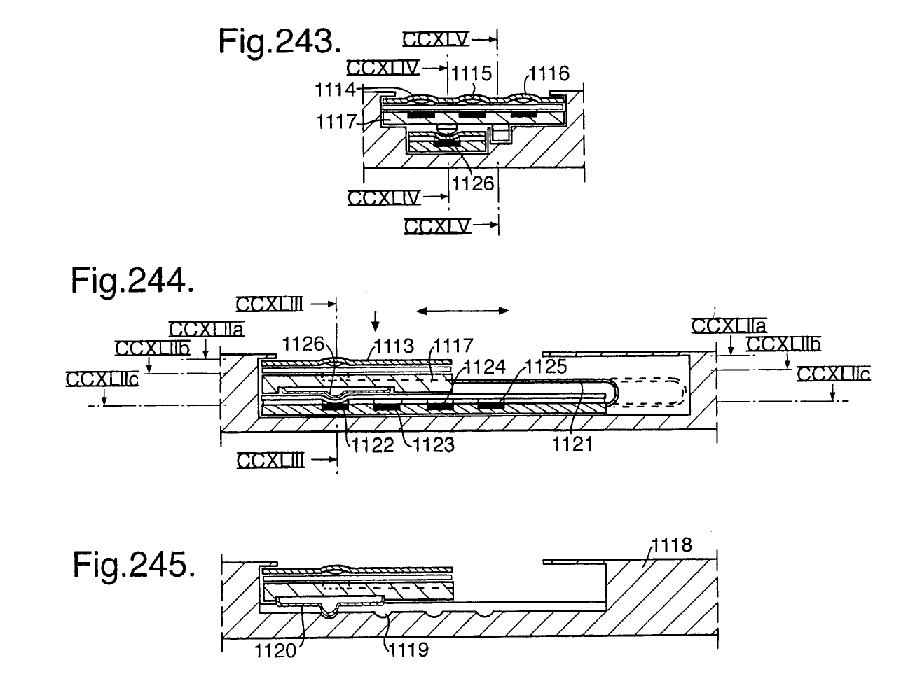

FIGS. 242a-242c, 243-245 show a fifty-fourth embodiment of the operating device, where FIG. 242a is the view CCXLIIa in FIG. 244, FIG. 242b is the view CCXLIIb in FIG. 244; FIG. 242c is the view CCXLIVc in FIG. 244; FIG. 243 is a sectional view taken along the line CCXLIII-CCXLIII in FIG. 244; FIG. 244 is a sectional view along the line CCXLIV-CCXLIV in FIG. 242; and FIG. 245 is a sectional view taken along the line CCXLV-CCXLV in FIG. 243.

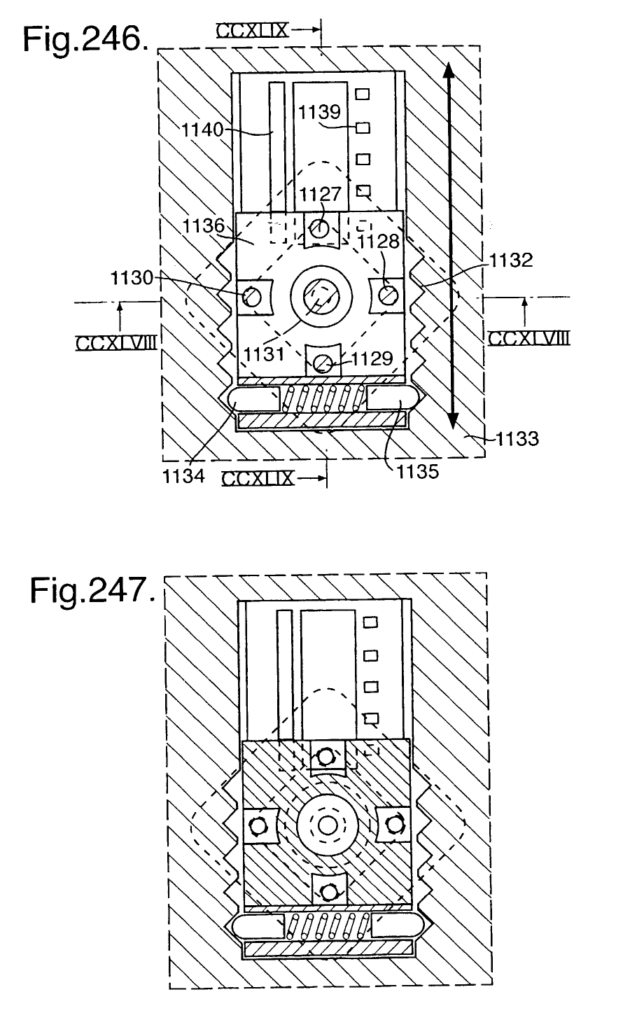

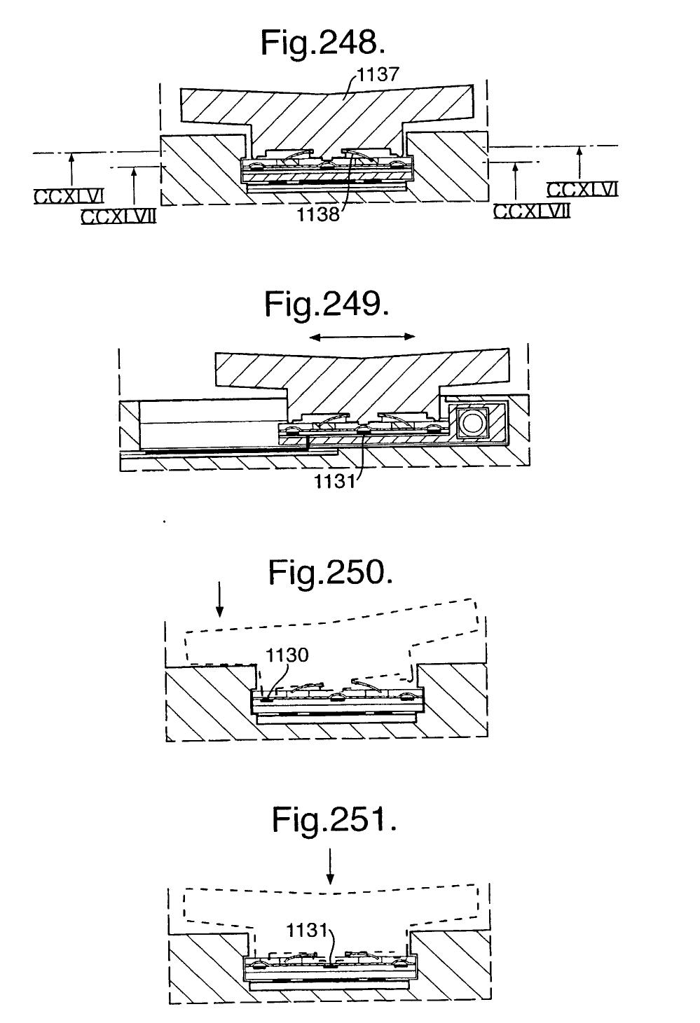

FIGS. 246-251 show a fifty-fifth embodiment of the operating device, where FIG. 246 is a sectional view taken along the line CCXLVI-CCXLVI in FIG. 248; FIG. 247 is a sectional view along the line CCXLVII-CCXLVII in FIG. 248; FIG. 248 is a sectional view along the line CCXLIX-CCXLIX in FIG. 246; and FIGS. 250 and 251 show the operating device with the control element in a tilting position and a depressed position respectively.

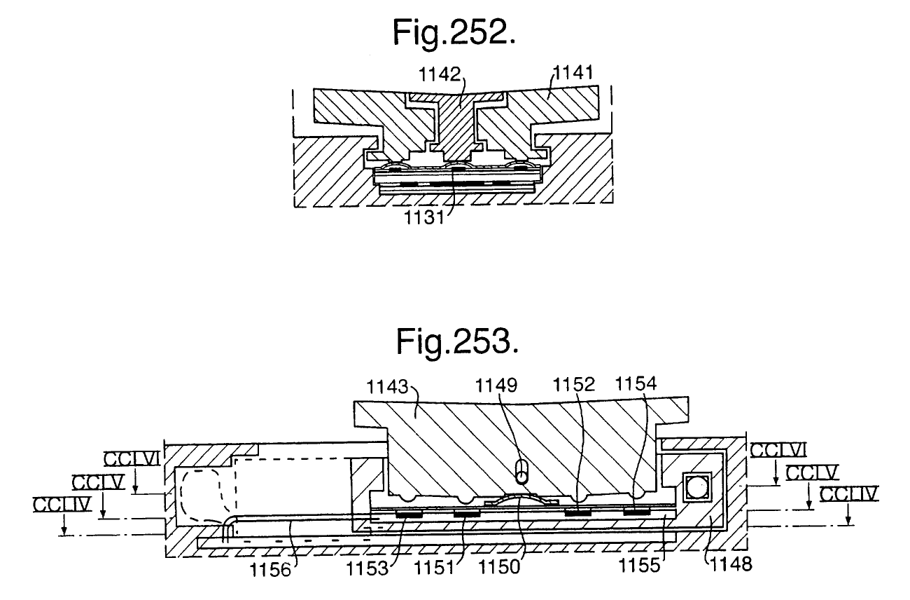

FIG. 252 shows a variant of the embodiment shown in FIG. 248 and represents a fifty-sixth embodiment of the operating device.

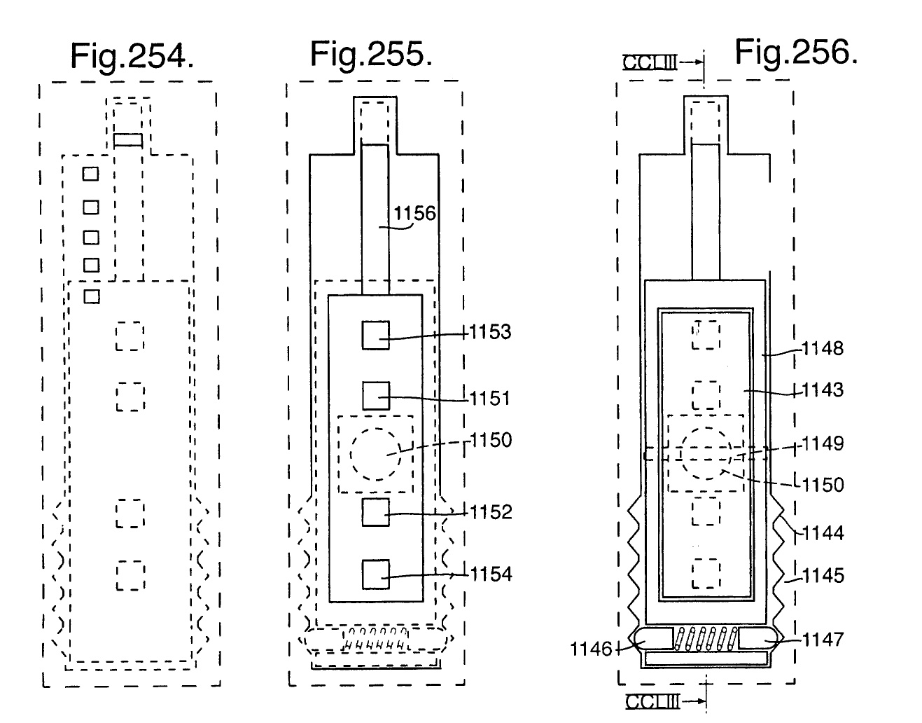

FIGS. 253, 254, 255 and 256 show a fifty-seventh embodiment of the operating device, where FIG. 253 is a sectional view taken along the line CCLIII-CCLIII in FIG. 256; FIG. 254 is a sectional view taken along the line CCLIV-CCLIV in FIG. 253; FIG. 255 is a sectional view taken along the line CCLV-CCLV in FIG. 253; and FIG. 256 is a sectional view taken along the line CCLVI-CCLVI in FIG. 253.

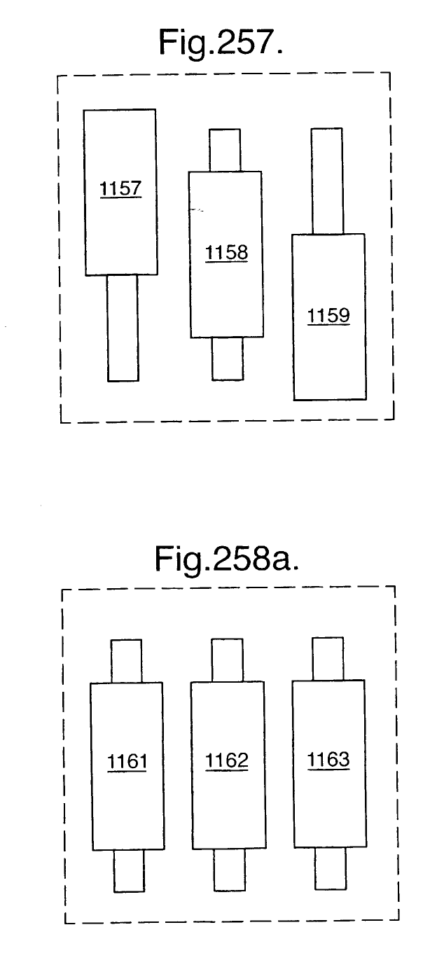

FIGS. 257, 258a, 258b and 259 show different possible uses of the operating device shown in FIGS. 253-256.

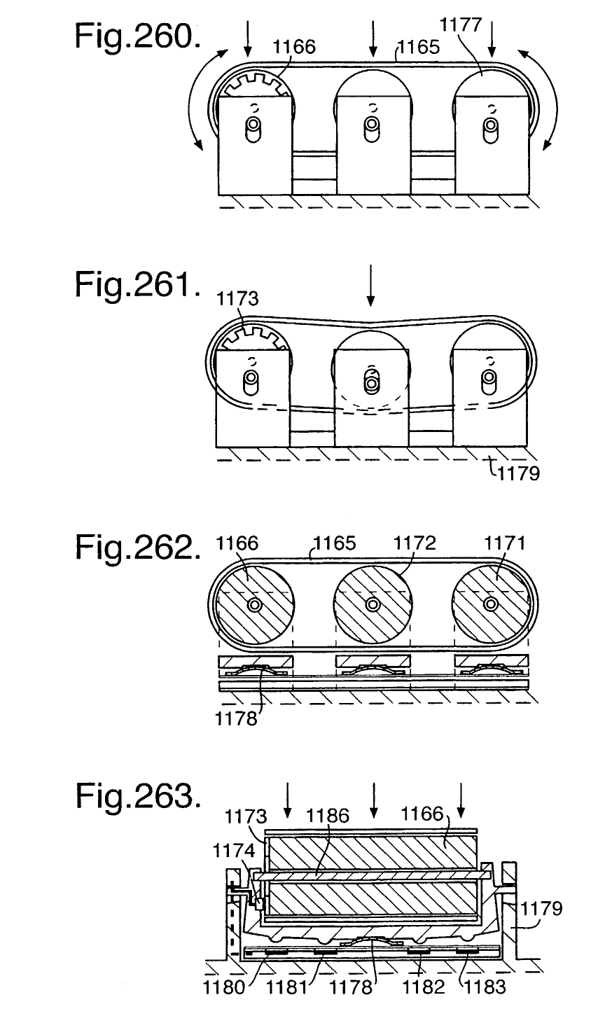

FIGS. 260-265 show a fifty-eighth embodiment of the operating device, where FIG. 262 is a sectional view along the line CCLXII-CLXXII in FIG. 265; and FIG. 263 is a sectional view along the line CCLXIII-CLXIII in FIG. 265.

FIGS. 266-268 show a fifty-ninth embodiment of the operating device and represent a simplified modification of the operating device shown in FIGS. 260-265.

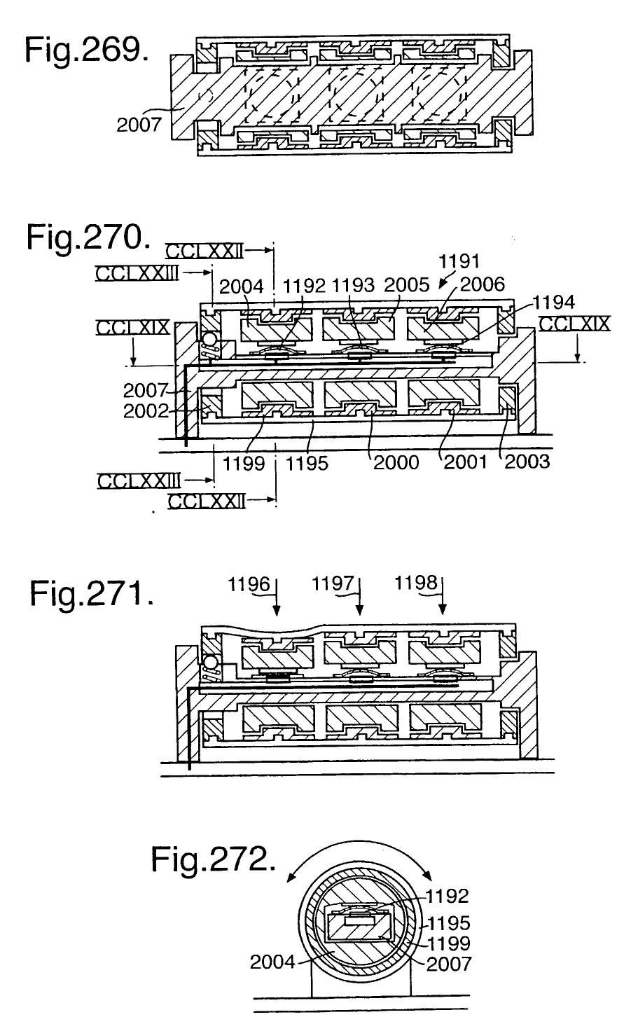

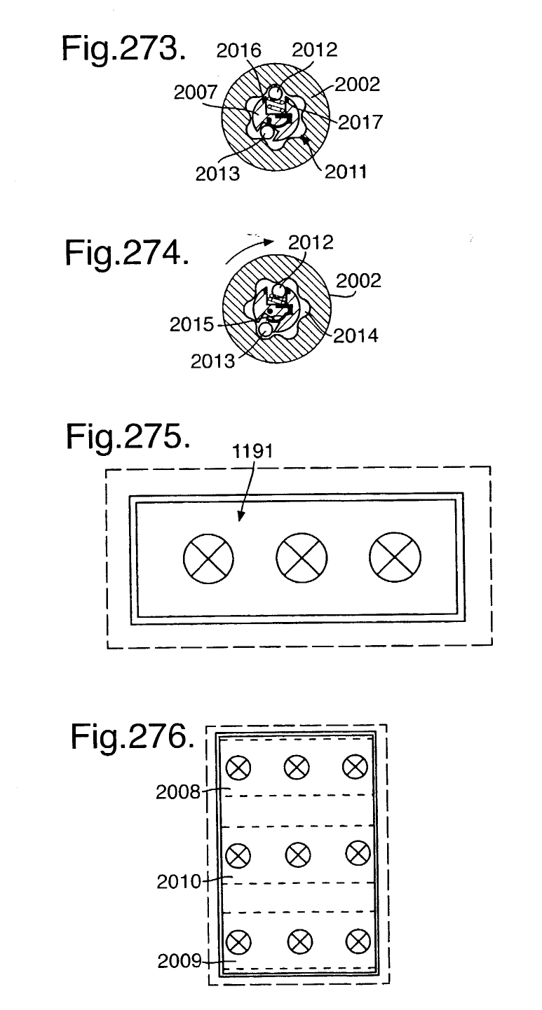

FIGS. 269-275 show a sixtieth embodiment of the operating device; and FIG. 276 shows a forty-third embodiment of the operating device shown in FIGS. 269-275, wherein FIG. 269 is a sectional view taken along the line CCLXIX-CCLXIX in FIG. 270; FIG. 272 is a sectional view taken along the line CLXXII-CLXXII in FIG. 270; and FIG. 273 is a sectional view taken along the line CCLXXIII-CCLXXIII in FIG. 270.

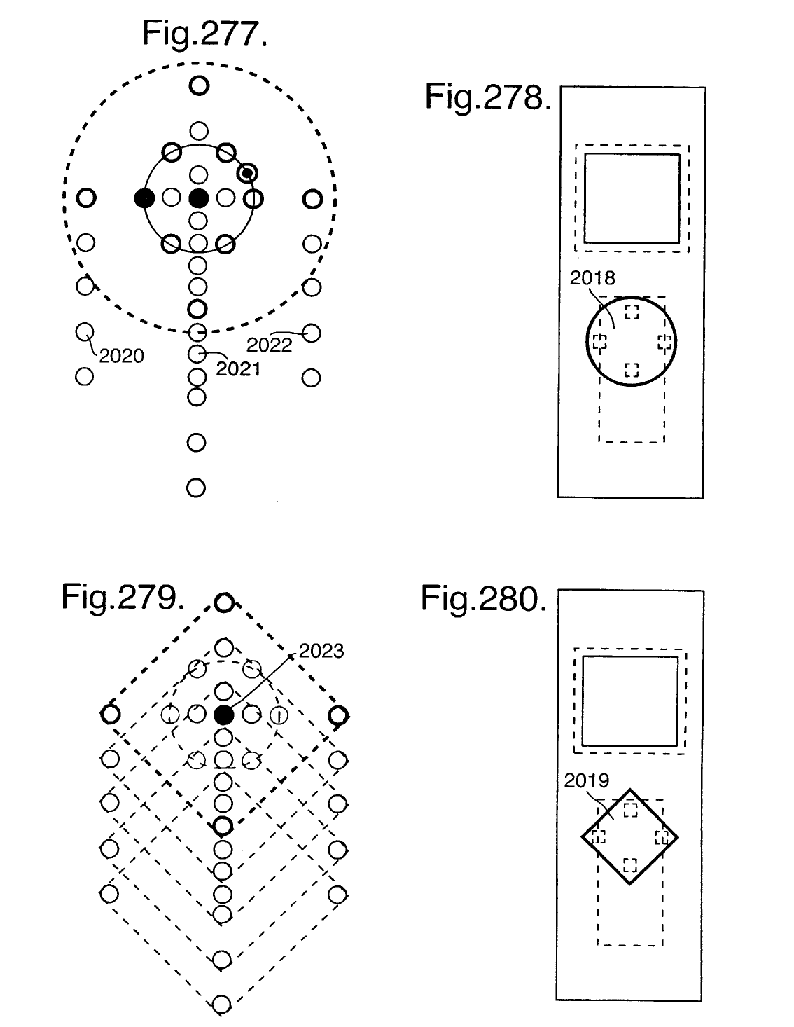

FIGS. 277 and 278 show a sixty-first embodiment of the operating device.

FIGS. 279 and 280 show a sixty-second embodiment of the operating device.

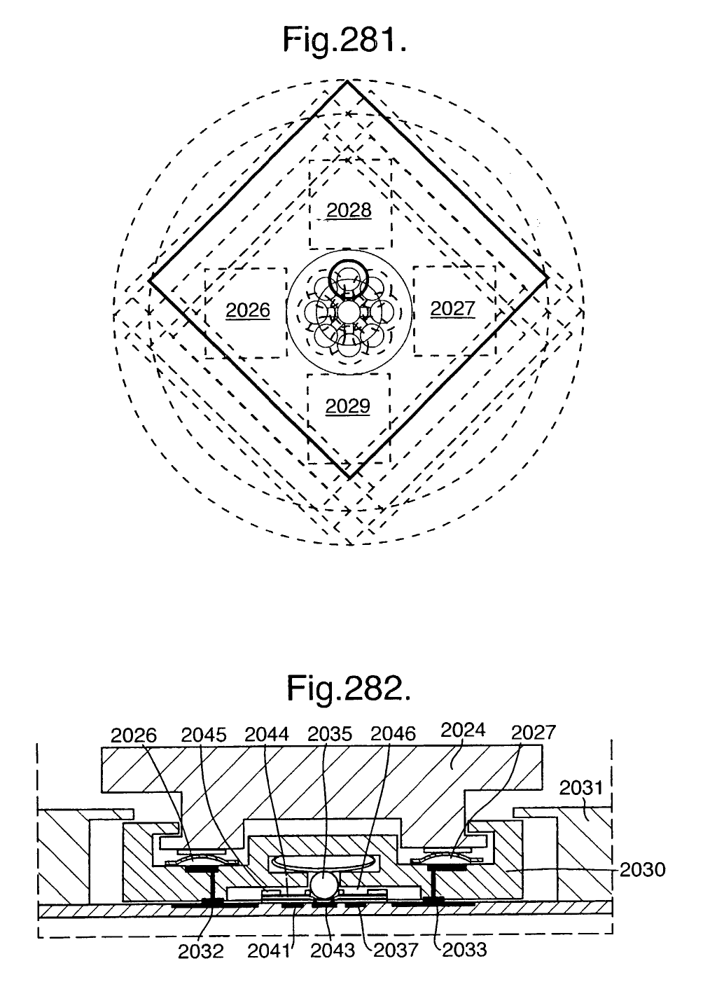

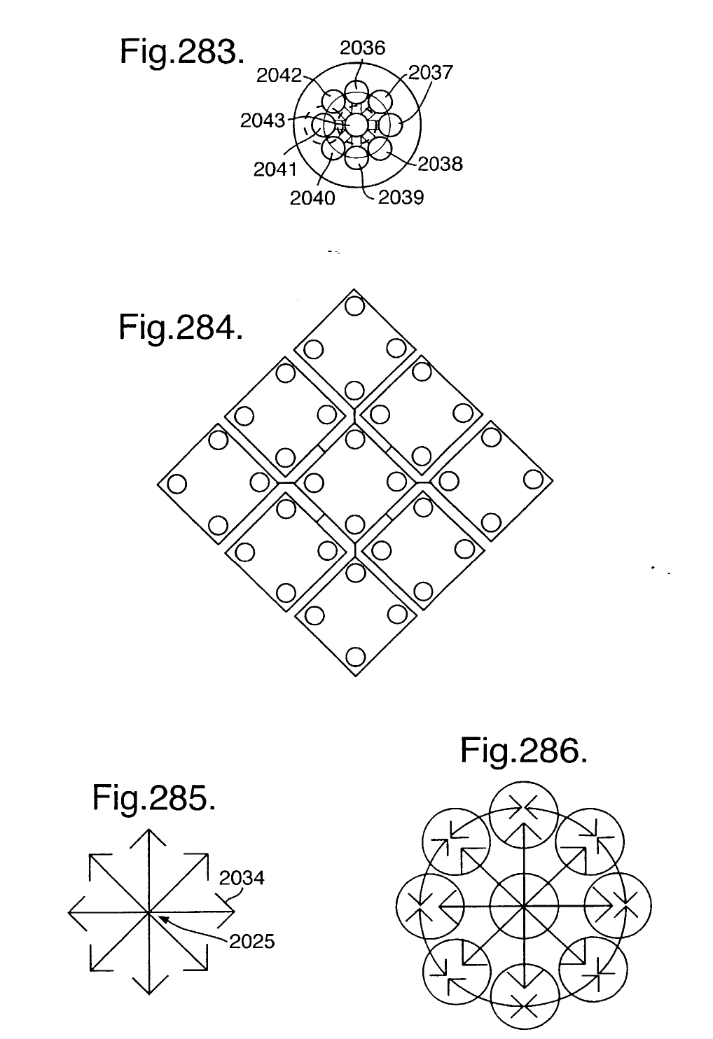

FIGS. 281-286 illustrate a sixty-third embodiment of the operating device.

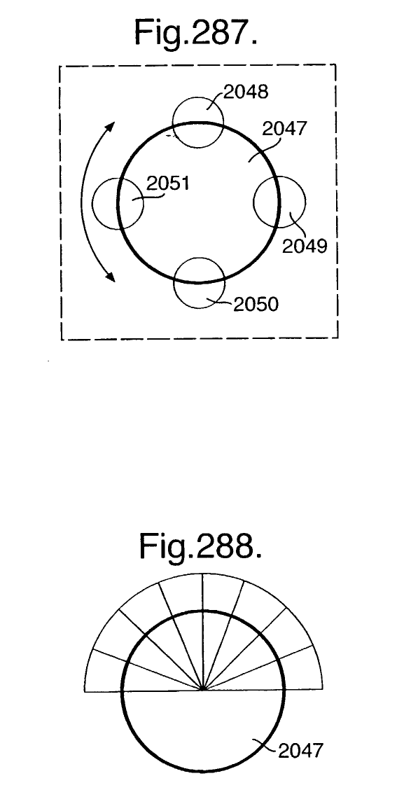

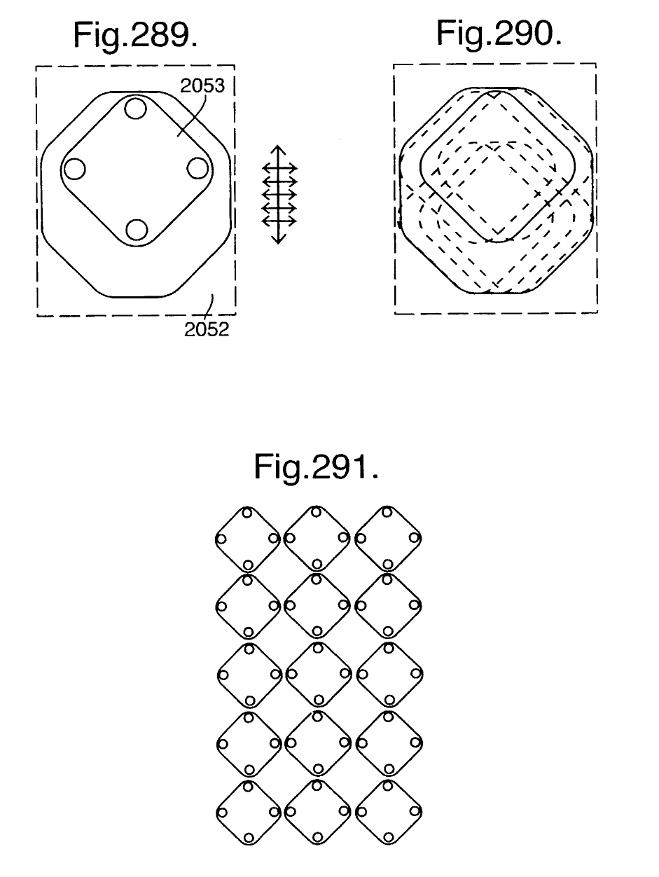

FIGS. 287 and 288 show a further modification of the operating device and represent a sixty-fourth embodiment.

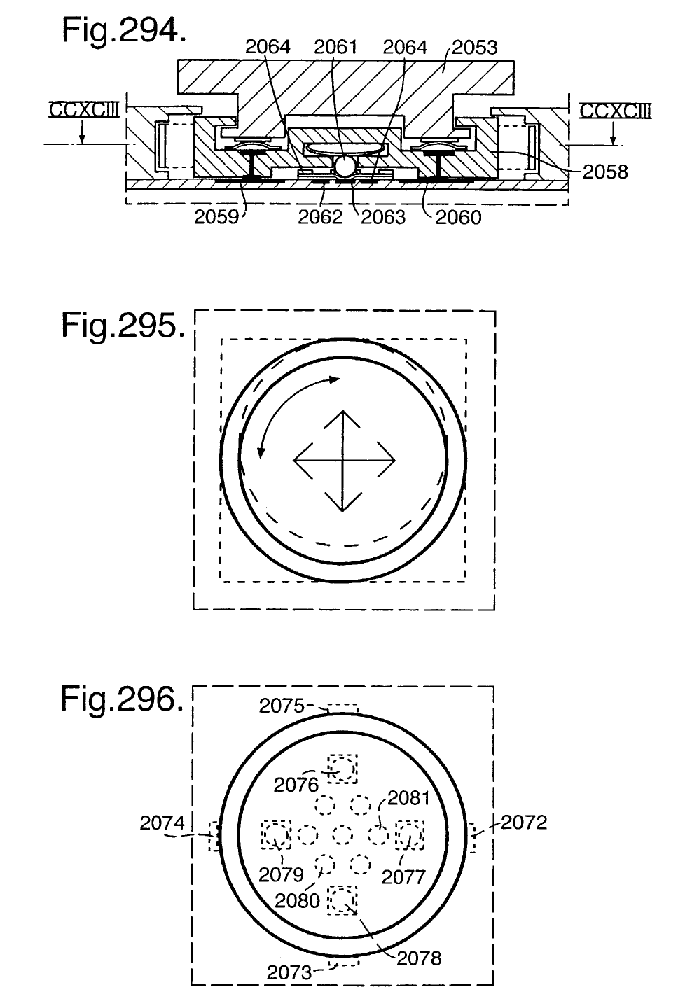

FIGS. 289-294 show a sixty-fifth embodiment of the operating device, where FIG. 293 is a sectional view taken along the line CCXCIII-CCXCIII in FIG. 294; and FIG. 294 is a sectional view taken along the line CCXCIV-CCXCIV in FIG. 293.

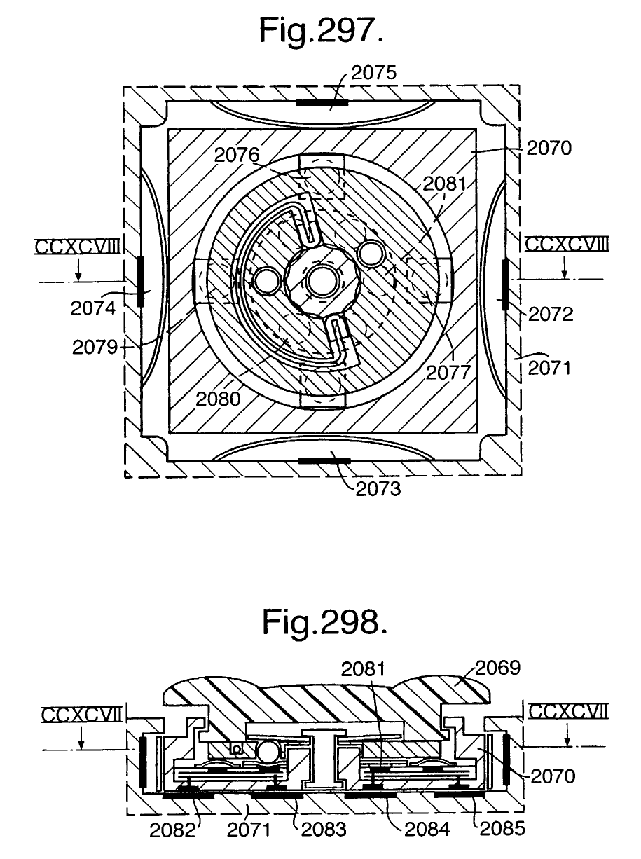

FIGS. 295-298 show a sixty-sixth embodiment of the operating device, where FIG. 297 is a sectional view taken along the line CCXCVII-CCXCVII in FIG. 298; and FIG. 298 is a sectional view taken along the line CCXCVIII-XXCXVIII in FIG. 297.

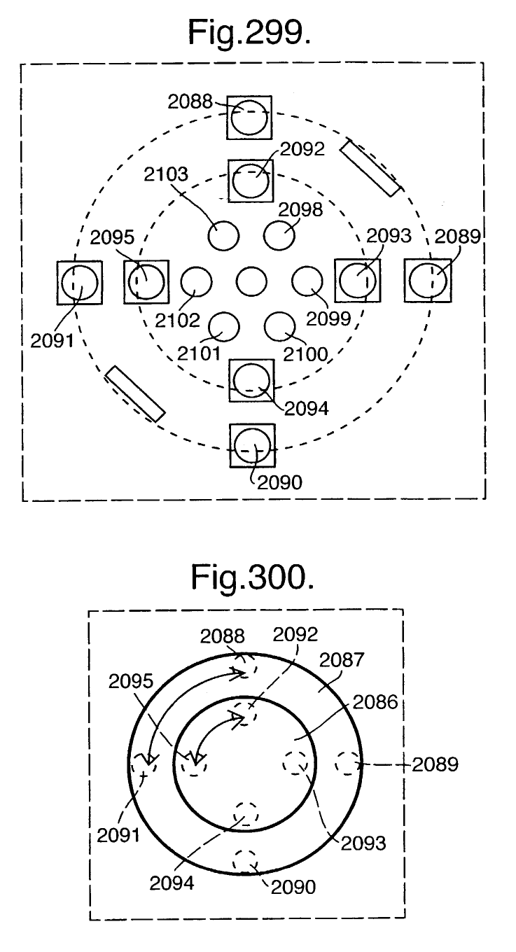

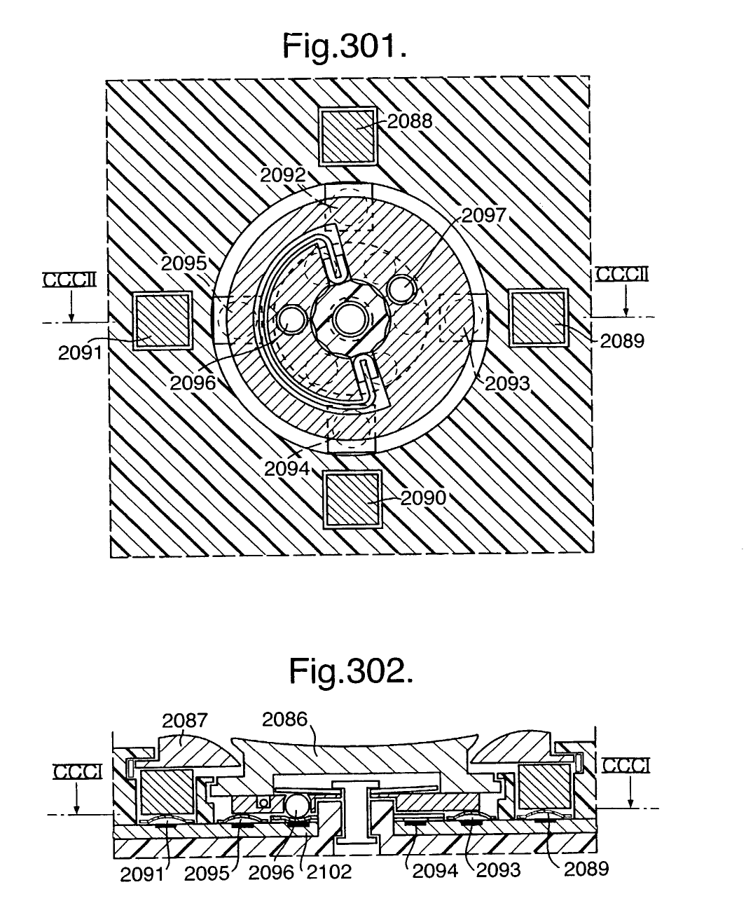

FIGS. 299-302 show a sixty-seventh embodiment of the operating device, where FIG. 301 is a sectional view taken along the line CCCI-CCCI in FIG. 302; and FIG. 302 is a sectional view taken along the line CCCII-CCCII in FIG. 301.

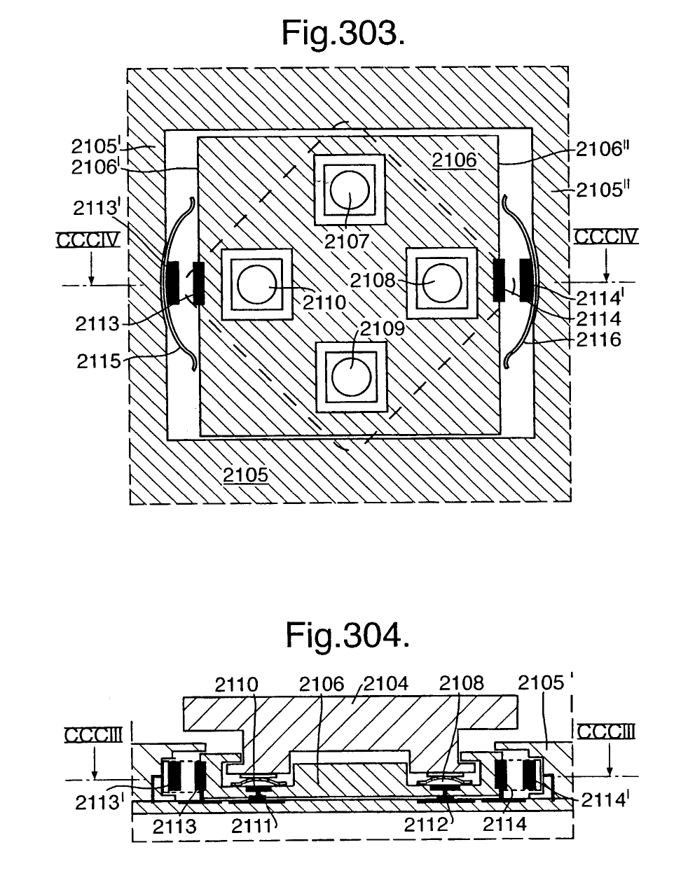

FIGS. 303-306 show a sixty-eighth embodiment of the operating device, where FIG. 303 is a sectional view taken along the line CCCIII-CCCIII in FIG. 304; and FIG. 304 is a sectional view along the line CCCIV-CCCIV in FIG. 303.

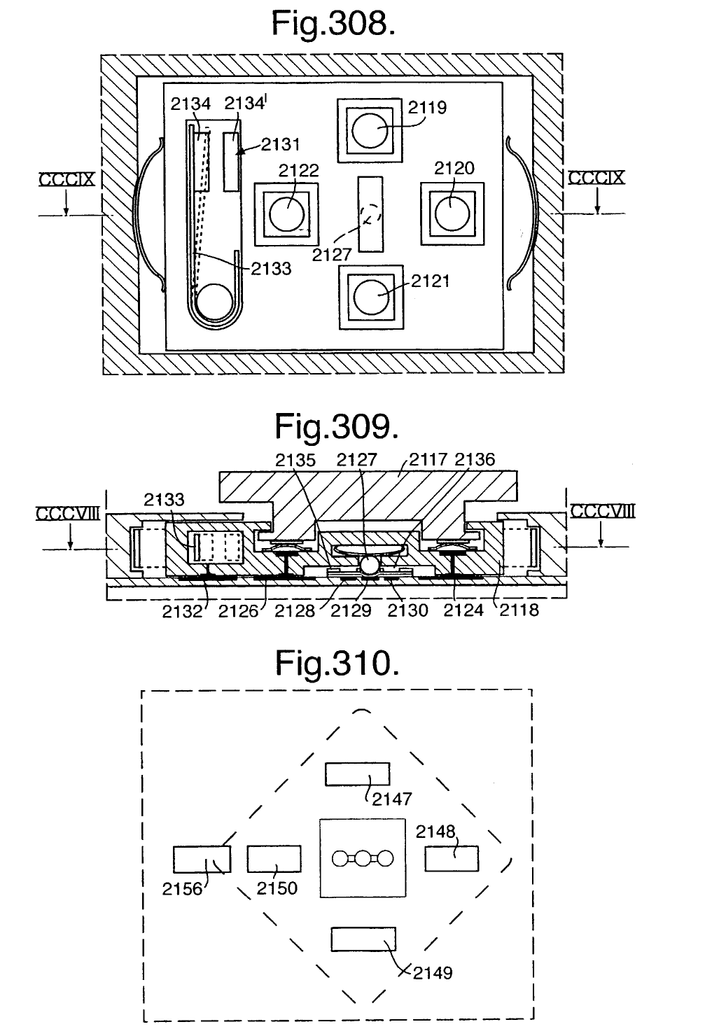

FIGS. 307-309 show a sixty-ninth embodiment of the operating device, where FIG. 308 is a sectional view taken along the line CCCVIII-CCCVIII in FIG. 309; and FIG. 309 is a sectional view taken along the line CCCIX-CCCIX in FIG. 308.

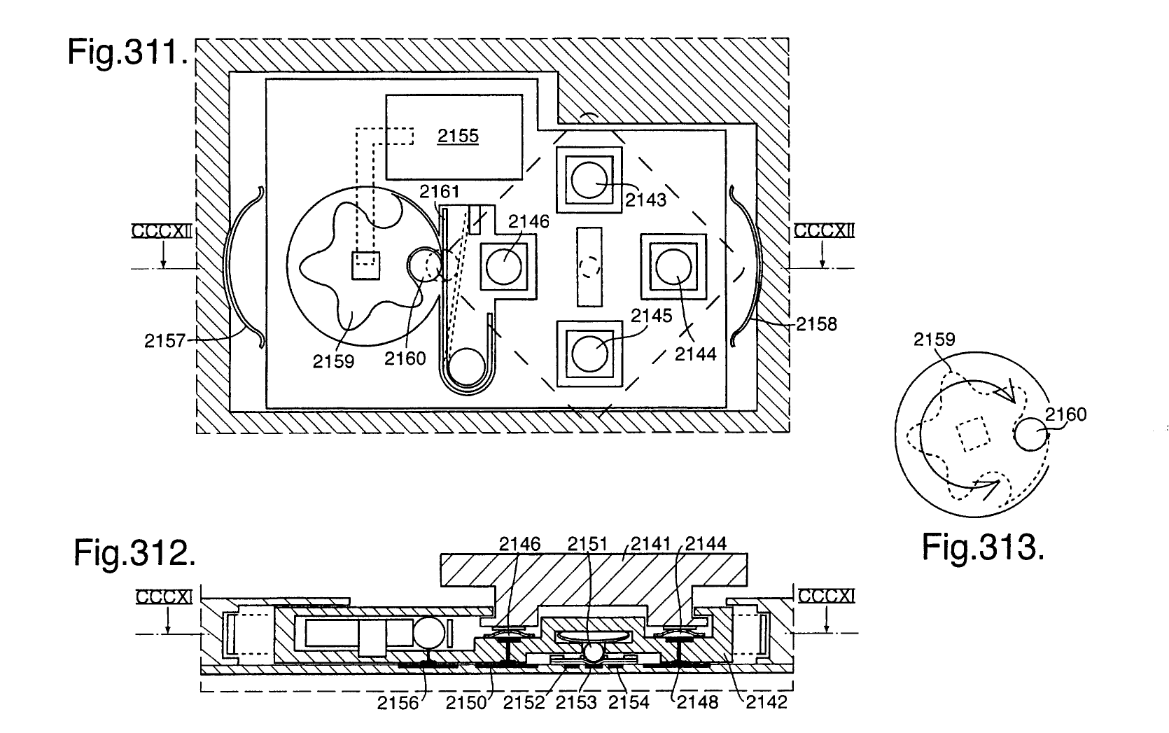

FIGS. 310-313 show a seventieth embodiment of the operating device, where FIG. 311 is a sectional view taken along the line CCCXI-CCCXI in FIG. 312; and FIG. 312 is a sectional view taken along the line CCCXII-CCCXII in FIG. 311.

In the solution according to FIGS. 1-6 there is a first slide 1 and, transverse to the direction of movement of the first slide 1, a parallel, stepwise movable second slide 2. Arranged on the second slide 2 is a control button 3 having a boss 4, which is movable orthogonal to the two faces of the second slide through a guide 5 in the second slide. The first slide 1 is movable in a housing 6 and stepwise movable with the aid of springs 7 that engage with grooves 8 on the first slide. In the housing and spaced from the underside of the first slide there is a plurality of switch elements 9-11 and 12-14, 15-17 and 18-20, and in addition there ire optoelectronic devices in the form of photodetector pair 21-23 to detect the longitudinal movement of the first slide 1, whilst optoelectronic devices 24, 24′ and 25, 25′ are provided to detect the two sideways movements of the slide. The longitudinal movement of the first slide is detected by means of a light path barrier 26, as shown in FIG. 3 which, for example, blocks the passage of light between the optoelectronic equipment or the detector 23, indicated in FIG. 3 by means of the reference numerals 23′ and 23 “. The sideways movement of the second slide is detectable when light passages 27 or 28 are blocked by the slide 2, as indicated in FIG. 2.

As shown in FIG. 6, the input from the optical switches 21-25 and the mechanical switches 9-20 is fed to a microprocessor 29 that feeds the data from these switches onto a display 30. Thus, the optical switches 21-23 will determine the row position for a cursor 31, whilst the optical devices 24, 24′ and 25, 25′ will determine whether the cursor is to lie in the left-hand or right-hand column. If both light apertures 27, 28 allow light through, the centre column will be selected for the cursor 31. The individual switches 9-20 can be depressed in the selected position so as to mark the character or symbol desired. It will be seen that the switches 9-20 are positioned two-dimensionally, so that composite, stepwise movements of the first and second slide will give coordinate determined positions for said boss 4, whereby one of the switch elements 9-20 at the position in question will be activated on depression of the control button 3 and the contact of the boss with the switch element. The control button 3 is preferably spring-loaded by means of a spring 32. At the bottom, the boss 4 preferably has a pin 4′ for engagement with the switch element, so as to obtain a more marked activation of the switch element. At the bottom, the switch may have a pin 4′ for marked engagement with the switch element.

Although initially the switches 9-20 may electromechanical, e.g., of the switch-pad or microswitch type or the like, it is possible that the switches may be capacitive-acting.

In the embodiment shown in FIGS. 7-11 there is a movable slide 33 which is movable preferably stepwise with the aid of a spring device 34 that engages with notches 35 on the slide 33. In this embodiment there is no transverse, stepwise movable slide, but there is a control button 36 that is tiltably supported on tilt and guide pins 37, 38 that are secured in blocks 39, 39′. Thus, the control buttons are tiltable sideways in addition to being depressible. Consequently, a study of, e.g., FIG. 9 will reveal that if the control button 36 is tilted in an anti-clockwise direction, a switch 49 will be activated by a pin 40 on a switch actuating member 41, whilst tilting of the control switch 36 an anti-clockwise direction will cause a pin 42 to activate a switch 51. On central depression of the control button 36, a pin 44 on the switch actuating member 41 will activate a switch 50. The control button 36 thus has the switch actuating member 41 movable through on opening 46 in the housing 47 and through an opening 48 in the slide 33 itself. The said pins 37 and 38 extend through openings 43 and 45, which are oval in vertical section. A stepwise positioning of the slide 33 and tilting or depression of the switch actuation member 41 will cause a coordinate-determined position of at least one pin 40, 42 or 44 to correspond with a coordinate-determined position of a respective switch element 4960. For the sake of clarity, optoelectronic devices, such as the devices 21-23 in FIG. 5, are not shown in FIG. 8, but it should be understood that such devices must necessarily be present. A device of this kind, indicated by means of the reference numerals 23′ and 23” in FIG. 9, shows a typical location. The pin 44 may optionally function as a light blocking member, or the slide may on its underside be equipped with a light blocking means, such as the means 26 in FIG. 3. The two pins 40, 42 are shorter in length than the pin 44, whereby the two shortest pins 40, 42 are thus designed to be able to actuate a respective switch element in one or the other of the rows of switches 49, 52, 55, 58 or 51, 54, 57, 60 separately timewise, and that the longest pin is only designed to operate one switch element 50, 53, 56, 59 at a time. However, it will be understood that the pIln40, for example, on depression of the control button 36 will be able to activate the switch 39, at the same time as the pin 44 through a combined movement of the button 36 will also be able to activate the switch 45. The same will happen if the control button 36 is tilted and depressed in a clockwise direction.

As explained in connection with FIG. 6, input from detectors and switches could also be fed, for example, to a display 30.

It can be seen in FIG. 12, and with reference to FIGS. 16 and 17, that the control button 61 on the underside thereof has a switch actuating member 62 having four switch actuating pins 63, 64, 65 and 66. The pins 63-66 are located at the corners of the square switch actuating member 62. Unlike the embodiment in FIG. 10, where two holes 37′, 38′ were provided in the control button, the embodiment shown in FIGS. 12-17 is provided with one elongate hole 66, the cross dimension of which diminishes from each end towards the centre of the hole, as can be seen in FIG. 15, and where the hole 66 interacts with a tilt and guide pin 67 that is arranged transverse to an opening 68 in the slide, as also is shown in FIG. 15. The pins 63-66 are arranged so as to be able to actuate a respective switch element 69-82, as indicated in FIG. 13, where these switch elements can interact with a microprocessor, as shown and explained in connection with FIG. 6. In order to detect the stepwise movement of the slide 83, which is effected with the aid of notches 84 in the slide that interact with springs 85, optoelectronic devices 86, 86′ can be provided as shown and explained in connection with the devices 21-23 in FIG. 5, so that the stepwise movement can be easily registered, either audibly, visually or a combination thereof A light barrier 87 can be arranged on the underside of the slide 83, or, for instance, the pins 63, 65 may form a light barrier when one or other of the pins is brought into contact with a switch. The specially shaped, elongate hole 66 gives the major advantage that only one of the pins 63-66 can enter into action with a switch 69-82 at a time. As mentioned above, the switches 69-82 can either be electromechanical, e.g., of the switch-pad or microswitch type or the like, but the switches could also be capacitive-acting. As shown in FIGS. 8 and 13 and also in FIG. 19, three parallel rows of such switch elements are provided. In the solution shown in FIGS. 12-17, it is thus in fact made possible for the control button 61 in one position of the slide 83 to operate one of four possible switches 69-82.

The solution shown in FIGS. 18-23 will now be explained in more detail. The solution works per se in an identical manner to the solution shown in FIGS. 12-17, but has a control button 88 having a switch actuating member 89 which has three switch actuating pins 90, 91, 92 that are equal in length, and where the pins are located at the corners of the triangular switch actuating member. Registration of the movement of the slide 93 can be effected by optoelectronic detectors 94, 94′ and by a plurality of such detectors, as indicated in FIG. 5, so that each step of the movement of the slide 93 is thus registered. A light barrier 95 may be provided, but it is also possible to allow, e.g., the pins 91 and 92 to form effective light barriers when the control button is depressed in a particular position of the slide 93. However, it is probably preferable to use a light barrier 95 to quickly and efficiently indicate the position of the slide 93 without having to tilt the control button. Thus, for instance, it is possible that the light barrier can be positioned as indicated by means of either the reference numeral 95 or the reference numeral 96 in FIG. 2. It is also conceivable that the light barrier 96 can be a longitudinal strip with light apertures 96′, as indicated in FIG. 18. In that case, it will mean that the light path is blocked between the stepwise positions of the slide 93. As with the two preceding embodiments in FIGS. 7-11 and FIGS. 12-17 respectively, a plurality of switches 97-108 are also provided, as shown in FIG. 19, which, via a microprocessor, can be connected to, e.g., a display, like the display 30 in FIG. 6.

FIGS. 24-28 show a modification of the solution shown in FIGS. 18-23. To prevent the control button from operating the switch actuating member 89 in intermediate positions between the positions defined by the springs 109 and the notches 110 on the slide, it will be an advantage to arrange between the switch elements supporting bridges for the pins 90-92, so that the switches 97-108 cannot be actuated by the pins in intermediate positions. Thus, in reality the switch button 88 will be immovable in the intermediate positions. Optionally, an end supporting bridge 120 may also be provided. The housing of the operating device is indicated in FIGS. 18-28 by the reference numeral 121.

Another operating device can be seen from that shown in FIGS. 29-34. In this embodiment there is a control button 122 provided with a downward projecting central boss 123 that is preferably rounded at the bottom, as indicated by means of the reference numeral 124. The boss is preferably spring-supported by a spring 125, e.g., a leaf spring. The boss is tiltably supported on a shaft 126 in the operating device housing 127. The shaft 126 has a pair of extended end areas 126′ and 126″, as indicated in FIGS. 30, 33 and 34. Furthermore, the boss 123 is movable along a limited central part of the shaft 126 against spring action generated by springs 128, 129. Projecting from the boss 123 transverse to the direction of the shaft 126 is a pair of opposing projections 130, 131.

In the housing and spaced from the control button 122, and spaced downward of the end areas 126′, 126″ of the shaft 126 and also downward of the projections 130, 131, is a plurality of switch elements 132, 133, 134 and 135, and breaker contacts 136, 136′. A first pair 132, 133 is designed to be actuated by a respective end area 126′, 126″ of the shaft 126 on the tilting thereof in one direction or the other, as indicated by the arrow 137 in FIG. 30. Similarly, a second pair 134, 135 of the switch elements will be designed to be actuated by a respective projection 130, 131 on the tilting of the control button 122 and its boss about the shaft 126 in one direction or the other as indicated by the arrow 138. A third pair of switch elements 136 and 139 are each designed to slide actuated by the bottom rounded portion of the boss 123 on the sliding movement of the boss in a respective direction on the shaft 126, as indicated by the arrows 140 and 142. When the control button 122 and thus the boss 123 are pushed towards the left, the switch element 136 will, but if the control button and the boss 123 are moved towards the right in FIG. 30, the switch 139 will be activated, This is due to the fact that the ends of the spring 125 come to bear against the switch 136 or 139.

If there is sufficient clearance between the shaft ends 126′, 126″ and respective switches 132, 133, it is also possible that the switch button 122 and its boss 123 can be pressed straight down so as to activate both switches 136, 139. Here, it will also be appreciated that the switches 132-135, and 136 and 139 could be, e.g., mechanical, electromechanical, e.g., of the switch-pad or microswitch type or the like, or optionally capacitive-acting. The switches 132-135, and 136 and 139, could be connected, for example, to a microprocessor which controls external functions, as for instance a display, telecommunications equipment etc. A connection of this kind is indicated in FIG. 6.

It will be seen in FIGS. 30 and 31 that the housing 127 has shoulders 141 that abut against the underside of the control button 122 when it is moved relative to the shaft 126 so as to prevent tilting of the control button during such movement. The leaf spring 125 is preferably provided with bent ends, so that the bent end will more easily activate a respective switch element 136, 139 when the rounded bottom part of the boss 123 is moved towards one part of the other of the leaf spring. As can be seen from FIG. 29, the control button boss 123 can thus be pushed in the direction of the arrows 140 and 142 along the short extent of the shaft 126. The arrows 143, 144, 145 and 146 indicate how the respective switches 132, 133, 134 and 135 can be activated on the depression of the control button at the respective points.

The embodiment shown in FIGS. 35-41 is per se quite similar to the embodiment shown and described in connection with FIGS. 29-34. Therefore, the reference numerals used in FIGS. 29-34 have also been used as far as possible in particular in FIGS. 36, 37, 40 and 41.

It will be seen that in this embodiment there is a control button 122 that has a boss 123. For the sake of simplicity, the arrows 142-146 are shown here on the control button 122 itself A control wheel 147 is located on the periphery of the control button 122 boss 123, which control wheel is stepwise rotatable relative to the housing 127′ and the boss 123, as indicated in FIG. 38. It will be seen that the control wheel 147 has an corrugated or toothed periphery 148 that is in spring engagement with positioning springs 149, 149′. As will be seen from FIG. 41, in addition to the switches 132-136 and 139, there are provided additional switches 150-153 which are associated with respective depression positions 154-157, as indicated in FIG. 35. In this solution there is a total of ten switches that can be actuated, i.e., the switches 132-136, 139 and 150-153. In addition, there are also optoelectric detectors 158 and 159 that detect the underside of the control wheel as this wheel is turned. For this purpose, the control wheel is equipped on its underside with alternating fields of light reflecting fields 160 and non-light reflecting fields 161, where via the detector 158 and 159 alternating fields can be counted by a microprocessor, as, e.g., indicated in FIG. 6, to determine the position of the wheel or how many movement steps the wheel has moved through. The rotation of the wheel 147 will thus be able to effect, for example, the control of an up or down movement in a menu, or other solutions where it is desirable to move through a list of functions or data that is to be used at a later time, e.g., on a display or in connection with other external equipment, as for instance a mobile telephone.

The switch elements 150 and 151 in this embodiment therefore form a fourth pair of switch elements, whilst the switches 152 and 153 form a fifth pair of switch elements. Advantageously, the fourth pair of switch elements 150, 151 are aligned with the first pair of switch elements 132, 133, whilst the fifth pair of switch elements 152, 153 are aligned with the second pair of switch elements. Advantageously, the third pair of switch elements 136, 139 are aligned with the first pair of switch elements 132, 133. Another and somewhat simpler variant of the operating device can be seen from that illustrated in FIGS. 42 and 43. The operating device shown in FIG. 42 has a slide that is longitudinal and movable relative to a housing 163 and where optoelectronic equipment 164 and 165 is provided for detecting the movement of the slide 162. Arranged on the slide is a movable control button 166 which, by means of an operation selected from the group consisting of depression, sideways tilting, forward tilting and backward tilting, is designed to initiate a switch function of at least one switch element 167. Alternatively, the control button 166 can actuate light blocking projections 168 and 169, incidentally as described in the international patent application referred to above, so that one light path or the other or optionally both light paths are blocked by the members 168, 169 when the control button 166 is manoeuvred either by sideways tilting or depression. On the underside of the slide 162 or at the ends thereof are projections 170, 171 which, when the slide 162 is moved in one direction or the other, are designed to block the light path in connection with the optoelectronic device 164 or 165. The slide is provided with notches 172 along the side thereof which can be brought into and out of engagement with a spring 173. Thus, the spring will cause the slide to take up a centre position, provided that it is not pushed in one longitudinal direction or the other.

The solution in FIG. 43 is similar to that shown in FIG. 42, where the slide is indicated by the reference numeral 174. The optoelectronic detectors are indicated by the reference numerals 175 and 176, the notches by reference numerals 177 and the spring by reference numeral 178. The light blocking projections are for simplicity indicated by the reference numerals 179 and 180. A control button 181 selectively actuates switches 182, 183 and 184, e.g., in the same way as shown and described in connection with FIGS. 18-21.

Another embodiment of the operating device will now be described in more detail with reference to FIGS. 44-50. In this embodiment there is a slide 185 that is longitudinally and stepwise movable, as indicated by the arrow 186, relative to a housing 187. A control element 188 is provided and is composed of two movable spring-supported control buttons 188′, 188″. Two pairs of longitudinal light channels, indicated respectively by 189, 189′ and 190, 190′, are provided in the slide 185. Light sources 191, 192 for respective pairs of light channels and light receiver pairs 191′ and 192′ for respective pairs of the longitudinal light channels are provided at the ends of the movement path of the slide 185.

On the slide, in connection with each pair of light channels, there is provided a light blocking means 193 and 194 for optionally blocking the passage of light through one or more light channels in the respective pairs of light channels 189, 189′, 190 and 190′. The two control buttons 188′ and 188″ will both be capable of being tilted sideways. The button 188′ will in addition be capable of being tilted forwards, whilst the button 188″ will be capable of being tilted backwards. A movement of the control buttons of this kind will ensure that the passage of light through one or more light channels will be blocked because the light blocking means 193 and/or 194 is moved slightly to the side or further to the side in order to block either one light channel or two light channels each. Along the side of the slide there is preferably provided a plurality of notches 195 which interact with positioning springs 196, thereby rendering stepwise movement of the slide 185 possible. As shown in connection with, for instance, FIGS. 42 and 43, a means for the transmission or non-transmission of light between a light source and a light receiver when the slide is in an end position may be provided on the underside of the slide. In the preferred embodiment shown in FIGS. 44-50, at least one through light channel 197 is provided through the slide and transverse to the longitudinal direction thereof A plurality of light sources and light receivers respectively, here indicated by the reference numerals 198 and 199, are arranged in the housing opposite the longitudinal sides of the slide, so that when the slide moves a light path is successively created between a light source and a light receiver. Thus, the respective light source and light receiver pair will be able to signal which longitudinal position the slide 185 is in fact in.

By connecting the light receiver 191′ and 192′ to a microprocessor, it will be possible to have the manoeuvres carried out by the control buttons 188′ and 188″ analysed and processed, together with position data for the slide 185, as for control of a display or other external equipment, e.g., a mobile telephone. A connection solution essentially like that shown in FIG. 6 is thus conceivable. The extra peripheral equipment is generally indicated by means of the reference numeral 30′ in FIG. 6.

The first control button 188′, which is arranged to be capable of being tilted sideways or tilted forwards, will actuate the light blocking means 193 and 194 causing them to block either the light channel 189 and/or the light channel 190. The forward tilting of the button 188′ will result in the bottom boss 200 of the button actuating both light barrier means 193 and 194 to move into a first position where both the light channels 189 and 190 are blocked.

If the second control button 188″ is tilted either sideways or backwards, the light channel 189′ and 190′ will also be affected. If the control button 188″ is tilted backwards, the light blocking means 193 and 194 will block both the light channels 189, 189′ and 190, 190′. If, however, the button is tilted to one side or the other, it will be either the light channel 189, 189′ or the channels 190, 190′ that both are blocked. To obtain an expedient operation of the buttons 188′, 188″ it will be desirable to spring-tension these, e.g., by means of disc springs 201 and 202.

Like the bottom boss 200 or pressing block of the first button 188′, the second button 188″ has a similar boss or pressing block 203. Provided on the bottom of the pressing block 200 and 203 is a buffer block button 200′, 203′. It will be seen in particular in FIG. 49 that the first control button has a through channel that is almost wedge-shaped and the second button 188′ has a similar channel, these channels being indicated by the reference numerals 204 an 205 respectively. The buttons 188′ and 188″ are supported around a common shaft 206, and the shaft 206 is mounted in shaft supports 207, 207′ and 207″.

On the interaction of the two control buttons, it is of course conceivable that one of the control buttons 188′ can be tilted towards the blocking means 193, whilst the control button 188″ can be tilted towards the blocking means 194. It will thus be appreciated that it may also be possible to block, for example, only one channel in one of the pairs of light channels and two channels in the other pair of light channels. Thus, this solution involves a large number of possible combinations through the use of the two control buttons.

Thus, from the illustrated embodiment it will be understood that a minimum of two channels of the light channels may be blockable to light at the same time, whilst it is also possible that three of four of the channels may be blockable to light at the same time.

In FIG. 50 only one 193 of the light blocking means is shown for the sake of clarity.

A modification of the device that has just be shown and explained in connection with FIGS. 44-50 will now be explained in more detail in connection with attached FIGS. 51-55.

The solution shown in these figures is per se like that apparent from FIGS. 49 and 50, with the exception of the boss of one of the control buttons, here indicated by means of the reference numeral 208 in FIGS. 53 and 54. It will be seen that the boss 208 is made in the form of a gripper block to be able to draw one or both of the barrier means 210, 211 sideways in the direction of the centre of the first control button 209, the second control button 212 having a bottom boss or pressing block 213 so as to be able to push one or both of the blocking means 210, 211 sideways in a direction away from the second control button. As also shown in connection with FIG. 50, the control buttons are via channels 208′ and 213′ supported on a common shaft 214 that is secured to shaft supports 215, 215′, 215″. Light channels 216, 216′ and 217, 217′ are provided.

When the control button 212 is tilted backwards, it will by means of its pressing block 213 push the blocking means 210 and 211 sideways in a direction away from the other control button 212, whereby the light channels 216, 216′ will be blocked. If the control button 212 are instead tilted to one side or the other, the boss or pressing block 213 will actuate either the blocking means 210 or the blocking means 211 and thus either block the light channel 216 or the light channel 216′. If the control button 209 is tilted forwards, the gripper block hooks 218, 218′ will grip blocking means 210 and 211 respectively and draw these sideways in the direction of the centre of the first control button 209. Thus, the light channels 217, 217′ will be blocked. If the control button 209 is instead tilted to one side or the other, either the hook 218 will try to draw the barrier means 210 towards the centre of the control button, thereby blocking the light channel 217, or the other hook 218′ will, when the button is tilted to the opposite side, draw the blocking means 211 towards the centre of the control button 209, thereby blocking the light channel 217 instead. In the solution that is evident from FIGS. 51-55 it is worth noting that a maximum of two light channels are blockable to light at the same time. If, for example, the button 209 is tilted forwards, the control button 212 will in effect have no function. If the control button 212 is tilted backwards, the barrier means 210, 211 will be out of the gripping range of the gripper block. To ensure a precise functioning of the two control buttons, they can be provided on the underside of their bosses or blocks with contact buttons 208″, 213″ for contact with springs 218, 219 as shown in FIGS. 54 and 55 and also indicated in FIGS. 52 and 53. If, for example, the control button 212 is tilted to one side and the control button 209 is tilted to the other side, the barrier means 210, for example, will block the light channel 216, whilst the barrier means 211 blocks the light channel 217′. As mentioned earlier, it is however not possible to have more than two channels blocked to light at the same time.

To register the longitudinal movement of the slide 220, in a similar way as shown and explained in connection with, inter alia, FIG. 44, a transverse light channel 221 can be provided that interacts successively with a plurality of optoelectronic detector pairs, such as detector pair 222, 222′. The transmission of light and the reception of light via the respective channels is provided by respective pairs of light sources and light receivers, indicated respectively by means of the reference numerals 223, 223′; 224, 224′; 225, 225′, and 226, 226′. In other respects, the explanations are like those given in connection with FIGS. 44-50 with regard to the detection and possible connection to a microprocessor and additional equipment.

Yet another embodiment of the operating device will now be described in connection with FIGS. 56-59. In this embodiment there is a slide 227 that is movable back and forth in the arrow direction indicated by the reference numeral 228, and where the slide 227 is supported in a housing 229. The slide 227 is preferably stepwise movable relative to the device housing 229. A control element 230 is mounted on the slide, and movement of the control element and/or the slide can preferably be made indicatable by sound, light or a combination thereof.

The slide 227 and its control element 230 will be positionable in n predetermined step positions, where n=1 . . . k, and k<20. In the embodiment shown in FIGS. 56 and 59, the slide 227 will be capable of a total of four step positions. The control element 230 also forms a control button that it tiltable and optionally also depressible relative to the device housing 229. The control button 230 has on its underside a plurality m of switch element actuating pins 231, 232 and 233, where m may be 2, 3 or 4. In the example shown in FIGS. 56-58 the number of pins is 3. Located on the slide 227 and underlying respective ones of the actuating pins is an equal plurality m of first switch members 234, 235 and 236 that are activatable and movable with the aid of the respective pins 231, 232, 233. The first switch members 234, 235, 236 all have via the slide 227 the same electric potential. Furthermore, a base plate 237 is provided, preferably in the form of a printed circuit board, and provided with a plurality n×m of switch members 238, 239, 240, 241, 242, 243, 244, 245, 246, 247, 248 and 249 that form in each of said n step positions potential respective pressure contact for the m first switch members 234, 235, 236. The second switch members are electrically insulated from each other. The control button 230 may be hinged to the slide 227 via a hinge pin 250 that is passed through a hole 251 in the control button and each end of which is supported on the slide in two supports 252, 252′. To prevent any short circuit between the slide 227 and the base plate 237, there may optionally be provided an electrically insulating plate 253 which has holes, 238′, 239′, 240′, 241′, 242′, 243′, 244′, 245′, 246′, 247′, 248′, 249′ that are aligned with respective switch members 238-249. The plate 253 also serves as a sliding plate for the slide 277. Advantageously, a number of notches 254 are provided in the housing 299 and they are arranged to interact with a spring 255 on the slide 227 (a spring 255′ may optionally interact with additional notches on the opposite side of the opening 256 in the housing). The spring may have a bulb 257 (optionally 257′ for spring 255′) for stepwise engagement with notches 258 and 259 arranged in pairs in the plate 253 and the base plate 237 respectively.

If the control button 230 is made tiltable forwards and backwards, and also sideways, the number of switch element actuating pins can be four.

In the modification of FIGS. 56-59 that is apparent from FIGS. 60-62 a slide 261 is shown that is positionable in n predetermined step positions, where n=1, . . . k, and where k<20. Two mutually independent sideways tiltable and respectively forward and backward tiltable control buttons 262 and 263 are arranged on the slide. On its underside, each control button is provided with a plurality of m switch element actuating pins, as for instance the pins 264, 265, 266 in FIG. 61. The number of switch actuating pins may be two or three although, for example, it is possible to have four or more such pins. In the illustrated case there are three such actuating pins on each control button. Located on the slide 261 and underlying respective one of said actuating pins is provided an equal plurality m of first switch members 267, 268 and 269. Similarly, respective first switch members 270, 271 and 272 are provided under the control button 262 and under the actuating pins of the control button. All of the first switch members 267-272 have the same electric potential via a base plate 273 that is preferably made in the form of a printed circuit board and is provided with a plurality n×m of second switch members, such as the second switch member 274 indicated in FIG. 61. Corresponding switch members 274 are also generally indicated in FIG. 62. Since a plurality n×m second switch members that are electrically insulated from one another are provided on the base plates, potential, respective pressure contact for the m first switch members belonging to each of the control buttons is formed in each of said n step positions.

The control buttons 262 and 263 may be hinged to the slide 261 via a hinge 275 that passes through a hole in respective control button and each of which is supported on the slide in two supports such as the supports 252, 252′ shown for the embodiment in FIGS. 56-59, but where the hinge pin 275 is slightly longer than the pin 250, which means that the supports are spaced slightly further apart. To prevent a short circuit between the slide 261 and the base plate 273, there may optionally be provided an electrically insulating plate 275 which has holes 274′ aligned with respective ones of switch members 274. The plate 275 also serves as a sliding plate for the slide 261. In the housing 276 there is advantageously provided, as was the case in the embodiment shown in particular. in FIG. 59, a number of notches that are arranged to interact with a spring on the slide. The spring may optionally have a bulb for stepwise engagement with notches arranged in pairs in respectively the insulating plate 275 and the base plate 273.

In the present embodiment according to FIGS. 60-62 it is thus possible to provide, for example, six switch element actuating pins in total. In a possible modification of the illustrated operating device it is conceivable to permit the number of actuating pins to be eight in total.

In the solution shown in FIGS. 63-69 there is a base part 277 having a plurality of first switch members, generally designated by 278, which are electrically insulated from one another. A slide 279 is provided and has tiltably arranged thereon a control button 280 which when tilted either forwards (X2) or to the side (X1 or X3) is arranged to actuate at least one of the switch elements 278. The slide is movable in a housing 285. In connection with the positions X1, X2 and X3, there are provided on the slide 279 other switch members 281, 282 and 283 which lie on a common electric potential, and which on stepwise movement of the slide are brought to lie opposite respective ones of said first switch members. As was the case in the embodiment in FIG. 59, a sliding and insulating plate 284 may be disposed between the slide and the base plate, although this is not necessary if the first switch members 278 are sufficiently recessed in the base plate. The control button is tiltable forwards into position X2 transverse to the direction of movement. In the illustrated case, there are m first switch members divided into two parallel rows that extend in the direction of movement of the slide. In FIG. 64, m is nine, but the number can of course be greater or smaller. In other respects the mode of operation is as shown and described in connection with FIGS. 56-59. The slide is moved into positions Y1-Y4, and in each position of Y either X1, X2 or X3 may be chosen, cf FIG. 69. FIG. 63 shows the device used in connection with a mobile telephone 286. Photodetectors 287 can indicate the position of the slide, so that the Y positions are established at each step.

FIGS. 70-72 show an operating device which has a slide 288 that is longitudinally and stepwise movable in a housing 289, where a control element 290 is mounted on the slide 288, and where the device preferably has optoelectronic equipment 291, 292 for detecting the stepwise movement and position of the slide. The slide 288 has notches 291 which interact stepwise with springs 292 to maintain the slide in a particular step position. On the slide 288 there is movably arranged as control element a two-part control button 290 that consists of first 293 and second 294 intertelescopic button parts which both extend through an opening 295 in the slide, where a first of the button parts 293 on the underside thereof is made having at least two switch element actuating pins 296, 297, and where the second of the button parts on the underside thereof is provided with just one switch element actuating pin 298. Located in the said housing 289 and spaced from the underside of the slide is a plurality of switch elements 299-310 which are positioned two-dimensionally, so that stepwise positioning of said slide 288 and either tilting or depression of the two-part control button 290 or depression of just the second button part 294 will cause a coordinate-determined position of at least one pin 296, 297, 298 to correspond to a coordinate-determined position for a respective switch element 299-310, whereby a switch element at the position in question will be activated on depression of the control button and the contact of the boss with the switch element.

Although the figures show that there are two buttons on the first button part 293, it is of course possible to have three or four pins positioned here. In the first part 293 of the control button 293 there are two elongate, parallel holes 311 having the same transverse dimension along their length, and where the holes interact with respective tilt and guide pins 312 provided in said opening 295 in the slide. The switches 299-310 may be mechanical, e.g., of the switch-pad or microswitch type or the like, optionally capacitive-acting.

The operating device shown in FIGS. 73-77 has slide 313 that is longitudinally and stepwise movable in a housing 314, where a control element 315 is mounted on the slide, and where the device has equipment 315, 316, 317 for detecting the stepwise movement of the slide. More specifically, on the slide there is movably arranged a control button 315 having a part 315′ projecting down through an opening 318 in the slide, where this part is provided with two downward tiltable arms 319, 319′ that project transverse to the direction of movement of the slide, and which each are so designed that on manipulation of the control button 315 they bend down one or the other or both of the projections 320, 321 projecting from the slide in the direction of movement thereof, and where each projection at an outer end thereof has a switch element actuating pin 320′, 321′. The part 315′ is supported by a spring 322. The slide 313 has at the end thereof where the pins 320′, 321′ are located on its underside a switch element actuating pin 316 which at each step position of the slide successively engages with and activates upon movement of the slide switch elements 317, 323, 324, 325 in order to indicate coordinate positions for the slide 313. Arranged in the said housing and spaced from the underside of the slide is a plurality of switch elements 326-329 and 330-333 which are positioned two-dimensionally for optional interaction with respective pins 320′ and 321′, so that the stepwise positioning of said slide and tilting or depression of the control button 315 causes the coordinate-determined position of at least one pin 320′, 321′ to correspond to the coordinate-determined position of a respective switch element 326-333, whereby at least one switch element at the position in question will be activated upon depression or tilting of the control button 315. The pin 316 will form contact with the switch elements 317, 323-325 step by step, and thus indicate the step position of the slide. For the sake of simplicity, the base part 334 has been omitted from the drawing in FIG. 73. The pins are designed to actuate a respective switch element separately timewise. Provided in the control button is one elongate hole 335 having the same transverse dimension along the length thereof, and where the hole interacts with a tilt and guide pin 336 located in said opening 318 in the slide. The switch elements are mechanical, e.g., of the switch-pad or microswitch type or the like and/or capacitive-acting. As shown, there are three parallel rows of switch elements, where the outer rows are actuated by said projections, whilst the middle row is actuated by the pin 316 on the underside of the slide 313.

FIGS. 78-80 show an operating device that consists of an endless belt 337 that is passed over two opposing rotating rollers 338, 339, where at least one of the rollers has means 340, i.e., holes or markings that interact with detector means 341 for detecting the stepwise rotation of the roller. A control button 343 is arranged below the upper surface 342 of the belt 337 and is tiltable about a shaft 344 to both sides, and also forwards and backwards, and in these respective tilting positions is designed to actuate a respective switch element 345-348. This solution could be used, for example, in connection with a mobile telephone 349, as shown in FIG. 78 where 350 denotes a display and the arrows 351-354 are respectively related to the switch elements 345-348. In this case, the user pushes on the belt until the desired menu position is reached and can then use the button under the belt 337 to navigate in the menu.

A variant is apparent from FIGS. 81 and 82 where the operating device consists of an endless belt 355 that causes two opposing rotating rollers 356, 357 to have coordinated rotation, where at least one of the rollers 356 has means 370, for example, holes or markings that interact with detector means 358 for detecting the stepwise rotation of the roller. A control button 359 is arranged in an area between the rollers 356, 357 and is tiltable to both sides, and also forwards and backwards, and which in these respective tilting positions is designed to actuate a respective switch element 360, 361. However, it should be understood that there are two more switch elements, although these are not shown, and they will be arranged as shown in FIG. 80, i.e., like the switch elements 347 and 348. This solution could be used, for example, in connection with a mobile telephone 362, as shown in FIG. 81 where 363 denotes a display and the arrows 363-366 are respectively related to the activation of the switch elements. The roller 356 or 357 can be moved by a person's finger, at the same time as the button 359 can be manipulated. The arrows 367, 367′ indicate possible rotation of the rollers. The arrows 368 and 369 can also indicate tiltability of the roller 338 and 339, although such tiltability is not shown in more detail here. In such a case, additional detectors would be needed as shown and described in the said PCT application.

FIG. 83 shows a control element 401 that is stepwise rotatable 360° and arranged to activate a spring-loaded switch 402 located centrally under the control element when the control element is depressed at any point on its upper surface 1′. To provide the stepwise rotatability a toothed flange 403 is advantageously provided on the control element, as indicated in FIG. 94, and the control element 1 is otherwise kept centred by means of spring elements 404, 405, 406 and 407. The spring element 407 is preferably equipped with a switch 408 for registering the stepwise movement of the switch. When the tip of a tooth thus passes the spring element 407, the spring will come to bear against the switch 408 and activate it, whereby the rotation of the control element is registered. However, it will be appreciated that the detecting means for detecting the stepwise rotational movement can consist of at least one optoelectronic detector, preferably two, as indicated by the reference numeral 409 in FIG. 85, which is arranged to detect the passing of markings, indicated by the reference numeral 410 in FIG. 86, which are arranged on the underside of the control element 401. Projecting flanges 411 on the control element 1 will ensure that the control element can only tilt with the flange 411 limited by the extent of the pocket in the axial direction. FIG. 85 shows what the switch 402 is like in a non-activated state, whilst the tilting as shown in FIG. 86 or the pure central depression as shown in FIG. 87 will result in the switch 402 being activated. FIGS. 88-91 show a first control element 413 that is arranged to be non-rotatable and to selectively activate one of four spring-loaded switches 414, 415, 416 and 417 located under the peripheral area of the control element. Such activation is effected by depression of the first control element 413 at predetermined points spaced 90° on the peripheral area of its surface. There is also a second control element 418 that interacts with means for detecting its stepwise rotational movement. This detection takes place in the same way per se as has just been described in connection with FIGS. 83-87, the second control element having on its underside a toothed portion 419 and where springs 420, 421, 422 and 423 hold the second control element centred, whilst the spring 423 is arranged to interact with a switch 424, so that when a top portion of the toothing 419 meets the spring 423, the switch will be activated. The second control element is stepwise rotatable 360° and arranged to activate a spring-loaded switch 425 located centrally under the first control element when the second control element is depressed at any point on its surface. Although it will be understood that the switch 424 may be a preferred solution for the detecting means, the use of an optoelectronic detector as shown and described in connection with FIGS. 85 and 86 is nevertheless conceivable.

It will be seen that the first control element 413 works independently of the second control element 418. The second control element 418 is provided with a cross portion 426 at the centre 426′ of which the switch 425 can be activated. The second control element 418 has a projecting flange 427 and the tilting of the second control element will therefore be limited by the possible movement of the flange 427 in a recess 428 in the operating device housing 429. The reference numeral 430 indicates a block located between the switch 425 and the centre 426′.

In the embodiment shown in FIGS. 92-94 there is a first control element 431 that is arranged to be non-rotatable and to selectively to activate one of four spring-loaded switches 432, 432′, 433 and 433′ located under the peripheral area of the control element 431. Only two of these switches are shown in FIG. 93 and are indicated by the reference numerals 432 and 433. Depression will take place at the arrows associated with the control element 431, as indicated in FIG. 94. The depression of the control element is effected at predetermined points spaced 90° apart on the peripheral area of the surface of the control element.

The second control element is indicated by the reference numeral 434 and is stepwise rotatable 360° and arranged to selectively activate one of four spring-loaded switches 435, 435′, 436 and 436′ located under the peripheral area of the control element (of which only two of these switches 435 and 436 are shown in FIG. 93), when the second control element is depressed at the position of such a switch, where the switches are placed at the position of the outermost arrows indicated in FIG. 94. As shown and explained in connection with, for example, FIGS. 84 and 90, this embodiment may also include in connection with the second control element a toothed peripheral portion with spring sensing and a switch arranged to sense the toothed peripheral portion on rotation of the second control element. Alternatively, and as shown in connection with, inter alia, FIGS. 85 and 86, it will of course be understood that the detecting means can consist of at least one optoelectronic detector that is arranged to detect the passing of markings located on the second control element as this element is rotated.

The operating device preferably has a base 437, to which is attached a centre stem 438, and where there is such clearance at the top that the first control element 431 can tilt relative to the element 438. Pins 435′ and 436′ are provided in connection with the respective switches 435 and 436 to form a mechanical connection between the underside of the first control element and a respective switch when the control element 431 is tilted in one of the four directions as shown in FIG. 94.

It is also conceivable that the detecting means for detecting the rotation of the second control element 402 may consist of at least one sliding contact 439, 440 which senses an annular portion 441, 442 on the underside of the second control element 434, said portion consisting alternately of electrically conductive and non-conductive areas.

In connection with the embodiments in FIGS. 88-91 and 92-94 respectively, it will be understood that the control element 431 could select one of the four switches (of which only the switches 435 and 436 are shown), whilst the rotation of the second control element 434 makes it possible to choose between functions and with the aid of the second control element to activate one of the four switches (only switches 432 and 433 are shown), depending on which function has been chosen.

In connection with, for example, the embodiment shown by way of example in FIGS. 92-94, it will be understood that the position of the outermost arrows (FIG. 94) may be unnecessarly space-consuming.

This is evident in particular from that shown in FIG. 95 where the first control element is indicated by the reference numeral 442 and the second control element by the reference numeral 443.

The control element 443 interacts with means for detecting its stepwise rotational movement, as for instance discussed in connection with FIGS. 89-91. As shown in FIGS. 95 and 96a, the second control element is stepwise rotatable 360° and arranged to selectively activate one of four spring-loaded switches 444, 445, 446 and 447 located under the peripheral area of the control element, and spaced 90° apart, on depression of the control element 443 at the position for such a switch. The control element 443 has an annular transparent portion 448, and light sources, for example, light emitting diodes 449, 450, 451 and 452 are positioned under said annular transparent portion 448 at the respective positions for said switches 444-447. Alternatively, as shown in FIG. 96b, the annular portion 448 may be replaced by a plurality of transparent openings 448′ which in mutual positions correspond to the steps of the control element.

As shown in FIGS. 96 and 97, the control element 443 surrounds a centrally located control element or switch element 442. This switch element 442 is arranged to be non-rotatable and to selectively activate one of four spring-loaded switches 453-456 located under the peripheral area of the control element on depression of the control element 442 at predetermined points spaced 90° apart on a peripheral area of its surface at said switches 453-456. The element 442 could also be arranged to control a cursor, as will be exemplified in connection with embodiments that will be described below. Alternatively, it is conceivable that the switch element 442 is stepwise rotatable 360° and arranged to activate either the switches 453-456 or a spring-loaded switch located centrally under the control element on depression of the switch element at any point on its surface. If there are, for instance, four switches 444-447 and four switches 453-456, it will be understood that the light sources 449-452 are expediently placed at the positions also for the switches of the switch element 442.

In the embodiment shown in FIGS. 99-100 there is a first control element 457 that is arranged to be non-rotatable but sideways movable and/or tiltable relative to a centre position thereof. It will be seen that a spring-loaded switch 458 is located centrally under the first control element 457 which can be activated when the control element 457 is depressed, preferably at any point on its surface. Centre position deviation detectors 459, 460 are, as shown in FIG. 98, provided to detect the direction of movement and extent of movement of the first control element 457 when it is displaced relative to its centre position. The second control element 461 interacts with means 462 to detect its stepwise rotational movement. The second control element 461 is stepwise rotatable 360° and is arranged to selectively activate one of four spring-loaded switches 463, 464, 465 and 466 located under the second control element, and spaced 90° apart, on depression of the control element at the position of such a switch. Springs 467 and 468 ensure that the second control element on account of a toothed portion around a periphery thereof is held in position at each step.

The switch 462 is shown in more detail in FIG. 101. The switch has a tongue 469 that is arranged to sense the toothed or corrugated peripheral portion 470 of the second control element 461. When the second control element moves in the direction of the arrow in FIG. 101, the tongue 469 will move in the same direction as shown by the broken lines, so that there will be a break in contact between a contact point 471 and a contact spring 472, a transverse projection 473 on the tongue pushing the contact spring 472 to the side. The same will also happen if the second control element moves in the opposite direction, the electric contact between the contact point 474 and the contact spring 472 also then being broken. The tongue 469 pivots about a pivot pin 475, but the pivot point of the tongue can shift, the tongue 469 being spring-loaded against the pivot pin 475.

Although the rotation detecting means per se can consist of the tilting switch just described that is arranged to register both the direction of rotation of the second control element and each step of the rotational movement, it is also possible that the rotation detecting means may consist of at least one optoelectronic detector arranged to detect the passing of markings located on the second control element as it is rotated. However, this is not shown in FIGS. 98-100, but may be of the same type as indicated in connection with FIG. 85.

Since it is desirable to allow the device as shown in FIGS. 98-101 to have the first control element non-rotatably but sideways movable and/or tiltable relative to a centre position thereof, it is necessary to have a centre position deviation detector, and this may consist of a sensor ring located at an underside area of the first control element, and a ring having contact points 459 over which the sensor ring can be moved, the number of contact points 459 contacted by the sensor ring when the first element is moved sideways being a function of the centre position deviation of the first control element, and the points that are contacted also indicate the direction of movement of the control element.

It will be appreciated that it is important to nominally hold the first control element in a centre position and also be able to return it to the centre position after it has been displaced sideways, and in the present chosen example blocks or rings of flexible material, for example, rubber, as indicated by the reference numeral 476, are used for this purpose. An elastic ring 477 over the sensor ring 460 is also provided to ensure that the sensor ring at all times has sufficient vertical pressure, and also to deal with the situation when the first control element 457 is tilted to one side or the other, and also is pressed straight down. A spacer block 478 in connection with the first control element 457 and spacer blocks 479 and 480 (only two of a total of four are shown) are also necessary.

In the embodiment shown in FIGS. 102-104 there is a first control element 481 that is arranged to be non-rotatable, but movable and/or tiltable sideways relative to a centre position thereof. Located centrally under the first control element is a spring-loaded switch 482 that can be activated on depression of the control element 481, preferably at any point on its surface. A second control element 483 is stepwise rotatable 360° and arranged to selectively activate one of four spring-loaded switches 484, 485, 486 and 487 located under the second control element, and spaced apart by 90°, on depression of the control element 483 at the position of such a switch. Means are provided for detecting the stepwise rotational movement of the second control element and the illustrated example consists of at least one optoelectronic detector 488 that is arranged to detect the passing of markings 489 located on the underside of the second control element 483 as the control element is rotated stepwise. The stepwise rotation is provided by means of a toothed or corrugated peripheral portion 490 on the second control element 483 that is in engagement with springs 491, 492.

To detect the direction of movement and extent of movement of the first control element relative to its centre position, there is provided a detector consisting of a sensor ring 493 that surrounds a lower portion of the first control element 481, and a ring of spaced-apart contact points or contact pins 494 towards which the sensor ring can be moved for contact with one or more thereof. The number of contact points contacted by the sensor ring will be a function of the deviation of the first control element from the centre position, and the points that are contacted position-wise thus indicate the direction of movement of the control element 481. To hold the contact points or contact pins spaced apart, there is provided a ring 495 of a flexible material, e.g., rubber, which has pointed pins 495′ that extend through the gap between neighbouring contact points 494. The contact pins 495′ extend from the periphery of the ring 493 and will thus have the function of holding the first control element 481 in a centre position and returning it to the centre position after it has been shifted sideways. A spring 496, for example a disc spring, ensures that the first control element 481 is normally held in a horizontal centre position or returned to such a position after a downward tilting of the control element 481.

To ensure precise contact between the underside of the second control element 483 and the switches 484487 when the second control element 483 is depressed at the position of one of these switches, a spacer block 497 is provided by respective switches 484-487.

Although the rotation detecting means shown is based on an optoelectronic detector, it will of course be possible to use, for example, a tilting switch construction as shown and described on connection with FIGS. 100 and 101 to register both the rotational direction of the second control element and each step of the rotational movement. The solution shown in FIGS. 102-104 is highly suitable in an operation mode as a control means for cursor control on a display screen. Stepwise rotation of the second control element 483 can expediently be used for, e.g., browsing through a program menu, whilst the first control element 481 can have said cursor control function or another function, for example, a confirmation function through activation of the switch 482.

In the embodiment shown in FIGS. 105-110 there is a first control element 498 that is arranged to be non-rotatable, but movable and/or tiltable sideways relative to a centre position thereof. Located centrally under the first control element is a spring-loaded switch 500 that is activatable on depression of the control element 498, preferably at any point on its surface.

A second control element 499 is arranged around the first control element 498 and is stepwise rotatable 360° and designed to activate one of four spring-loaded switches 510, 502, 503, 504 located under the second control element, and spaced 90° apart, on depression of the control element at the position of such a switch. The second control element has along a peripheral portion thereof a toothed or corrugated design, as indicated by the reference numeral 499′. Springs 505, 506, 507, 508 interact with the toothed peripheral portion 499′ in order to provide stepwise rotation of the second control element 499. At the same time, these springs 505-508 ensure that the second control element 499 is held in its centre position, even when rotated.

To detect the stepwise rotational movement of the second control element 499 there is provided an optoelectronic detector 509 that is arranged to detect the passing of markings 510 located on the second control element as it is rotated. Although this is a preferred solution, it will of course be possible to use a rotation detecting means as shown and described in connection with FIGS. 100 and 101 or, for example, one or more switches that interact with the springs 505-508.

To detect the direction of movement and deviation of movement of the first control element 498 relative to a centre position thereof, there are provided at least two resistors that are arranged at an angle of 90° to one another to form x,y elements. In the illustrated example, four resistors are provided, resistors 512, 512″ that represent x elements and resistors 512′, 512′″ that represent y elements. These resistors are each contacted by a respective sliding contact, as for instance the sliding contact 513 shown in connection with the resistor 512 in FIG. 107. Each sliding contact forms a linkage with a common, centrally located guide pin 516 on the underside of the first control element 498. The sliding contacts 513, 513″ of the x resistors 512, 512″ are rigidly connected to one another via said linkage 514, and the sliding contacts 513′, 513′″ of the y resistors 512′, 512′″ are also rigidly connected to one another via said linkage 515. In the proposed embodiment of the operating device, it will be seen that the sliding contacts 513, 513′, 513″, 513′″ are spring-tensioned. This spring tensioning ensures that the first control element 498 is held in a centre position and can be returned to the centre position when it is made to shift sideways.

Although the exemplary embodiment shows the possibility of using four resistors 512, 512′, 512″, 512′″ interacting with respective sliding contacts 513, 513′, 513″, 513′″, it will be understood that would be possible to dispense with, for example, the resistors 512″ and 512′″, if so desired, so that the sliding contacts 513″ and 513′″ will thus have no function other than to provide a supporting surface for the respective springs. In FIG. 109 it is shown bow the sliding contacts 513, 513″ move when the first control element 498 is shifted only in the x-direction. The spring attached to the sliding contact 513 will be compressed, whilst the spring attached to the sliding contact 513″ will extend. The sliding contacts 513′ and 513′″ remain motionless in this case. FIG. 110 shows a composite x, y movement with full extent of movement in both the x and the y direction.

A spacer block 511 is provided by each switch 501-504 to ensure precise activation of respective switches when the second control element 499 is depressed at the position of a respective switch.

The embodiment shown in FIGS. 111-116 will now be described. In this case too, there is a first control element 517. This control element is non-rotatable, but movable sideways relative to a centre position thereof. In the case of this embodiment, it is not desirable that the first control element should be tiltable relative to the centre position, but it can be depressible. The first control element 517 is held in its centre position and can be returned to the centre position with the aid of a centring means 518 in the form of a disc of a flexible material, e.g., rubber. Located centrally under the first control element is a spring-loaded switch 519 that is activated on depression of the control element. The second control element is indicated by the reference numeral 520, and is rotatable 360° and arranged to selectively activate one of four spring-loaded switches 521-524 located under the second control element, and spaced 90° apart, these being activated when the control element 520 is depressed at a position for such a switch. Centre position deviation detectors are also provided in this embodiment to detect the direction of movement and extent of movement relative to the centre position of the first control element. For this purpose, at least two curved resistors 525 and 526 are provided, the centres of which are at an angle of 90° to one another to form x, y elements, the resistors being contacted by their respective sliding contact 527 and 528. The sliding contacts 527 and 528 form a linkage with a common centrally located guide pin 529 on the underside of the first control element 517. As indicated, each sliding contact 527, 528 is mounted on an arm 527′, 528′ which has a fixed pivot point 530, 531 at the centre of curvature of the respective resistors 525, 526. The arm 527′, 528′, has at its end that is opposite the location of the sliding contact an elongate slot 527″, 528″ for interaction with the guide pin 529 when the guide pin moves as a consequence of the deviation of the first control element 517 from its centre position. The thus detected x and y resistance values will be a function of the deviation of the first control element from its centre position and the direction of movement of the control element. Although in this case only one x resistor and one y resistor are shown, it will be appreciated that it is also possible to have two x-related resistors and two y-related resistors. However, this is not considered necessary.

To detect the stepwise rotation of the second control element 520, this element has on a peripheral portion thereof a toothed design, indicated by 532 in FIG. 112. Springs 533 and 534 effect the stepwise movement in interaction with the toothed structure 532. To allow detection of the stepwise movement of the second control element 520, markings 535 are located on its underside and are detected by an optoelectronic detector 536.

The embodiment shown in FIGS. 117-119 will now be described. In this embodiment there is a first control element 537 and a second control element 538. The first control element is arranged to be non-rotatable, but movable and/or tiltable sideways relative to a centre position thereof. Located centrally under the first control element is a spring-loaded switch 539 that is activatable on depression or tilting of the control element, preferably at any point on its surface. The second control element is rotatable 360° and arranged to selectively activate one of four spring-loaded switches 540-543 located under the second control element and spaced 90° apart. These can be activated when the second control element 538 is depressed at a position for such a switch. In the illustrated example, the first control element 537 is held in its centre position and can be returned to such a centre position by means of a plurality of springs 544 which bear against a peripheral portion of the control element 537. The periphery of the second control element 538 is provided with a toothed structure 545 and the stepwise movement of the control element 538 is assured by springs 546, 547 that engage with the toothed structure 545. To detect of the stepwise rotation of the second control element 538, markings, for example may be provided on the underside of the control element, as shown and explained in connection with FIGS. 111-114 and indicated by the reference numeral 535, in interaction with at least one optoelectronic detector 548 that is arranged to detect the passing of the markings as the second control element is rotated. To detect deviation from the centre position in connection with the direction and extent of movement of the first control element 537, at least two resistors are arranged at an angle of 90° to one another to form x, y elements. In the illustrated example as best shown in FIG. 115, two resistors 549, 550 that represent x elements and two resistors 551, 552 that represent y elements are provided. These resistors are contacted by their respective sliding contact, respectively sliding contacts 553, 554, 555 and 556. These sliding contacts 553-556 are located on the underside of the first control element 537, and detected x and y resistance values, based on the potentiometer principle or volt box principle will be a function of the deviation of the first control element 537 from its centre position and its direction of movement.

FIGS. 120-124 show yet another embodiment of the operating device having a first control element 557 that is non-rotatable, but movable and/or tiltable sideways relative to a centre position thereof. Located centrally under the first control element 557 is a spring-loaded switch 559 that is activatable on depression or tilting of the control element, preferably at any point on its surface. A second control element 558 that surrounds the first control element 557 interacts with means for detecting the stepwise rotation of the second control element 558. As can be seen in connection with FIGS. 111-114, markings can be provided on the underside of the first control element, like the markings 535 indicated in FIG. 84, these markings being detected by an optoelectronic detector 560 when the second control element 558 is given a stepwise movement.

The second control element 558 is rotatable 360° and arranged to selectively activate one of four spring-loaded switches 561, 562, 563 and 564 located under the second control element and spaced 90° apart. Activation is effected by the depression of the second control element 558 at a respective position for such a switch 561-564. The stepwise rotational movement of the second control element 558 is caused by a toothed peripheral portion 565 thereof and springs 566, 567. The first control element 557, apart from being centrally supported by the switch 559, is also at its peripheral portion supported by an elastically yielding cushioning 568, for example, a ring of rubber. To hold the first control element in its centre position and to return it to the centre position after sideways displacement, there is provided a plurality of spring-loaded blocks 569 which bear against a peripheral portion of the first control element, as shown clearly in FIGS. 120 and 121. To actuate the switches 561-564, a spacer block 570 is provided between the underside of the second control element 158 and a respective switch in order to ensure activation.

Centre position deviation detectors are provided to detect the direction and extent of movement of the first control element 557. The centre position deviation detectors consist in this case of at least two optoelectronic detectors 571, 572 that are arranged to face the underside of the first control element 557, and which are oriented at an angle of 90° to one another to form x and y elements. A graphic pattern 573, for example, a plurality of concentric rings, is provided on the underside of the first control element 557. The combined x and y detection by the detectors 571 and 572 of the said graphic pattern 573 when the first control element 557 is moved sideways will thus be a function of the centre position deviation of this control element and its direction of movement. Although in FIG. 124 only three concentric rings are shown, the number of rings may of course be greater. The rings could also to be replaced by another appropriate graphic pattern.

FIGS. 125-128 show a first control element 573 that is non-rotatable, but movable and/or tiltable sideways relative to a centre position thereof. Located centrally under the first control element 573 is a spring-loaded switch 574 that is activable on depression or tilting of the control element, preferably at any point on its surface. A second control element 575 interacts with means 576 to detect the stepwise rotation of the second control means. This means 576 is the same as that described in connection with the previous embodiment shown in FIGS. 100 and 101 and the description will therefore not be repeated here. As was the case with the preceding embodiments, the stepwise operation of the second control element is assured by means of a toothed peripheral portion 577 in interaction with contact springs 578, 579. The second control element 575 is rotatable 360° and arranged to selectively activate one of four spring-loaded switches 580, 581, 582 and 583 located under the second control element and spaced 90° apart. Activation of these switches is effected by the depression of the second control element 575 at a respective position for such a switch. Disposed between the underside of the second control element 575 and respective switches 580-583 are spacer blocks 584, 585 to ensure precise actuation of the switches, such as the switches 581 and 583 shown on FIGS. 126 and 127. To detect the direction of movement and extent of movement of the first control element 573 relative to a centre position thereof, there are provided centre position deviation detectors which in this embodiment of the operating device consist of a supporting cross 586 with its ends, for example the ends 587, 588 (see FIG. 87) anchored in or in connection with a common base member 589 of the device, and where the supporting cross is anchored at its centre point to a central pin 590 that extends from the underside of the first control element and is also rigidly connected to the first control element 573, as is clearly evident in FIGS. 126 and 127. A first strain gauge set 591 and 592 forms strain sensors in the x direction and is located on two of the arms of the supporting cross. A second strain gauge set 593 and 594 forms strain sensors in the y direction and is located on the other two arms of the supporting cross. Although strain gauge sets consisting of at least two strain gauge sets, like the strain gauges 591, 592 and 593, 594, are shown, it will be understood that it is possible to use, for example, just one set of strain gauges, for example, consisting of strain gauge 591 on one of the arms of the supporting cross, and similarly, for example, strain gauge 593 on another of the arms of the supporting cross. However, for optimum detection, it will be expedient to have a strain gauge on each of the arms of the supporting cross. Electric connections to the strain gauges can be made via said end areas of the supporting cross. The supporting cross 586 is made having arms that are resilient, so that when the control element 573 is either tilted or pushed sideways, a slight deformation will occur in the arms of the supporting cross 586, as for instance the arms 586′, 586″ shown in FIG. 87, where the deformation, merely for illustrative purposes, is shown greatly exaggerated. Such strain gauges are extremely sensitive to deformation, and by placing the strain gauges as elements in a measuring bridge, deformations of the supporting cross can be measured accurately and thus give a signal that is a function of the centre position deviation of the control element and the direction of movement of the control element. Since the arms are resilient, elastic, the first control element will normally be held in its centre position and also be returned to the centre position by means of the arms of the supporting cross after the control element 573 is released.

FIGS. 129-132 show an operating device consisting of a control element 595 that is arranged to be rotatable 360°, and also tiltable sideways relative to a centre position thereof. The device also has a non-rotatable tilting platform 596 which is so designed that on the tilting of the control element over a predetermined, flexible resistance threshold it is able to activate at least one of a plurality of spring-loaded switches under the tilting platform at the periphery thereof. These switches are indicated by the reference numerals 597-600. Although the number of switches in the illustrated example is four, it will be understood that more switches can be used if desired, provided that they are spaced apart at the same angle.

A support and pivot pin 601 for the control element extends upwards from the centre of the tilting platform 596. The control element 595 is pivotable about the upper end of the pin 601, whilst between the lower end area of the pin 601 and the tilting platform 596 there is a clearance, so that the pin can be tilted sideways and forwards/backwards, but not rotated relative to the tilting platform, so that tilting of the control element 595 relative to the tilting platform can be detected by the strain gauges 610-613.

Extending down from the underside of the control element 595 is an annular flange 595′ whose inside wall has a corrugated or toothed shape 602 so as to be able to cause stepwise rotational movement of the control element when this corrugated shape or toothing 602 engages with springs 603, 604, 605 and 606. To detect the stepwise rotational movement of the control element 595, there are provided optoelectronic detectors 607, 608 that face the underside of the control element 595 for detection of movement of markers 609 on the underside of the control element when the control element is rotated stepwise. As an alternative, the rotation detecting means could, of course, consist of a tilting switch as shown and described in connection with FIGS. 100 and 101, for registering both the rotational direction of the control element and each step of the rotational movement. As a further alternative, the rotation detecting means could consist of at least one switch that is arranged to sense the toothed wall portion 602. However, the illustrated embodiment of the rotation detecting means is the embodiment preferred at present.

To detect the centre position deviation of the control element when it tilts, there is provided a detector device consisting of the strain gauge sets 610, 611 and 612, 613 which represent x elements and y elements respectively. These strain gauges 610-613 can, for example, be part of a measuring bridge. Electrical connection to the strain gauges 610-613 takes place via a terminal connection 614 that is shown schematically in FIGS. 129 and 130 The connection 614 is terminated, for example, on a printed circuit board attached to a base part 615 of the device. Similarly, the detectors 607 and 608 may also be electrically connected to a printed circuit board in the base part 615 via wiring 616. When the control element 595 is pushed slightly sideways, against the action of the springs 603-606, the sensitive strain gauges 610-613 will register this movement and this will have an impact on, for example, the said measuring bridge. If the control element is tilted relative to its nominal centre position, this will also generate changes in condition of the strain gauges 610-613, as these are attached partly to the tilting platform 596 and partly to said pin 601. If the tilting exceeds the resistance that the spring-loaded switches 597-600 represent individually, one of these switches will be activated. In an expedient embodiment of the platform 596, there is of course nothing to prevent two of the switches 597-600 from being activated at the same time if desired, for example, if the control element 595 at its outer portion is depressed at an area located between switches that are rotationally adjacent. As indicated above, the springs 603-606 not only have the function, together with the toothed portion 602, of causing the stepwise movement, but also ensure that the control element 595 normally is or can be returned to its centre position.

In use, the operating device as shown in FIGS. 129-132 will have two different functions. In one mode, it will be able to function as a pure rotary switch with the control element 595 and with the indicated four (repression positions as also indicated by means of the reference numerals 597′, 598′, 599′ and 600′ in FIG. 131. In this mode, the strain gauges 620-613 will be rendered inactive. By moving in a function menu it will be possible to select cursor control function. Alternatively, this cursor control function can begin to operate automatically if the user moves to a function that requires cursor control. The springs in connection with the switches 597-600 will normally be so stiff that it is possible to move the control element 595 and thus cause deformation of the strain gauges 610-613 that is sufficient to be able to exercise cursor control without thereby activating any of the switches 597-600. To confirm a position associated with a cursor of this kind, this can be made by depressing the control element 595 at a respective switch, or in that the tilting platform 596 is so designed that at least one of the switches 597-600 will be activated when the control element 595 is depressed at its periphery at any point thereon.

However, it will be understood that the embodiments of the operating device shown in FIGS. 98-128 and FIGS. 186-190 will also be capable of having two different functions. In one mode, the second control element will be able to function as a pure rotary switch with the four indicated depression positions for switches, and where a first control element is a pure confirmation button. In this mode, the centre position deviation detectors will be rendered inactive. By moving in a function menu, it will be possible to select cursor control function, so that the centre position deviation detectors then become active. Alternatively, this cursor control function can become active automatically if the user moves to a function that requires cursor control.

Although some of the embodiments are shown having both a first control element and a second control element, it is quite conceivable that only the first control element is used as the sole control element, in the attached claims designated “controlling member”. A controlling member of this kind could, for example, function as a cursor control means and as a means for confirming selected position of the cursor. All the embodiments that have means for detecting centre position deviation will be suitable for this purpose.

It is also conceivable that the second control element as shown in connection with FIGS. 98-128 and FIGS. 186-190 is not present, which means that the first control element thus becomes a controlling member for cursor control with a function as otherwise described in detail in connection with the embodiments in question.

The solutions described are highly suitable in connection with a display screen where visual feedback during use is given. One and the same operating device can per se be used for different types of apparatuses and tasks. The limitations of the operating device reside in part in its construction and in part in how it is programmed in relation to its use, and also that the size of the display screen to a large extent will be decisive for the tasks that can be assigned to the operating device.

The invention will now be further described in purely general terms with reference to attached FIGS. 133-139.

FIG. 133 shows an operating device of a type that has been described in detail in connection with some of the embodiments previously described. There is a first control element 617 and a second control element 618 which surrounds the first control element. The control element 617 will be capable of being moved sideways in all x, y positions that are possible in order to control a cursor 620 on a display screen 619. The reference numeral 621 in FIG. 134 indicates an area of the first control element 617 which must be touched in order to move the cursor 620 as shown in the figure towards, for example, an icon or other marking 622 on the display screen 619. FIG. 135 indicates by means of reference numeral 623 the depression position on the first control element 617 for confirming selected position at 624 as shown in FIG. 135. The movement for depression will be different from the movement of the first control element or centre button 617 for positioning the cursor, and will also require more physical force. On depression in this way there could be a risk of moving the cursor. This can be compensated per se by programming in a memory, and in this connection reference is made to FIG. 136. From the time t1 to t2 the movement of the cursor will be almost steady. At the time t2, the cursor will have reached the desired point 624. Here, in time there will be a halt in the movement until the time t3, when the centre button or the first control element is depressed at 623 to confirm the selection. Until this depression is confirmed, there will be a risk of the cursor 620 moving uncontrollably out of position. To solve this problem, a memory function is entered that gives the cursor the message to return to the position in which it was last stationary. This will be the position for the marker at the time t2, i.e., the position 624. It will be seen that what is found in time after t3 is that which happens in connection with the return of the first control element to its centre position and depression of the first control element. As an alternative to that shown here, it is possible, for example, that the first control element 617 will have to be depressed constantly in order to move the cursor. When the first control element 617 is released so that it moves upwards, the cursor will stop, whereupon the position of the cursor can be confirmed by a short depression of the first control element. A subsequent prolonged depression of the first control element will enable the cursor to be moved again. This solution will also call for a certain memory function which must be programmed.

In some of the embodiments that have already been described and in some additional embodiments that are to be described, it may be appropriate to use as centre position deviation detector strain gauge technology, which is known per se, and the operating device will be able to function in a slightly different way in different modes depending upon the programming of peripheral equipment that is provided.

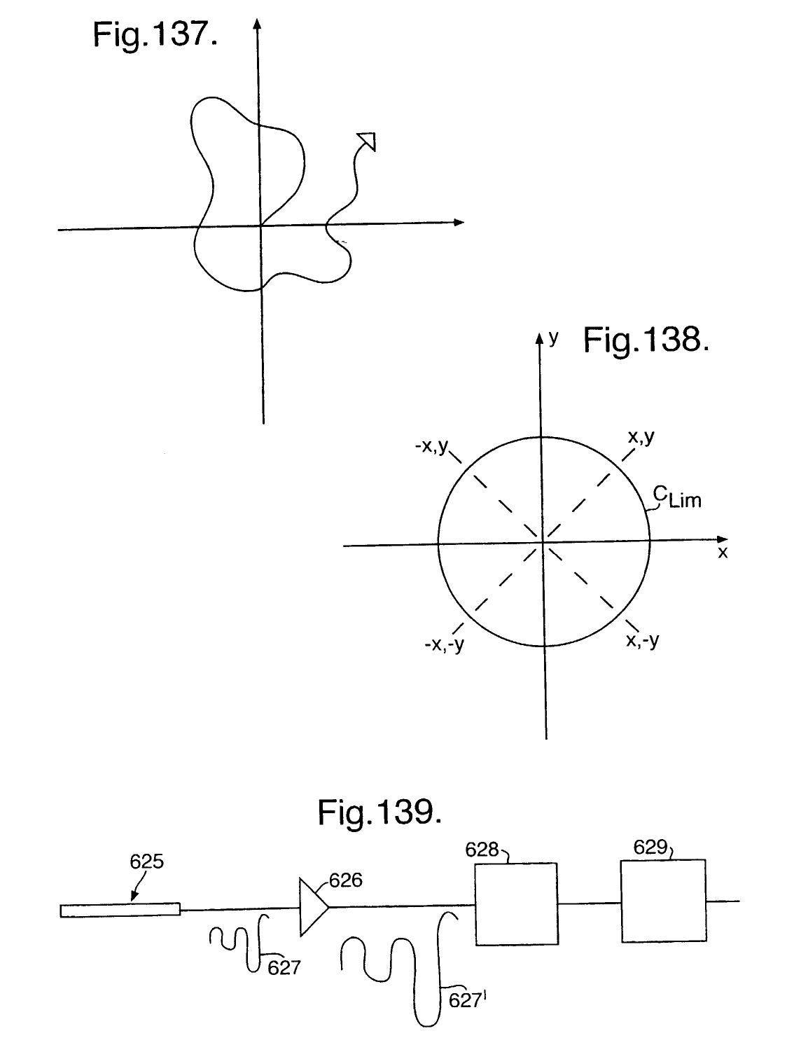

FIG. 137 illustrates a cursor control mode (use of mouse function). In that, for example, two or four strain gauges form a part of a measuring bridge, it is possible to register with the aid of strain gauge technology the centre position deviations for respective zones x,y; −x,y; −x,−y; and x, −y towards which the first control element, optionally the controlling member (a control element) is pushed. In a solution of this kind it is possible to replace fixed switch positions as shown in connection with solutions comprising an outer, rotatable ring (second control element).

With reference to FIG. 138 it is noted that detection of depression (in the z direction) by using strain gauges only can take place by programming the movement the cursor may have. If the cursor makes a movement within the circle Cₗᵢₘ as on a specific, but limited depression (approximately like the depression of the strain gauges in the x and y direction), this can be programmed to represent the same as a depression of the first control element, or controlling member (if a second control element is not present or active), and thus a confirmation of a possible earlier movement. In connection with normal cursor control, however, the cursor will move outside the circle Cₗᵢₘ. As shown in FIG. 139, the signals that the strain gauges, here indicated in general by the reference numeral 625, provide will be amplified through an analog amplifier 626. The signal 627 that is fed into the amplifier 626 will be outputted as an amplified analog signal 627′ (the signals 627 and 627′ are only shown by way of illustration and should not be accorded any other significance, and are not limiting for the invention). The signal 627′ is fed into an analog/digital converter 628 and the signal is outputted from the converter to a microprocessor 629 for further processing and outputting for the control of, for example, a cursor on a display screen, as shown and explained in connection with FIGS. 133-136.

The principle of the use of a centre button or a control element, or controlling member, for cursor control is that it must always be based on technology that reads off movement in the x and y direction and possibly the z direction.

In connection with FIGS. 133-136, reference is made to the fact that the first control element or controlling member (if there is no second control element surrounding the first control element), emphasis is given to a depression of the control element/controlling member in connection with the selection of marker position. A main point with this solution is of course that the user should be able to make a desired selection in a simple and precise manner. However, in connection with a modification of the illustrated solutions, and preferably as a supplement, it is possible to use a capacitive sensor that is sensitive to touch and where there is no need for physical displacement to register the difference between being touched by a finger and not being touched. This could be utilised by placing a capacitive sensor of this kind on the top of the first control element, or controlling member, and reading out a signal from the capacitive sensor that indicates whether the sensor (the first control element/controlling member) has been touched or not. For instance, the untouched state may indicate an off status, whilst a touched state may indicate an on status.

As mentioned above, a capacitive sensor needs no physical pressure to emit a signal. This can be utilised in such manner that when the cursor has been moved so that it is stationary over an icon or the like, as shown for example in FIG. 135, where the reference numeral 622 indicates the icon, the reference numeral 624 indicates the desired position, and the reference numeral 620 indicates the cursor, it is possible to lift the finger so that there is no touching of the capacitive sensor, in order to then replace the finger on the sensor and thus make the selection. Related to the signal from the sensor, this means that it is registered that the marker is in fact in a zone where a selection is possible at the transition from on to off, and that within a certain time Δ1 after this there will be an off to on transition.

FIGS. 140 and 141 show an operating device having a first control element 630 and a second control element 631. The first control element may be divided into a first capacitive element 630′, a second capacitive element 630″ and a dielectric area therebetween indicated by the reference numeral 630′″. In this solution the capacitive sensor thus consists of a first control element 630 (alternatively the controlling member if the second control element 631 is not present). As an alternative, the first control element can form a first capacitive element which interacts with a second capacitive element 631 that consists of the second control element. It must then be ensured that there is a dielectric 632 between these two capacitive elements, for instance in the form of air or in the form of a material that is attached to the periphery of either the first or the second control element and that runs in a groove on the second or the first control element (not shown) respectively.

It will thus be possible to allow the element 630 to act as an ordinary cursor control means (e.g., a computer mouse) as long as there is a finger in contact with the capacitive sensor 630′, 630″, optionally the element 630 and 631. A selection is made by moving the cursor over a chosen icon, WAP connection or the like, whereupon the finger is lifted from the sensor. By binding this signal from the capacitive sensor, a change from off to on will be ignored, and the element, such as the element 630, will thus function as a cursor control means. The change from on to off will be interpreted as a selection of the position to which the cursor (the pointer) pointed when the finger was lifted off the element 630 and thus away from the sensor 630′, 630″, optionally from the sensor that is formed by the two elements 630, 631. If the cursor on the screen does not point to an icon or another form of option, selection will not be made when the finger is removed from the operating device. It will also be understood that the solution shown in FIG. 142 can be particularly favourable in that the finger which rests on the element 630 will not activate the sensor until the finger tip contacts the element 631.

In some of the solutions described a switch is provided which on depression of the first control element 630 (alternatively the cursor member if the second control element 631 is not present) causes the switch to be activated so that the user obtains information when the switch is depressed.

As indicated earlier, it will be highly probable that movements in the x-, y direction will be great in the short period of time (the time after t3) it takes physically to depress the z direction switch. Therefore, the history of the cursor must be provided through a suitable software design as means for finding the option the user wishes to select. In this case, as also mentioned earlier, it is possible to make use of the fact that the x, y movements are uncontrollably large and thus lock the cursor function to the position that the cursor had on the display screen when the movements became excessively large.

Considerably larger x-, y movements are obtained by pressing on the element 630 at the edge remote from its centre or centre position than when the element is depressed in the middle, as the case will be when the user, by using the element 630, is to control the cursor on a display screen. When the operating device according to the invention is to be used to carefully move the cursor around on a display screen, the x, y movements of the element 630 will appear quite small. If the cursor is lying over a selectable area at the same time as the movements in the x, y direction have become so great that they no longer provide a controlled mouse control, the icon that the cursor was on when the large movements started will be selected. As a numerical example, it can be said that the minimum time required to control a cursor on the whole screen is two seconds. If the force in the x, y direction corresponds to a movement across the whole screen of 0.5 seconds, an uncontrollable situation has arisen and a selection must therefore be made.

A further embodiment of an operating device will now be described in more detail primarily with reference to FIGS. 143-147, and then in connection with FIGS. 148 and 149.

The device has a control element 633 that is cylindrical in shape and arranged to be rotatable 360° about a horizontal axis and supported on a non-rotatable, but sideways tiltable and depressible drum 634. Provided on the drum at an outer portion thereof are detector means 635, 636 for detecting the stepwise rotation of the control element 633 relative to the drum, for example by detecting optical markings 637 or physical notches on an area of the control element 633 that faces the drum 634. Guides 638 are expediently provided on both sides of the drum to ensure a good support of the control element 633 on the drum 634. For the sake of simplicity, only one point is indicated by the reference numeral 638, but it will be understood that such guides must be present on both sides of the drum and in engagement with the control element. On the side of the drum 634 where the said detector means 635, 636 are not present, a part of the control element may optionally be made having a toothed portion, as indicated by means of the reference numeral 639 so as to ensure a stepwise movement of the control element 633 relative to the drum 634 when the control element is rotated about the drum 634.

The drum 634 is supported on a base part 640 and spring-supported by means of a centrally located spring 641 to take up a neutral position relative to the base part 640. When the drum is tilted against the action of the spring 641 to one side or the other in response to an actuation of the control element 633, contacts 642 or 643 will come into contact with current-carrying connections 644 or 645. A simple depression against the action of the spring will cause both switch functions 642, 644 and 643, 645 to enter into operation.

Wiring to the movement detector 635, 636 has not been included in the figures, but it will be understood that this can be provided using an ordinary wiring connection per se to the drum 634 and then to the detectors 635, 636.

In the solution shown here, rotation of the control element relative to the drum 634 could be used, for example, to browse through a menu, whilst tilting the control element 633 and the drum 634 could confirm the selection of options at particular point in the menu.

As shown in FIG. 149, the operating device is located in a centre position. The base part, here indicated by the reference numeral 646, is supported in a centre position deviation detector 647 that is arranged to detect small tilting movements of the control element 633 relative to its neutral or centre position, and in the proposed embodiment the centre position deviation detector consists of a supporting cross 648 or supporting beam which via its ends is anchored in or connected to a common base 648, and by means of its central point anchored in a central pin 649 that extends down from the base part 646. The strain gauge set 650, 651, 652, 653 forms strain sensors on the supporting cross 648 or supporting beam, the strain detectable by the said strain gauge set being a function of the centre position deviation of the control element and the direction of movement of the control element 633. In a solution of this kind, the control element 633 and the drum 643 are used, for example, for cursor control on a display screen, although this embodiment is not as suitable as those described earlier.

Advantageously, each strain gauge set consists of at least two strain gauges, as for instance the strain gauges 651, 653 and 650, 652. However, it will be understood that it is possible to use only the strain gauges 650 and 653. However, in the illustrated embodiment in FIG. 148 each supporting cross arm 654, 654′, 654″ and 654′″ is provided with at least one strain gauge.

A further embodiment of the operating device according to FIGS. 150-154 will now be described, where the device has a control element that is actuatable by the finger of an operator to execute at least two function commands, where the control element 655 is located on a slide 656 and thus arranged to be capable of moving along a path and being caused in the individual stepwise positions to make a tilting movement or a depression movement, and where the stepwise positions are detectable. In the illustrated embodiment in FIGS. 150-154, the control element in each of the said positions is tiltable sideways, forwards and/or backwards, and also optionally centrally depressible. The stepwise positions are detectable with the aid of a busbar 657 on the base part 658 of the device that faces the underside of the slide 656 and a row of contact points 659, 660, 661, 662 and 663. Sliding contacts 664 and 665 are provided on the slide for contact with the busbar 657 and successive one of the contacts 659-663 respectively. Spring-loaded switches or contact points 666-679, as shown in FIG. 151, are also provided in connection with the base part, which by means of the selected movement of the control element 655 in a step position of the slide 656 can selectively actuate these switches on tilting forwards, backwards or to the side and optionally direct depression, wings or projections being provided at the underside of the control element, such as the projections 681, 682 shown on FIG. 152. In the rearmost position of the slide 656, the control element 655 will be positioned above a resistance ring 682 which has a spring-loaded switch 683 in the centre thereof. When the control element 655 is tilted downwards, the projection 681 on the underside of the control element and where this projection is electrically conductive will come into contact with the resistance ring 682, so that a voltage divider is thus produced as a result of the contact of the projection 618 with the resistance ring 682. If the conductive contact ring 681, together with the ends points 682′, 682″, forms part of, for example, a measuring bridge circuit, the tilting direction of the control element 655 will be able to control one of several functions, for example, control of a cursor on a display screen. Direct depression of the control element 655 will activate the switch 683 and thus confirm the position of the cursor.

The stepwise movement of the slide 656 is made possible by means of spring-loaded projections 684, 685, where the spring is indicated by the reference numeral 686, which form releasable engagement with depressions 687 in the housing of the operating device 688 along the movement path of the slide 656. To cause the control element 655 to take up a centre position, there are provided elastically yielding means 689 between a flange of the control element 655 and a flange on the slide 656.

The embodiment shown in FIGS. 155-157 will now be described in more detail. The control element in these figures is indicated by the reference numeral 690, and is via a pin 691 supported in a support plate 692 that is tiltable in the operating device slide 693 and supported there by a spring-loaded switch 694. Strain gauges 695, 696, 697, 698 are fastened to the pin 691 and to the support plate 692 in order in a first function mode of the operating device to detect small tilting movements of the control element 690 which will not activate the switch 694, and in a second function mode to simulate a multipoint switch, optionally in interaction with the spring-loaded switch 694, the strain gauges 695-698 collectively indicating which direction the control element is tilted in and to what extent. Wiring from a printed circuit board 699 on a base plate 700 of the device is provided by means of flexible wiring connection 701. As shown in FIG. 158, electrical power supply to the strain gauges 695-698 can be provided via contact 702 which forms contact with contact 703 on the support plate 692, so that the wiring via connection 701 is broken when the control element 690 is depressed straight down for activation of the switch 694.

The stepwise movement of the device slide 708 relative to the device housing 709 is assured by projections 704, 705 which are spring-loaded by means of a spring 707, and where the projections form engagement with a row of depressions 706 that together form a toothed edge along the movement path of the slide 708 in the operating device housing 709. To determine the stepwise position of the slide 708 relative to the housing 709, there is provided a plurality of light sources 710 (only one of the five shown has been indicated by a reference numeral) that interact with a respective light receiver 711 (only one of the five shown in the drawing has been indicated by a reference numeral). The light from the light source 710 to the light receiver 711 passes through a channel 712 in the slide 708. Although the stepwise positions are detectable by optical detectors, it will be possible to use as an alternative electromechanical switches, e g., in connection with the projections 704, 705.

Yet another embodiment of the operating device will now be described in connection to FIGS. 159-166. FIGS. 159-161 show how the operating device according to the present invention could be used in connection with a functional apparatus 714 which has a touch-sensitive screen 715, and where the housing 714′ of the apparatus 714 has a tiltable cover 714″ that is connected to the housing 714′ via a pivotal connection 716. In connection with the operating device, there is provided a control element 717 that is tiltably and depressibly arranged in a slide 718, and where the slide is longitudinally movable in the operating device housing 719. The slide 718 is stepwise movable in the housing 719. This is made possible by means of pins 720, 721 that are spring-loaded by a tension spring 722. Depressions are provided on both sides along the sliding path of the slide 718 relative to the housing 719, thus forming an edge on the housing along the movement path that has a toothed appearance. This can be seen most clearly in FIG. 162. The stepwise positions of the slide 178 relative to the housing 719 are detectable by means of a busbar 724 on the base part 725 of the device, and where the busbar 724 faces the underside of the slide and also a row of contact points 726-730 on the base part and facing the underside of the slide. Sliding contacts 731 and 732 with electrical connection 733 therebetween effect respectively contact with the busbar 724 and successive contact with the contact points 726-730. Spring-loaded contact pins 734, 735 and 736 are also provided in connection with the slide 718 in order, on movement of the control element 717 in a selected step position, to cause these contact pins 734, 735, 736 to form contact via openings 737, 738, 739 in the device base part 725 with position-adapted areas on a touch screen 740 located under the base part 725 so as to mark a selected function command related to the position and tilting direction of the control element. In each of said positions, the control element is preferably tiltable sideways and centrally depressible, and optionally also tiltable forwards and/or backwards. Openings in the base part corresponding to the openings 737, 738 and 739 in the base part 725 are also found at the positions in the base part 725 that are indicated by the reference numerals 741, 742, 743 and 744. The control element 717 is spring-tensioned in the slide 718 by means of a spring 745. On central depression of the control element 717, where the control element moves about a supporting shaft 746 in connection with an elongate hole 747 in the control element, a pin 748 on the control element 717 will only actuate the central contact pin, such as the pin 735 in the selected slide position.

The operating device shown in FIGS. 167-172 will now be described in more detail.

In this embodiment there is a control element 749 that is spring tensioned relative to a slide 759 and where there are provided two busbars 751, 752 fastened to the operating device housing 753 at each end thereof. The slide 750 that is slidable along the bars 751, 752 is adapted to move stepwise along this path. This is done by providing in the slide a ball 754 which is spring-tensioned by means of a spring 755, and where the ball 754 on the longitudinal movement of the slide will successively come into engagement with depressions 756 in a contact pattern 757 arranged on the base part 758 of the device. This contact pattern 757 is shown in more detail in FIG. 168 and consists of a contact bar 759 and contact pads 760, 761, 762, 763, 764 and 765. As shown in FIG. 168, the ball 754 will always be in contact with the contact bar 759, but will along its movement be in contact with successive ones of the contact pads 761-765, and will in the intermediate positions be capable of forming contact with two adjacent contact pads. With the aid of the contact bar 759 and the contact pads 760-765 it is possible to sense the individual positional position that the slide 750 is in.

Tilting or depression of the control element 749 relative to the slide 750 will cause a current-carrying contact 766 or 767 (where these two are electrically connected) to form contact with either the busbar 751 or the busbar 752, or on direct depression of the control element 749 will connect the two busbars 751 and 752.

The control element 749 is spring-tensioned relative to the slide 750 by means of a spring 768. The intention of the illustrated embodiment has been that the control element should be tiltable sideways or depressible.

Yet another embodiment of the operating device is shown in FIG. 173.

In this embodiment there is a control element 769 that is actuatable by an operator's finger to execute at least two function commands, and where the control element is mounted on a slide 770 and thus arranged to be movable stepwise along a path and caused in the individual stepwise positions to make a depression movement or a tilting movement. The stepwise positions should be detectable.

In each of the positions, the control element is preferably tiltable sideways and forwards, and also centrally depressible. The control element 769 will in this connection interact with one or more spring-loaded switches 771, 772 and 773. The stepwise movements of the control element 769 are produced by means of pins 774, 775 that are spring-tensioned by a spring 776. The pins will stepwise engage with recesses 777 provided along the movement path of the slide 770 in the device housing 778.

The stepwise positions of the slide and thus the control element 769 are detectable with the aid of a busbar 779 and a row of contact points 780. The busbar 779 and the contact points are arranged on the device base part 781 and face the underside of the slide 770. Sliding contacts 782 on the slide are provided for contact with the busbar and successive one of the contacts 780 respectively. As the slide moves along its path, the control element 769 will, when depressed or tilted, cause the spring-loaded switches 771, 772 and 773 to selectively be brought into contact with contact points 783, 784 or 785 at the stepwise positions of the control element 769 and the slide 770. In connection with the slide 770 and the base part 780, there will be open portions 786 that will also expose functional elements on the base part, for example, the busbars, the contact points or pads, any optical detectors, wiring or the like. To avoid this, these open portions are covered by a set of slats 787, 788, 789 through which the control element 769 extends, the transverse edges of adjacent slats always overlapping as shown in FIG. 174 when the control element 769 is moved forwards and backwards, thus moving the slats in their longitudinal direction. FIGS. 175 and 176 show a variant of the embodiment in FIGS. 173, 174. There is a first control element 790 which is arranged to be tiltable forwards, backwards and sideways, and is also depressible in a slide 791. The slide is stepwise movable, and this is made possible with the aid of two pins 792 and 793 which are mutually spring-tensioned by a spring 794. These pins 792, 793 form stepwise engagement with depressions 795 along a part of the movement path of the slide, so that there is a toothed portion along opposing edges of the operating device housing 796. Spring-loaded contacts 796, 797, 798 and 799 are provided in connection with the slide. These spring-loaded contacts 796-799 are arranged in connection with the selected movement of the control element in a step position of the slide 791 so as to be able to actuate the contacts to form contact with at least one contact bar 800, 801 or a contact pad 802, and thus mark the selected function related to the position of the control element and the tilting direction or depression of the control element 790. If the control element 790 is tilted so that the contact 796 enters into operation, contact will be formed between the contact 796 and the contact bar 800. Similarly, on tilting to the opposite side, the contact 798 will form contact with the contact bar 801. If the control element 790 is tilted forwards or backwards, either the contact 799 or the contact 797 will form contact with one of the contact pads 802. If the control element is pressed straight down, two of the contact pads 802 will come into contact with contact 797 and contact 799 respectively, whilst the contact bar 800 will form contact with the contact 796 and the contact bar 801 will form contact with the contact 798.

To detect the stepwise movement of the slide, there is provided a busbar 803 and a plurality of contact points 804, electrical connection being made transverse to the slide, and sliding contacts on the slide for contact with the busbar 803 and successive ones of the contact points 804 respectively.

A pin 805 at the end of the slide 791 is provided for abutment against an end spring 806, so that if the slide is pushed all the way to the bottom position (to the left in FIG. 175), the contact 804′ will become temporarily active together with the busbar 803, e.g., in order to initiate a tilting function (trigger function), but when the control element 790 is released, the spring 806 in interaction with the pin will push the slide back to the closest real step position, here indicated by the reference numeral 804″.

In a way similar to that describe d in connection with FIGS. 173-174, this embodiment also includes a set of slats 807, 808 for covering the opening which is in the operating device housing 796 so as to prevent there being open access to functional elements on the base part and parts of the slide, i.e., for instance, busbars, contact points and pads, detectors, wiring or the like. Because the transverse edges of the adjacent slats always overlap, the slats 807, 808 effectively cover the opening in the housing 796 when the control element 790 is moved forwards and backwards, thereby moving the slats in their longitudinal direction.

The embodiment shown in FIGS. 177-179 will now be described in more detail. In this embodiment there is a control element 809. This control element is, like that shown and described in connection with the preceding embodiments, actuatable by an operator's finger to execute at least two function commands. The control element 809 is arranged to be capable of being moved stepwise along a path and caused in the individual stepwise positions to make a tilting movement or a depression movement, and where the stepwise positions are detectable, for example, with the aid of optical detectors. The control element 809 is supported in a slide 810 and the stepwise movement is assured by means of pins 811 and 812 that are mutually spring-tensioned by a spring 813. The pins 811, 812 form stepwise engagement with depressions 814 provided along an edge portion of the operating device housing 815 that faces the slide. Light sources 816 and light receivers 817 are provided on opposite sides of the slide for the purpose of detecting the stepwise positions of the slide 810. Light can pass from a light source 816 to a light receiver 817 through an opening 818 in the slide 810. It will also be understood that when the slide is moved, some of the pairs of light sources and light receivers will not be in communication, whilst one or more of the light sources and the light receivers will be in light communication. Thus, a definite determination of the position of the slide is obtained.

However, it is also conceivable that the reference numerals 816 and 817 may be contact pins that are slidable together with the slide 810 and where these contact pins form contact with busbars 819, 820.

It will be seen that the control element 809 is spring-supported on the slide 810 by means of a spring 821. At the bottom, the control element 809 has actuating pins 822, 823, 824 and 825. If the control element 809 is tilted forwards, the pin 822 will come into contact with a contact foil 826; if the control element 809 is tilted to one side or the other or backwards respective pins 823, 825 and 824 will come into contact with contact foil 827, 829 and 828, the respective pins on actuation of the contact foils forming electrical contact therein. As shown in FIG. 178, the contact foils are elongate, so that they can always be made to create a switch function irrespective of where the slide 810 and control element 809 move along the possible path of movement.

If the control element 809 is depressed centrally, all the contact foils 826-829 could be activated. The contact foils 826-829 are preferably made as a single unit, but where the areas of the contacts 826-829 are electrically insulated from one another.

In the embodiments that have just been described where means are provided, for example, in the form of strain gauges or voltage dividers to detect tilting movements of the control element relative to its neutral position, it may, as previously described, be expedient in certain cases to provide the upper surface of the control element 830 with a capacitive-acting sensor consisting of sensor elements 830′ and 830″.

As indicated above in connection with two of the embodiments, there might be a need for a covering arrangement designed for an operating device, where the device has a control element that is actuatable by an operator's finger to execute at least two function commands, and where the control element is mounted on a slide and thus arranged to be moved along a path and caused in the individual stepwise positions to make a tilting movement or a depression movement, and where the stepwise positions are detectable.

In connection with that shown in FIGS. 181-192, reference will for the sake of simplicity be made to a previous embodiment that is shown in FIGS. 173 and 174. The individual functional parts will however not be described in more detail as these have been described exhaustively in connection with the said figures.

The open portions facing the base part 781 of the device and the slide 770 and also functional elements mounted on the base part, such as the busbar 779, the contact pads 780 and the contact points 783, 784 and 785 are covered according to the illustrated embodiment by a set of overlapping slats 787, 788 and 789. As shown in FIGS. 173 and 174, the control element 769 extends up through these slats in their respective openings 787′, 788′ and 789′. Transverse edges of adjacent slats will always overlap each other when the control element 769 is moved forwards and backwards, thereby moving the slats in their longitudinal direction. The slats are covered by a cover 778′ that is fastened to the device housing 778.

FIGS. 182-185 shows the positions of the slats when the control element 769 is displaced in the longitudinal direction relative to the housing 778.

FIG. 186 shows an operating device having a first control element 831 that is actuatable by an operator's finger to execute at least two function commands, and a second control element 832 that surrounds the first control element and is actuatable by an operator's finger to execute at least two function commands. The first control element 831 is arranged to be non-rotatable, but movable sideways and/or tiltable relative to the centre position thereof. Located centrally under the first control element 831 is a spring-loaded switch 833 that is activatable on depression of the first control element, preferably at any point on the surface thereof. The second control element 832 interacts with a means (not shown) to detect its stepwise rotational movement, the second control element 832 being stepwise rotatable 360° and arranged to selectively activate one of four spring-loaded switches 834-837 located under the second control element, and spaced 90° apart, on depression of the control element 832 at the position for such a switch. The stepwise movement is assured in that the second control element has a peripheral portion 832′ that is toothed or corrugated and which interacts with springs 838, 839. The means for detecting the rotational movement of the second control element 832 may, for example, be as shown and described in connection with FIG. 92, Fig.; FIGS. 100 and 101; FIGS. 102-104; FIGS. 105 and 108; and FIGS. 111 and 114. A solution as shown in FIGS. 102 and 104 is therefore simply as an example indicated by the reference numeral 840.

To detect the direction and extent of movement of the first control element 831, use is made of a centre position deviation detector consisting of an annular body 841 that is secured to the base part 842 of the device and surrounds a peripheral portion 831′ of the lower portion of the control element or controlling member 831 (if there is no second control element 832), and where the annular body 841 on a wall portion thereof that faces the first control element 831 or operating member is equipped with a plurality of spring-loaded contacts 843 which have contact with said peripheral portion, and where one or more of the contacts 843 are activated as a function of the centre position deviation and direction of movement of the first control element or controlling member 831. The contacts consist either of electromechanical switches or of capacitive sensors. As all the contacts 843 are spring-loaded, they will hold the first control element in its centre position, and also return it to the centre position if it is moved from the centre position and then released.

The embodiment shown in FIGS. 188-190 shows an operating device having a first control element 844 and a second control element 845 which surrounds the first control element and where each of these is actuatable by an operator's finger to execute at least two function commands. The first control element 844 is arranged to be non-rotatable, but moveable sideways and/or tiltable relative to a centre position thereof. Located centrally under the first control element is a spring-loaded switch 846 which is activatable on depression of the control element 844, preferably at any point on its surface. The second control element 845 interacts with means for detecting its rotational movement, and the means may, for example, be as shown an described in connection with FIG. 92; FIGS. 100 and 101; FIGS. 102-104; FIGS. 105 and 108; and FIGS. 111 and 114. A solution that is shown in FIGS. 102 and 104 is therefore simply as an example indicated by the reference numeral 847. The stepwise movement is assured in that the second control element has a peripheral portion 845′ which is toothed or corrugated and which interacts with springs 852, 853.

The second control element is stepwise rotatable 360° and is arranged to selectively activate one of four spring-loaded switches 848, 849, 850, 851 located under the second control element, and spaced 90° apart, on depression of the control element 845 at the position for such a switch.

To detect the direction and extent of movement of the first control element 844 there is provided a centre position deviation detector consisting of a plurality of contact pairs 852 placed in a ring, a sinuous or waved ring spring 853 around the first control element 844 or controlling member (if the second control element 845 either is not present or is inoperative) and spaced apart therefrom, which ring spring also surrounds the ring of contact pairs 852, where the wave crests 853′ of the ring spring abut against an annular supporting wall 854 that surrounds the ring spring 853 and is fastened to the device base part 855, and where the troughs of the waves 853″ of the ring spring are fastened to one end of a respective spoke 856. As shown, a plurality of spokes 856 are provided and each of these extends from the spring 853 (at trough 853″) via an intermediate space between adjacent contact pairs 852 and to a hub 857 that is secured to the first control element 844 or controlling member, wherein sideways movement and/or tilting of the first control element 844, or the controlling member, in a desired direction draws part or parts 853″ (in reality wave trough 853″) of the ring spring 853 towards contact 852′ on one of contact pairs 852 and contact 852″ on neighbouring contact pair 852. The number of such pairwise activated contacts 852′, 852″ will thus indicate the centre position deviation and direction of movement of the first control element or controlling member.

The hub 857 together with the spokes 856 and the spring 853 will cause the first control element 844 to be held in its centre position and returned to the centre position after sideways displacement and/or tilting.

Disposed between the underside of the second control element 845 and the switches 848-851, by each switch, is a spacer block, such as the blocks 858 and 859 by the switches 849 and 851 respectively, to ensure a precise activation of respective switch on depression of the second control element at the position for such a switch.

FIGS. 191-194 show an operating device having a control element 860 that is actuatable by an operator's finger to execute at least two function commands, where the control element is mounted on a slide 861 and arranged to capable of being moved stepwise along a path and caused in each individual position to make a sideways tilting movement or depression movement relative to the slide, and where the stepwise positions are detectable. The control element 860 is tiltable and depressible relative to a supporting shaft 862. The control element 860, on a face 860′ thereof under the position of the supporting shaft, is equipped with a plurality of engagement recesses 863, 864, 865, 866, preferably four, for position-determining on stepwise engagement with a spring-loaded engagement ball 867 on the slide the orientation of the control element 860 relative to the slide 861. Provided in the control element is a light source 868 or light receiver that is directed towards the device base part 869. Arranged on the base part 869 are at least two, preferably three, parallel rows of light receivers 870 or light sources (if 868 is a light receiver) in the direction of movement of the slide and selectively arranged for light communication with said light source 868 or said light receiver (if 870 is light sources) respectively on the tilting of the control element to a desired position. A light source 871 and a light receiver 872 are placed on the base part 869 at a respective end of the movement path of the slide 861, and where the light path between these is broken when the control element 860 is depressed (for example, confirmation function). A spring 879 in a slot 880 on the control element 860 will return the control element to its position as shown in FIG. 193. Alternatively, the engagement recesses 864-866 may be shaped asymmetrically so that the spring-loaded ball 867 in interaction therewith will return the control element to engagement between recess 863 and the ball 867. It is also conceivable that the shaft 862, for example, has a square cross-section and is supported at its ends in the slide 861 by springs acting in opposite directions.

On tilting as shown in FIG. 194, the light communication between the element 868 and any one of the elements 870 will give a number of options as regards, for example, apparatus function. If there is a total of three rows of light receivers 870 and five in each row, this gives 15 options all told, but in the chosen embodiment it is intended that only in the centre position (cf. FIG. 193) is detection to take place on depression of the control element.

The power supply/wiring to the light source 868 (which may optionally be a light receiver) takes place, for example via sliding contact connections 873, 874, and where these also may communicate with sliding contacts, as for example sliding contact 875 that is in contact with a busbar 876 in connection with the connection 873. A second sliding contact 877 intended for contact with the busbar 878 is also indicated in connection with the connection 874.

Light communication between a respective light receiver in the central row 870′ of light receivers 870 and the light source 868 will at all times determine the stepwise position of the slide 861.

To obtain optimum light communication between the light source 868 and the light receivers 870, for example, the rows 870″ and 870′″ may be arranged so as to be angled, as indicated in broken lines in FIG. 194.

The stepwise movement of the slide 861 is provided with the aid of toothed or corrugated portions 881′, 881″ on the device housing 881 in interaction with two spring-loaded pins 882, 883 on the slide 861, as shown in FIG. 192.

FIGS. 195-198 show an operating device having a control element that is actuatable by an operator's finger to execute at least two function commands, where the control element is supported in a depressible and stepwise tiltable manner relative to the device housing 885, and where the stepwise positions are detectable. At its lower end 884′, the control element 884 is slidably mounted in a ball-shaped body 886 and designed to actuate on axial depression movement a spring-loaded switch 887 located in said body 886, for example in connection with a confirmation of selected position of the control element. Provided in the body is a light source 888 (or light receiver) which when the control element 884 is tilted, thereby adjusting the position of the body 886 relative to the housing 885, can be brought into desired optical contact with one of a plurality of light receivers 889 (or light sources if 888 represents a light receiver) recessed in part of a wall portion surrounding the body. The switch 887 is arranged to activate the light source 888 (or light receiver) located in the body. The control element 884 is tiltable forwards and backwards and also sideways to both sides.

Arranged on the surface of the spherical body 886 are two rows of engagement recesses 890 and 891, each preferably including three engagement recesses, such as 890′, 890″, 890′″ for the recesses 890, and where the recesses 890 and 891 are spaced 90° apart, where each row is arranged for stepwise engagement with an associated spring-loaded engagement ball 892, 893 which projects from a point on the wall portion surrounding the body 886 to selectively position-determine the orientation of the control element relative to the housing in a forwards/backwards direction and sideways direction. Power supply to the light source 888 (or the light receiver) in the body is provided via sliding contact connections 894, 895 between the body 886 and the surrounding wall portion of the housing 885.

In the variant shown in FIG. 199, the control element 896 at its lower end 896′ is similarly slidably mounted in a spherical body 897 and designed to actuate on axial depression movement a spring-loaded switch 898, for example, for a confirmation function, in the same way as for the switch 887. The switch 898 is located in the said body 897 in the same way as shown in FIGS. 195 and 197, but does not control any light source in this case. The control element 896 is also tiltable forwards and backwards and sideways to both sides.

Arranged on a wall surface of the device housing that surrounds the spherical body is a field of m rows and n columns of equidistant engagement recesses 899. These can per se have a position as shown in FIG. 196, and the reference numeral 899 is therefore also used there. Each row (x direction in FIG. 196) and each column (y direction in FIG. 196) is arranged for stepwise engagement with one single spring-loaded engagement ball 900 provided for the field and which projects from a point on the surface of the body for selectively position-determining in stepwise engagement with the individual recesses 899 the orientation of the control element relative to the housing 901 in a forwards/backwards direction and a sideways direction. The current path to and from the switch 898 in the body 897 is effected via sliding contact connections between the body and the surrounding wall portion. For the sake of simplicity, only the connection 902 is shown in FIG. 199.

The engagement recesses 899 are provided with electrically conductive contacts 903. The ball 900 may either be current-carrying in that it forms electrical connection 904 with a terminal on the switch 898, i.e., that the spring-loaded ball 900 receives power supply on the activation of the said switch 898, and thus forms a current path via one of said contacts 903, or the ball 900 may be short-circuiting due to a special design of each recess 899 in interaction with respective contact 903.

The number of engagement recesses 899 (FIG. 199) or light receivers 889 (FIGS. 195-198) related to one of the tilting movement planes is m, and related to another of the tilting movement planes that is at 90° to the first tilting movement plane the number is n, the number of possible tilting positions thus being m×n. In the illustrated embodiment m=n=3, although this should not be regarded as in any way defining the limits of the embodiment shown and described.

FIGS. 200-202 show an operating device having a control element 1001 that can rotate and be depressed at four different points, such as the points 1002, 1003, 1004 and 1005. Detection of the rotation of the control element 1001 is effected in that two balls 1006, 1007 are passed on rotation of the control element over a foil 1008 having membrane switches 1009. The balls 1006 and 1007 will alternately detect, i.e., activate a respective membrane switch. Depression of the control element 1001 will be registered in that a disc spring 1010 in connection with the switch 1011 is depressed. In the illustrated case, there is a total of twelve rotation steps, represented by the membrane switches 1012-1017. The respective steps are provided in that a spring 1018 presses against a central portion 1019 of the operating device that is fixed. The balls 1006 and 1007 are held in place between the membrane and a flat spring 1020 that is secured by means of a pin 1021 provided in connection with the operating device housing 1022. FIG. 204 shows how steps can be provided in connection with the rotation of a control element, merely shown schematically in FIG. 203 by the reference numeral 1023, and where the path along which the spherical body 1024 is moved has holes or depressions in which the ball 1024 is pressed by a spring 1025, thereby providing contact in the membrane path indicated by the reference numeral 1026 for activating the membrane switch 1027. Said holes or depressions are indicated by the reference numeral 1028 in FIGS. 203 and 204, and FIG. 204 shows a total of twelve such holes 1028 which each represent the step positions of the control element 1023. The said pressure switches shown in connection with FIGS. 200 and 202 may optionally, as shown in FIG. 203, consist of membrane switches, here indicated by the reference numeral 1029 in connection with these switches.

FIGS. 205-210 illustrate the use of the invention in connection with a touch screen. The mode of operation is per se the same as that shown and described in connection with preceding FIGS. 200-204, but in this case instead of a membrane with membrane switches, a so-called touch screen is used, and is indicated by the reference numeral 1030. In this case too the control element, indicated by the reference numeral 1031, is rotatable, and the positions are defined by the spring-loaded ball 1032 in interaction with the definable holes, indicated generally by the reference numeral 1033. At the depression points 1034, 1035, 1036, 1037, the control element 1031 is spring-loaded, so that depression overcomes the spring force at the point concerned and causes a pressure ball or similar, in FIG. 205 indicated by the reference numeral 1038, to be pressed down against the touch screen and thus activate an appropriate point thereon, as for instance the point 1035′ on the touch screen 1039 shown in FIG. 210. Advantageously, the control element 1031 can be pivotally arranged in a body 1040 that is tiltable relative to the touch screen 1039, as shown in FIGS. 209 and 210. The actual apparatus housing shown in FIGS. 207-210 is indicated by the reference numeral 1041.

In FIGS. 211 and 2112, and also in FIGS. 213-216, the solution shown in FIGS. 200-202 is arranged on a stepwise movable slide 1042. Means that are known per se (not shown) in FIGS. 211 and 212 can be used to sense the stepwise position of the slide. These figures show a total of five stepwise positions that are secured by means of springs 1043 and 1044 which form engagement with respective notches 1045 and 1046 on the slide 1042. Otherwise, the same elements as those shown in FIGS. 200-202 are indicated by means of the same reference numerals. Signals from the membrane switches 1012-1017 are transmitted to peripheral equipment (not shown) by means of a cable 1047 that also conveys signals from the switches 1002-1005. A modification of the solution just shown and described in connection with FIGS. 211 and 212 is shown in FIGS. 213-216. In this solution all detection is carried out directly on a foil or membrane 1048 that has a number of switch points, as for instance the switch point 1049 shown in FIG. 213. The stepwise sliding positions can be registered by means of a pressure-loaded ball 1050 in the centre relative to the control element 1051. The ball 1052 corresponds to the ball 1006 in FIGS. 202 and 212, and therefore its function does not need to be described any further. All foil or membrane switches can be located on a common printed circuit board 1053, and it will be seen that when the control element 1051 is depressed, a membrane switch 1054 will be activated, in that a pressure spring 1055 has a pin 1056 that causes depression of the membrane for contact formation.

FIGS. 217-225 show an operating device in the form of a rotary switch or rotatable control element 1057 that can be moved along a guide 1058. The control element 1057 is mounted on a slide 1059, and the stepwise movement and position maintenance is ensured by a toothed portion 1060 on the operating device housing 1061 in interaction with a spring-loaded pair of pins 1062, 1063. The stepwise rotation of the control element 1057 is assured by means of springs 1064, 1065 in engagement with a toothed portion 1066 on the control element 1057. As shown in FIG. 219, there are four depression points 1067, 1068, 1069 and 1070. The rotatable control element 1057 surrounds a non-rotatable control element 1071 that is arranged to actuate a strain gauge bridge 1072, the function of which will not be described in more detail as a clear explanation has been given in connection with FIGS. 125-128. Transmission of signals from the switches and from the strain gauge 272 located on the slide 1059 can be made to peripheral equipment via a cable 1047′.

The central control element 1071 forms per se a previously described centre position deviation detector where the strain measurement via the strain gauge 1072 consists of a strain gauge set. As described above, a control element of this kind 1071 will be suitable for, e.g., mouse control of a pointer on a display screen.

To detect the respective stepwise positions, sliding contacts can be provided in connection with the slide, where for example a sliding contact, as for instance the sliding contact 1073 forms successive contact with contact points 1074, whilst a second sliding contact 1075 forms contact with a contact bar 1076. FIG. 223 shows a solution for the rotatable control element 1057, whereby with the aid of a toothing 1057′ it is possible to sense the stepwise movement of the control element 1057.

FIGS. 226-229 show a variant of how a central cursor control switch or centre position deviation detector can be constructed. In this connection, reference can also be made to that shown and described in connection with FIGS. 133-139. In the solution shown in FIG. 226 it will be seen that the centre position deviation detector in this case consists of a strain gauge set, indicated by the reference numeral 1077 also in FIG. 227, provided in a cross shape directly on a printed circuit board 1078. The control element, indicated here by the reference numeral 1079, will be anchored in the printed circuit board 1078 via a post 1080. As shown in FIG. 226, the control element is anchored in the centre of the cross shape. In the embodiment shown in FIG. 226, the control element 279 (that is not rotatable) has in its upper face an actuatable switch 1081. In other respects, the solution shown in FIGS. 226 and 227 is like that shown and described earlier. A modification of the solution can be seen in FIGS. 228 and 229 which show the respective sections in FIG. 227. Here, it will be seen that the central control element (that is not rotatable) is indicated by the reference numeral 1082 and is anchored directly in the printed circuit board 1083 via a post 1084. In addition to causing deformation of the centre position deviation detector 1077, the control element 1082 is also arranged to be able, when tilted downwards, to actuate respective spring-loaded contact points or switches 1085, 1086, 1087 and 1088. These switches may optionally consist of membrane switches located on the circuit board 1083, or may consist of conventional pressure switches that are located on the circuit board and spring-loaded in the usual way.

Here there will be two alternative ways of controlling a cursor on a screen.

The first way is to depress the control element 1079 so that the switch 1081 is activated or the switches 1085-1088. The system which will be constructed in connection with the operating device will be coded, so that when one or more of the contacts 1085-1088 is activated, the strain gauges, represented by 1077, will begin to read the extent of movement of the control element. When the control element is released, the contact-is broken and the cursors will stop. To activate selection, it is possible to make the system react either on a double click or on a depression of the outermost ring, indicated here by the reference numeral 1079′, for activation of the associated switches 1085′, 1086′, 1087′ and 1088′.

The other way is to move the control element 1079 to control the cursor, but without the switches 1081, 1085-1088 being closed. If selection is to be confirmed, the control element can be depressed until one of the springs associated with one of these switches collapses and contact is thus formed.

In connection with an operating device it is expedient that the control elements which are to be operated by one finger both should be easy to operate and should provide secure engagement with a finger. FIGS. 231-235 show various solutions of such control elements. FIG. 231 a shows that the control element, indicated here by the reference numeral 1089, for example in connection with a functional apparatus 1090, has an outer annular portion 1091 that is made having a toothed or corrugated surface, and also having a central portion 1092 that is provided with a plurality of upright pins 1093. As can be seen from FIG. 232, the said pins 1093 will extend upwards to the level of or the level below said corrugated surface 1091. As shown in FIG. 233, the said outer annular portion 1091 and the central portion 1092 may be movable relative to one another, i.e., that there is a small gap 1094 between them. Depending upon the area of use and the type of operating device that such control elements are to be used with, the control elements can be given different shapes, e.g., oval, elliptical, triangular (not shown) or square (shown in FIG. 234). It will also be seen in connection with FIG. 235 that the control element, in this case indicated by the reference numeral 1095, has a central concave portion 1096 having a plurality of upright pins 1097 which it will be understood will give excellent friction against a finger that is to operate the control element.

In the solution shown in FIGS. 236-241 there is a control element 1098 that is mounted on a stepwise movable slide 1099, where the stepwise position is secured by engagement notches 1100 that form engagement with spring-loaded balls 1101, 1102 on the slide 1099. As shown, inter alia, in FIG. 238, the control element 1090 is provided with at least two switch actuating pins 1103 and 1104. It will also be seen that mounted on the slide is at least one switch actuating body, such as a spring-loaded ball 1105. Preferably, there are two such balls 1105 and 1106, as indicated in FIG. 239.

The switches that are actuatable by said balls 1105 and 1106 are indicated by the reference numerals 1107 and 1108 in FIG. 236. In addition to the said switch actuating pins 1103 and 1104, additional switch actuating buttons 1109 and 1110 may be provided as indicated in FIG. 241. The pins 1109 and 1110 will be arranged to selectively actuate the switch points 1107 or 1108, whilst the switch actuating pins 1103 and 1104 are arranged to be able to actuate the switch points 1111. As shown, the said switch points 1107, 1108 and 1111 are located on a common base 1112 and preferably consist of membrane switches.

Another solution is shown in FIGS. 242-245. In these figures there is a control element 1113 that has a plurality of membrane switches 1114, 1115 and 1116. The control element 1113 is mounted on a slide 1117 that is stepwise movable relative to the operating device housing 1118, the housing 1118 having depressions 1119 that engage with a spring 1120 on the slide, so that the slide is held in the respective stepwise position. Signals from the switches 1114-1116 are transmitted to external equipment (not shown) via a flexible cable connection 1121. In addition, located under the movement path of the slide 1117 is a number of additional switches, preferably membrane switches, indicated here by the reference numerals 1122, 1123, 1124 and 1125. These switches, preferably membrane switches, are provided on the underside of the slide and are actuated by a spring-loaded pin 1126 for successive activation of the switches 1122-1125 so as to indicate the position in which the slide 1117 is located.

FIGS. 246-251 show an operating device that is of the sliding switch type and where there is a total of five pressure points 1127-1131. As with the previous embodiments, the stepwise movement is assured by means of notches 1132 on the operating device housing 1133 in interaction with spring-loaded pins 1134, 1135 located on the slide 1136 itself. All five switch positions 1127-1131 can be actuated by one and the same control element 1137. The control element is held in position by means of a large disc-like spring 1138. On central pressure, as shown in FIG. 251, the spring 1138 collapses, thereby actuating the central switch 1131. This switch actuation takes place before any switch action can take place at the other switch points 1127-1130.

Sideways tilting will result in respective ones of the switches 1127-1130 being activated.

To detect the step at which the slide 1136 is located, it will be expedient to equip the slide with sliding contacts which, as explained earlier, can form contact with contact points 1139 and busbar 1140 respectively. Transmission of signals from the switches 127-1131 may take place, for example, by means of a cable or by using sliding contacts. A variant of the solution shown in connection with FIGS. 246-251 can be seen from FIG. 252. In this figure it will be seen that the control element, indicated by the reference numeral 1141, has a central depressible portion 1142 that is arranged to actuate the centrally located switch 1131. The control element part 1141 is also arranged to actuate respective ones of the switches 1127-1130 that are located sideways relative to the switch 1131. Depression of the switch 1131 can thus be effected by pressure on the control element part 1142, as this will move independently of the remaining part 1141 of the control element.

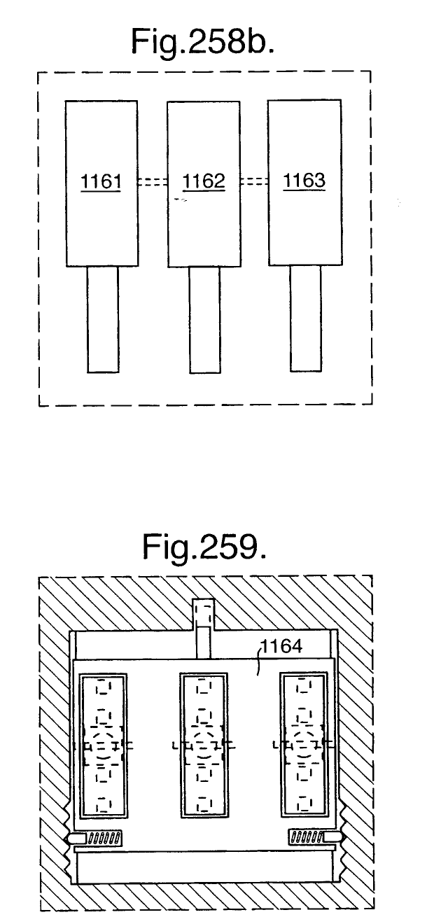

FIGS. 253-256 will now be described in more detail. In these figures, there is a control element 1143 that is tiltably and depressibly mounted on a stepwise movable slide. As with the preceding solutions, the stepwise movement is assured by notches 1144 on the operating device housing 1145 that interact with spring-loaded pins 1146, 1147 on the stepwise movable slide 1148. The control element 1143 is tiltable about a pivot pin 1149 and supported by a spring 1150. The control element is thus both tiltable and depressible on the slide 1148, the tilting direction being in the direction of movement of the slide 1148. On its underside, the control element is shaped to actuate two switches 1151 and 1152 on downward depression, and on respective tilting movement to similarly actuate two respective switches, respectively the switches 1151, 1153 and 1152, 1154. It will be seen that the switches 1151-1154 can expediently be membrane switches located on a common base on the slide in the direction of movement of the slide, said base in FIG. 253 being indicated by the reference numeral 1155. Transmission of signals between the slide and peripheral equipment can expediently be effected via a cable 1156. In this solution, as shown in FIGS. 257, 258 and 259, it will be possible to put several such operating devices side by side and thus obtain more switch combinations for operating various apparatus needs. In FIG. 257 the control elements for the respective operating devices are indicated by the reference numerals 1157, 1158, 1159. In these figures it is shown that the individual control elements are arranged to be capable of being moved independently of each other. In the solution shown in FIG. 258a, where three operating devices have been placed next to one another, all the control elements 1160, 1161 and 1162 are interconnected in that, for example, the tilt shafts 1149 on all the slides 1148 have been interconnected and can consist of a common shaft, as indicated in FIG. 258b. Alternatively, as shown in FIG. 259, the operating device can have a common slide 1164. Although this solution is shown having the type of operating device where the control element is only tiltable in one direction, namely the direction of movement of the sliding element, it will be understood that other types of sliding switches which have several tilting points could easily be used by following the same inventive principle with the same slide for all the control elements that are to actuate respective switch functions.

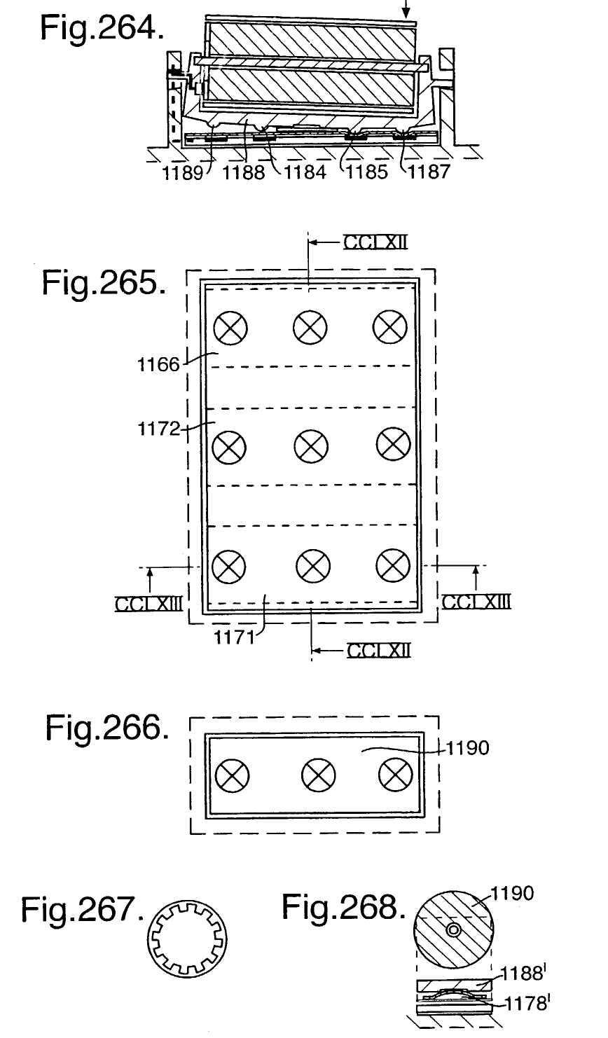

The solution shown in FIGS. 260-265 will now be described in more detail. In this solution there is an endless belt 1165 that is in engagement with at least two spaced-apart rollers 1166, 1177. However, it could be useful to provide at least one additional roller, for example, such as the roller 1172. There will be a means in connection with at least one of the rollers, such as the roller 1166, to detect the movement of the belt 1165 and thus of the rollers. This means can consist of, e.g., a toothed portion 1173 on the end of a roller, and which with the aid of a detector 1174, for example a microswitch or an optical detector, detects the rotation of the roller 1166. As will be seen in FIG. 264, the control element, in the form of for example, two or more rollers, is tiltable sideways and at the same time is depressible to actuate at least one switch function. To this end, each roller, as for instance the roller 1166, is spring-supported by a spring 1178.

However, it should be pointed out that each roller, such as the rollers 1166, 1172 and 1171, is independently depressible and tiltable relative to a common support unit 1179 for all the rollers, so as to be able to cause a respective switch function. Preferably, the switches that are connected with the switch functions are in the form of membrane switches, although this is not necessarily a condition. As with the operating device that is shown and described in connection with FIGS. 253-256, it is desirable that preferably two switches at a time, indicated here by the reference numerals 1180-1183, are activatable in pairs. A central depression of a roller that is an integral part of the operating device will thus cause the switches 1181 and 1182 to be activated by the pins 1184 and 1185 on the underside of the cradle in which each roller and its roller shaft is supported. Tilting to one side or the other, for example as shown in FIG. 264, will cause the pins 1185 and 1187 on the cradle 1188 to activate the switches 1182 and 1183, whilst the pins 1184 and 1189 will activate the switches 1181 and 1180 when the roller 1166 and the associated cradle 1188 is tilted to the opposite side.

Thus, it will be understood that there will be a vast number of possible activation combinations related also to the position in which the belt 1165 has moved together with the respective rollers. However, it will be seen that the roller 1172 does not necessarily need to be in direct contact with the belt, as the position of the belt will in any case be detectable because of the rotation of the roller 1166 and the detection means involved, indicated by the reference numerals 1173, 1174.

Although the solution shown in FIGS. 260-265 is preferred in connection with at least two rollers that are jointly rotatable with the aid of a belt 1165, it will be understood that optionally also just one roller could be provided, as shown in FIG. 266 and indicated by the reference numeral 1190. The support will be effected in the same way as shown and described in connection with, inter alia, FIG. 263, so that the roller with its cradle, indicated by the reference numeral 1188′, will be supported by a spring 1178′. Detection of the rotation of the roller could be effected by the same means as shown and described in connection with FIG. 261 and also FIG. 263, i.e., by means of detection field as indicated in FIG. 267 in interaction with a detector 1174 (not shown in connection with FIGS. 266-268).

Yet another embodiment of the operating device can be seen from FIGS. 269-275. In this embodiment, there is at least one roller that is stepwise rotatable and depressible in order to actuate at least one switch function. It will be seen that the roller, indicated here by the reference numeral 1191, is provided internally with a plurality of stationary, spring-loaded switches 1192, 1193, 1194. The roller has a surface layer 1195 that is movable relative to the rest of the roller body. The said layer I 195, as indicated by the arrows 1196, 1197 and 1198, is depressible in the axial direction of the roller 1191 so as to actuate a respective one of the switches 1191-1194. The surface layer 1195 has in addition circumferential contact portions 1199, 2000 and 2001 with respective flanks 2002 and 2003. The parts of the operating device that are indicated by the reference numerals 2004, 2005, 2006 and 2007 are not rotatable.

Preferably, as shown in FIG. 276, there may be provided at least two rollers of this type that are held apart and where the surface layer of the rollers is defined by a belt that is passed over and is movable relative to the roller bodies. In the solution shown in FIG. 276 there are three such rollers, indicated by the reference numerals 2008, 2009 and 2010.

The roller body, such as the flank 2002, will have a combined step movement and rotation sensing mechanism 2011. This can be implemented in that a flank of the roller has a rotatable part 2002 and a stationary part 2007. The stationary part 2007 is expediently provided with spherical bodies 2012, 2013, which follow a path 2014 in the rotatable part 2002. One of the spherical bodies 2013 interacts with a breaker contact 2015 in order to sense the step movement, whilst the other spherical body interacts with one or the other of two contact points 2016, 2017 on respective rotation of the roller and its flank 2002 so as to sense the direction of rotation.

FIGS. 277 and 278 and similarly FIGS. 279 and 280 show control elements 2018 and 2019 that are tiltably mounted on a slide that is stepwise movable relative to a plurality of stationary switches, as for instance the switches 2020, 2021 and 2022, that are selectively actuatable by the control element in each step position of the slide. For detection of the slide-based movement of the control element, the slide can be equipped with at least one spherical body, as for instance the spherical body indicated schematically by the reference numeral 2023 in FIG. 279, where the slide on its movement into step positions successively actuates step position related switches that are actuatable by the spherical body 2023, such as the switches 2021. These switches 2021 may be membrane switches mounted on a common base member (not shown) together with the switches 2020 and 2022. It is possible that the switches 2020 and 2021 and 2022 may be formed by a touch screen, and where the slide in which the control element 2018 or 2019 is tiltably arranged will be movable relative to the touch screen. An essential point here is that it is possible to change control element type without having to alter the membrane switch structure, and thus the illustrated embodiment can be useful with an operating device both of the type shown in FIGS. 213-216 and of the type shown in FIGS. 237-241.

A further embodiment of the operating device can be seen from FIGS. 281-286. In this solution there is a control element 2024 that is displaceable sideways relative to a centre position 2025 as indicated in FIG. 285. The control element 2024 will, both in its centre position and in the sideways displaced positions, be tiltable for activation of at least one switch function, as represented by the switches 2026 and 2027. Additional switches are provided, such as the switches 2028 and 2029. The control element 2024 will be spring-supported by the springs in the switches 2026-2029 as shown in FIG. 282, and the control element 2024 will be tiltably supported in a sliding body 2030 that is movable relative to the operating device housing 2031. The sliding body is equipped with said switches 2026-2029, and these switches can, for instance, be spring switches or microswitches that are electrically connected to the operating device housing 2031 via sliding contacts, such as the sliding contacts 2032 and 2033 shown in FIG. 282. The switches 2026-2029 will respectively be actuatable by the control element 2024 when it is tilted relative to the sliding body 2030 when the sliding body either is in the said centre position 2025 or is in a sideways defined position, as for instance the position 2034, see FIG. 285. The movement of the control element 2024 is controllable with the aid of a spring-loaded ball 2035 that runs over the membrane switches 2036-2043, of which the switches 2041, 2043 and 2037 are shown in FIG. 282. Disposed between the ball 2035 and the membrane, indicated here by the reference numeral 2044, is a layer of material 2045 provided with a plurality of grooves 2046 which communicate with respective holes that are connected to the respective switches 2036-2043 in order to position the sliding body of the control element with the aid of the ball 2035, and actuate by means of this ball a membrane switch in the position defined by the respective hole. Although FIG. 285 shows an approximate star shape towards sideways outer points, it will also be conceivable with the scope of the invention to move from outer point to outer point without having to return to the midpoint or centre position 2025.

As is also shown in FIG. 286, this should be possible. It will also be possible to provide at the outer points a spring function, so that the slide 2030 automatically returns to the centre position if it is released. As presented graphically in FIG. 284, but which has nothing to do with real movements as these appear in FIG. 281, it will be understood that by means of the outlined solution it will be possible to obtain a total of nine positions of the control element, and where it is possible to actuate the switches 2026-2029 of the control element in each of these switch positions, so that a total of 36 possible depressions are obtained for this type of operating device. However, the number of sideways movements of the control element must by no means be considered limited by that shown and described in connection with FIGS. 281-286.

The embodiment shown in FIGS. 287 and 288 has particular connection with an operating device where there is a stepwise rotatable control element that is tiltable in each step position for activating at least one switch function. In these figures, a control element is expediently indicated by the reference numeral 2047 and will in each rotary position be capable of selectively activating switch functions represented by the switches 2048-2051. However, in a number of cases, it may be expedient that the control element 2047 should be stepwise rotatable through an angle of less than 360°, but that the control element in each step position is arranged to selectively operate one of the possible switch functions, in the illustrated example four possible switch functions. From that shown in FIG. 288 it will be seen that the control element 2047 is rotatable through an angle that is less than 360°, in the illustrated example 180°, although this should not be understood as in any way defining the limits of the invention. Within this angle range, there is indicated in the illustrated example a total of eight steps in which the control element can activate switch functions.

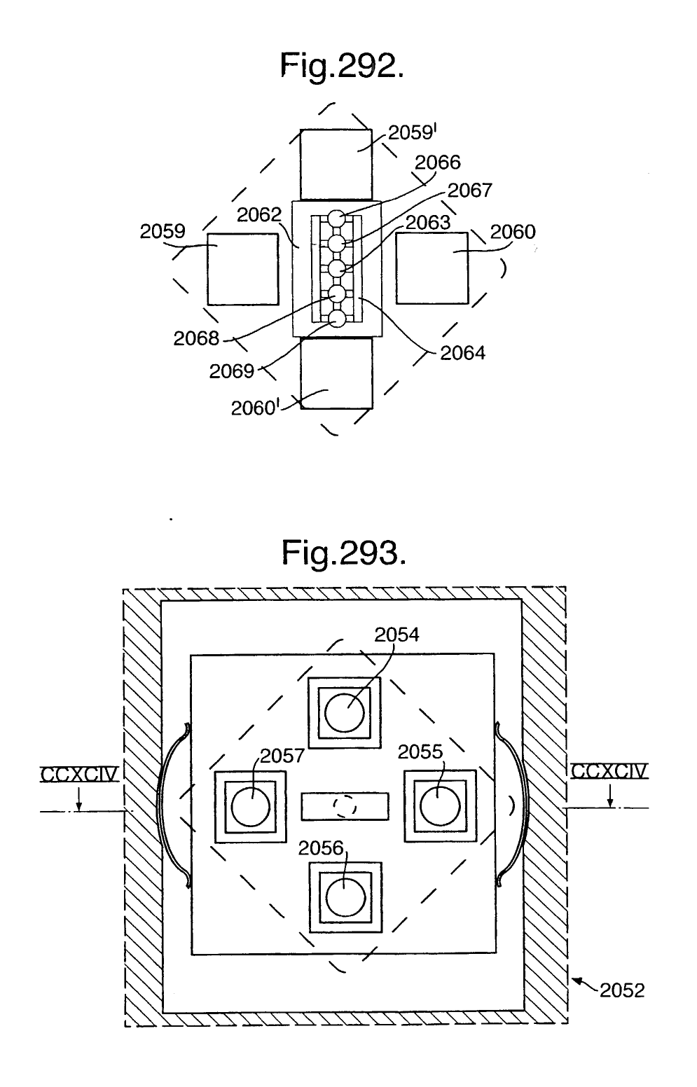

The invention will now be explained further with reference to that shown in FIGS. 289-294. In these figures the operating device has a control element 2053 that is stepwise displaceable relative to the operating device housing 2052, where the control element in the stepwise positions is tiltable for activating at least one switch function. The switch function can be represented by the switches as indicated in FIG. 293 by the reference numerals 2054-2057. The control element 2053 is tiltably mounted in a sliding body 2058 that is movable relative to said housing 2052. The said switches 2054-2057 may, for example, be spring switches or microswitches, and the switches are electrically connected to the housing, for example, by means of sliding contacts 2059, 2059′, 2060 and 2060′. The switches 2054-2057 are respectively actuatable by the control element 2053 on the tilting thereof relative to the sliding body 2058 when the sliding body is in a defined position. The movement of the control element is controllable by means of a ball 2061 that is spring-loaded and is arranged to actuate membrane switches 2062, 2063 and 2064 in the chosen example. Disposed between the ball 2061 and the membrane on which the switches are located, is a layer of material 2065 that is provided with a plurality of grooves and respective holes for positioning the sliding body of the control element, and for actuating, with the aid of the ball, a membrane switch at the position defined by the respective hole. The control element 2053 is by means of its sliding body 2058 sideways displaceable in each step position, and the sideways movement will either cause activation of a membrane switch, such as the membrane switch 2062 or 2064 in such sideways position as a toggle or tilting function of the sliding body 2058, or cause the control element 2053 to make a tilting movement and switch function actuation in such sideways position. It will be seen that for each step position of the sliding body 2058 the ball 2061 will actuate a respective membrane switch, indicated by the reference numerals 2066, 2067, 2063, 2068 and 2069 in FIGS. 292. Sideways movement in each of these step positions will activate sideways membrane switches, generally indicated here by the reference numerals 2062 and 2064. Since external equipment could easily detect that no movement of the sliding body 2058 from one position to the next has been made when a switch 2062 or 2064 is activated, it will be understood that the sliding body still has the defined position. Thus, the switches 2062 and 2064 could consist of a single elongate switch. However, it may be as expedient in fact to provide separate switch points aligned with the centrally arranged switch points just mentioned.

Referring more closely to that shown in FIG. 291, it will thus be understood that the solution shown here permits a total of fifteen possible positions of the control element 2053 together with its sliding member, so that there is a total of 60 possible activatable switch functions in this solution of the operating device.

In the solution shown in FIGS. 295-298 the control element is per se of the same type as that shown and described in connection with, inter alia, FIGS. 200-202.

It will be seen in this solution that the control element 2069, together with its sliding member 2070, is movable sideways relative to the operating device housing 2071 in order to execute a switch function initiated by the sideways movement when activating a switch, such as one of the switches 2072, 2073, 2074 or 2075 mounted on a wall face of the housing 2071 that faces the control element and its sliding member 2070. It will be seen that transmission of signals from the switches 2076, 2077, 2078 and 2079 and from the respective membrane switches, indicated by the reference numerals 2080 and 2081, can take place across the housing 2071 via sliding contact connection between the sliding body 2070 and the housing 2071, represented by the sliding contact 2082, 2083, 2084 and 2085. As shown in connection with FIGS. 299-300, and which represents a modification of that shown in FIGS. 200-202, the control element, indicated here by the reference numeral 2086, can be surrounded by a preferably rotatable switch actuating ring 2087, which is so designed that when turning and/or depressed it actuates at least one of a plurality of functional elements, for example, switches, indicated here by the reference numerals 2088, 2089, 2090 and 2091.

The control element 2086 and the switch actuating ring 2087 will be independently rotatable and depressible for selective actuation of the respective switches 2092-2095 and 2088-2091. Advantageously, but not necessarily, all the switches included in this illustrated solution can consist of membrane switches. Rotation of the switch actuating ring 2087 can be detected by means of, for example, sliding contact that is moved over contact points, or by using a device on the ring that actuates membrane switches. However, this is not shown in the figures.

The switches that can be activated by the control element 2086 are indicated by the reference numerals 2092, 2093, 2094 and 2095 in FIGS. 299, 300 and 301. The membrane switches that are arranged to detect the rotational position of the control element 2086 on actuation by the balls 2096 and 2097 are indicated by the reference numerals 2098-2103 in FIG. 299, these last-mentioned switches preferably being membrane switches.

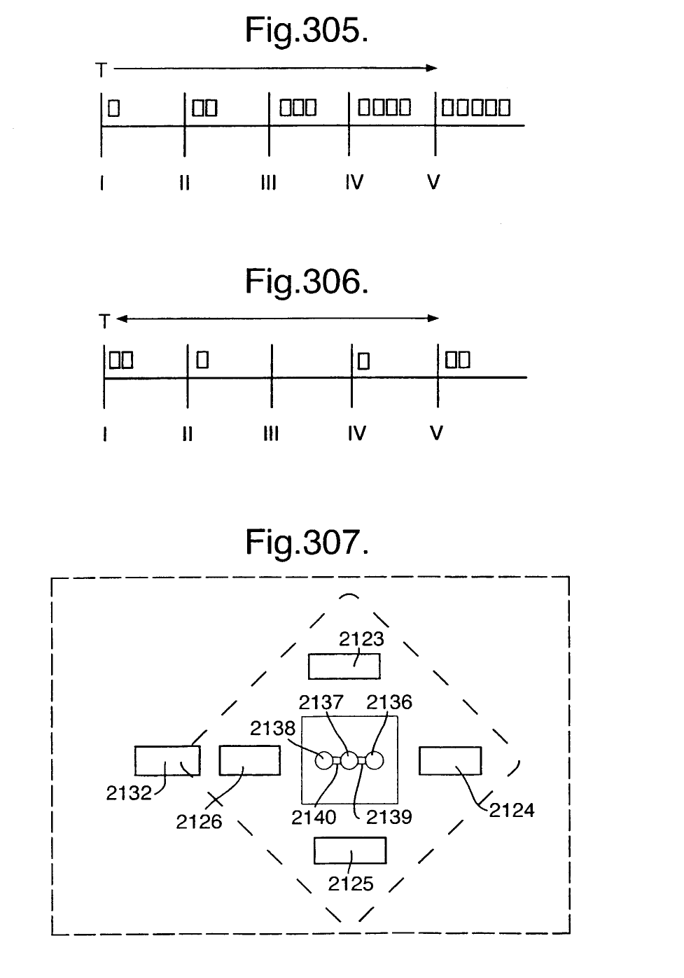

A variant of the solution shown in, for example, FIGS. 293, 294 and 297, 298 can be seen from FIGS. 303-306. In this embodiment there is a control element 2104 that is arranged so as to be displaceable relative to the operating device housing 2105, the control element being mounted on a sliding body 2106. The control element 2104 is tiltable relative to the sliding body 2106 so as to cause activation of at least one switch function connected with the switches 2107, 2108, 2109 and 2110, where these switches are preferably spring switches or microswitches with a spring resistance. If other types of switches are chosen, it will be necessary to provide a spring mechanism between the sliding body and the control element. The switches 2107-2110 will thus be actuatable by the control element 2104 when it is tilted relative to the sliding body. As shown in more detail in FIGS. 303 and 304, the said switches are supported by the sliding body and electrical connection with external equipment, e.g., in connection with the operating device housing 2105 is effected via sliding contacts 2111, 2112 as shown in FIG. 304. The aim here is to be able to make a sideways movement of the control element 2014 relative to a starting position, such as the starting position shown in FIG. 303 in the direction of a wall 2105′ or 2105″. When the control element 2104 is pushed to the side, the sliding member will also be moved with it, so that at least one side, such as the side 2106′ or 2106″ will help to operate a switch function that is formed either by a switch on the wall 2105′ or by interacting switch parts on the wall and on the sliding body, these interacting switch parts in FIGS. 303 and 304 being indicated by the reference numerals 2113, 2113′ and 2114, 2114′ respectively. The sliding body 2106 is held in place by springs 2115, 2116 at each end. The illustrated solution with a short sideways shift to one side or the other is intended to simulate a larger and previously described sliding function. In this case it is intended that the illustrated solution in FIGS. 303 and 304 should be able to replace five stepwise sliding positions. As an example, it is possible that the control element 2104 is pressed repeatedly towards the left, so that the contact 2114, 2113′ is closed. These movements will thus simulate a longer movement path of the sliding body. Alternatively, the contact time may be determining for the number of steps that are simulated. In this connection, it is conceivable that the user of the operating device will, for example, be given a light signal or sound signal that indicates the number of steps the control element 2104 apparently moves through. In this connection, as indicated in FIG. 305, it is possible that for each simulated step position a specific number of pulses is required. It is thus also possible that the contacts 2133, 2133′ are capacitive units or magnets which in a pulsating manner are sought to be driven apart, and that activating pulses will thus be felt by the user of the operating device. In the solution indicated in FIG. 306, it is assumed that the control element 2104 will at all times be in the centre position (as shown in FIGS. 303, 304) or will move back to this centre position. Movement of the switch in one direction or the other will cause the message that the control element 2104 has been moved to be given via a microprocessor. In this case, a pulse can be given, and will either, as suggested above, be felt by the user's finger or a light or sound signal could be given. If the control element 2104 is released so that it returns to its centre position, the user has thus come one step further. If the control element is held in one outer position or the other, it will be reflected that a further step has been taken. The solution shown in FIGS. 307-309 represents a further development of that shown and described in connection with FIGS. 303-306.

The same principles per se are applied here as described above, but in this case the pulse generator is not located in connection with a wall switch or interacting switch parts on the wall and on the sliding body. The control element is indicated here by the reference numeral 2117 and is tiltable relative to a sliding body 2118. On the sliding body there are mounted spring-loaded switches 219-220, 221, 222 which are actuatable by the control element 2117 when it is tilted relative to the sliding body 2118. To enable transmission of signals from the switches 2119-2122, sliders and sliding contacts, in

FIG. 307 indicated by the reference numeral 2123, 2126, are provided. When the control element 2117 and with it the sliding member 2118 is pushed sideways, a spherical body 2127 in connection with the sliding body 2118 will actuate membrane switches 2128, 2129 and 2130. These membrane switches will actuate a switch 2131 via sliding contacts 2132, so that the switch 2131 is fed with electrostatic or electromagnetic pulsing, depending upon which switch 2128, 2130 is actuated. The switch is spring-loaded by a spring 2133 and has elements 2134 and 2134′ that may be in the form of electrostatic units or electromagnetic devices, so that this is an attraction or a repulsion that is felt by the user as a movement. The switch 2131 is thus not a switch in the true meaning of the word, but a device that has contacts which are either attracted to one another or lose contact.

Other forms of noticeable displacement are of course conceivable within the scope of the invention. As will also be seen from FIG. 307, the ball 2127 will run over the membrane switches 2128-2130. Disposed between the ball and the membrane is a layer of material 2135 provided with a plurality of grooves and holes, generally indicated in FIG. 309 by the reference numeral 2136, but in FIG. 307 indicated by the reference numerals 2136, 2137 and 2138 for the respective switch positions of the switches 2130, 2129 and 2128, and where the grooves between these holes are indicated by the reference numerals, 2139, 2140. The respective holes 2136-2138 will thus cause positioning of the sliding body 2118 of the control element, and the ball 2127 will actuate a respective membrane switch at the position defined by a respective hole.

In the solution shown in FIGS. 310-313 the same principle per se is used as that used in connection with FIGS. 303-306 and 307-309. Here, the control element is indicated by the reference numeral 2141 and is mounted on a sliding member 2142. As in the preceding embodiments, the sliding member is equipped with switches 2143-2146 which can be actuated by the control element 2141 when it is tilted relative to the sliding member 2142. Signals from the switches can be transmitted via sliding contacts, in FIG. 310 indicated by the reference numerals 2147-2150. A ball located on the sliding member 2142 is indicated by the reference numeral 2151 and is arranged to actuate switches, preferably membrane switches, indicated by the reference numerals 2152, 2153, 2154. In addition, a motor 2155 is provided on the sliding body 2142, and this motor receives power transmission via sliding contacts 2156. The operation of the motor for rotating in one direction or the other is caused by activation of one of the switches 2152-2154 when the control element 2141 with the sliding member 2142 is pushed to one side or the other against the action of the springs 2157 and 2158. The motor 2155 drives a cam 2159 which actuates a ball 2160 that is connected to a spring 2161. Each time the motor 2155 is run and the ball 2160 is moves across the top of the cam 2159, the spring 2160 will move towards the right, as shown by the dotted line in FIG. 311. When the control element 2141 with the sliding member 2142 is moved to one side or the other, the cam will rotate one way and when the sliding movement takes place in the other direction, the cam will rotate in the opposite direction. The spring 2161 is preferably a powerful spring and will give definite feedback to the user's finger when the spring 2161 with its ball 2160 snaps back into a depression in the cam 2159 after passing an elevation. Other conceivable methods of marking are of course possible within the scope of the invention, and that shown here therefore merely serves as an illustration of a typical exemplary embodiment.

The repeated switch function operations or the duration of the switch functions will thus be adapted to be able to simulate step movements of the sliding member relative to the operating device housing.

Although the embodiments shown in FIGS. 303-312 are associated with a non-rotatable control element, it will of course be conceivable within the scope of the invention to modify the solution by, for example, implementing the principles that are linked to, for example, the embodiment shown in FIGS. 295-298 and 299-302.

1. An operating device, e.g., for telephones, mobile telephones, remote control units, text and character transmitters, calculators, electronic planners or the like, where the device has a control element that is actuatable by an operator's finger to execute at least two function commands, and preferably where the movement of the control element is indicatable, where the device has a slide that is longitudinally and stepwise movable in a housing, where the control element is mounted on the slide, and where the device has optoelectronic equipment for detecting the stepwise movement of the slide, characterised in
that movably arranged on the first slide is a control button having a switch actuating member projecting down through an opening in the slide, wherein this member on its underside is provided with a plurality of switch element actuating pins;
that located in the said housing and spaced from the underside of the first slide is a plurality of switch elements that are positioned two-dimensionally, so that stepwise positioning of said slide and tilting or depression of the switch actuating member causes the coordinate-determined position of at least one pin to correspond to the coordinate-determined position of the respective switch element, whereby a switch element at the position in question will be activated on the depression of the control button and the contact of the boss with the switch element.

2. An operating device as disclosed in claim 1, characterised in
that the switch actuating member has three pins, one of which is greater in length than the other two.

3. An arrangement as disclosed in claim 2, characterised in
that the two shortest pins are arranged to be able to actuate a respective switch element either separately timewise, and that the longest pin is only arranged to operate one switch element at a time.

4. An operating device as disclosed in claim 1, characterised in
that the switch actuating member is triangular and has three pins of equal length, and where the pins are located at corners of the triangle.

5. An operating device as disclosed in claim 1, characterised in
that the switch actuating member is square and has four pins of equal length that are located at the corners of the square.

6. An arrangement as disclosed in claim 4 or 5, characterised in
that the pins are designed to actuate a respective switch element separately timewise.

7. An arrangement as disclosed in claim 1 or 3, characterised in
that provided in the control button are two elongate, parallel holes of the same cross-sectional dimension along their length, and where the hole interacts with respective tilt and guide pins provided in said opening in the slide.

8. An arrangement as disclosed in claim 3, 4, 5, or 6, characterised in
that provided in the control button is one elongate hole having a cross-sectional dimension that diminishes from each end towards the central part of the hole, and where the hole interacts with a tilt and guide pin provided in said opening in the slide.

9. An operating device as disclosed in any one of claims 1-8, characterised in
that the switch is mechanical, e.g., of the switch-pad or microswitch type or the like.

10. An operating device as disclosed in any one of claims 1-8, characterised in
that the switch is capacitive-acting.

11. An operating device as disclosed in any one of claims 1-10, characterised in
that there are provided three parallel rows of switch elements.

12. An operating device as disclosed in claim 11, characterised in
that arranged between the switch elements in each row are supporting bridges for the pins, so that the control button cannot tilt between step positions of the slide.

13. An operating device, e.g., for telephones, mobile telephones, remote control units, text and character transmitters, calculators, electronic planners or the like, where the device has a control element that is actuatable by an operator's finger to execute at least two function commands, and preferably where the movement of the control element is indicatable, where the device has a control button that is tiltable relative to the operating device housing, and where the device has switch elements for actuating on the manipulation of the control button, e.g., by tilting, at least one of the switch elements, characterised in
that the control button is equipped with a downward projecting, central, spring-supported boss that is rounded at the bottom;
that the boss is tiltably supported on a shaft in the housing and, preferably against spring action, movable along a limited part of the shaft;
that the shaft is tiltable relative to the housing;
that projecting from the boss, transverse to the direction of the shaft, there is a pair of oppositely oriented projections;
that provided in the said housing and spaced from the underside of the control button is a plurality of switch elements that are positioned two-dimensionally;
that in a first pair of switch elements each one is designed to be actuated by a respective end area of the shaft on the tilting thereof in one direction or the other;
that in a second pair of switch elements each one is designed to be actuated by a respective projection when the control button and its boss are tilted about the shaft in one direction or the other;
that in a third pair of switch elements each one is designed to be actuated by the boss on its sliding movement in a respective direction on the shaft.

14. An operating device as disclosed in claim 13, characterised in
that the switch elements are mechanical, e.g., of the switch-pad or microswitch type or the like.

15. An operating device as disclosed in claim 13, characterised in
that the switch elements are capacitive-acting.

16. An operating device as disclosed in claim 13, characterised in
that the housing has shoulders that come to bear against the underside of the control button when it is moved relative to the shaft, so as to prevent tilting of the control button during such movement.

17. An operating device as disclosed in claim 13 or 14, characterised in
that the boss of the control button is supported by a leaf spring having bent ends, where a respective end, on depression actuated by the movement of the boss along the shaft, causes activation of a respective switch element in the third pair.

18. An operating device as disclosed in one or more of preceding claims 13-17, characterised in
that also arranged in the housing and surrounding the control button boss is a control wheel that is stepwise rotatable relative to the housing and the boss;
that the control wheel when tilted down in one of a plurality of positions relative to the housing is arranged to actuate a respective switch element in a fourth or fifth pair of switch elements; and
that provided in the housing under the control wheel is a light source-light receiver pair unit that registers the rotational movement of the control wheel by detecting alternate light reflecting and non-reflecting markings of the underside of the control wheel.

19. An operating device as disclosed in claim 18, characterised in
that the fourth pair of switch elements is aligned with the first pair of switch elements.

20. An operating device as disclosed in one or more of preceding claims 13-19, characterised in
that the fifth pair of switch elements is aligned with the second pair of switch elements.

21. An operating device as disclosed in one or more of preceding claims 13-20, characterised in
that the third pair of switch elements is aligned with the first pair of switch elements.

22. An operating device, e.g., for telephones, mobile telephones, remote control units, text and character transmitters, calculators, electronic planners or the like, where the device has a control element that is actuatable by an operator's finger to execute at least two function commands, where the device has a slide that is longitudinal and movable relative to a housing, where the control element is mounted on the slide, the movement of the control element and/or the slide preferably being indicatable, and where the device has optoelectronic equipment for detecting the movement of the slide, in characterised in
that arranged on the slide is a movable control button which on an operation selected from the group consisting of depression, sideways tilting, forward tilting and backward tilting, is arranged to initiate a switch function of at least one switch element;
that the slide is movable forwards or backwards against spring action from a neutral position to a respective end position:
that provided on the underside of the slide are projections arranged to block passage of light between a light source and a light receiver when the slide is in an end position.

23. An operating device, e.g., for telephones, mobile telephones, remote control units, text and character transmitters, calculators, electronic planners or the like, where the device has a control element that is actuatable by an operator's finger to execute at least two function commands, where the device has a slide that is longitudinally movable relative to a housing, where the control element is mounted on the slide, the movement of the control element and/or the slide preferably being indicatable, and where the device has optoelectronic equipment for detecting the stepwise movement of the slide, characterised in
that arranged on the slide is a movable control button which when depressed or tilted sideways is arranged to initiate a switch function in a least one switch means;
that provided on the slide is a pair of light channels in the longitudinal direction of the slide;
that provided on the slide in connection with each light channel is a light blocking means for optionally blocking the passage of light through one or both light channels on operation of the control button; and
that the slide is stepwise movable forwards or backwards against spring action.

24. An operating device, e.g., for telephones, mobile telephones, remote control units, text and character transmitters, calculators, electronic planners or the like, where the device has a control element that is actuatable by an operator's finger to execute at least two function commands, where the device has a slide that is longitudinally and stepwise movable relative to a housing, where the control element is mounted on the slide, the movement of the control element and/or the slide preferably being indicatable, and where the device has optoelectronic equipment for detecting the movement of the slide, characterised in
that provided in the slide are two pairs of longitudinal light channels;
that light sources and light receivers for each light channel are arranged at respective ends of the movement path of the slide, or that at least the light receivers are arranged at an end of a respective light channel;
that arranged on the slide in connection with each pair of the light channels is a light blocking means for optionally blocking the passage of light through one or more light channels;
that arranged on the slide are two movable, spring-supported control buttons, which on operation selected from the group consisting of sideways tilting, forward tilting and backward tilting, are arranged to initiate the blocking of the passage of light through one or more light channels;
that the slide is stepwise movable forwards or backwards against spring action.

25. An operating device as disclosed in claim 23 or 24, characterised in
that provided on the underside of the slide is a means for transmission or non-transmission of light between a light source and a light receiver when the slide is in an end position.

26. An operating device as disclosed in claim 23 or 24, characterised in
that through the slide transverse to its longitudinal direction there is provided at least one through-going light channel, and that in the housing opposite the longitudinal sides of the slide there is provided a plurality of light sources and light receivers respectively, so that on the movement of the slide a light path is successively formed between a light source and a light receiver.

27. An operating device as disclosed in claim 23, characterised in
that a first of the control buttons is arranged to be capable of being tilted sideways or tilted forwards, and that a second of the control buttons is arranged to be capable of being depressed, tilted sideways or tilted backwards.

28. An operating device as disclosed in one or more of claims 24-27, characterised in
that the first control button is arranged to move one blocking means or the other to a first blocking position thereof which blocks one channel in a pair of channels.

29. An operating device as disclosed in one or more of claims 24-28, characterised in
that the second control button is arranged to move one and/or the other blocking means to a second blocking position thereof which blocks both channels in a pair of channels.

30. An operating device as disclosed in one or more of preceding claims 24-29, characterised in
that the control buttons are provided with a pressing block for pushing the blocking means sideways in the direction away from the control button.

31. An operating device as disclosed in one or more of preceding claims 24-26, characterised in
that the first control button is provided with a gripper block for drawing the blocking means sideways in the direction of the centre of the first control button; and
that the second control button is provided with a pressing block for pushing the blocking means sideways in the direction away from the control button.

32. An operating device as disclosed in one or more of claims 24-26 and 31, characterised in
that the first and second control buttons are arranged to move one or the other of the blocking means to a first or second blocking position thereof respectively that blocks one channel in a pair of channels.

33. An operating device as disclosed in one or more of claims 24-26, 31 and 32, characterised in
that a maximum of two channels are blockable to light at the same time.

34. An operating device, e.g., for telephones, mobile telephones, remote control units, text and character transmitters, calculators, electronic planners or the like, where the device has a control element that is actuatable by an operator's finger to execute at least two function commands, where the device has a slide that is longitudinally and stepwise movable relative to the device housing, where the control element is mounted on the slide, the movement of the control element and/or the slide preferably being indicatable, characterised in
that the slide is positionable in n predetermined step positions, where n=1, . . . k, and k<20;
that movably arranged on the slide is a tiltable, optionally also depressible control button which on its underside is provided with a plurality m of switch element actuating pins, where m=2, 3 or 4;
that located on the slide and underlying respective ones of said actuating pins is an equal plurality m of first switch members that are movable and activatable by said pins;
that the first switch members all have the same electric potential; and
that a base plate is provided in the form of a printed circuit board and furnished with a plurality n×m of second switch members which form in each of said n step positions potential, respective pressure contact for the m first switch members.

35. An operating device, e.g., for telephones, mobile telephones, remote control units, text and character transmitters, calculators, electronic planners or the like, where the device has a control element that is actuatable by an operator's finger to execute at least two function commands, where the device has a slide that is longitudinally and stepwise movable relative to the device housing, where the control element is mounted on the slide, the movement of the control element and/or the slide preferably being indicatable, characterised in
that the slide is positionable in n predetermined step positions, where n=1, . . . k, and k<20;
that arranged on the slide are two independently movable, sideways tiltable and respectively forward and backward tiltable control buttons, where each control button on its underside is provided with a plurality m of switch element actuating pins, where m=2, 3 or 4;
that located on the slide and underlying respective ones of said actuating pins is an equal plurality m of first switch members that are movable and activatable by said pins;
that the first switch members all have the same electric potential; and
that a base plate is provided in the form of a printed circuit board and furnished with a plurality n×m of second switch members which form in each of said n step positions potential, respective pressure contact for the m first switch members.

36. An operating device as disclosed in claim 34, characterised in
that the control button is forward-tiltable in the direction of the direction of movement of the slide or transverse to the direction of movement.

37. An operating device as disclosed in claim 34, characterised in
that the m first switch members are divided into two or three parallel rows that extend in the direction of movement of the slide.

38. An operating device as disclosed in claim 34 or 35, characterised in
that optionally disposed between the slide and the base plate are n electrically insulating slide-sliding plates equipped with n×m holes that are aligned with respective ones of said n×m of second switch members.

39. An operating device, e.g., for telephones, mobile telephones, remote control units, text and character transmitters, calculators, electronic planners or the like, where the device has a control element that is actuatable by an operator's finger to execute at least two function commands, and preferably where the movement of the control element is indicatable, where the device has a slide that is longitudinally and stepwise movable in a housing, where the control element is mounted on the slide, and where the device has optoelectronic equipment for detecting the stepwise movement of the first slide, characterised in
that movably arranged on the slide is a two-part control button consisting of two intertelescopic button parts which both extend through an opening in the slide, where a first of the button parts on its underside is made having at least two switch element actuating pins, and where a second of the button parts on its underside is provided with just one switch element actuating pin; and
that located in said housing and spaced from the underside of the slide is a plurality of switch elements that are positioned two-dimensionally, so that stepwise positioning of said slide and either tilting or depression of the two-part button or depression of only the second button part causes a coordinate-determined position of at least one button to correspond to a coordinate-determined position of a respective switch element, whereby a switch element at the position in question will be activated upon depression of the control button and the contact of the boss with the switch element.

40. An operating device as disclosed in claim 39, characterised in
that on the first switch part there are three or four pins.

41. An arrangement as disclosed in claim 39 or 40, characterised in
that provided in the first part of the control button are two elongate, parallel holes of equal cross-sectional dimension along their length, and where the holes interact with respective tilt and guide pins provided in said opening in the slide.

42. An operating device as disclosed in any one of claims 39-41, characterised in
that the switch is mechanical, e.g., of the switch-pad or microswitch type or the like.

43. An operating device as disclosed in any one of claims 39-41, characterised in
that the switch is capacitive-acting.

44. An operating device as disclosed in any one of claims 49-41, characterised in
that there are provided three parallel rows of switch elements.

45. An operating device, e.g., for telephones, mobile telephones, remote control units, text and character transmitters, calculators, electronic planners or the like, where the device has a control element that is actuatable by an operator's finger to execute at least two function commands, and preferably where the movement of the control element is indicatable, where the device has a slide that is longitudinally and stepwise movable in a housing, where the control element is mounted on the slide, and where the device has equipment for detecting the stepwise movement of the slide, characterised in
that movably arranged on the slide is a control button having a part projecting downward through an opening in the slide, where this part is provided with two downward tiltable arms projecting transverse to the direction of movement of the slide, each of which is arranged on manipulation of the control button to bend downwards one or the other or both of said projections, and where each projection at an outer end thereof has a switch element actuating pin;
that the downward projecting part has on its underside a switch element actuating button which at each step position of the slide comes into engagement with and activates a switch element for indication of a coordinate position of the slide;
that located in said housing and spaced from the underside of the slide is a plurality of switch elements that are positioned two-dimensionally, so that stepwise positioning of said slide and tilting or depression of the control button causes the coordinate-determined position of at least one pin to correspond with the coordinate-determined position of a respective switch element, whereby a switch element at the position in question will be activated on depression of the control button and the contact of the boss with the switch element.

46. An arrangement as disclosed in claim 45, characterised in
that the pins are designed to actuate a respective switch element separately timewise.

47. An arrangement as disclosed in claim 45 or 46, characterised in
that provided in the control button is an elongate hole having the same cross-sectional dimension along its length, and where the hole interacts with a tilt and guide pin provided in said opening in the slide.

48. An operating device as disclosed in any one of claims 45-47, characterised in
that the switch elements are mechanical, e.g., of the switch-pad or microswitch type or the like and/or capacitive-acting.

49. An operating device as disclosed in one or more of claims 45-48, characterised in
that there are provided three parallel rows of switch elements, where the outer rows are actuated by said projections, whilst the central row is actuated by the pin on the underside of the downward projecting part.

50. An operating device, e.g., for telephones, mobile telephones, remote control units, text and character transmitters, calculators, electronic planners or the like, where the device has a control element that is actuatable by an operator's finger to execute at least two function commands, and preferably where the movement of the control element is indicatable, where the device has a functional part that is stepwise movable and has equipment for detection of such movement, where the operating device consists of an endless belt that is passed over two opposing rotating rollers, where at least one of the rollers has a means that interacts with a detector means for detecting the stepwise rotation of the roller, characterised in
that located under the upper surface of the belt is a control button that is tiltable to both sides, and also forwards and backwards, and which in these respective tilting positions is arranged to actuate a respective switch element.

51. An operating device, e.g., for telephones, mobile telephones, remote control units, text and character transmitters, calculators, electronic planners or the like, where the device has a control element that is actuatable by an operator's finger to execute at least two function commands, and preferably where the movement of the control element is indicatable, where the device has a functional part that is stepwise movable and has equipment for detection of such movement, where the operating device consists of an endless belt that causes two opposing rotating rollers to have coordinated rotation, where at least one of the rollers has a means that interacts with a detector means for detecting the stepwise rotation of the roller, characterised in
that disposed between the rollers is a control button that it tiltable to both sides, and also forwards and backwards, and which in these respective tilting positions is arranged to actuate a respective switch element.

52. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, characterised in
that the control element is stepwise rotatable 360° and is arranged to activate a spring-loaded switch located centrally under the control element on depression of the control element at any point on its upper surface; and
that a means is provided for detecting the stepwise rotational movement of the control element.

53. A device as disclosed in claim 52, characterised in
that said detecting means consists of at least one switch that is arranged to sense a toothed peripheral portion of the control element.

54. A device as disclosed in claim 52, characterised in
that said detecting means consists of at least one optoelectronic detector that is arranged to detect the passing of markings provided on the control element as it is rotated.

55. A device as disclosed in claim 52, characterised in
that said detecting means consists of at least one sliding contact that senses an annular portion of the underside of the control element, and where said portion consists of alternating electrically conductive and non-conductive areas.

56. An operating device, e.g., for telephones, mobile telephones, remote control units, text and character transmitters, calculators, electronic planners, computer equipment, games equipment, alarm equipment, access control equipment, control equipment or the like, where the device has a first control element that is actuatable by an operator's finger to execute at least two function commands, and a second control element surrounding the first control element and that is actuatable by an operator's finger to execute at least two function commands, characterised in
that the first control element is arranged to be non-rotatable and to selectively activate one of four spring-loaded switches located under the peripheral area of the control element on depression of the first control element at predetermined points spaced 90° apart on a peripheral area of its surface; and
that the second control element interacts with a means for detecting its stepwise rotational movement, the second control element being stepwise rotatable 360° and arranged to activate a spring-loaded switch located centrally under the first control element on depression of the second control element at any point on its surface.

57. A device as disclosed in claim 56, characterised in
that said detecting means consists of at least one switch that is arranged to sense a toothed peripheral portion of the second control element

58. A device as disclosed in claim 56, characterised in
that said detecting means consists of at least one optoelectronic detector that is arranged to detect the passing of markings located on the second control element as it is rotated.

59. An operating device, e.g., for telephones, mobile telephones, remote control units, text and character transmitters, calculators, electronic planners, computer equipment, games equipment, alarm equipment, access control equipment, control equipment or the like, where the device has a first control element that is actuatable by an operator's finger to execute at least two function commands, and a second control element surrounding the first control element and that is actuatable by an operator's finger to execute at least two function commands, characterised in
that the first control element is arranged to be non-rotatable and to selectively activate one of four spring-loaded switches located under the peripheral area of the control element on depression of the control element at predetermined points spaced 90° apart on a peripheral area on its surface; and
that the second control element interacts with a means for detecting its stepwise rotational movement, the second control element being stepwise rotatable 360° and arranged to selectively activate one of four spring-loaded switches located under the first control element and spaced 90° apart on depression of the second control element at the position for such a switch.

60. A device as disclosed in claim 59, characterised in
that said detecting means consists of at least one switch that is arranged to sense a toothed peripheral portion of the second control element.

61. A device as disclosed in claim 59, characterised in
that said detecting means consists of at least one optoelectronic detector that is arranged to detect the passing of markings located on the second control element as it is rotated.

62. A device as disclosed in claim 63, characterised in
that said detecting means consists of at least one sliding contact that senses an annular portion on the underside of the second control element, where said portion consists of alternating electrically conductive and non-conductive areas.

63. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, characterised in
that the control element interacts with means for detecting its stepwise rotational movement, the control element being stepwise rotatable 360° and arranged to selectively activate one of four spring-loaded switches located under the peripheral area of the control element, and spaced 90° apart, on depression of the control element at the position of such a switch;
that the control element has an annular portion that is wholly or sectionally transparent; and
that light sources are placed under said portion at the positions of said switches.

64. A device as disclosed in claim 63, characterised in
that the control element surrounds a centrally located switch element.

65. A device as disclosed in claim 63, characterised in
that the switch element is arranged to be non-rotatable and to selectively activate one of four spring-loaded switches located under the peripheral area of the control element on depression of the switch element at predetermined points, spaced 90° apart, on a peripheral area of its surface.

66. A device as disclosed in claim 63, characterised in
that the switch element is stepwise rotatable 360° and is arranged to activate a spring-loaded switch centrally located under the control element on depression of the switch element at any point on its surface.

67. A device as disclosed in claim 64, characterised in
that the light sources are placed at the positions of the switch element switches.

68. An operating device, e.g., for telephones, mobile telephones, remote control units, text and character transmitters, calculators, electronic planners, computer equipment, games equipment, alarm equipment, access control equipment, control equipment or the like, where the device has a first control element that is actuatable by an operator's finger to execute at least two function commands, and a second control element surrounding the first control element and that is actuatable by an operator's finger to execute at least two function commands and, characterised in
that the first control element is arranged to be non-rotatable, but sideways movable and/or tiltable relative to a centre position thereof;
that located centrally under the first control element is a spring-loaded switch that is ctivatable on depression of the control element, preferably at any point on its surface;
that centre position deviation detectors are provided for detecting the direction and extent of movement of the first control element;
that the second control element interacts with a means for detecting its stepwise rotational movement, the second control element being stepwise rotatable 360° and arranged to selectively activate one of four spring-loaded switches located under the second control element and spaced 90° apart, on depression of the control element at the position of such a switch.

69. An operating device, e.g., for telephones, mobile telephones, remote control units, text and character transmitters, calculators, electronic planners, computer equipment, games equipment, alarm equipment, access control equipment, control equipment or the like, where the device has a controlling member (control element) that is actuatable by an operator's finger to execute at least two function commands, characterised in
that the controlling member is arranged to be non-rotatable, but sideways movable and/or tiltable relative to a centre position thereof,
that located centrally under the controlling member is a spring-loaded switch that is activatable on depression of the controlling member, preferably at any point on its surface;
that centre position deviation detectors are provided for detecting the direction and extent of movement of the controlling member.

70. A device as disclosed in claim 68, characterised in
that said rotation detecting means consists either of at least one switch that is arranged to sense a toothed peripheral portion of the second control element or of a tilting switch that is arranged to register both the direction of rotation of the second control element and each step of the rotational movement.

71. A device as disclosed in claim 68, characterised in
that said rotation detecting means consists of at least one optoelectronic detector that is arranged to detect the passing of markings located on the second control element as it is rotated.

72. A device as disclosed in claim 68 or 69, characterised in
that the centre position deviation detector consists of:
a) a sensor ring located on an underside area of the first control element; and
b) a ring of contact points over which the sensor ring can be moved, the number of contact points contacted by the sensor ring being a function of the centre position deviation of the first control element, and the points that are contacted indicate the direction of movement of the control element.

73. A device as disclosed in claim 68 or 69, characterised in
that the centre position deviation detector consists of:
a) a sensor ring surrounding a lower part of the first control element; and
b) a ring of equidistant contact points or pins towards which the sensor ring can be moved for contact with one or more of these, the number of contact points contacted by the sensor ring being a function of the centre position deviation of the first control element, and the points that are contacted indicate the direction of movement of the control element.

74. A device as disclosed in claim 68 or 69, characterised in
that the centre position deviation detector consists of:
at least two resistors that are arranged at angle of 90° to one another to form x, y elements, the resistors being contacted by their respective sliding contact located on the underside of the first control element, the detected x and y resistance values being a function of the centre position deviation of the first control element and the direction of movement of the control element.

75. A device as disclosed in claim 68, characterised in
that the centre position deviation detector consists of:
at least two resistors that are arranged at angle of 90° to one another to form x, y elements, the resistors being contacted by their respective sliding contact which forms a linkage having a common centrally located control pin on the underside of the first control element, detected x and y resistance values being a function of the centre position deviation of the first control element and the direction of movement of the control element.

76. A device as disclosed in claim 68 or 69, characterised in
that the detector has two x-related resistors and two y-related resistors.

77. A device as disclosed in claim 75 or 75, characterised in
that the sliding contacts of the x-resistor are rigidly connected to one another via said linkage; and
that the sliding contacts of the y-resistor are rigidly connected to one another via said linkage.

78. A device as disclosed in claim 68 or 69, characterised in
that the centre position deviation detector consists of:
at least two curved resistors whose centres are at an angle of 90° to one another for forming x, y elements, the resistors being contacted by their respective sliding contact which forms a linkage with a common centrally located guide pin on the underside of the first control element or the controlling member, detected x and y resistance values being a function of the centre position deviation and direction of movement of the first control element or controlling member.

79. A device as disclosed in claim 78, characterised in
that each sliding contact is mounted on an arm which has a fixed centre of rotation at the centre of curvature of the respective resistor; and
that the arm at its end opposite the position of the sliding contact has an elongate slot for interaction with said guide pin when the guide pin moves in response to the centre position deviation of the first control element or controlling member.

80. A device as disclosed in claim 68 or 69, characterised in
that the centre position deviation detector consists of:
a) at least two optoelectronic detectors facing the underside of the first control element or controlling member and which are oriented at an angle of 90° to one another to form x and y elements; and
b) a graphic pattern, e.g., a plurality of concentric rings, located on the underside of the first control element or controlling member,
wherein the combined x and y detection of the said graphical pattern is a function of the centre position deviation and direction of movement of the first control element or controlling member.

81. A device as disclosed in claim 68 or 69, characterised in
that the centre position deviation detector consists of:
a) a supporting cross with its ends anchored in, or in communication with, a common base member, and with its central point anchored in a central pin that projects down from the underside of the first control element or controlling member;
b) a first strain gauge set that forms strain sensors in the x-direction and is located on at least one of the arms of the supporting cross;
c) a second strain gauge set that forms strain sensors in the y-direction and is located on at least one other of the arms of the supporting cross;
wherein the deformation of the supporting cross arms detected by said two of strain gauge sets is a function of the centre position deviation and direction of movement of the control element, or controlling member.

82. A device as disclosed in claim 81, characterised in
that each strain gauge set consists of at least two strain gauges; and
that each supporting cross arm is provided with at least one strain gauge.

83. A device as disclosed in claim 68 or 69, characterised in
that the centre position deviation detector consists of:
an annular body secured to the base part of the device and surrounding a peripheral portion of the lower part of the first control element or controlling member, and where an annular body on a wall portion thereof facing the first control element or the controlling member is equipped with a plurality of spring-loaded contacts that abut against said peripheral portion, and where one or more of the contacts are activated as a function of the centre position deviation and direction of movement of the first control element or controlling member.

84. A device as disclosed in claim 83, characterised in that the contacts form either electromechanical switches or capacitive sensors.

85. A device as disclosed in claim 68 or 69, characterised in
that the centre position deviation detector consists of:
a plurality of contact pairs placed in a ring;
a sinuous or waved annular spring placed around the first control element or controlling member and spaced apart therefrom, and which also surrounds the ring of contact pairs, where the wave crests of the annular spring abut against annular supporting wall which surrounds the annular spring and is secured to the base part of the device, and where the wave troughs of the annular spring are secured to one end of a respective spoke of a plurality of spokes which extend from the spring via the space between adjacent pairs of contacts to a hub that is secured to the first control element or controlling member;
wherein sideways movement and/or tilting of the first control element or controlling member in a desired direction draws a portion or portions of the annular spring towards contacts of adjacent pairs of contacts, and where the number of activated contacts thus indicates the centre position deviation and direction of movement of the first control element or controlling member.

86. A device as disclosed in one or more of claims 68-85, characterised in
that the first control element or controlling member is held in and returned to the centre position by centring means selected from the group consisting of:
a) blocks or a ring of a flexible material, e.g., rubber;
b) at least three springs that bear against a peripheral portion of the control element or controlling member;
c) two pairs of springs which via connecting arms actuate a central pin on the control element or controlling member;
d) a disc of a flexible material;
e) a plurality of spring-loaded blocks which bear against a peripheral portion of the control element or controlling member;
f) a mulitarmed resilient clamping cross;
g) a plurality of spring-loaded contacts that abut against a lower peripheral portion of the first control element or controlling member;
h) a sinuous or waved annular spring placed around the first control element, or controlling member, but spaced therefrom, where the wave crests of the annular spring abut against an annular supporting wall that surrounds the annular spring and is secured to the base part of the device, and where the wave troughs of the annular spring are fastened to one end of a respective spoke,
a plurality of spokes which each extend from the spring to a hub that is fastened to the first control element or controlling member.

87. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, characterised in
that the control element is arranged to be 360° rotatable and tiltable sideways relative to a centre position thereof;
that there is provided a means for detecting the centre position deviation of the control element when it is tilted;
that the device has a non-rotatable tilting platform which when the control element is tilted beyond a certain resistance threshold is designed to activate at least one of a plurality of spring-loaded switches arranged under the tilting platform at the periphery thereof;
that from the centre of the tilting platform there extends upwards a support and pivot pin for the control element; and
that the control element interacts with a means for detecting its stepwise rotational movement.

88. A device as disclosed in claim 87, characterised in
that said rotation detecting means consists of at least one switch that is arranged to sense a toothed wall portion of on the control element.

89. A device as disclosed in claim 87, characterised in
that said rotation detecting means consists of a tilting switch that is arranged to register both the rotational direction of the control element and each step of the rotational movement.

90. A device as disclosed in claim 87, characterised in
that the said rotation detecting means consists of optoelectronic detectors which face the underside of the control element to detect the movement of markers on the underside of the control element as it rotates stepwise.

91. A device as disclosed in claim 87, characterised in
that the number of switches is at least four and they are spaced apart at equal angles.

92. A device as disclosed in claim 87, characterised in
that said centre position deviation detectors consist of:
strain gauge sets equidistant from one another, preferably 90° apart, in connection with said pin and the tilting platform for detecting the tilting of the control element in the x and y direction.

93. A device as disclosed in claim 87, characterised in
that the control element is held in its centre position and returned thereto by means of the spring tension effect provided by said switches.

94. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, characterised in
that the control element is cylindrical in shape and arranged to be rotatable 360° about a horizontal axis and supported on a non-rotatable, but sideways tiltable and depressible drum;
that provided on the drum at an outer portion thereof is a detector means for detecting the stepwise rotation of the control element relative to the drum, e.g., by detecting optical markings or physical indentations on an area of the control element that faces the drum;
that the drum is supported on a base and spring-supported by means of a centrally located spring to take up a neutral position relative to the base; and
that the drum against the action of the spring
a) on tilting to one side or the other caused by the actuation of the control element is arranged to activate one or two switches, and
b) on central depression of the control element is arranged to actuate both the switches.

95. A device as disclosed in claim 94, characterised in
that the base part is supported in a centre position deviation detector that detects small tilting movements of the control element relative to its neutral position or centre position, and that the centre position deviation detector consists of:
a) a supporting cross or a beam having its ends anchored in a common base, and having its midpoint anchored in a central pin that extends down from the base part, and
b) strain gauge sets that form strain sensors on the supporting cross or beam, the strain that is detectable by said strain gauge sets being a function of the deviation from the centre position of the control element and the direction of movement of the control element.

96. A device as disclosed in claim 95, characterised in
that each strain gauge set consists of at least two strain gauges; and
that each supporting cross arm is provided with at least one strain gauge.

97. A device as disclosed in any one of preceding claims 68-86, characterised in
that the first control element or the controlling member on its upper surface is provided with a capacitive sensor.

98. A device as disclosed in any one of preceding claims 68-86 characterised in that the first control element and the second control element together form a capacitive sensor.

99. A device as disclosed in any one of preceding claims 87-93, characterised in that the control element is provided with a capacitive sensor.

100. An operating device, e.g., for telephones, mobile telephones, remote control units, text and character transmitters, calculators, electronic planners, computer equipment, games equipment, alarm equipment, access control equipment, control equipment or the like, where the device has a first control element that is actuatable by an operator's finger to execute at least two function commands, and a second control element that surrounds the first control element and is actuatable by an operator's finger to execute at least two function commands, characterised in
that the first control element is arranged to be non-rotatable, but sideways movable is and/or tiltable relative to a centre position thereof;
that the centre position deviation detector is provided to detect the direction and extent of movement of the first control element;
that the second control element interacts with a means for detecting its stepwise rotational movement, the second control element being stepwise rotatable 360°, spaced apart, spring-loaded switches on depression of the control element at the position of such a switch; and
either
that the surface of the first control element is provided with a capacitive-acting sensor, or
that the first control element and the second control element together form a capacitive-acting sensor.

101. A device as disclosed in claim 100, characterised in
that located centrally under the first control element is a spring-loaded switch that is activatable on depression of the first control element, preferably at any point on its surface.

102. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, characterised in
that the control element is arranged to be rotatable 360° and sideways tiltable relative to a centre position thereof;
that there is provided a means for detecting the centre position deviation of the control element when it is tilted;
that the control element interacts with a means for detecting its stepwise rotational movement; and
that the surface of the control element is provided with capacitive-acting sensor.

103. A device as disclosed in claim 102, characterised in
that the device has a non-rotatable tilting platform which on the tilting of the control button beyond a certain resistance threshold is arranged to be able to activate at least one of a plurality of spring-loaded switches located under the tilting platform at its periphery; and
that from the centre of the tilting platform there extends upwards a support and pivot pin for the control element.

104. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, where the control element is mounted on a slide and thus arranged to be movable stepwise along a path and caused in the individual stepwise positions to make a tilting movement or depression movement, and where the stepwise positions are detectable, characterised in
that the control element in each of said positions is tiltable sideways, forwards and/or backwards, and also optionally centrally depressible;
that the stepwise positions are detectable with the aid of a busbar on the base part of the device facing the underside of the slide and a row of contact points on the base part of the device facing the underside of the slide, and sliding contacts on the slide for contact with the busbar and successive ones of the contacts respectively, and spring-loaded contacts or breaker contacts in connection with the base part for selectively actuating by means of the chosen movement of the control element in a step position of the slide these contacts or breaker contacts so as to mark a selected function related to the position and tilt direction.

105. An operating device as disclosed in claim 104, characterised in that the control element has on a flanged portion thereof a conductive first ring, and that at an end portion of the movement path of the slide there is located a second ring made in the form of a resistor body or having a plurality of contact points, wherein on a composite tilting movement of the control element electric contact is thus formed.

106. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, where the control element is arranged to be movable stepwise along a path and caused in the individual stepwise positions to make a tilting movement or depression movement, and where the stepwise positions are detectable, for example, by means of optical detectors or electromechanical switches, characterised in
that the control element is via a pin supported in a support plate that is tiltable in the slide of the device and supported there by a spring-loaded switch; and
that strain gauges are fastened to the pin and on the supporting plate in order in a first function mode of the device to detect small tilting movements of the control element that do not activate the switch, and in a second function mode to simulate a multipoint switch, optionally in interaction with the spring-loaded switch, the strain gauges indicating the tilt direction of the control element.

107. A device as disclosed in claim 106, characterised in
that the electrical connection to the strain gauges is so designed that it is broken when the control element is depressed for activation of the spring-loaded switch.

108. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, where the control element is mounted on a slide and is thus arranged to be movable stepwise along a path and caused in the individual stepwise positions to make a tilting movement or depression movement, and where the stepwise positions are detectable, characterised in
that the control element in each of said positions is tiltable sideways, centrally depressible, and also tiltable forwards and/or backwards;
that the stepwise positions are detectable with the aid of a busbar on the base part of the device facing the underside of the slide and a row of contact points on the base part of the device facing the underside of the slide, and sliding contacts on the slide for contact with the busbar and successive ones of the contacts respectively, and spring-loaded contact pins in connection with the slide in order by means of the chosen movement of the control means in the step position of the slide to cause the contact pins via openings in the base part to form contact with position-adjusted areas on a touch screen located under the base part so as to mark the selected command related to the position and the tilt direction.

109. An operating device as disclosed in claim 108, characterised in that it forms a part of a cover that is tiltable relative to the touch screen housing.

110. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, where the control element is mounted on a slide and is thus arranged to be movable stepwise along a path and caused in the individual stepwise positions to make a tilting movement or depression movement, and where the stepwise positions are detectable, characterised in
that the slide is movable along two busbars;
that tilting or depression of the control element causes contact elements to form electrical contact with one or both busbars; and
that provided on a base part of the device are contact fields having spaced apart recesses in connection therewith for engagement with a spring-loaded ball and simultaneous stepwise electrical contact between two or three of the contact fields.

111. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, where the control element is mounted on a slide and is thus arranged to be movable stepwise along a path and caused in the individual stepwise positions to make a tilting movement or depression movement, and where the stepwise positions are detectable, characterised in
that the control element in each of said positions is tiltable sideways, forwards and/or backwards, and also optionally centrally depressible;
that the stepwise positions are detectable with the aid of a busbar on the base part of the device facing the underside of the slide and a row of contact points on the base part of the device facing the underside of the slide, and sliding contacts on the slide for contact with the busbar and successive ones of the contacts respectively, and spring-loaded contacts in connection with the slide in order by means of the chosen movement of the control element in a step position of the slide to actuate the contacts to form contact with at least one contact bar or a contact pad and thus mark a selected function related to the position and the tilt direction.

112. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, where the control element is mounted on a slide and is thus arranged to be movable stepwise along a path and caused in the individual stepwise positions to make a tilting movement or depression movement, and where the stepwise positions are detectable, for example, by means of optical detectors, characterised in
that the control element in each of said positions is tiltable sideways, forwards and backwards; and
that provided on the base part of the device that is beneath the device slide are four contact foils that are electrically insulated from one another and either are separate units or are made of a uniform piece of foil, respective pins on the control element being arranged to actuate the contact foils individually or several at a time on the said tilting or depression movements.

113. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, where the control element is arranged to be movable stepwise along a path and caused in the individual stepwise positions to make a tilting movement or depression movement, and where the stepwise positions are detectable, for example, by means of optical detectors or electromechanical switches, characterised in
that means are provided, for example, in the form of strain gauges, for detecting tilting movements of the control element relative to its neutral position; and
that the upper surface of the control element is provided with a capacitive-acting sensor.

114. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, where the control element is mounted on a slide and is thus arranged to be movable stepwise along a path and caused in the individual stepwise positions to make a tilting movement or depression movement, and where the stepwise positions are detectable, characterised in
that the control element is sideways tiltable or depressible relative to a supporting shaft;
that the control element on a surface thereof under the position of the supporting shaft is equipped with a plurality of engagement recesses, preferably four, for position-determining on stepwise engagement with a spring-loaded engagement ball on the slide the orientation of the control element relative to the slide;
that located in the control element is a light source or light receiver that is directed towards the base part of the device;
that arranged on the base part are at least three parallel rows of light receivers or light sources in the direction of movement of the slide and selectively aligned for light communication with said light source or said light receiver respectively when the control element is tilted to the desired position; and
that a light source and a light receiver are placed on the base part at the respective end of the movement path of the slide, and where the light path between them is broken when the control element is depressed.

115. A device as disclosed in claim 114, characterised in
that the position of the slide is determined with the aid of light communication between the light source (or light receiver) of the control element and a middle row of light receivers (or light sources).

116 A device as disclosed in claim 114 or 115, characterised in
that the position of the control element relative to the light receivers (or light sources) on the base member is confirmed by depression of the control element only when this is in a centre position, i.e., points down towards an element in said middle row.

117. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, where the control element is mounted in a depressible and stepwise tiltable manner relative to the device housing, and where the stepwise positions are detectable, characterised in
that the control element at its lower end is slidably mounted in a spherical body and arranged so as to actuate on axial depression movement a spring-loaded switch located in said body;
that provided in the body is a light source or light receiver which, when the control element is tilted, thereby adjusting the position of the body relative to the housing, can be brought into desired optical contact with one of a plurality of light receivers or light sources that are recessed in part of a wall portion that surrounds the body;
that the switch is arranged to activate the light source or light receiver provided in the body;
that the control element is tiltable forwards and backwards, and sideways to both sides;
that arranged on the surface of the spherical body are two rows of engagement recesses, each preferably having three engagement recesses spaced 90° apart, where each row is arranged for stepwise engagement with an associated spring-loaded engagement ball that projects from a point on the wall portion surrounding the body for selectively position-determining the orientation of the control element relative to the housing in a forward/backward direction and a sideways direction; and
that power supply to the light source or light receiver in the body takes place via sliding contact connections between the body and the surrounding wall portion.

118. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, where the control element is mounted in a depressible and stepwise tiltable manner relative to the device housing, and where the stepwise positions are detectable, characterised in
that the control element at its lower end is slidably mounted in a spherical body and arranged so that on axial depression movement it actuates a spring-loaded switch located in said body;
that the control element is tiltable forwards and backwards, and sideways to both sides;
that arranged on a wall surface of the device housing that surrounds the spherical body is a field of m rows and n columns of equidistant engagement recesses, where each row and each column is arranged for stepwise engagement with a spring-loaded engagement ball associated with the field that projects from a point on the surface of the body for selectively position-determining the orientation of the control element relative to the housing in a forward/backward direction and a sideways direction; and
that power supply to the switch in the body is takes place via sliding contact connections between the body and the surrounding wall portion.

119. A device as disclosed in claim 118, characterised in
that the engagement recesses are provided with electrically conductive contacts that are short-circuited by the spring-loaded ball.

120. A device as disclosed in claim 118, characterised in
that the engagement recesses are provided with electrically conductive contacts; and
that a current path through the spring-load ball is established on activation of said switch and thus a current path via one of said contacts in a respectively selected engagement recess.

121. A device as disclosed in claims 117 or 118, characterised in
that the number of engagement recesses related to one of the tilting movement planes is m;
that the number of engagement recesses related to a second of the tilting movement planes that is at 90° to the first tilting movement plane is n; and
that the number of possible tilting positions is m×n.

122. A device as disclosed in claim 117, 118 or 121, characterised in
that m=n=3.

123. An operating device as disclosed in one or more of preceding claims 108-126, characterised in
that the open portions facing the base part of the device and the slide, and functional elements placed on the base part, e.g., busbars, contact points and pads, optical detectors, wiring and the like, are covered by a set of slats through which the control element projects, the transverse edges of adjacent slats always overlapping each other when the control element is moved forwards and backwards, thereby moving the slats in their longitudinal direction.

124. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, and where the control element is stepwise rotatable relative to a plurality of stationary pressure switches that are selectively actuatable by the control element;
characterised in
that for detecting its rotational positions the control element is equipped with at least one spherical body which at step positions of the control element successively actuates step position related switches that are actuatable by the spherical body.

125. An operating device as disclosed in claim 124, characterised in
that the switches which are actuatable by the spherical body are membrane switches.

126. An operating device as disclosed in claim 124 or 125, characterised in
that the control element is equipped with two spherical bodies, where one of these always actuates a step position related switch and the other is located between two such switches.

127. An operating device as disclosed in claim 124, characterised in
that said pressure switches and step position related switches are formed by a touch screen; and
that the control element is rotatably arranged in a body that is tiltable relative to the touch screen.

128. An operating device as disclosed in claim 124, 125 or 126, characterised in
that the operating device is mounted in a stepwise movable slide; and
that a means is provided for sensing the position of the slide.

129. An operating device as disclosed in claim 128, characterised in
that both said pressure switches and said step position related switches consist of membrane switches arranged on a common base member; and
that said means for sensing the position of the slide consists of a spherical body arranged on the slide which successively actuates membrane switches on the base member on the stepwise movement of the slide.

130. An operating device as disclosed in claims 68, 69, 81 or 82, characterised in
that the device is arranged on a stepwise movable slide.

131. An operating device as disclosed in claim 68, 69 or 130, characterised in
that the centre position deviation detector consists of a strain gauge set that is positioned in cross shape directly on a printed circuit board, and that the control element is anchored in the circuit board in the centre of the cross shape.

132. An operating device as disclosed in claim 68 or claim 130 now dependent on claim 72, characterised in
that the first control element is provided with an actuatable switch in its upper surface.

133. An operating device as disclosed in claim 131, characterised in
that the first control element is arranged to interact with a plurality of spring-loaded breaker contact points, the breaker contact points preferably being arranged on the circuit board.

134. An operating device arrangement, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, and where the control element is stepwise rotatable relative to a plurality of stationary pressure switches that are selectively actuatable by the control element;
characterised in
that the control element has an exterior annular portion that is made having a toothed or corrugated surface, and a centrally located portion provided with a plurality of upright pins.

135. An arrangement as disclosed in claim 134, characterised in
that said pins extend upwards to a level with or a level below said surface.

136. An arrangement as disclosed in claim 134, characterised in
that the outer portion of the control element and its central portion are movable relative to one another.

137. A control element arrangement on an operating device for electronic equipment, where the control element is mounted on a slide that is stepwise movable along a path so as to be manipulated in the individual positions to actuate at least two switch functions in each of the step positions of the slide, characterised in
that the control element is approximately oval, elliptical, triangular or square; and
that the control element is provided with a central, concave portion that has a plurality of upright pins for forming friction with the finger operating the control element.

138. A operating device for electronic equipment, where the operating device has a multi-directional tiltable control element that is mounted on a stepwise movable slide, characterised in
that the control element is provided with at least two switch actuating pins;
that arranged on the slide is at least one switch actuating body, e.g., a spring-loaded ball; and
that the switches actuated by said pins and said body all consist of membrane switches that are arranged on a common base.

139. An operating device for electronic equipment, where the operating device has a multipoint depressible control element that is mounted on a stepwise movable slide, characterised in
that the control element is provided with a plurality of membrane switches and where the slide forms a common support for the membrane switches; and
that located under the slide and along the movement path is a plurality of additional membrane switches for successive activation of a respective step position of the slide.

140. An operating device for electronic equipment, where the operating device has a control element that is tiltably and depressibly mounted on a stepwise movable slide; characterised in
that the control element is supported centrally relative to the slide by a disc spring;
that a first switch is located centrally under the control element and is operatable on central depression of the control element; and
that at least two additional switches are located sideways away from the first switch and are selectively operatable by a respective tilting movement of the control element.

141. An operating device as disclosed in claim 140, characterised in
that the switches are membrane switches.

142. An operating device as disclosed in claim 140 or 141, characterised in
that the control element consists of a centrally depressible part that is arranged to actuate the first, centrally located switch and a part that surrounds the central part and is movable relative thereto arranged so as to actuate on tilting a respective one of several switches arranged sideways relative to the first switch.

143. An operating device for electronic equipment, where the operating device has a control element that is tiltably and depressibly mounted on a stepwise movable slide, characterised in
that the control element is tiltable and depressible on the slide in the direction of movement of the slide, the underside of the control element being shaped so as to actuate on depression movement two switches and on each respective tilting movement to also actuate two respective switches.

144. An operating device as disclosed in claim 143, characterised in
that the switches are membrane switches mounted on a common base in the direction of movement of the slide.

145. An operating device for electronic equipment, where the operating device has a control element means that is tiltably and depressibly mounted on a movable slide, characterised in
that said means consists of two control elements that are mounted jointly on the slide to be tiltable and depressible independent of each other in order to actuate switches in respective sets of switches, said switches in each set being mounted in the direction of movement of the slide, and wherein the underside of each slide is shaped so that on a depression movement it actuates two switches and on each tilting movement also actuates two respective switches.

146. An operating device s disclosed in claim 145, characterised in
that the switches are membrane switches.

147. An operating device for electronic equipment, where the operating device has a control element in the form of an endless belt that is in rolling engagement with at least two spaced apart rollers, where at least one of the rollers interacts with a means for detecting the movement of the belt and thus the movement of the rollers, and where the control element is sideways tiltable and depressible in order to actuate at least one switch function, characterised in
that each roller is spring-supported;
that each roller is independently depressible and tiltable relative to a common support unit for all the rollers, so as to cause a respective switch function.

148. An operating device as disclosed in claim 147, characterised in
that the switches are membrane switches, where preferably two of these are activated by each switch function.

149. An operating device for electronic equipment, where the operating device has a control element in the form of a roller that is rotatable and depressible in order to actuate at least one switch function, characterised in that the roller in addition to being centrally depressible is also sideways tiltable, is spring-supported; and
that the roller when depressed or tilted relative to a support unit causes two switches to be activated by each switch function, said switches being membrane switches.

150. An operating device as disclosed in claim 147, 148 or 149, characterised in
that the roller is supported in a cradle which on its underside is provided with a plurality of pins; and
that by each switch function two of the pins are activated for actuating respective membrane switches.

151. An operating device for electronic equipment, where the operating device has a control element in the form of at least one roller that is stepwise rotatable and depressible for actuating at least one switch function, characterised in
that the body of the roller is provided internally with a plurality of stationary, spring-loaded switches; and
that the roller has a surface layer that is movable relative to the rest of the roller body, said layer at defined portions thereof, seen in the axial direction, being depressible in order to actuate a respective switch.

152. An operating device as disclosed in claim 151, characterised in
that there is provided at least two rollers held apart from each other, and where the surface layer of the roller is defined by a belt that is passed over and is movable relative to the roller bodies.

153. An operating device as disclosed in claim 151, characterised in
that the roller body has a combined step movement and rotational direction sensing mechanism, wherein a flank on the roller has a rotatable part and a stationary part, and where the stationary part has spherical bodies that follow an undulating path in the rotatable part, and wherein one of the spherical bodies interacts with a breaker contact in order to sense the step movement, whilst the other spherical body interacts with one or the other of two contact points on respective turning of the roller for sensing the rotational direction.

154. An operating device, e.g., for telephones, mobile telephones, remote control units, text and character transmitters, calculators, electronic planners, computer equipment, games equipment, alarm equipment, access control equipment, control equipment or the like, where the device has a control element that is actuatable by an operator's finger to execute at least two function commands, and where the control element is tiltably mounted on a slide that is stepwise movable relative to a plurality of stationary switches that are selectively actuatable by the control element in each step position of the slide;
characterised in
that the slide for detecting the slide-based movement of the control element is equipped with at least one spherical body which on movement of the slide into step positions successively actuates step-position related switches, for example, membrane switches, actuatable by the spherical body, mounted on a base member.

155. An operating device as disclosed in claim 1, characterised in
that said switches are formed by a touch screen; and
that the control element is tiltably mounted in the slide, the slide being movable relative to the touch screen.

156. An operating device for electronic equipment, where the operating device has a control element that is sideways displaceable relative to a centre position, the control element in the centre position and the sideways displaced positions being tiltable for activating at least one switch function, characterised in
that the control element is tiltably mounted in a sliding body that is movable relative to the operating device housing;
that the sliding body is equipped with a plurality of switches, for example, spring switches or microswitches, where the switches are electrically connected to the housing, and where the switches are respectively actuatable by the control element on the tilting thereof relative to the sliding body when the sliding body either is in the said centre position or is in a sideways defined position; and
that displacement of the control element is controllable with the aid of a ball that runs over the membrane switches, between the ball and the membrane there being disposed a layer of material provided with a plurality of grooves that communicate with respective holes in order to position the sliding body of the control element, and also to actuate by means of the ball a membrane switch at the position defined by the respective hole.

157. An operating device for electronic equipment, where the operating device has a stepwise rotatable and in each position tiltable control element for activating at least one switch function,
characterised in
that the control element is stepwise rotatable through an angle that is less than 360°; and
that the control element in each stepwise position is arranged to selectively be able to operate one of four possible switch functions.

158. An operating device for electronic equipment, where the operating device has a control element that is stepwise displaceable relative the operating device housing, the control element in the stepwise positions being tiltable for activating at least one switch function,
characterised in
that the control element is tiltably mounted in a sliding body that is movable relative to the operating device housing;
that the sliding body is equipped with a plurality of switches, for example, spring switches or microswitches, where the switches are electrically connected to the housing, and where the switches respectively are actuatable by the control element on the tilting thereof relative to the sliding body when the sliding body is in a defined position; and
that displacement of the control element is controllable by means of a ball that runs across membrane switches, between the ball and the membrane there being disposed a layer of material provided with a plurality of grooves and respective holes in order to position the sliding body of the control element and to actuate by means of the ball a membrane switch at the position defined by the respective hole.

159. An operating device as disclosed in claim 158, characterised in
that the control element with its sliding body is sideways displaceable in each step position;
that the sideways movement either causes activation of a membrane switch in such sideways position as a toggle or tilting function, or enables the control element to make a tilting movement and switch function actuation in the sideways position.

160. An operating device as disclosed in one or more of claims 124-126,
characterised in
that the control element is sideways movable relative to the operating device housing in order to execute a switch function initiated by the sideways movement on activation of a switch located on a wall surface of the housing that faces the control element.

161. An operating device as disclosed in one or more of claims 124-126 and claim 160, characterised in
that the control element is rotatably supported in a sliding body that is sideways movable relative to the operating device housing to provide the sideways movement of the control element; and
that the sliding body is equipped with a plurality of switches, for example, spring switches or microswitches, where the switches are electrically connected to the housing, and where the switches respectively are actuatable by the control element on the tilting thereof in a desired step-rotated position relative to the sliding body when the sliding body is either in a centre position or in a sideways defined position.

162. An operating device as disclosed in one or more of claims 124-126,
characterised in
that the control element is surrounded by a, preferably stepwise, rotatable switch actuating ring, which is arranged so that when turned and/or depressed it actuates at least one of a plurality of functional elements, for example, switches.

163. An operating device as disclosed in claim 162, characterised in
that the control element and the switch actuating ring are rotatable independent of one another; and
that all the switches consist of membrane switches.

164. An operating device as disclosed in claim 162 or 163, characterised in
that the rotation of the switch actuating ring is detected by means of a sliding contact that is moved over contact points or by using a device on the ring that actuates membrane switches.

165. An operating device for electronic equipment, where the operating device has a control element that is displaceable relative to the operating device housing, the control element being tiltable for activating at least one switch function, characterised in
that the control element is tiltably mounted in a sliding body that is movable relative to the operating device housing;
that the sliding body is equipped with a plurality of switches, for example, spring switches or microswitches, where the switches are electrically connected to the housing and where the switches respectively are actuatable by the control element when it is tilted relative to the sliding body; and
that on sideways displacement of the control element relative to a starting position thereof towards a wall of the housing, thereby moving the sliding member, at least one side or area of the sliding member is arranged to operate a switch function linked to either
a) a switch on said wall,
b) interacting switch parts on the wall and on the sliding body,
c) a switch mounted in the sliding body, the switch being electrostatically or electromagnetically actuatable by a means that registers movement of the sliding member relative to the housing;
d) a switch that is actuatable by a motor driven cam, where the motor is controllable by a device that registers movement of the sliding member relative to the housing, or
e) light or sound-based markers on the sliding member or the operating device housing.

166. An operating device as disclosed in claim 165, characterised in
that either repeated switch function operations or the duration of the switch function are adapted to simulate step movements of the sliding body relative to the operating device housing.

167. An operating device as disclosed in claim 165, characterised in
that said device consists of a ball that runs over membrane switches, between the ball and the membrane there being disposed a layer of material provided with a plurality of holes and grooves therebetween, respective holes causing positioning of the sliding body of the control element, and wherein the ball actuates a membrane switch at the position defined by the respective hole.

168. An operating device as disclosed in at least one of claims 138, 139, 140, 154, 156, 158-160, and 165-167,
characterised in
that the control element is arranged to be capable of rotation in relation to the sliding body.
